(19) United States
(12) Patent Application Publication
(10) Pub. No.: US 2013/0040853 A1
(43) Pub. Date: Feb. 14, 2013

(54) Context Specific Genetic Screen Platform to Aid in Gene Discovery and Target Validation

(71) Applicants: Lynda Chin, Houston, TX (US); Timothy P. Heffernan, Sugar Land, TX (US); Ronald A. DePinho, Houston, TX (US)

(72) Inventors: Lynda Chin, Houston, TX (US); Timothy P. Heffernan, Sugar Land, TX (US); Ronald A. DePinho, Houston, TX (US)

(73) Assignee: Dana-Farber Cancer Institute Inc., Boston, MA (US)

(21) Appl. No.: 13/521,882

(22) PCT Filed: Jan. 21, 2011
(86) PCT No.: PCT/US11/22085

§ 371 Date: Sep. 20, 2012

Related U.S. Application Data
(60) Provisional application No. 61/297,143, filed on Jan. 21, 2010.

(51) Int. Cl. C40B 30/06

(52) U.S. Cl. 506/10

(57) ABSTRACT

The present invention relates to a context-specific forward genetic screen designed to systematically assign relative weight of biological evidence to a library of high-probability driver genetic elements in a genetically defined cancer-sensitized model system whose constellation of engineered mutations reflects a particular clinically relevant genetic subclass of a given tumor type. The screen may be formed in vivo or ex vivo. The screen allows for the formulation of clinical path hypotheses for targeting driver genetic elements and, in parallel, the rapid functional validation of the role of the driver genetic element(s) in the cancer. In this manner, the context-specific genetic screen can systematically assign the biological relevance of a library of genetic elements to a clinically-definable genetic and disease context, as well as inform combinations of drugs in the clinic such one uses one drug that targets the newly discovered genetic element or its protein and another drug that targets those genetic elements or its associated proteins which have been engineered into the primary cell model.

### RELATED APPLICATIONS

This application claims the benefit of U.S. Ser. No. 61/297,143, filed Jan. 21, 2010, the content of which is incorporated herein by reference in its entirety.

### FIELD OF THE DISCLOSURE

Embodiments of the present disclosure are directed to a context specific genetic screen platform to aid in gene discovery and target validation.

### BACKGROUND OF THE DISCLOSURE

Cancer is genetically heterogeneous and cancer gene functions are highly context-dependent. Cancer is driven by abnormalities in DNA sequence (e.g., mutations, copy number alterations, etc.) of the genes in its genome. The identification of genes that are somatically altered and hence drive oncogenesis has been a central aim of cancer research since the advent of recombinant DNA technology.

Development of targeted therapy for cancer has been shaped by the paradigms of oncogene addiction and tumor maintenance, stipulating that there are specific oncogenic lesions that a particular tumor is exquisitely dependent upon for viability. At the same time, the relative importance of these tumor maintenance targets appear to be dependent on the particular constellation of associated genetic alterations in each tumor, providing a potential basis for variable therapeutic responses in the clinic. Thus, knowledge of the genetic context in which a target serves a critical cooperative and rate-limiting role in tumor maintenance would illuminate the potential clinical development path for such targeted therapy.

Throughout this description, including the foregoing description of related art, any and all publicly available documents described herein, including any and all U.S. patents, are specifically incorporated by reference herein in their entirety. The foregoing description of related art is not intended in any way as an admission that any of the documents described therein, including pending United States patent applications, are prior art to embodiments of the present disclosure. Moreover, the description herein of any disadvantages associated with the described products, methods, and/or apparatus, is not intended to limit the disclosed embodiments. Indeed, embodiments of the present disclosure may include certain features of the described products, methods, and/or apparatus without suffering from their described disadvantages.

### SUMMARY OF THE DISCLOSURE

The present invention relates to the identification of genes and/or genetic elements that modulates a function or a phenotype associated with tumorigenesis of a cell.

According to some embodiments, there is provided a method of identifying a gene that modulates a function or a phenotype associated with tumorigenesis of a cell comprising one or more of the following steps: introducing into a cell representative of a given phenotype or histological type a nucleic acid library that comprises a collection of genetic elements of interest and an oncogene, and/or other genetic element associated with the oncogenic process, to produce a genetically engineered target cell having a cancer cell genotype; transplanting, e.g. orthotopically the target cell into a non-human mammal to produce a tumor in the mammal; and identifying in the tumor expression of one or more of the genetic elements of interest. In some embodiments, the cell representative of a given phenotype or histological type is a primary cell. In some embodiments, the primary cell is immortalized. In some embodiments, the cell representative of a given phenotype or histological type is a mammalian cell. In some embodiments, the cell representative of a given phenotype or histological type is a progenitor cell or stem cell. In some embodiments, the target cell is genetically engineered to express TERT.

The methods according to the present embodiments may further comprise inactivating or suppressing one of more tumor suppressor protein pathways in the cell representative of a given phenotype or histological type. The tumor suppressor protein pathway may be RB and/or p53.

The methods according to the present embodiments may further comprise a validation step or steps. In some embodiments, the validation step(s) may comprise the following: introducing into the target cells produced in step (a) an nucleic acid capable of modulating (i.e., increasing or decreasing) the expression of the genetic element identified in step (c) to produced a modified target cell; orthotopically transplanting the modified target cell into a non-human mammal; and determining whether the modified target cell reduces tumor formation in the mammal as compared to a control.

According to some embodiments, the nucleic acid library comprises siRNA, shRNA, microRNA or an antisense nucleic acid to the genetic elements of interest. In some embodiments, the nucleic acid library may comprise nucleic acids encoding inactive or dominant negative versions of the genetic elements of interest.

According to some embodiments, the oncogene used in the methods of the present embodiments is selected from one or more of the following: a BRAF oncogene; a NRAS oncogene; a KRAS oncogene; a PI3K oncogene; a PKCi oncogene; a HER2 oncogene; a APC oncogene; an EGFR oncogene; a PTEN KD oncogene; aNF1 KD oncogene; a Myr-AKT oncogene; a Myr-P110a oncogene; β-catenin oncogene; an EGFRvIII oncogene.

According the some embodiments, the one or more candidate genes or genetic elements of interest are selected from kinase genes and/or genetic elements. The kinases are wildtype kinases or activated mutant kinases.

According the some embodiments, the one or more candidate genes or genetic elements of interest are selected from phosphatase genes and/or genetic elements.

According the some embodiments, the one or more candidate genes or genetic elements of interest are selected from methyltransferase gene and/or genetic elements.

According the some embodiments, the one or more candidate genes or genetic elements of interest are selected from genes and/or genetic elements involved in the PI3K signaling pathway.

According the some embodiments, the one or more candidate genes or genetic elements of interest are selected from genes and/or genetic elements involved in a G-protein coupled receptor signaling pathway.

According the some embodiments, the one or more candidate genes or genetic elements of interest are selected from genes and/or genetic elements involved in the receptor tyrosine kinase signaling pathway.

According the some embodiments, the function or a phenotype associated with tumorigenesis is metastasis, cell migration, angiogenesis, extracellular matrix degradation, anchorage-independent growth, or anoikis.

According to some embodiments, there is provided a method for screening for biologically active agents that interact with an engineered tumorigenesis pathway. In some embodiments comprising one or more of the following steps: producing a genetically engineered target cell having a cancer cell genotype, said producing step comprising introducing into a cell representative of a given phenotype or histological type an oncogene and a one or more genes or genetic elements of interest linked to the oncogenic process associated with the oncogene; contacting the genetically engineered target cell with a candidate biologically active agent; and determining whether the biologically active agent affects the tumorigenic phenotype. The tumorigenic phenotype may be, for example, metastasis, cell migration, angiogenesis, extracellular matrix degradation, anchorage-independent growth, or anoikis.

### BRIEF DESCRIPTION OF THE DRAWINGS

FIG. 1 shows a schematic of a context-specific genetic screen.

FIG. 2A provides a schematic for the experimental design for a screen according to some embodiments of the present invention.

FIG. 2B provides a schematic of the canonical JNK signaling pathway. Kinases that were scored and validated in the experiment of Example 1 are circled.

FIG. 3 provides a summary of results using the methods according to some embodiments. During secondary validation screens with individual JNK signaling components, robust oncogenic activity was observed by both MAP2K₄ and MAPK9/JNK2 individually when transduced into HMEL-BRAF^{V600E} melanocytes, resulting in tumor formation within 16 weeks with penetrance of 30% and 50% respectively.

FIGS. 4A and 4B shows nuclear (activated) phospho-cJUN in a human melanoma specimen by immunohistochemistry. FIG. 4B shows Reverse-Phase-Protein Array analysis of 96 human melanoma specimens probed with phospho-JNK antibody. The red dashed line represents the baseline level of p-JNK in human melanocytes.

FIGS. 5A to 5D shows knockdown of JNK expression with an inducible shRNA by western blot. FIG. 5B is a representative experiment showing inhibition of anchorage independent growth in a human melanoma cell line (M619) upon knockdown of JNK2 with two independent shRNAs. FIG. 5C shows compilation data of soft agar assays in 4 human melanoma cell lines. FIG. 5D shows a western blot of 10 human melanoma cell lines probed with total and phospho-cJUN.

FIGS. 6A to 6D shows a table detailing the tumor penetrance of the HMEL xenograft lines T1 and T2 when two independent shRNAs targeting JNK2 are expressed. FIG. 6B is a representative picture of tumor size from the control group (−DOX) and the experimental group (+DOX). The lower panel shows a fluorescent picture showing RFP-shRNA targeting JNK2 expressed in the appropriate tumor samples. FIG. 6C shows the effect of JNK2 knockdown (+DOX) on tumor initiation. Data is graphed as tumor volume in mm³ over time. FIG. 6D is a comparison of tumor volume at the completion of the experiment.

FIGS. 7A and B show the effects of JNK2 knockdown on established tumor growth. DOX was added to mice water once tumors reached 100-200 mm³ and then tumor volume measured over time. These data suggest that JNK2 is required to maintain the growth of established tumor in vivo.

FIGS. 8A to 8D show the cooperation between BRAF, UV, and JNK. FIG. 8A is a western blot measuring the expression of JNK and cJUN in cells treated with increasing fluence of UVB. FIG. 8B represents a measure of colony formation in soft agar in which mouse melanocytes were transduced with wild type (WT) or mutant BRAF (V600E), treated with UVB, and then seeded in soft agar to measure transformation. These data suggest that the transforming effects of UV are context-dependent. FIG. 8C is a Kaplan-Meyer plot of tumor free survival of inducible BRAF transgenic mice treated +/−UVB on neonatal day 1. Aggressive melanomas formed in the inducible BRAF transgenic mice with higher penetrance upon treated with UVB. FIG. 8D shows nuclear (activated) p-cJUN staining in melanomas that formed in iBRAF mice treated with UV.

FIGS. 9A to 9D show the knockdown of JNK2 inhibits the growth of established human melanoma xenografts. A.) M619 (BRAF-mut) human melanoma cells were engineered to express two independent doxycycline-inducible JNK2 shRNAs and injected into NUDE mice. mice were randomly separated into two groups when tumors reached 150 mm³ in size and shRNA induced upon addition of doxycycline to the drinking water. Tumor size was measured and graphed over time. The experiment was terminated when control tumors approached 2 cm³. B.) Weight in grams of tumors at endpoint of study. C.) Western analysis showing JNK2 knockdown in dox treated animals. D.) QPCR of tumor RNA. * denotes dox-treated tumors.

FIGS. 10A and 10B shows genetic and cellular context determines selection of transforming kinases. A.) Schematic of experimental design. Context specific screens were performed to compare transformation of human melanocytes (hMEL-BRAF^{V600E}) and mouse astrocytes (mAst-INK4A/ARF−/−; PTEN−/−) by a focused kinase library. B.) Table listing kinases that conferred tumorigenicity to hMEL and mAST cell lines in vivo.

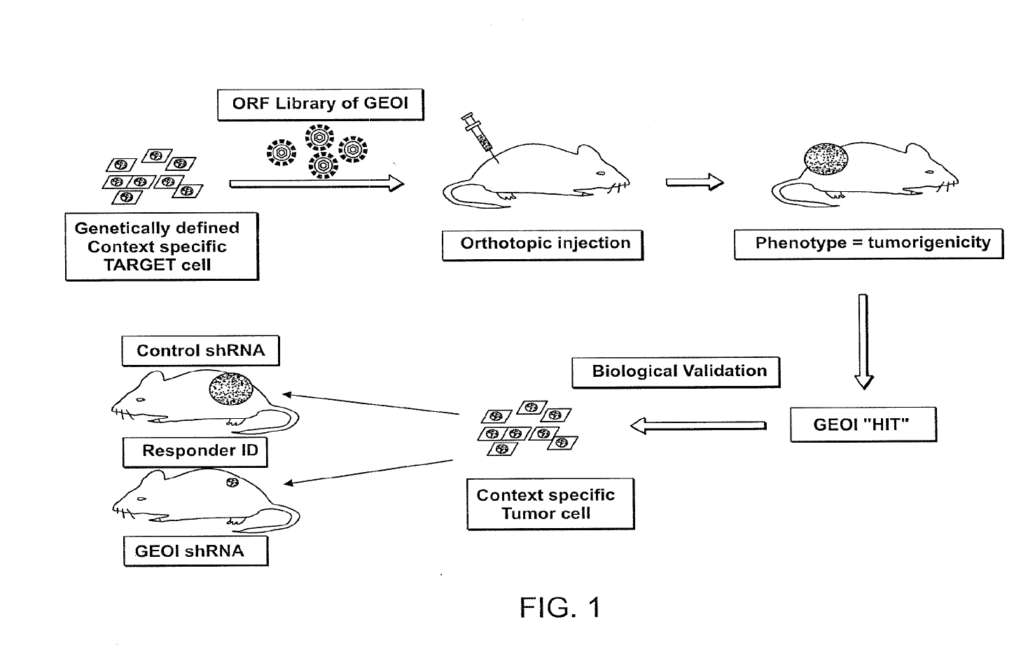

### DETAILED DESCRIPTION OF THE INVENTION

For the purposes of promoting an understanding of the principles of the invention, reference will now be made to the embodiments illustrated in the drawings, and specific language will be used to describe the same. It should nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

### Context Specific Functional Genetic Screen Platform

According to some embodiments, there is provided a genetic screen platform that can systematically assign upfront biological and clinical relevance in context of a functionality or phenotype to a library of GEOI (genetic elements of interest) for a specific clinically-definable genetic context. The genetic screen platform allows for the identification of new drug targets, and in parallel, the identification of new clinical path hypothesis which teaches which additional novel pathways act cooperatively with those pathways altered in the predetermined genetic context and therefore informs the use of single or combination targeted therapies directed towards the new cancer pathway and/or the known cancer pathway. New drug targets may be screened and identified in vitro or in vivo.

In some embodiments, the context-specific screen is composed of the following three elements: a population of target cells; a tumorigenesis or metastasis phenotypic model, and a GEOI library.

Example 1 of the specification provides a description of one context specific functional genetic screen according to the present embodiments that focuses on the identification of protein kinases that could cooperate with oncogenic BRAF in melanomagenesis. The example uses human TERT-immortalized melanocyte with p53 and RB inactivation (HMEL) transduced with oncogenic BRAF (BRAFV600E) as the Target Cell with highly relevant Genetic Context (i.e., BRAF is mutated in over 60% of human melanoma). This HMEL-BRAFV600E melanocyte is only weakly tumorigenic and does not form tumors readily in vivo. A focused driver kinase library containing sequenced verified ORFs for 110 of the most frequently mutated kinases in human cancers into a universal lentiviral vector. Lentiviruses expressing these kinases were then transduced into the Target Cells with pooled infections followed by transplantation into skin, the orthotopic site for melanoma (e.g. appropriate microenvironment).

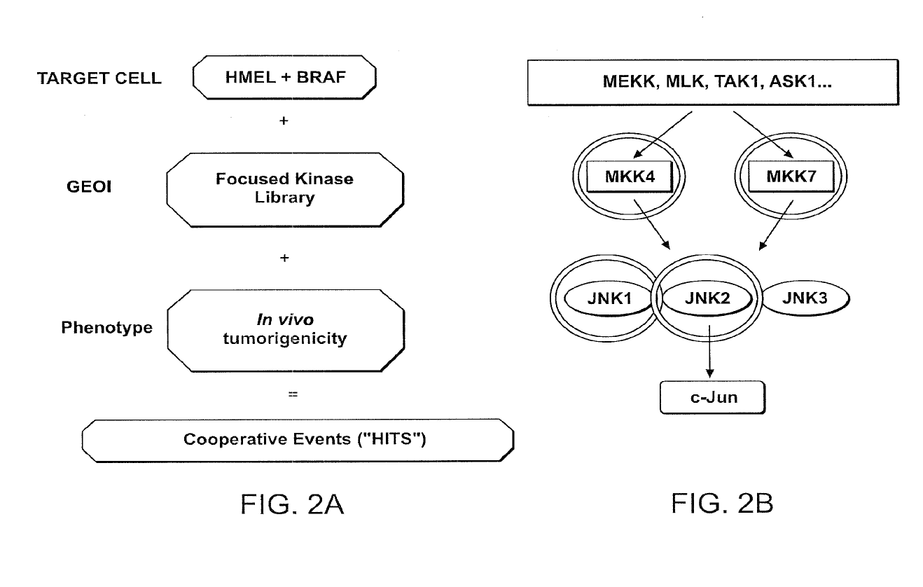

Library-transduced cells developed tumors more rapidly in vivo (relative latency 10-18 weeks) indicating presence in the library of kinases that can cooperate with BRAF* to drive transformation of TERT-immortalized melanocytes. Candidate cooperating kinases were next recovered from the resultant tumors by genomic PCR-sequencing. In this manner, we identified 14 recurrent “hits” (defined as positively selected for in more than one resultant tumor in vivo), indicating that 14 of the 110 driver kinases are likely to be true oncogenic drivers in BRAF mutated melanocytes in vivo. Moreover, the relative strength of functional activity can be inferred by recurrence, i.e. single hits would be considered less robust. When layered on pathway knowledge, we can further prioritize those hits in pathway(s) that might be enriched for. For example, all four core signaling mediators (both MAPKK and MAPK levels) of the JNK pathway scored (FIG. 2), a genetic profile that points to a strong preference (or requirement) for JNK activation in BRAF mutated melanocytes during in vivo tumorigenesis. The results immediately informs the clinical path hypothesis that JNK inactivation is therapeutically efficacious in BRAFV600E melanoma, and that concurrent inhibition of JNK and BRAF signaling is a rational combination strategy—a clear clinical path hypothesis that will guide not only validation and drug screening but also patient selection/stratification in clinical trials.

It is worth noting that in the above screen, there are 23 hits total of which 9 are single hits. These single hits are not discarded as a deeper screen may identify these genes as important targets in BRAF* melanomas as well as identify a new pathway beyond JNK to also target in these cancers. These single hits include, CAMKV, HSPB8, MARK1, PRKCH, SNRK, and TBCK.

### Target Cells

According to the some embodiments, the target cells are mammalian cells (e.g., human cells or murine cells) that have been engineered to harbor signature genetic alterations defined for the corresponding human or murine cancer types (i.e., genetic context). This genetic context defines the clinical path approach that can lead to an indication of the therapeutics, e.g. a disease type in a genetically defined subpopulation. Thus, the target cells are engineered according to the molecular and genomic knowledge of a particular tumor type.

In some embodiments, the target cells are engineered to express and/or overexpress one or more (e.g., 2, 3, 4, 5, 6, 7, 8, 9, etc.) oncogenes, thereby defining the genetic context of the cells. The oncogene may be any oncogene or gene for which mutations have been implicated in a cancer. For example, the oncogene may be any oncogene resulting from DNA sequence abnormalities and/or mutations leading the overexpression of the normal gene. Preferred examples of oncogenes include, but are not limited to, oncogenic forms of a gene selected from the groups consisting of: APC, ABL1, AR (androgen receptor), BRCA1, BRCA2, BRAF, BCL1, BCL2, BCL6, CBFA2, CSF1R, EGFR, ERBB2 (HER-2/neu), EGFRvIII, Flt-3, FOS, ras, NRAS, KRAS, HRAS, MDR1, MYB, MYC, LCK, MYCL1, MYCN, NRAS, p′73, Rb-1, Rb-2, ROS1, RET, SRC, Smad4, TCF3, TP53 (also known as p53), VHL, PI3K, PKCi, HER2, PTEN (Phosphatase and Tensin homolog deleted on chromosome Ten), aNF1 KD, Myr-AKT, Myr-P110a, β-catenin. The table below provides a list for preferred categories of oncogenes.

| Category | Examples |
|---|---|
| Growth factors, or mitogens | c-Sis |
| Receptor tyrosine kinases | epidermal growth factor receptor (EGFR), |
| | platelet-derived growth factor receptor |
| | (PDGFR), and vascular endothelial growth |
| | factor receptor (VEGFR), HER2/neu |
| Cytoplasmic tyrosine kinases | Src-family, Syk-ZAP-70 family, and BTK |
| | family of tyrosine kinases, the Abl gene in |
| | CML - Philadelphia chromosome |
| Cytoplasmic Serine/threonine | Raf kinase, and cyclin-dependent kinases |
| kinases and their regulatory | (through overexpression). |
| subunits | |
| Regulatory GTPases | Ras protein |
| Transcription factors | myc gene |

In some embodiments, the oncogene is selected from mutant oncogenic forms of p53 (TP53), p′73, ras, BRAF, APC (adenomatous polyposis coli), myc, VHL (von Hippel's Lindau protein), Rb-1 (retinoblastoma), Rb-2, BRCA1, BRCA2, AR (androgen receptor), Smad4, MDR1, and Flt-3.

In some embodiments, target cells are engineered with a constellation (e.g., one or more) cancer-relevant genetic alterations. The target cells may be engineered to express and/or overexpress one or more oncogenes using any method known in the art. For example, the target cells may be transiently or stably transfected or transduced with any suitable vector which includes a polynucleotide sequence encoding an oncogene. In some embodiments, target cells may be transiently or stably transfected or transduced with any suitable vector which includes a polynucleotide sequence encoding an oncogene and a suitable promoter and enhancer sequences to direct overexpression of the oncogene. The term “overexpression” as used herein in the specification and claims below refers to a level of expression which is higher than a basal level of expression typically characterizing a given cell under otherwise identical conditions.

According to some embodiments, the target cells may be further engineered to inactivate or suppress one or more tumor suppressor protein pathways. In some embodiments, the tumor suppressor protein pathways are the RB and p53 pathways. Thus, for example, the RB pathway may be suppressed or inactivated by further engineering the cell to express p53DD. The p53 pathway may be suppressed or inactivated by further engineering the cell to express CDK4-R24C.

In some embodiments, the target cells are non-tumor cells. Non-tumor cells include, but is not limited to, the following: primary cells (e.g., mouse, human, or other mammalian primary cell), stem or progenitor cells (e.g., stem or progenitor cells obtained from a primary tissue source). Optionally, the target cells are comprise a cell culture. By cell culture iit is meant a collection of two or more cells. The cells in the culture may be homogenous. Alternatively, the cells in the culture are heterogenous. The target cells may be an established cell line representative of a particular cell lineage. In some embodiments, the targets cells are primary cells representative of a particular cell lineage. In some embodiments, the targets cells are tumor naïve primary cells representative of a particular cell lineage. Thus, the target cell populations may be populations of primary cells from a tissue or organ. In some embodiments, the targets cells are primary cells obtained from a tissue in which human cancer develops. Accordingly, primary cells and cells lines may be obtained from a tissue or organ that includes, but is not limited to, the following: breast (e.g., ducts of the breast tissue), ovaries, testes, lungs, bladder, cervix, head and neck, skin, bone, prostate, liver, lung, brain, larynx, gall bladder, pancreas, rectum, parathyroid, thyroid, adrenal, thyroid, neural tissue, colon, stomach, endothelial, epithelial, adipose, muscle, bone marrow, heart, lymphatic system, bronchi, kidneys, and blood. Cells can be isolated from tissues for ex vivo culture using any method known in the art.

Most primary human cell cultures have limited lifespan. After a certain number of population doublings cells undergo the process of senescence and stop dividing, while generally retaining viability. Accordingly, in some embodiments, it may be desirable to establish or immortalize a cell line. The establishment of an immortalized cell line may be achieved using any method known in the art, such as, for example, artificial expression of the telomerase gene (e.g., TERT).

TABLE 1
Examples Context-Specific In Vivo Genetic Screens

| | | Host | | |
|---|---|---|---|---|
| Cancer | Tissue | Species | Immortalization | Genetic Elements |
| Melanoma | Primary | Human | hTERT | BRAF*, NRAS*, shPTEN |
| | Melanocytes | | | |
| Melanoma | Primary | Mouse | INK4A/ARF −/− | BRAF*, NRAS*, shPTEN |
| | Melanocytes | | | |
| Ovarian | Primary Ovarian | Human | hTERT | Myr-PIK3CA, Myr-AKT, |
| | Surface | | | MYC, PKCi |
| | Epithelial Cells | | | |
| Ovarian | Primary | Human | hTERT | Myr-PIK3CA, Myr-AKT, |
| | Fallopian Tubual | | | MYC, PKCi |
| | Epithelial Cells | | | |
| Breast | Primary | Human | hTERT | HER2, Cyclin D, |
| | Mammary | | | PIK3CA*, Triple Neg. |
| | Epithelial Cells | | | |
| GBM | Neural Stem | Human | Myc | EGFRvIII, shPTEN, |
| | Cells | | | shNF1, CDK4, PDGFRα |
| GBM | Primary | Human | hTERT | EGFRvIII, shPTEN, |
| | Astrocytes | | | shNF1, CDK4, PDGFRα |
| GBM | Primary | Mouse | INK4A/ARF −/−, | EGFRvIII, PTEN −/−, |
| | Astrocytes | | p53 −/− | shNF1, CDK4, PDGFRα |
| PDAC | Primary | Human | hTERT | KRAS*, p53DD, |
| | Pancreatic | | | shPTEN, shSMAD4 |
| | Ductal Epithelial | | | |
| | Cells | | | |
| PDAC | Primary | Mouse | NA | KRAS*, p53+/−, PTEN+/−, |
| | Pancreatic | | | SMAD4, INK4A/ARF |
| | Ductal Epithelial | | | +/− |
| | Cells | | | |
| LUNG | Primary | Human | hTERT | KRAS*, EGFR*, BRAF* |
| | Bronchiole | | | |
| | Epithelial Cells | | | |
| Colon | Primary Colonic | Human | hTERT | KRAS*, BRAF*, β- |
| | Epithelial Cells | | | catenin |

The table below identifies oncogenes and mutations according to some embodiments.

| GENE | CAN | Mutation |
|---|---|---|
| AKT | Amplified | |
| APC | Deleted | 331Δ, 1309Δ, 1941Δ |
| BRAF | | G469E, V600E |
| EGFR | Amplified | Activating VIII, L858R |
| HER2 | Amplified | |
| KRAS | | G12V, Q61K, Q61R |
| NF1 | Deleted | |
| NRAS | | G12V, Q61K, Q61R |
| PIK3CA | Amplified | E545K, H1047R |
| PKCi | Amplified | |
| PTEN | Deleted | |

The following examples are provided to illustrate what is meant by engineering the target cells to harbor signature genetic alterations defined for the corresponding human cancer types or to engineer the target cells to create a particular genetic context. For example, in human Burkitt's lymphoma, the C-MYC oncogene is translocated downstream of the enhancer of the immunoglobulin heavy chain gene, resulting in overexpression of C-MYC, which increases both the rate of cell division and chromosomal instability. Thus, in some embodiments, targets cells may be designed to express a C-MYC oncogene and/or overexpress C-MYC. The cells may be primary tumor naïve cells from lymphatic tissue.

HER2 overexpression has been observed in advanced ovarian cancer. Thus, in some embodiments, primary cells from non-tumor ovarian tissue may be engineered to express an HER2 oncogene and/or overexpress HER2.

Overexpression of HER2 has also been linked to converting noninvasive breast cancer into invasive disease. Thus, in some embodiments, tumor naïve primary cells from breast tissue may be engineered to express an HER2 oncogene and/or overexpress HER2.

p53 overexpression has been observed in human breast cancer. Thus, in some embodiments, tumor naïve primary cells from breast tissue (e.g., breast ducts) may be engineered to express a p53 oncogene, overexpress p53 allele harboring a dominant-negative mutation, and/or overexpress the MDM2 and/or MDM4 oncogene for example. In some embodiments, the target cells may be engineered as a knockdown of p53 or knockdown of ARF tumor suppressor.

Ras mutations are common in pulmonary adenocarcinomas of humans, mice, rats and hamsters. Thus, in some embodiments, tumor naïve primary cells from pulmonary tissue may be engineered to express a ras oncogene and/or overexpress ras harboring oncogenic mutations. In some embodiments, the target cells may be engineered with genetic alterations for Ras regulatory proteins (e.g., knockdown of NF-1).

The following table provides a list of genes for which mutations have been implicated in cancer suitable for use with the present embodiments.

TABLE 2
Genes for which mutations have been implicated in cancer

| | | | Cancer | Cancer | | | | |
|---|---|---|---|---|---|---|---|---|
| | | Gene | Somatic | Germ. | Tumor | Tissue | Mut | Translocation |
| Symbol | Name | ID | Mut | Mut | Types | Type | Type | Partner |
| ABL1 | v-abl Abelson | 25 | yes | | CML, | L | T, | BCR, ETV6, |
| | murine | | | | ALL, T- | | Mis | NUP214 |
| | leukemia viral | | | | ALL | | | |
| | oncogene | | | | | | | |
| | homolog 1 | | | | | | | |
| ABL2 | v-abl Abelson | 27 | yes | | AML | L | T | ETV6 |
| | murine | | | | | | | |
| | leukemia viral | | | | | | | |
| | oncogene | | | | | | | |
| | homolog 2 | | | | | | | |
| ACSL3 | acyl-CoA | 2181 | yes | | prostate | E | T | ETV1 |
| | synthetase | | | | | | | |
| | long-chain | | | | | | | |
| | family | | | | | | | |
| | member 3 | | | | | | | |
| AF15Q14 | AF15q14 | 57082 | yes | | AML | L | T | MLL |
| | protein | | | | | | | |
| AF1Q | ALL1-fused | 10962 | yes | | ALL | L | T | MLL |
| | gene from | | | | | | | |
| | chromosome | | | | | | | |
| | 1q | | | | | | | |
| AF3p21 | SH3 protein | 51517 | yes | | ALL | L | T | MLL |
| | interacting | | | | | | | |
| | with Nck, 90 kDa | | | | | | | |
| | (ALL1 | | | | | | | |
| | fused gene | | | | | | | |
| | from 3p21) | | | | | | | |
| AF5q31 | ALL1 fused | 27125 | yes | | ALL | L | T | MLL |
| | gene from | | | | | | | |
| | 5q31 | | | | | | | |
| AKAP9 | A kinase | 10142 | yes | | papillary | E | T | BRAF |
| | (PRKA) | | | | thyroid | | | |
| | anchorA protein | | | | | | | |
| | (yotiao) 9 | | | | | | | |
| AKT1 | v-akt murine | 207 | yes | | breast, | E | Mis | . |
| | thymoma viral | | | | colorectal, | | | |
| | oncogene | | | | ovarian, | | | |
| | homolog 1 | | | | NSCLC | | | |
| AKT2 | v-akt murine | 208 | yes | | ovarian, | E | A | . |
| | thymoma viral | | | | pancreatic | | | |
| | oncogene | | | | | | | |
| | homolog 2 | | | | | | | |
| ALK | anaplastic | 238 | yes | yes | ALCL, | L, E, M | T, | NPM1, TPM3, |
| | lymphoma | | | | NSCLC, | | Mis, A | TFG, TPM4, |
| | kinase (Ki-1) | | | | Neuroblastoma | | | ATIC, CLTC, |
| | | | | | | | | MSN, ALO17, |
| | | | | | | | | CARS, EML4 |
| ALO17 | KIAA1618 | 57714 | yes | | ALCL | L | T | ALK |
| | protein | | | | | | | |
| APC | adenomatous | 324 | yes | yes | colorectal, | E, M, O | D, | . |
| | polyposis of | | | | pancreatic, | | Mis, | |
| | the colon gene | | | | desmoid, | | N, F, S | |
| | | | | | hepatoblastoma, | | | |
| | | | | | glioma, | | | |
| | | | | | other | | | |
| | | | | | CNS | | | |
| ARHGEF | RHO guanine | 23365 | yes | | AML | L | T | MLL |
| 12 | nucleotide | | | | | | | |
| | exchange | | | | | | | |
| | factor (GEF) | | | | | | | |
| | 12 (LARG) | | | | | | | |
| ARHH | RAS homolog | 399 | yes | | NHL | L | T | BCL6 |
| | gene family, | | | | | | | |
| | member H | | | | | | | |
| | (TTF) | | | | | | | |
| ARNT | aryl | 405 | yes | | AML | L | T | ETV6 |
| | hydrocarbon | | | | | | | |
| | receptor | | | | | | | |
| | nuclear | | | | | | | |
| | translocator | | | | | | | |
| ASPSCR1 | alveolar soft | 79058 | yes | | alveolar | M | T | TFE3 |
| | Part sarcoma | | | | soft part | | | |
| | chromosome | | | | sarcoma | | | |
| | region, | | | | | | | |
| | candidate 1 | | | | | | | |
| ASXL1 | additional sex | 171023 | yes | | MDS, | L | F, N, | . |
| | combs like 1 | | | | CMML | | Mis | |
| ATF1 | activating | 466 | yes | | malignant | E, M | T | EWSR1, FUS |
| | transcription | | | | melanoma | | | |
| | factor 1 | | | | of | | | |
| | | | | | soft | | | |
| | | | | | parts, | | | |
| | | | | | angiomatoid | | | |
| | | | | | fibrous | | | |
| | | | | | histiocytoma | | | |
| ATIC | 5- | 471 | yes | | ALCL | L | T | ALK |
| | aminoimidazole- | | | | | | | |
| | 4- | | | | | | | |
| | carboxamide | | | | | | | |
| | ribonucleotide | | | | | | | |
| | formyltransferase/ | | | | | | | |
| | IMP | | | | | | | |
| | cyclohydrolase | | | | | | | |
| ATM | ataxia | 472 | yes | yes | T- | L, O | D, | . |
| | telangiectasia | | | | PLL, leukemia, | | Mis, | |
| | mutated | | | | lymphoma, | | N, F, S | |
| | | | | | medullo | | | |
| | | | | | blastoma, | | | |
| | | | | | glioma | | | |
| BCL10 | B-cell | 8915 | yes | | MALT | L | T | IGH@ |
| | CLL/lymphoma | | | | | | | |
| | 10 | | | | | | | |
| BCL11A | B-cell | 53335 | yes | | B-CLL | L | T | IGH@ |
| | CLL/lymphoma | | | | | | | |
| | 11A | | | | | | | |
| BCL11B | B-cell | 64919 | yes | | T-ALL | L | T | TLX3 |
| | CLL/lymphoma | | | | | | | |
| | 11B | | | | | | | |
| | (CTIP2) | | | | | | | |
| BCL2 | B-cell | 596 | yes | | NHL, | L | T | IGH@ |
| | CLL/lymphoma 2 | | | | CLL | | | |
| BCL3 | B-cell | 602 | yes | | CLL | L | T | IGH@ |
| | CLL/lymphoma 3 | | | | | | | |
| BCL5 | B-cell | 603 | yes | | CLL | L | T | MYC |
| | CLL/lymphoma 5 | | | | | | | |
| BCL6 | B-cell | 604 | yes | | NHL, | L | T, | IG loci, |
| | CLL/lymphoma 6 | | | | CLL | | Mis | ZNFN1A1, |
| | | | | | | | | LCP1, PIM1, |
| | | | | | | | | TFRC, |
| | | | | | | | | MHC2TA, |
| | | | | | | | | NACA, |
| | | | | | | | | HSPCB, |
| | | | | | | | | HSPCA, |
| | | | | | | | | HIST1H4I, |
| | | | | | | | | IL21R, |
| | | | | | | | | POU2AF1, |
| | | | | | | | | ARHH, |
| | | | | | | | | EIF4A2, |
| | | | | | | | | SFRS3 |
| BCL7A | B-cell | 605 | yes | | BNHL | L | T | MYC |
| | CLL/lymphoma | | | | | | | |
| | 7A | | | | | | | |
| BCL9 | B-cell | 607 | yes | | B-ALL | L | T | IGH@, IGL@ |
| | CLL/lymphoma 9 | | | | | | | |
| BCR | breakpoint | 613 | yes | | CML, | L | T | ABL1, |
| | cluster region | | | | ALL, | | | FGFR1, JAK2 |
| | | | | | AML | | | |
| BHD | folliculin, Birt- | 201163 | | yes | renal, | E, M | Mis. | . |
| | Hogg-Dube | | | | fibrofolliculomas, | | N, F | |
| | syndrome | | | | trichodiscomas | | | |
| BIRC3 | baculoviral | 330 | yes | | MALT | L | T | MALT1 |
| | IAP repeat- | | | | | | | |
| | containing 3 | | | | | | | |
| BLM | Bloom | 641 | | yes | leukemia, | L, E | Mis, | . |
| | Syndrome | | | | lymphoma, | | N, F | |
| | | | | | skin | | | |
| | | | | | squamous | | | |
| | | | | | cell, | | | |
| | | | | | other | | | |
| | | | | | cancers | | | |
| BMPR1A | bone | 657 | | yes | gastrointestinal | E | Mis, | . |
| | morphogenetic | | | | polyps | | N, F | |
| | protein | | | | | | | |
| | receptor, type | | | | | | | |
| | IA | | | | | | | |
| BRAF | v-raf murine | 673 | yes | | melanoma, | E | Mis, | AKAP9, |
| | sarcoma viral | | | | colorectal, | | T, O | KIAA1549 |
| | oncogene | | | | papillary | | | |
| | homolog B1 | | | | thyroid, | | | |
| | | | | | borderline | | | |
| | | | | | ov, | | | |
| | | | | | Non | | | |
| | | | | | small- | | | |
| | | | | | cell lung | | | |
| | | | | | cancer | | | |
| | | | | | (NSCLC), | | | |
| | | | | | cholangiocarcinoma, | | | |
| | | | | | pilocytic | | | |
| | | | | | astrocytoma | | | |
| BRCA1 | familial | 672 | yes | yes | breast, | E | D, | . |
| | breast/ovarian | | | | ovarian | | Mis, | |
| | cancer gene 1 | | | | | | N, F, S | |
| BRCA2 | familial | 675 | yes | yes | breast, | L, E | D, | . |
| | breast/ovarian | | | | ovarian, | | Mis, | |
| | cancer gene 2 | | | | pancreatic, | | N, F, S | |
| | | | | | leukemia | | | |
| | | | | | (FANCB, | | | |
| | | | | | FANCD1) | | | |
| BRD3 | bromodomain | 8019 | yes | | lethal | E | T | NUT |
| | containing 3 | | | | midline | | | |
| | | | | | carcinoma | | | |
| | | | | | of | | | |
| | | | | | young | | | |
| | | | | | people | | | |
| BRD4 | bromodomain | 23476 | yes | | lethal | E | T | NUT |
| | containing 4 | | | | midline | | | |
| | | | | | carcinoma | | | |
| | | | | | of | | | |
| | | | | | young | | | |
| | | | | | people | | | |
| BRIP1 | BRCA1 | 83990 | | yes | AML, | L, E | F, N, | . |
| | interacting | | | | leukemia, | | Mis | |
| | protein C- | | | | breast | | | |
| | terminal | | | | | | | |
| | helicase 1 | | | | | | | |
| BTG1 | B-cell | 694 | yes | | BCLL | L | T | MYC |
| | translocation | | | | | | | |
| | gene 1, anti- | | | | | | | |
| | proliferative | | | | | | | |
| BUB1B | BUB1 budding | 701 | | yes | rhabdom | M | Mis, | . |
| | uninhibited by | | | | yosarcoma | | N, F, S | |
| | benzimidazole | | | | | | | |
| | s 1 homolog | | | | | | | |
| | beta (yeast) | | | | | | | |
| C12orf9 | chromosome | 93669 | yes | | lipoma | M | T | LPP |
| | 12 open | | | | | | | |
| | reading frame 9 | | | | | | | |
| C15orf21 | chromosome | 283651 | yes | | prostate | E | T | ETV1 |
| | 15 open | | | | | | | |
| | reading frame | | | | | | | |
| | 21 | | | | | | | |
| CANT1 | calcium | 124583 | yes | | prostate | E | T | ETV4 |
| | activated | | | | | | | |
| | nucleotidase 1 | | | | | | | |
| CARD11 | caspase | 84433 | yes | | DLBL | L | Mis | . |
| | recruitment | | | | | | | |
| | domain family, | | | | | | | |
| | member 11 | | | | | | | |
| CARS | cysteinyl- | 833 | yes | | ALCL | L | T | ALK |
| | tRNA | | | | | | | |
| | synthetase | | | | | | | |
| CBFA2T1 | core-binding | 862 | yes | | AML | L | T | MLL, RUNX1 |
| | factor, runt | | | | | | | |
| | domain, alpha | | | | | | | |
| | subunit | | | | | | | |
| | 2; translocated | | | | | | | |
| | to, 1 (ETO) | | | | | | | |
| CBFA2T3 | core-binding | 863 | yes | | AML | L | T | RUNX1 |
| | factor, runt | | | | | | | |
| | domain, alpha | | | | | | | |
| | subunit 2; | | | | | | | |
| | translocated to, | | | | | | | |
| | 3 (MTG-16) | | | | | | | |
| CBFB | core-binding | 865 | yes | | AML | L | T | MYH11 |
| | factor, beta | | | | | | | |
| | subunit | | | | | | | |
| CBL | Cas-Br-M | 867 | yes | | AML, | L | T, | MLL |
| | (murine) | | | | JMML, | | Mis | |
| | ecotropic | | | | MDS | | S, O | |
| | retroviral | | | | | | | |
| | transforming | | | | | | | |
| CBLB | Cas-Br-M | 868 | yes | | AML | L | Mis S | . |
| | (murine) | | | | | | | |
| | ecotropic | | | | | | | |
| | retroviral | | | | | | | |
| | transforming | | | | | | | |
| | sequence b | | | | | | | |
| CBLC | Cas-Br-M | 23624 | yes | | AML | L | M | . |
| | (murine) | | | | | | | |
| | ecotropic | | | | | | | |
| | retroviral | | | | | | | |
| | transforming | | | | | | | |
| | sequence c | | | | | | | |
| CCND1 | cyclin D1 | 595 | yes | | CLL, B- | L, E | T | IGH@, FSTL3 |
| | | | | | ALL, | | | |
| | | | | | breast | | | |
| CCND2 | cyclin D2 | 894 | yes | | NHL, CLL | L | T | IGL@ |
| CCND3 | cyclin D3 | 896 | yes | | MM | L | T | IGH@ |
| CD74 | CD74 | 972 | yes | | NSCLC | E | T | ROS1 |
| | molecule, | | | | | | | |
| | major | | | | | | | |
| | histocompatibility | | | | | | | |
| | complex, | | | | | | | |
| | class II | | | | | | | |
| | invariant chain | | | | | | | |
| CDH1 | cadherin 1, | 999 | yes | yes | lobular | E | Mis, | . |
| | type 1, E- | | | | breast, | | N, F, S | |
| | cadherin | | | | gastric | | | |
| | (epithelial) | | | | | | | |
| | (ECAD) | | | | | | | |
| CDH11 | cadherin 11, | 1009 | yes | | aneurys | M | T | USP6 |
| | type 2, OB- | | | | mal | | | |
| | cadherin | | | | bone | | | |
| | (osteoblast) | | | | cysts | | | |
| CDK4 | cyclin | 1019 | | yes | melanoma | E | Mis | . |
| | dependent | | | | | | | |
| | kinase 4 | | | | | | | |
| CDK6 | cyclin- | 1021 | yes | | ALL | L | T | MLLT10 |
| | dependent | | | | | | | |
| | kinase 6 | | | | | | | |
| CDKN2A- | cyclin- | 1029 | yes | yes | melanoma, | L, E, | D, S | . |
| p14ARF | dependent | | | | pancreatic, | M, O | | |
| | kinase | | | | multiple | | | |
| | inhibitor 2A -- | | | | other | | | |
| | p14ARF | | | | tumor | | | |
| | protein | | | | types | | | |
| CDKN2A- | cyclin- | 1029 | yes | yes | melanoma, | L, E, | D, | . |
| p16 | dependent | | | | pancreatic, | M, O | Mis, | |
| (INK4a) | kinase | | | | multiple | | N, F, S | |
| | inhibitor 2A | | | | other | | | |
| | (p16(INK4a)) | | | | tumor | | | |
| | gene | | | | types | | | |
| CDX2 | caudal type | 1045 | yes | | AML | L | T | ETV6 |
| | homed box | | | | | | | |
| | transcription | | | | | | | |
| | factor 2 | | | | | | | |
| CEBPA | CCAAT/enhancer | 1050 | yes | | AML, | L | Mis, | . |
| | binding | | | | MDS | | N, F | |
| | protein | | | | | | | |
| | (C/EBP), alpha | | | | | | | |
| CEP1 | centrosomal | 11064 | yes | | MPD, | L | T | FGFR1 |
| | protein 1 | | | | NHL | | | |
| CHCHD7 | coiled-coil- | 79145 | yes | | salivary | E | T | PLAG1 |
| | helix-coiled- | | | | adenoma | | | |
| | coil-helix | | | | | | | |
| | domain | | | | | | | |
| | containing 7 | | | | | | | |
| CHEK2 | CHK2 | 11200 | | yes | breast | E | F | . |
| | checkpoint | | | | | | | |
| | homolog (S. pombe) | | | | | | | |
| CHIC2 | cysteine-rich | 26511 | yes | | AML | L | T | ETV6 |
| | hydrophobic | | | | | | | |
| | domain 2 | | | | | | | |
| CHN1 | chimerin | 1123 | yes | | extraskeletal | M | T | TAF15 |
| | (chimaerin) 1 | | | | myxoid | | | |
| | | | | | chondro | | | |
| | | | | | sarcoma | | | |
| CIC | capicua | 23152 | yes | | soft | M | T | DUX4 |
| | homolog | | | | tissue | | | |
| | (Drosophila) | | | | sarcoma | | | |
| CLTC | clathrin, heavy | 1213 | yes | | ALCL, | L | T | ALK, TFE3 |
| | polypeptide | | | | renal | | | |
| | (Hc) | | | | | | | |
| CLTCL1 | clathrin, heavy | 8218 | yes | | ALCL | L | T | . |
| | polypeptide- | | | | | | | |
| | like 1 | | | | | | | |
| CMKOR1 | chemokine | 57007 | yes | | lipoma | M | T | HMGA2 |
| | orphan | | | | | | | |
| | receptor 1 | | | | | | | |
| COL1A1 | collagen, type | 1277 | yes | | dermatofibrosarcoma | M | T | PDGFB, USP6 |
| | I, alpha 1 | | | | protuberans, | | | |
| | | | | | aneurys | | | |
| | | | | | mal | | | |
| | | | | | bone | | | |
| | | | | | cyst | | | |
| COPEB | core promoter | 1316 | yes | | prostate, | E, O | Mis, N | . |
| | element | | | | glioma | | | |
| | binding | | | | | | | |
| | protein | | | | | | | |
| | (KLF6) | | | | | | | |
| COX6C | cytochrome c | 1345 | yes | | uterine | M | T | HMGA2 |
| | oxidase | | | | leiomyoma | | | |
| | subunit VIc | | | | | | | |
| CREB1 | cAMP | 1385 | yes | | clear cell | M | T | EWSR1 |
| | responsive | | | | sarcoma, | | | |
| | element | | | | angioma | | | |
| | binding | | | | toid | | | |
| | protein 1 | | | | fibrous | | | |
| | | | | | histiocytoma | | | |
| CREB3L2 | cAMP | 64764 | yes | | fibromyxoid | M | T | FUS |
| | responsive | | | | sarcoma | | | |
| | element | | | | | | | |
| | binding | | | | | | | |
| | protein 3-like 2 | | | | | | | |
| CREBBP | CREB binding | 1387 | yes | | AL, | L | T | MLL, MORF, |
| | protein (CBP) | | | | AML | | | RUNXBP2 |
| CRTC3 | CREB | 64784 | yes | | salivary | E | T | MAML2 |
| | regulated | | | | gland | | | |
| | transcription | | | | mucoepidermoid | | | |
| | coactivator 3 | | | | | | | |
| CTNNB1 | catenin | 1499 | yes | | colorectal, | E, M, O | H, | PLAG1 |
| | (cadherin- | | | | cvarian, | | Mis, T | |
| | associated | | | | hepatoblastoma, | | | |
| | protein), beta 1 | | | | others, | | | |
| | | | | | pleomorphic | | | |
| | | | | | salivary | | | |
| | | | | | adenoma | | | |
| CYLD | familial | 1540 | yes | yes | cylindroma | E | Mis, | . |
| | cylindromatosis | | | | | | N, F, S | |
| | gene | | | | | | | |
| D10S170 | DNA segment | 8030 | yes | | papillary | E | T | RET, |
| | on | | | | thyroid, | | | PDGFRB |
| | chromosome | | | | CML | | | |
| | 10 (unique) | | | | | | | |
| | 170, H4 gene | | | | | | | |
| | (PTC1) | | | | | | | |
| DDB2 | damage- | 1643 | | yes | skin | E | Mis, N | . |
| | specific DNA | | | | basal | | | |
| | binding | | | | cell, skin | | | |
| | protein 2 | | | | squamous | | | |
| | | | | | cell, | | | |
| | | | | | melanoma | | | |
| DDIT3 | DNA-damage- | 1649 | yes | | liposarcoma | M | T | FUS |
| | inducible | | | | | | | |
| | transcript 3 | | | | | | | |
| DDX10 | DEAD (Asp- | 1662 | yes | | AML* | L | T | NUP98 |
| | Glu-Ala-Asp) | | | | | | | |
| | box | | | | | | | |
| | polypeptide 10 | | | | | | | |
| DDX5 | DEAD (Asp- | 1655 | yes | | prostate | E | T | ETV4 |
| | Glu-Ala-Asp) | | | | | | | |
| | box | | | | | | | |
| | polypeptide 5 | | | | | | | |
| DDX6 | DEAD (Asp- | 1656 | yes | | B-NHL | L | T | IGH@ |
| | Glu-Ala-Asp) | | | | | | | |
| | box | | | | | | | |
| | polypeptide 6 | | | | | | | |
| DEK | DEK | 7913 | yes | | AML | L | T | NUP214 |
| | oncogene | | | | | | | |
| | (DNA | | | | | | | |
| | binding) | | | | | | | |
| DICER1 | dicer 1, | 23405 | | yes | pleuropulmonary | E | Mis | . |
| | ribonuclease | | | | blastoma | | F, N | |
| | type III | | | | | | | |
| DUX4 | double | 22947 | yes | | soft | M | T | CIC |
| | homeobox, 4 | | | | tissue | | | |
| | | | | | sarcoma; | | | |
| | | | | | rhadomyosarcoma, | | | |
| | | | | | ganglioneuroblastoma, | | | |
| | | | | | bladder | | | |
| EGFR | epidermal | 1956 | yes | yes | glioma | E, O | A, O, | . |
| | growth factor | | | | NSCLC | | Mis | |
| | receptor | | | | | | | |
| | (erythroblastic | | | | | | | |
| | leukemia viral | | | | | | | |
| | (v-erb-b) | | | | | | | |
| | oncogene | | | | | | | |
| | homolog, | | | | | | | |
| | avian) | | | | | | | |
| EIF4A2 | eukaryotic | 1974 | yes | | NHL | L | T | BCL6 |
| | translation | | | | | | | |
| | initiation | | | | | | | |
| | factor 4A, | | | | | | | |
| | isoform 2 | | | | | | | |
| ELF4 | E74-like factor | 2000 | yes | | AML | L | T | ERG |
| | 4 (ets domain | | | | | | | |
| | transcription | | | | | | | |
| | factor) | | | | | | | |
| ELK4 | ELK4, ETS- | 2005 | yes | | prostate | E | T | SLC45A3 |
| | domain protein | | | | | | | |
| | (SRF | | | | | | | |
| | accessory | | | | | | | |
| | protein 1) | | | | | | | |
| ELKS | ELKS protein | 23085 | yes | | papillary | E | T | RET |
| | | | | | thyroid | | | |
| ELL | ELL gene (11-19 | 8178 | yes | | AL | L | T | MLL |
| | lysine-rich | | | | | | | |
| | leukemia | | | | | | | |
| | gene) | | | | | | | |
| ELN | elastin | 2006 | yes | | B-ALL | L | T | PAX5 |
| EML4 | echinoderm | 27436 | yes | | NSCLC | E | T | ALK |
| | microtubule | | | | | | | |
| | associated | | | | | | | |
| | protein like 4 | | | | | | | |
| EP300 | 300 kd E1A- | 2033 | yes | | colorectal, | L, E | T | MLL, |
| | Binding | | | | breast, | | | RUNXBP2 |
| | protein gene | | | | pancreatic, | | | |
| | | | | | AML | | | |
| EPS15 | epidermal | 2060 | yes | | ALL | L | T | MLL |
| | growth factor | | | | | | | |
| | receptor | | | | | | | |
| | pathway | | | | | | | |
| | substrate 15 | | | | | | | |
| | (AF1p) | | | | | | | |
| ERBB2 | v-erb-b2 | 2064 | yes | | breast, | E | A, | . |
| | erythroblastic | | | | ovarian, | | Mis, O | |
| | leukemia viral | | | | other | | | |
| | oncogene | | | | tumor | | | |
| | homolog 2, | | | | types, | | | |
| | neuro/glioblastoma | | | | NSCLC, | | | |
| | derived | | | | gastric | | | |
| | oncogene | | | | | | | |
| | homolog | | | | | | | |
| | (avian) | | | | | | | |
| ERCC2 | excision repair | 2068 | | yes | skin | E | Mis, | . |
| | cross- | | | | basal | | N, F, S | |
| | complementing | | | | cell, skin | | | |
| | rodent repair | | | | squamous | | | |
| | deficiency, | | | | cell, | | | |
| | complementation | | | | melanoma | | | |
| | group 2 | | | | | | | |
| | (xeroderma | | | | | | | |
| | pigmentosum | | | | | | | |
| | D) | | | | | | | |
| ERCC3 | excision repair | 2071 | | yes | skin | E | Mis, S | . |
| | cross- | | | | basal | | | |
| | complementing | | | | cell, skin | | | |
| | rodent repair | | | | squamous | | | |
| | deficiency, | | | | cell, | | | |
| | complementation | | | | melanoma | | | |
| | group 3 | | | | | | | |
| | (xeroderma | | | | | | | |
| | pigmentosum | | | | | | | |
| | group B | | | | | | | |
| | complementing) | | | | | | | |
| ERCC4 | excision repair | 2072 | | yes | skin | E | Mis, | . |
| | cross- | | | | basal | | N, F | |
| | complementing | | | | cell, skin | | | |
| | rodent repair | | | | squamous | | | |
| | deficiency, | | | | cell, | | | |
| | complementation | | | | melanoma | | | |
| | group 4 | | | | | | | |
| ERCC5 | excision repair | 2073 | | yes | skin | E | Mis, | . |
| | cross- | | | | basal | | N, F | |
| | complementing | | | | cell, skin | | | |
| | rodent repair | | | | squamous | | | |
| | deficiency, | | | | cell, | | | |
| | complementation | | | | melanoma | | | |
| | group 5 | | | | | | | |
| | (xeroderma | | | | | | | |
| | pigmentosum, | | | | | | | |
| | complementation | | | | | | | |
| | group G | | | | | | | |
| | (Cockayne | | | | | | | |
| | syndrome)) | | | | | | | |
| ERG | v-ets | 2078 | yes | | Ewing | M, E, L | T | EWSR1, |
| | erythroblastosis | | | | sarcoma, | | | TMPRSS2, |
| | virus E26 | | | | prostate, | | | ELF4, FUS, |
| | oncogene like | | | | AML | | | HERPUD1 |
| | (avian) | | | | | | | |
| ETV1 | ets variant | 2115 | yes | | Ewing | M, E | T | EWSR1, |
| | gene 1 | | | | sarcoma, | | | TMPRSS2, |
| | | | | | prostate | | | SLC45A3, |
| | | | | | | | | C15orf21, |
| | | | | | | | | HNRNPA2B1. |
| | | | | | | | | ACSL3 |
| ETV4 | ets variant | 2118 | yes | | Ewing | M, E | T | EWSR1, |
| | gene 4 (E1A | | | | sarcoma, | | | TMPRSS2, |
| | enhancer | | | | Prostate | | | DDX5, KLK2, |
| | binding | | | | carcinoma | | | CANT1 |
| | protein, E1AF) | | | | | | | |
| ETV5 | ets variant | 2119 | yes | | Prostate | E | T | TMPRSS2, |
| | gene 5 | | | | | | | SCL45A3 |
| ETV6 | ets variant | 2120 | yes | | congenital | L, E, M | T | NTRK3, |
| | gene 6 (TEL | | | | fibrosarcoma, | | | RUNX1, |
| | oncogene) | | | | multiple | | | PDGFRB, |
| | | | | | leukemia | | | ABL1, MN1, |
| | | | | | and | | | ABL2, |
| | | | | | lymphoma, | | | FACL6, |
| | | | | | secretory | | | CHIC2, |
| | | | | | breast, | | | ARNT, JAK2, |
| | | | | | MDS, | | | EVI1, CDX2, |
| | | | | | ALL | | | STL, HLXB9, |
| | | | | | | | | MDS2, PER1, |
| | | | | | | | | SYK, TTL, |
| | | | | | | | | FGFR3, PAX5 |
| EVI1 | ecotropic viral | 2122 | yes | | AML, | L | T | RUNX1, |
| | integration site 1 | | | | CML | | | ETV6, |
| | | | | | | | | PRDM16, |
| | | | | | | | | RPN1 |
| EWSR1 | Ewing | 2130 | yes | | Ewing | L, M | T | FLI1, ERG, |
| | sarcoma | | | | sarcoma, | | | ZNF278, |
| | breakpoint | | | | desmoplastic | | | NR4A3, FEV, |
| | region 1 | | | | small | | | ATF1, ETV1, |
| | (EWS) | | | | round | | | ETV4, WT1, |
| | | | | | cell | | | ZNF384, |
| | | | | | tumor, | | | CREB1, |
| | | | | | ALL, | | | POU5F1, |
| | | | | | clear cell | | | PBX1 |
| | | | | | sarcoma, | | | |
| | | | | | sarcoma, | | | |
| | | | | | myoepithelioma | | | |
| EXT1 | multiple | 2131 | | yes | exostoses, | M | Mis, | . |
| | exostoses type | | | | osteosarcoma | | N, F, S | |
| | 1 gene | | | | | | | |
| EXT2 | multiple | 2132 | | yes | exostoses, | M | Mis, | . |
| | exostoses type | | | | osteosarcoma | | N, F, S | |
| | 2 gene | | | | | | | |
| FACL6 | fatty-acid- | 23305 | yes | | AML, | L | T | ETV6 |
| | coenzyme A | | | | AEL | | | |
| | ligase, long- | | | | | | | |
| | chain 6 | | | | | | | |
| FANCA | Fanconi | 2175 | | yes | AML, | L | D, | . |
| | anemia, | | | | leukemia | | Mis, | |
| | complementation | | | | | | N, F, S | |
| | group A | | | | | | | |
| FANCC | Fanconi | 2176 | | yes | AML, | L | D, | . |
| | anemia, | | | | leukemia | | Mis, | |
| | complementation | | | | | | N, F, S | |
| | group C | | | | | | | |
| FANCD2 | Fanconi | 2177 | | yes | AML, | L | D, | . |
| | anemia, | | | | leukemia | | Mis, | |
| | complementation | | | | | | N, F | |
| | group D2 | | | | | | | |
| FANCE | Fanconi | 2178 | | yes | AML, | L | N, F, S | . |
| | anemia, | | | | leukemia | | | |
| | complementation | | | | | | | |
| | group E | | | | | | | |
| FANCF | Fanconi | 2188 | | yes | AML, | L | N, F | . |
| | anemia, | | | | leukemia | | | |
| | complementation | | | | | | | |
| | group F | | | | | | | |
| FANCG | Fanconi | 2189 | | yes | AML, | L | Mis, | . |
| | anemia, | | | | leukemia | | N, F, S | |
| | complementation | | | | | | | |
| | group G | | | | | | | |
| FBXW7 | F-box and | 55294 | yes | | colorectal, | E, L | Mis, | . |
| | WD-40 | | | | endometrial, | | N, D, F | |
| | domain protein | | | | T- | | | |
| | 7 (archipelago | | | | ALL | | | |
| | homolog, | | | | | | | |
| | Drosophila) | | | | | | | |
| FCGR2B | Fc fragment of | 2213 | yes | | ALL | L | T | . |
| | IgG, low | | | | | | | |
| | affinity IIb, | | | | | | | |
| | receptor for | | | | | | | |
| | (CD32) | | | | | | | |
| FEV | FEV protein- | 54738 | yes | | Ewing | M | T | EWSR1, FUS |
| | (HSRNAFEV) | | | | sarcoma | | | |
| FGFR1 | fibroblast | 2260 | yes | | MPD, | L | T | BCR, FOP, |
| | growth factor | | | | NHL | | | ZNF198, |
| | receptor 1 | | | | | | | CEP1 |
| FGFR1OP | FGFR1 | 11116 | yes | | MPD, | L | T | FGFR1 |
| | oncogene | | | | NHL | | | |
| | partner (FOP) | | | | | | | |
| FGFR2 | fibroblast | 2263 | yes | | gastric. | E | Mis | . |
| | growth factor | | | | NSCLC, | | | |
| | receptor 2 | | | | endometrial | | | |
| FGFR3 | fibroblast | 2261 | yes | | bladder, | L, E | Mis, T | IGH@, ETV6 |
| | growth factor | | | | MM, T- | | | |
| | receptor 3 | | | | cell | | | |
| | | | | | lymphoma | | | |
| FH | fumarate | 2271 | | yes | lieomyomatosis, | E, M | Mis, | . |
| | hydratase | | | | renal | | N, F | |
| FIP1L1 | FIP1 like 1 (S. cerevisiae) | 81608 | yes | | idiopathic | L | T | PDGFRA |
| | | | | | hypereosinophilic | | | |
| | | | | | syndrome | | | |
| FLI1 | Friend | 2313 | yes | | Ewing | M | T | EWSR1 |
| | leukemia virus | | | | sarcoma | | | |
| | integration 1 | | | | | | | |
| FLT3 | fms-related | 2322 | yes | | AML, | L | Mis, O | . |
| | tyrosine kinase 3 | | | | ALL | | | |
| FNBP1 | formin binding | 23048 | yes | | AML | L | T | MLL |
| | protein 1 | | | | | | | |
| | (FBP17) | | | | | | | |
| FOXL2 | forkhead box | 668 | yes | | granulosa- | O | Mis | . |
| | L2 | | | | cell | | | |
| | | | | | tumor of | | | |
| | | | | | the | | | |
| | | | | | ovary | | | |
| FOXO1A | forkhead box | 2308 | yes | | alveolar | M | T | PAX3 |
| | O1A (FKHR) | | | | rhabdomyosarcomas | | | |
| FOXO3A | forkhead box | 2309 | yes | | AL | L | T | MLL |
| | O3A | | | | | | | |
| FOXP1 | forkhead box | 27086 | yes | | ALL | L | T | PAX5 |
| | P1 | | | | | | | |
| FSTL3 | follistatin-like | 10272 | yes | | B-CLL | L | T | CCND1 |
| | 3 (secreted | | | | | | | |
| | glycoprotein) | | | | | | | |
| FUS | fusion, derived | 2521 | yes | | liposarcoma, | M, L | T | DDIT3, ERG, |
| | from t(12;16) | | | | AML, | | | FEV, ATF1, |
| | malignant | | | | Ewing | | | CREB3L2 |
| | liposarcoma | | | | sarcoma, | | | |
| | | | | | angiomatoid | | | |
| | | | | | fibrous | | | |
| | | | | | histiocytoma, | | | |
| | | | | | fibromyxoid | | | |
| | | | | | sarcoma | | | |
| FVT1 | follicular | 2531 | yes | | B-NHL | L | T | IGK@ |
| | lymphoma | | | | | | | |
| | variant | | | | | | | |
| | translocation 1 | | | | | | | |
| GAS7 | growth arrest- | 8522 | yes | | AML* | L | T | MLL |
| | specific 7 | | | | | | | |
| GATA1 | GATA binding | 2623 | yes | | megakaryoblastic | L | Mis, F | . |
| | protein 1 | | | | leukemia | | | |
| | (globin | | | | of | | | |
| | transcription | | | | Downs | | | |
| | factor 1) | | | | Syndrome | | | |
| GATA2 | GATA binding | 2624 | yes | | AML(CML | L | Mis | . |
| | protein 2 | | | | blast | | | |
| | | | | | transformation) | | | |
| GMPS | guanine | 8833 | yes | | AML | L | T | MLL |
| | monphosphate | | | | | | | |
| | synthetase | | | | | | | |
| GNAQ | guanine | 2776 | yes | | uveal | E | Mis | . |
| | nucleotide | | | | melanoma | | | |
| | binding | | | | | | | |
| | protein (G | | | | | | | |
| | protein), q | | | | | | | |
| | polypeptide | | | | | | | |
| GNAS | guanine | 2778 | yes | | pituitary | E | Mis | . |
| | nucleotide | | | | adenoma | | | |
| | binding | | | | | | | |
| | protein (G | | | | | | | |
| | protein), alpha | | | | | | | |
| | stimulating | | | | | | | |
| | activity | | | | | | | |
| | polypeptide 1 | | | | | | | |
| GOLGA5 | golgi | 9950 | yes | | papillary | E | T | RET |
| | autoantigen, | | | | thyroid | | | |
| | golgin | | | | | | | |
| | subfamily a, 5 | | | | | | | |
| | (PTC5) | | | | | | | |
| GOPC | golgi | 57120 | yes | | glioblastoma | O | O | ROS1 |
| | associated | | | | | | | |
| | PDZ and | | | | | | | |
| | coiled-coil | | | | | | | |
| | motif | | | | | | | |
| | containing | | | | | | | |
| GPC3 | glypican 3 | 2719 | | yes | Wilms | O | T, D, | . |
| | | | | | tumor | | Mis, | |
| | | | | | | | N, F, S | |
| GPHN | gephyrin | 10243 | yes | | AL | L | T | MLL |
| | (GPH) | | | | | | | |
| GRAF | GTPase | 23092 | yes | | AML, | L | T, F, S | MLL |
| | regulator | | | | MDS | | | |
| | associated | | | | | | | |
| | with focal | | | | | | | |
| | adhesion | | | | | | | |
| | kinase | | | | | | | |
| | pp125(FAK) | | | | | | | |
| HCMOGT-1 | sperm antigen | 92521 | yes | | JMML | L | T | PDGFRB |
| | HCMOGT-1 | | | | | | | |
| HEAB | ATP_GTP | 10978 | yes | | AML | L | T | MLL |
| | binding | | | | | | | |
| | protein | | | | | | | |
| HEI10 | enhancer of | 57820 | yes | | uterine | M | T | HMGA2 |
| | invasion 10- | | | | leiomyoma | | | |
| | fused to | | | | | | | |
| | HMGA2 | | | | | | | |
| HERPUD1 | homocysteine- | 9709 | yes | | prostate | E | T | ERG |
| | inducible, | | | | | | | |
| | endoplasmic | | | | | | | |
| | reticulum | | | | | | | |
| | stress- | | | | | | | |
| | inducible, | | | | | | | |
| | ubiquitin-like | | | | | | | |
| | domain | | | | | | | |
| | member 1 | | | | | | | |
| HIP1 | huntingtin | 3092 | yes | | CMML | L | T | PDGFRB |
| | interacting | | | | | | | |
| | protein 1 | | | | | | | |
| HIST1H4I | histone 1, H4i | 8294 | yes | | NHL | L | T | BCL6 |
| | (H4FM) | | | | | | | |
| HLF | hepatic | 3131 | yes | | ALL | L | T | TCF3 |
| | leukemia | | | | | | | |
| | factor | | | | | | | |
| HLXB9 | homeo box | 3110 | yes | | AML | L | T | ETV6 |
| | HB9 | | | | | | | |
| HMGA1 | high mobility | 3159 | yes | | microfol | E, M | T | . |
| | group AT- | | | | licular | | | |
| | hook 1 | | | | thyroid | | | |
| | | | | | adenoma, | | | |
| | | | | | various | | | |
| | | | | | benign | | | |
| | | | | | mesenchymal | | | |
| | | | | | tumors | | | |
| HMGA2 | high mobility | 8091 | yes | | lipoma | M | T | LHFP, |
| | group AT- | | | | | | | RAD51L1, |
| | hook 2 | | | | | | | LPP, HEI10, |
| | (HMGIC) | | | | | | | COX6C, |
| | | | | | | | | CMKOR1 |
| HNRNPA2B1 | heterogeneous | 3181 | yes | | prostate | E | T | ETV1 |
| | nuclear | | | | | | | |
| | ribonucleoprotein | | | | | | | |
| | A2/B1 | | | | | | | |
| HOOK3 | hook homolog 3 | 84376 | yes | | papillary | E | T | RET |
| | | | | | thyroid | | | |
| HOXA11 | homeo box | 3207 | yes | | CML | L | T | NUP98 |
| | A11 | | | | | | | |
| HOXA13 | homeo box | 3209 | yes | | AML | L | T | NUP98 |
| | A13 | | | | | | | |
| HOXA9 | homeo box A9 | 3205 | yes | | AML* | L | T | NUP98, MSI2 |
| HOXC11 | homeo box | 3227 | yes | | AML | L | T | NUP98 |
| | C11 | | | | | | | |
| HOXC13 | homeo box | 3229 | yes | | AML | L | T | NUP98 |
| | C13 | | | | | | | |
| HOXD11 | homeo box | 3237 | yes | | AML | L | T | NUP98 |
| | D11 | | | | | | | |
| HOXD13 | homeo box | 3239 | yes | | AML* | L | T | NUP98 |
| | D13 | | | | | | | |
| HRAS | v-Ha-ras | 3265 | yes | yes | infrequent | E, L, M | Mis | . |
| | Harvey rat | | | | sarcomas, | | | |
| | sarcoma viral | | | | rare | | | |
| | oncogene | | | | other | | | |
| | homolog | | | | types, | | | |
| | | | | | rhadomy | | | |
| | | | | | osarcoma, | | | |
| | | | | | ganglioneuroblastoma, | | | |
| | | | | | bladder | | | |
| HRPT2 | hyperparathyroidism 2 | 3279 | yes | yes | parathyroid | E, M | Mis, | . |
| | | | | | adenoma, | | N, F | |
| | | | | | mulitiple | | | |
| | | | | | ossifying | | | |
| | | | | | jaw | | | |
| | | | | | fibroma | | | |
| HSPCA | heat shock | 3320 | yes | | NHL | L | T | BCL6 |
| | 90 kDa protein | | | | | | | |
| | 1, alpha | | | | | | | |
| HSPCB | heat shock | 3326 | yes | | NHL | L | T | BCL6 |
| | 90 kDa protein | | | | | | | |
| | 1, beta | | | | | | | |
| IDH1 | isocitrate | 3417 | yes | | gliobastoma | O | Mis | . |
| | dehydrogenase | | | | | | | |
| | 1 (NADP+), | | | | | | | |
| | soluble | | | | | | | |
| IDH2 | socitrate | 3418 | yes | | GBM | M | M | . |
| | dehydrogenase | | | | | | | |
| | 2 (NADP+), | | | | | | | |
| | mitochondrial | | | | | | | |
| IGH@ | immunoglobulin | 3492 | yes | | MM, | L | T | MYC, |
| | heavy locus | | | | Burkitt | | | FGFR3, PAX5, |
| | | | | | lymphoma, | | | IRTA1, IRF4, |
| | | | | | NHL, | | | CCND1, |
| | | | | | CLL, B- | | | BCL9, BCL8, |
| | | | | | ALL, | | | BCL6, BCL2, |
| | | | | | MALT, | | | BCL3, |
| | | | | | MLCLS | | | BCL10, |
| | | | | | | | | BCL11A. |
| | | | | | | | | LHX4, DDX6, |
| | | | | | | | | NFKB2, |
| | | | | | | | | PAFAH1B2, |
| | | | | | | | | PCSK7 |
| IGK@ | immunoglobulin | 50802 | yes | | Burkitt | L | T | MYC, FVT1 |
| | kappa locus | | | | lymphoma, | | | |
| | | | | | B- | | | |
| | | | | | NHL | | | |
| IGL@ | immunoglobulin | 3535 | yes | | Burkitt | L | T | BCL9, MYC, |
| | lambda | | | | lymphoma | | | CCND2 |
| | locus | | | | | | | |
| IKZF1 | IKAROS | 10320 | yes | | ALL | L | D | . |
| | family zinc | | | | | | | |
| | finger 1 | | | | | | | |
| IL2 | interleukin 2 | 3558 | yes | | intestinal | L | T | TNFRSF17 |
| | | | | | T-cell | | | |
| | | | | | lymphoma | | | |
| IL21R | interleukin 21 | 50615 | yes | | NHL | L | T | BCL6 |
| | receptor | | | | | | | |
| IL6ST | interleukin 6 | 3572 | yes | | hepatocellular | E | O | . |
| | signal | | | | ca | | | |
| | transducer | | | | | | | |
| | (gp130, | | | | | | | |
| | oncostatin M | | | | | | | |
| | receptor) | | | | | | | |
| IRF4 | interferon | 3662 | yes | | MM | L | T | IGH@ |
| | regulatory | | | | | | | |
| | factor 4 | | | | | | | |
| IRTA1 | immunoglobulin | 83417 | yes | | B-NHL | L | T | IGH@ |
| | superfamily | | | | | | | |
| | receptor | | | | | | | |
| | translocation | | | | | | | |
| | associated 1 | | | | | | | |
| ITK | IL2-inducible | 3702 | yes | | peripheral | L | T | SYK |
| | T-cell kinase | | | | T-cell | | | |
| | | | | | lymphoma | | | |
| JAK2 | Janus kinase 2 | 3717 | yes | | ALL, | L | T, | ETV6, PCM1, |
| | | | | | AML, | | Mis, O | BCR |
| | | | | | MPD, | | | |
| | | | | | CML | | | |
| JAK3 | Janus kinase 3 | 3718 | yes | | acute | L | Mis | . |
| | | | | | megakaryocytic | | | |
| | | | | | leukemia, | | | |
| JAZF1 | juxtaposed | 221895 | yes | | endometrial | M | T | SUZ12 |
| | with another | | | | stromal | | | |
| | zinc finger | | | | tumors | | | |
| | gene 1 | | | | | | | |
| KDM5A | lysine (K)- | 5927 | yes | | AML | L | T | NUP98 |
| | specific | | | | | | | |
| | demethylase | | | | | | | |
| | 5A, JARID1A | | | | | | | |
| KDM6A | lysine (K)- | 7403 | yes | | renal, | E, L | D, N, | . |
| | specific | | | | oesophageal | | F, S | |
| | demethylase | | | | SCC, | | | |
| | 6A, UTX | | | | MM | | | |
| KIAA1549 | KIAA1549 | 57670 | yes | | pilocytic | O | O | BRAF |
| | | | | | astrocytoma | | | |
| KIT | v-kit Hardy- | 3815 | yes | yes | GIST, | L, M, | Mis, O | . |
| | Zuckerman 4 | | | | AML, | O, E | | |
| | feline sarcoma | | | | TGCT, | | | |
| | viral oncogene | | | | mastocytosis, | | | |
| | homolog | | | | melanoma, | | | |
| | | | | | epithelioma | | | |
| KLK2 | kallikrein- | 3817 | yes | | prostate | E | T | ETV4 |
| | related | | | | | | | |
| | peptidase 2 | | | | | | | |
| KRAS | v-Ki-ras2 | 3845 | yes | | pancreatic, | L, E, | Mis | . |
| | Kirsten rat | | | | colorectal, | M, O | | |
| | sarcoma 2 | | | | lung, | | | |
| | viral oncogene | | | | thyroid, | | | |
| | homolog | | | | AML, | | | |
| | | | | | others | | | |
| KTN1 | kinectin 1 | 3895 | yes | | papillary | E | T | RET |
| | (kinesin | | | | thryoid | | | |
| | receptor) | | | | | | | |
| LAF4 | lymphoid | 3899 | yes | | ALL, T- | L | T | MLL, RUNX1 |
| | nuclear protein | | | | ALL | | | |
| | related to AF4 | | | | | | | |
| LASP1 | LIM and SH3 | 3927 | yes | | AML | L | T | MLL |
| | Protein 1 | | | | | | | |
| LCK | lymphocyte- | 3932 | yes | | T-ALL | L | T | TRB@ |
| | specific | | | | | | | |
| | protein | | | | | | | |
| | tyrosine kinase | | | | | | | |
| LCP1 | lymphocyte | 3936 | yes | | NHL | L | T | BCL6 |
| | cytosolic | | | | | | | |
| | protein 1 (L- | | | | | | | |
| | plastin) | | | | | | | |
| LCX | leukemia- | 80312 | yes | | AML | L | T | MLL |
| | associated | | | | | | | |
| | protein with a | | | | | | | |
| | CXXC domain | | | | | | | |
| LHFP | lipoma | 10186 | yes | | lipoma | M | T | HMGA2 |
| | HMGIC fusion | | | | | | | |
| | partner | | | | | | | |
| LIFR | leukemia | 3977 | yes | | salivary | E | T | PLAG1 |
| | inhibitory | | | | adenoma | | | |
| | factor receptor | | | | | | | |
| LMO1 | LIM domain | 4004 | yes | | T-ALL | L | T | TRD@ |
| | only 1 | | | | | | | |
| | (rhombotin 1) | | | | | | | |
| | (RBTN1) | | | | | | | |
| LMO2 | LIM domain | 4005 | yes | | T-ALL | L | T | TRD@ |
| | only 2 | | | | | | | |
| | (rhombotin- | | | | | | | |
| | like 1) | | | | | | | |
| | (RBTN2) | | | | | | | |
| LPP | LIM domain | 4026 | yes | | lipoma, | L, M | T | HMGA2, |
| | containing | | | | leukemia | | | MLL, C12orf9 |
| | preferred | | | | | | | |
| | translocation | | | | | | | |
| | partner in | | | | | | | |
| | lipoma | | | | | | | |
| LYL1 | lymphoblastic | 4066 | yes | | T-ALL | L | T | TRB@ |
| | leukemia | | | | | | | |
| | derived | | | | | | | |
| | sequence 1 | | | | | | | |
| MADH4 | Homolog of | 4089 | yes | yes | colorectal, | E | D, | . |
| | Drosophila | | | | pancreatic, | | Mis, | |
| | Mothers | | | | small | | N, F | |
| | Against | | | | intestine, | | | |
| | Decapentaplegic | | | | gastrointestinal | | | |
| | 4 gene | | | | polyps | | | |
| MAF | v-maf | 4094 | yes | | MM | L | T | IGH@ |
| | musculoaponeurotic | | | | | | | |
| | fibrosarcoma | | | | | | | |
| | oncogene | | | | | | | |
| | homolog | | | | | | | |
| MAFB | v-maf | 9935 | yes | | MM | L | T | IGH@ |
| | musculoaponeurotic | | | | | | | |
| | fibrosarcoma | | | | | | | |
| | oncogene | | | | | | | |
| | homolog B | | | | | | | |
| | (avian) | | | | | | | |
| MALT1 | mucosa | 10892 | yes | | MALT | L | T | BIRC3 |
| | associated | | | | | | | |
| | lymphoid | | | | | | | |
| | tissue | | | | | | | |
| | lymphoma | | | | | | | |
| | translocation | | | | | | | |
| | gene 1 | | | | | | | |
| MAML2 | mastermind- | 84441 | yes | | salivary | E | T | MECT1, |
| | like 2 | | | | gland | | | CRTC3 |
| | (Drosophila) | | | | mucoepidermoid | | | |
| MAP2K4 | mitogen- | 6416 | yes | | pancreatic, | E | D, | . |
| | activated | | | | breast, | | Mis, N | |
| | protein kinase | | | | colorectal | | | |
| | kinase 4 | | | | | | | |
| MDM2 | Mdm2 p53 | 4193 | yes | | sarcoma, | M, O, | A | . |
| | binding | | | | glioma, | E, L | | |
| | protein | | | | colorectal, | | | |
| | homolog | | | | other | | | |
| MDM4 | Mdm4 p53 | 4194 | yes | | GBM, | M | A | . |
| | binding | | | | bladder, | | | |
| | protein | | | | retinoblastoma | | | |
| | homolog | | | | | | | |
| MDS1 | myelodysplasia | 4197 | yes | | MDS, | L | T | RUNX1 |
| | syndrome 1 | | | | AML | | | |
| MDS2 | myelodysplastic | 259283 | yes | | MDS | L | T | ETV6 |
| | syndrome 2 | | | | | | | |
| MECT1 | mucoepidermoid | 94159 | yes | | salivary | E | T | MAML2 |
| | translocated 1 | | | | gland | | | |
| | | | | | mucoepidermoid | | | |
| MEN1 | multiple | 4221 | yes | yes | parathyroid | E | D, | . |
| | endocrine | | | | tumors, parathyroid | | Mis, | |
| | neoplasia type | | | | adenoma, | | N, F, S | |
| | 1 gene | | | | pituitary | | | |
| | | | | | adenoma, | | | |
| | | | | | pancreatic | | | |
| | | | | | islet | | | |
| | | | | | cell, | | | |
| | | | | | carcinoid | | | |
| MET | met proto- | 4233 | yes | | papillary | E | Mis | . |
| | oncogene | | | | renal, | | | |
| | (hepatocyte | | | | head- | | | |
| | growth factor | | | | neck | | | |
| | receptor) | | | | squamous | | | |
| | | | | | cell | | | |
| MHC2TA | MHC class II | 4261 | yes | | NHL | L | T | BCL6 |
| | transactivator | | | | | | | |
| MITF | microphthalmia- | 4286 | yes | | melanoma | E | A | . |
| | associated | | | | | | | |
| | transcription | | | | | | | |
| | factor | | | | | | | |
| MKL1 | megakaryoblastic | 57591 | yes | | acute | L | T | RBM15 |
| | leukemia | | | | megakaryocytic | | | |
| | (translocation) 1 | | | | leukemia | | | |
| MLF1 | myeloid | 4291 | yes | | AML | L | T | NPM1 |
| | leukemia | | | | | | | |
| | factor 1 | | | | | | | |
| MLH1 | E. coli MutL | 4292 | yes | yes | colorectal, | E, O | D, | . |
| | homolog gene | | | | endometrial, | | Mis, | |
| | | | | | ovarian, | | N, F, S | |
| | | | | | CNS | | | |
| MLL | myeloid/lymphoid | 4297 | yes | | AML, | L | T, O | MLL, MLLT1, |
| | or mixed- | | | | ALL | | | MLLT2, |
| | lineage | | | | | | | MLLT3, |
| | leukemia | | | | | | | MLLT4, |
| | (trithorax | | | | | | | MLLT7, |
| | homolog, | | | | | | | MLLT10, |
| | Drosophila) | | | | | | | MLLT6, ELL, |
| | | | | | | | | EPS15, AF1Q, |
| | | | | | | | | CREBBP, |
| | | | | | | | | SH3GL1, |
| | | | | | | | | FNBP1, |
| | | | | | | | | PNUTL1, |
| | | | | | | | | MSF, GPHN, |
| | | | | | | | | GMPS, |
| | | | | | | | | SSH3BP1, |
| | | | | | | | | ARHGEF12, |
| | | | | | | | | GAS7, |
| | | | | | | | | FOXO3A, |
| | | | | | | | | LAF4, LCX, |
| | | | | | | | | SEPT6, LPP, |
| | | | | | | | | CBFA2T1, |
| | | | | | | | | GRAF, EP300, |
| | | | | | | | | PICALM, |
| | | | | | | | | HEAB |
| MLLT1 | myeloid/lymphoid | 4298 | yes | | AL | L | T | MLL |
| | or mixed- | | | | | | | |
| | lineage | | | | | | | |
| | leukemia | | | | | | | |
| | (trithorax | | | | | | | |
| | homolog, | | | | | | | |
| | Drosophila); | | | | | | | |
| | translocated to, | | | | | | | |
| | 1 (ENL) | | | | | | | |
| MLLT10 | myeloid/lymphoid | 8028 | yes | | AL | L | T | MLL, |
| | or mixed- | | | | | | | PICALM, |
| | lineage | | | | | | | CDK6 |
| | leukemia | | | | | | | |
| | (trithorax | | | | | | | |
| | homolog, | | | | | | | |
| | Drosophila); | | | | | | | |
| | translocated to, | | | | | | | |
| | 10 (AF10) | | | | | | | |
| MLLT2 | myeloid/lymphoid | 4299 | yes | | AL | L | T | MLL |
| | or mixed- | | | | | | | |
| | lineage | | | | | | | |
| | leukemia | | | | | | | |
| | (trithorax | | | | | | | |
| | homolog, | | | | | | | |
| | Drosophila); | | | | | | | |
| | translocated to, | | | | | | | |
| | 2 (AF4) | | | | | | | |
| MLLT3 | myeloid/lymphoid | 4300 | yes | | ALL | L | T | MLL |
| | or mixed- | | | | | | | |
| | lineage | | | | | | | |
| | leukemia | | | | | | | |
| | (trithorax | | | | | | | |
| | homolog, | | | | | | | |
| | Drosophila); | | | | | | | |
| | translocated to, | | | | | | | |
| | 3 (AF9) | | | | | | | |
| MLLT4 | myeloid/lymphoid | 4301 | yes | | AL | L | T | MLL |
| | or mixed- | | | | | | | |
| | lineage | | | | | | | |
| | leukemia | | | | | | | |
| | (trithorax | | | | | | | |
| | homolog, | | | | | | | |
| | Drosophila); | | | | | | | |
| | translocated to, | | | | | | | |
| | 4 (AF6) | | | | | | | |
| MLLT6 | myeloid/lymphoid | 4302 | yes | | AL | L | T | MLL |
| | or mixed- | | | | | | | |
| | lineage | | | | | | | |
| | leukemia | | | | | | | |
| | (trithorax | | | | | | | |
| | homolog, | | | | | | | |
| | Drosophila); | | | | | | | |
| | translocated to, | | | | | | | |
| | 6 (AF17) | | | | | | | |
| MLLT7 | myeloid/lymphoid | 4303 | yes | | AL | L | T | MLL |
| | or mixed- | | | | | | | |
| | lineage | | | | | | | |
| | leukemia | | | | | | | |
| | (trithorax | | | | | | | |
| | homolog, | | | | | | | |
| | Drosophila); | | | | | | | |
| | translocated to, | | | | | | | |
| | 7 (AFX1) | | | | | | | |
| MN1 | meningioma | 4330 | yes | | AML, | L, O | T | ETV6 |
| | (disrupted in | | | | meningioma | | | |
| | balanced | | | | | | | |
| | translocation) 1 | | | | | | | |
| MPL | myeloproliferative | 4352 | yes | yes | MPD | L | Mis | . |
| | leukemia | | | | | | | |
| | virus | | | | | | | |
| | oncogene, | | | | | | | |
| | thrombopoietin | | | | | | | |
| | receptor | | | | | | | |
| MSF | MLL septin- | 10801 | yes | | AML* | L | T | MLL |
| | like fusion | | | | | | | |
| MSH2 | mutS homolog | 4436 | yes | yes | colorectal, | E | D, | . |
| | 2 (E. coli) | | | | endometrial, | | Mis, | |
| | | | | | ovarian | | N, F, S | |
| MSH6 | mutS homolog | 2956 | yes | yes | colorectal, | E | Mis, | . |
| | 6 (E. coli) | | | | endometrial, | | N, F, S | |
| | | | | | ovarian | | | |
| MSI2 | musashi | 124540 | yes | | CML | L | T | HOXA9 |
| | homolog 2 | | | | | | | |
| | (Drosophila) | | | | | | | |
| MSN | moesin | 4478 | yes | | ALCL | L | T | ALK |
| MTCP1 | mature T-cell | 4515 | yes | | T cell | L | T | TRA@ |
| | proliferation 1 | | | | prolymphocytic | | | |
| | | | | | leukemia | | | |
| MUC1 | mucin 1, | 4582 | yes | | B-NHL | L | T | IGH@ |
| | transmembrane | | | | | | | |
| MUTYH | mutY homolog | 4595 | | yes | colorectal | E | Mis | . |
| | (E. coli) | | | | | | | |
| MYC | v-myc | 4609 | yes | | Burkitt | L, E | A, T | IGK@, BCL5, |
| | myelocytomatosis | | | | lymphoma, | | | BCL7A, |
| | viral | | | | amplified | | | BTG1, |
| | oncogene | | | | in | | | TRA@, IGH@ |
| | homolog | | | | other | | | |
| | (avian) | | | | cancers, | | | |
| | | | | | B-CLL | | | |
| MYCL1 | v-myc | 4610 | yes | | small | E | A | . |
| | myelocytomatosis | | | | cell lung | | | |
| | viral | | | | | | | |
| | oncogene | | | | | | | |
| | homolog 1, | | | | | | | |
| | lung | | | | | | | |
| | carcinoma | | | | | | | |
| | derived (avian) | | | | | | | |
| MYCN | v-myc | 4613 | yes | | neuroblastoma | O | A | . |
| | myelocytomatosis | | | | | | | |
| | viral | | | | | | | |
| | related | | | | | | | |
| | oncogene, | | | | | | | |
| | neuroblastoma | | | | | | | |
| | derived (avian) | | | | | | | |
| MYH11 | myosin, heavy | 4629 | yes | | AML | L | T | CBFB |
| | polypeptide | | | | | | | |
| | 11, smooth | | | | | | | |
| | muscle | | | | | | | |
| MYH9 | myosin, heavy | 4627 | yes | | ALCL | L | T | ALK |
| | polypeptide 9, | | | | | | | |
| | non-muscle | | | | | | | |
| MYST4 | MYST histone | 23522 | yes | | AML | L | T | CREBBP |
| | acetyltransferase | | | | | | | |
| | (monocytic | | | | | | | |
| | leukemia) 4 | | | | | | | |
| | (MORF) | | | | | | | |
| NACA | nascent- | 4666 | yes | | NHL | L | T | BCL6 |
| | polypeptide- | | | | | | | |
| | associated | | | | | | | |
| | complex alpha | | | | | | | |
| | polypeptide | | | | | | | |
| NBS1 | Nijmegen | 4683 | | yes | NHL, | L, E, | Mis, | . |
| | breakage | | | | glioma, | M, O | N, F | |
| | syndrome 1 | | | | medullo | | | |
| | (nibrin) | | | | blastoma, | | | |
| | | | | | rhabdomyosarcoma | | | |
| NCOA1 | nuclear | 8648 | yes | | alveolar | M | T | PAX3 |
| | receptor | | | | rhadomyosarcoma | | | |
| | coactivator 1 | | | | | | | |
| NCOA2 | nuclear | 10499 | yes | | AML | L | T | RUNXBP2 |
| | receptor | | | | | | | |
| | coactivator 2 | | | | | | | |
| | (TIF2) | | | | | | | |
| NCOA4 | nuclear | 8031 | yes | | papillary | E | T | RET |
| | receptor | | | | thyroid | | | |
| | coactivator 4- | | | | | | | |
| | PTC3 (ELE1) | | | | | | | |
| NF1 | neurofibromatosis | 4763 | yes | yes | neurofibroma, | O | D, | . |
| | type 1 | | | | glioma | | Mis, | |
| | gene | | | | | | N, F, | |
| | | | | | | | S, O | |
| NF2 | neurofibromatosis | 4771 | yes | yes | meningioma, | O | D, | . |
| | type 2 | | | | acoustic | | Mis, | |
| | gene | | | | neuroma | | N, F, | |
| | | | | | | | S, O | |
| NFKB2 | nuclear factor | 4791 | yes | | B-NHL | L | T | IGH@ |
| | of kappa light | | | | | | | |
| | polypeptide | | | | | | | |
| | gene enhancer | | | | | | | |
| | in B-cells 2 | | | | | | | |
| | (p49/p100) | | | | | | | |
| NIN | ninein | 51199 | yes | | MPD | L | T | PDGFRB |
| | (GSK3B | | | | | | | |
| | interacting | | | | | | | |
| | protein) | | | | | | | |
| NONO | non-POU | 4841 | yes | | papillary | E | T | TFE3 |
| | domain | | | | renal | | | |
| | containing, | | | | cancer | | | |
| | octamer- | | | | | | | |
| | binding | | | | | | | |
| NOTCH1 | Notch | 4851 | yes | | T-ALL | L | T, | TRB@ |
| | homolog 1, | | | | | | Mis, O | |
| | translocation- | | | | | | | |
| | associated | | | | | | | |
| | (Drosophila) | | | | | | | |
| | (TAN1) | | | | | | | |
| NOTCH2 | Notch | 4853 | yes | | marginal | L | N, F | . |
| | homolog 2 | | | | zone | | Mis | |
| | | | | | lymphoma, | | | |
| | | | | | DLBCL | | | |
| NPM1 | nucleophosmin | 4869 | yes | | NHL, | L | T, F | ALK, RARA, |
| | (nucleolar | | | | APL, | | | MLF1 |
| | phosphoprotein | | | | AML | | | |
| | B23, | | | | | | | |
| | numatrin) | | | | | | | |
| NR4A3 | nuclear | 8013 | yes | | extraskeletal | M | T | EWSR1 |
| | receptor | | | | myxoid | | | |
| | subfamily 4, | | | | chondrosarcoma | | | |
| | group A, | | | | | | | |
| | member 3 | | | | | | | |
| | (NOR1) | | | | | | | |
| NRAS | neuroblastoma | 4893 | yes | | melanoma, | L, E | Mis | . |
| | RAS viral (v- | | | | MM, | | | |
| | ras) oncogene | | | | AML, | | | |
| | homolog | | | | thyroid | | | |
| NSD1 | nuclear | 64324 | yes | | AML | L | T | NUP98 |
| | receptor | | | | | | | |
| | binding SET | | | | | | | |
| | domain protein 1 | | | | | | | |
| NTRK1 | neurotrophic | 4914 | yes | | papillary | E | T | TPM3, TPR, |
| | tyrosine | | | | thyroid | | | TFG |
| | kinase, | | | | | | | |
| | receptor, type 1 | | | | | | | |
| NTRK3 | neurotrophic | 4916 | yes | | congenital | E, M | T | ETV6 |
| | tyrosine | | | | fibrosarcoma, | | | |
| | kinase, | | | | Secretory | | | |
| | receptor, type 3 | | | | breast | | | |
| NUMA1 | nuclear mitotic | 4926 | yes | | APL | L | T | RARA |
| | apparatus | | | | | | | |
| | protein 1 | | | | | | | |
| NUP214 | nucleoporin | 8021 | yes | | AML, | L | T | DEK, SET, |
| | 214 kDa | | | | T-ALL | | | ABL1 |
| | (CAN) | | | | | | | |
| NUP98 | nucleoporin | 4928 | yes | | AML | L | T | HOXA9, |
| | 98 kDa | | | | | | | NSD1, |
| | | | | | | | | WHSC1L1, |
| | | | | | | | | DDX10, |
| | | | | | | | | TOP1, |
| | | | | | | | | HOXD13, |
| | | | | | | | | PMX1, |
| | | | | | | | | HOXA13, |
| | | | | | | | | HOXD11, |
| | | | | | | | | HOXA11, |
| | | | | | | | | RAP1GDS1, |
| | | | | | | | | HOXC11 |
| NUT | nuclear protien | 256646 | yes | | lethal | E | T | BRD4, BRD3 |
| | in testis | | | | midline | | | |
| | | | | | carcinoma | | | |
| | | | | | of | | | |
| | | | | | young | | | |
| | | | | | people | | | |
| OLIG2 | oligodendrocyte | 10215 | yes | | T-ALL | L | T | TRA@ |
| | lineage | | | | | | | |
| | transcription | | | | | | | |
| | factor 2 | | | | | | | |
| | (BHLHB1) | | | | | | | |
| OMD | osteomodulin | 4958 | yes | | aneurysmal | M | T | USP6 |
| | | | | | bone | | | |
| | | | | | cysts | | | |
| PAFAH1B2 | platelet- | 5049 | yes | | MLCLS | L | T | IGH@ |
| | activating | | | | | | | |
| | factor | | | | | | | |
| | acetylhydrolase, | | | | | | | |
| | isoform Ib, | | | | | | | |
| | beta subunit | | | | | | | |
| | 30 kDa | | | | | | | |
| PALB2 | partner and | 79728 | | yes | Wilms | L, O, E | F, N, | . |
| | localizer of | | | | tumor, | | Mis | |
| | BRCA2 | | | | medulloblastoma, | | | |
| | | | | | AML, | | | |
| | | | | | breast | | | |
| PAX3 | paired box | 5077 | yes | | alveolar | M | T | FOXO1A, |
| | gene 3 | | | | rhabdomyosarcoma | | | NCOA1 |
| PAX5 | paired box | 5079 | yes | | NHL, | L | T, | IGH@, ETV6, |
| | gene 5 (B-cell | | | | ALL, B- | | Mis, | PML, FOXP1, |
| | lineage | | | | ALL | | D, F, S | ZNF521, ELN |
| | specific | | | | | | | |
| | activator | | | | | | | |
| | protein) | | | | | | | |
| PAX7 | paired box | 5081 | yes | | alveolar | M | T | FOXO1A |
| | gene 7 | | | | rhabdomyosarcoma | | | |
| PAX8 | paired box | 7849 | yes | | follicular | E | T | PPARG |
| | gene 8 | | | | thyroid | | | |
| PBX1 | pre-B-cell | 5087 | yes | | pre B- | L, M | T | TCF3, EWSR1 |
| | leukemia | | | | ALL, | | | |
| | transcription | | | | myoepithelioma | | | |
| | factor 1 | | | | | | | |
| PCM1 | pericentriolar | 5108 | yes | | papillary | E, L | T | RET, JAK2 |
| | material 1 | | | | thyroid, | | | |
| | (PTC4) | | | | CML, | | | |
| | | | | | MPD | | | |
| PCSK7 | proprotein | 9159 | yes | | MLCLS | L | T | IGH@ |
| | convertase | | | | | | | |
| | subtilisin/kexin | | | | | | | |
| | type 7 | | | | | | | |
| PDE4DIP | phosphodiesterase | 9659 | yes | | MPD | L | T | PDGFRB |
| | 4D | | | | | | | |
| | interacting | | | | | | | |
| | protein | | | | | | | |
| | (myomegalin) | | | | | | | |
| PDGFB | platelet- | 5155 | yes | | DFSP | M | T | COL1A1 |
| | derived growth | | | | | | | |
| | factor beta | | | | | | | |
| | polypeptide | | | | | | | |
| | (simian | | | | | | | |
| | sarcoma viral | | | | | | | |
| | (v-sis) | | | | | | | |
| | oncogene | | | | | | | |
| | homolog) | | | | | | | |
| PDGFRA | platelet- | 5156 | yes | | GIST, | L, M, O | Mis, | FIP1L1 |
| | derived growth | | | | idiopathic | | O, T | |
| | factor, alpha- | | | | hypereosinophilic | | | |
| | receptor | | | | syndrome | | | |
| PDGFRB | platelet- | 5159 | yes | | MPD, | L | T | ETV6, |
| | derived growth | | | | AML, | | | TRIP11, HIP1, |
| | factor receptor, | | | | CMML, | | | RAB5EP, H4, |
| | beta | | | | CML | | | NIN, |
| | polypeptide | | | | | | | HCMOGT-1, |
| | | | | | | | | PDE4DIP |
| PER1 | period | 5187 | yes | | AML, | L | T | ETV6 |
| | homolog 1 | | | | CMML | | | |
| | (Drosophila) | | | | | | | |
| PHOX2B | paired-like | 8929 | yes | yes | neuroblastoma | O | Mis, F | . |
| | homeobox 2b | | | | | | | |
| PICALM | phosphatidylinositol | 8301 | yes | | TALL, | L | T | MLLT10, |
| | binding | | | | AML, | | | MLL |
| | clathrin | | | | | | | |
| | assembly | | | | | | | |
| | protein | | | | | | | |
| | (CALM) | | | | | | | |
| PIK3CA | phosphoinositide- | 5290 | yes | | colorectal, | E, O | Mis | . |
| | 3-kinase, | | | | gastric, | | | |
| | catalytic, alpha | | | | gliobastoma, | | | |
| | polypeptide | | | | breast | | | |
| PIK3R1 | phosphoinositide- | 5295 | yes | | gliobastoma, | E, O | Mis, | . |
| | 3-kinase, | | | | ovarian, | | F, O | |
| | regulatory | | | | colorectal | | | |
| | subunit 1 | | | | | | | |
| | (alpha) | | | | | | | |
| PIM1 | pim-1 | 5292 | yes | | NHL | L | T | BCL6 |
| | oncogene | | | | | | | |
| PLAG1 | pleiomorphic | 5324 | yes | | salivary | E | T | TCEA1, LIFR, |
| | adenoma gene 1 | | | | adenoma | | | CTNNB1, |
| | | | | | | | | CHCHD7 |
| PML | promyelocytic | 5371 | yes | | APL, | L | T | RARA, PAX5 |
| | leukemia | | | | ALL | | | |
| PMS1 | PMS1 | 5378 | | yes | colorectal, | E | Mis, N | . |
| | postmeiotic | | | | endometrial, | | | |
| | segregation | | | | ovarian | | | |
| | increased 1 (S. cerevisiae) | | | | | | | |
| PMS2 | PMS2 | 5395 | | yes | colorectal, | E | Mis, | . |
| | postmeiotic | | | | endometrial, | | N, F | |
| | segregation | | | | ovarian, | | | |
| | increased 2 (S. cerevisiae) | | | | medulloblastoma, | | | |
| | | | | | glioma | | | |
| PMX1 | paired | 5396 | yes | | AML | L | T | NUP98 |
| | mesoderm | | | | | | | |
| | homeo box 1 | | | | | | | |
| PNUTL1 | Peanut like 1 | 5413 | yes | | AML | L | T | MLL |
| | (Drosophila) | | | | | | | |
| POU2AF1 | POU domain, | 5450 | yes | | NHL | L | T | BCL6 |
| | class 2, | | | | | | | |
| | associating | | | | | | | |
| | factor 1 | | | | | | | |
| | (OBF1) | | | | | | | |
| POU5F1 | POU domain, | 5460 | yes | | sarcoma | M | T | EWSR1 |
| | class 5, | | | | | | | |
| | transcription | | | | | | | |
| | factor 1 | | | | | | | |
| PPARG | peroxisome | 5468 | yes | | follicular | E | T | PAX8 |
| | proliferative | | | | thyroid | | | |
| | activated | | | | | | | |
| | receptor, | | | | | | | |
| | gamma | | | | | | | |
| PRCC | papillary renal | 5546 | yes | | papillary | E | T | TFE3 |
| | cell carcinoma | | | | renal | | | |
| | (translocation- | | | | | | | |
| | associated) | | | | | | | |
| PRDM16 | PR domain | 63976 | yes | | MDS, | L | T | EVI1 |
| | containing 16 | | | | AML | | | |
| PRF1 | perforin1 (pore | 5551 | | yes | various | L | M | . |
| | forming | | | | leukaemia, | | | |
| | protein) | | | | lymphoma | | | |
| PRKAR1A | protein kinase, | 5573 | yes | yes | myxoma, | E, M | T, | RET |
| | cAMP- | | | | endocrine, | | Mis, | |
| | dependent, | | | | papillary | | N, F, S | |
| | regulatory, | | | | thyroid | | | |
| | type I, alpha | | | | | | | |
| | (tissue specific | | | | | | | |
| | extinguisher 1) | | | | | | | |
| PRO1073 | PRO1073 | 29005 | yes | | renal | E | T | TFEB |
| | protein | | | | cell | | | |
| | (ALPHA) | | | | carcinoma | | | |
| | | | | | (childhood | | | |
| | | | | | epithelioid) | | | |
| PSIP2 | PC4 and | 11168 | yes | | AML | L | T | NUP98 |
| | SFRS1 | | | | | | | |
| | interacting | | | | | | | |
| | protein 2 | | | | | | | |
| | (LEDGF) | | | | | | | |
| PTCH | Homolog of | 5727 | yes | yes | skin | E, M | Mis, | . |
| | Drosophila | | | | basal | | N, F, S | |
| | Patched gene | | | | cell, | | | |
| | | | | | medulloblastoma | | | |
| PTEN | phosphatase | 5728 | yes | yes | glioma, | L, E, | D, | . |
| | and tensin | | | | prostate, | M, O | Mis, | |
| | homolog gene | | | | endometrial, | | N, F, S | |
| | | | | | harmartoma, | | | |
| PTPN11 | protein | 5781 | yes | | JMML, | L | Mis | . |
| | tyrosine | | | | AML, | | | |
| | phosphatase, | | | | MDS | | | |
| | non-receptor | | | | | | | |
| | type 11 | | | | | | | |
| RAB5EP | rabaptin, RAB | 9135 | yes | | CMML | L | T | PDGFRB |
| | GTPase | | | | | | | |
| | binding | | | | | | | |
| | effector | | | | | | | |
| | protein 1 | | | | | | | |
| | (RABPT5) | | | | | | | |
| RAD51L1 | RAD51-like 1 | 5890 | yes | | lipoma, | M | T | HMGA2 |
| | (S. cerevisiae) | | | | uterine | | | |
| | (RAD51B) | | | | leiomyoma | | | |
| RAF1 | v-raf-1 murine | 5894 | yes | | pilocytic | M | T | SRGAP3 |
| | leukemia viral | | | | astrocytoma | | | |
| | oncogene | | | | | | | |
| | homolog 1 | | | | | | | |
| RANBP17 | RAN binding | 64901 | yes | | ALL | L | T | TRD@ |
| | protein 17 | | | | | | | |
| RAP1GDS1 | RAP1, GTP- | 5910 | yes | | T-ALL | L | T | NUP98 |
| | GDP | | | | | | | |
| | dissociation | | | | | | | |
| | stimulator 1 | | | | | | | |
| RARA | retinoic acid | 5914 | yes | | APL | L | T | PML, |
| | receptor, alpha | | | | | | | ZNF145, |
| | | | | | | | | TIF1, |
| | | | | | | | | NUMA1, |
| | | | | | | | | NPM1 |
| RB1 | retinoblastoma | 5925 | yes | yes | retinoblastoma, | L, E, | D, | . |
| | gene | | | | sarcoma, | M, O | Mis, | |
| | | | | | breast, | | N, F, S | |
| | | | | | small | | | |
| | | | | | cell lung | | | |
| RBM15 | RNA binding | 64783 | yes | | acute | L | T | MKL1 |
| | motif protein | | | | megakaryocytic | | | |
| | 15 | | | | leukemia | | | |
| RECQL4 | RecQ protein- | 9401 | | yes | osteosarcoma, | M | N, F, S | . |
| | like 4 | | | | skin | | | |
| | | | | | basal | | | |
| | | | | | and | | | |
| | | | | | sqamous | | | |
| | | | | | cell | | | |
| REL | v-rel | 5966 | yes | | Hodgkin | L | A | . |
| | reticuloendotheliosis | | | | Lymphoma | | | |
| | viral | | | | | | | |
| | oncogene | | | | | | | |
| | homolog | | | | | | | |
| | (avian) | | | | | | | |
| RET | ret proto- | 5979 | yes | yes | medullary | E, O | T, | H4, |
| | oncogene | | | | thyroid, | | Mis, | PRKAR1A, |
| | | | | | papillary | | N, F | NCOA4, |
| | | | | | thyroid, | | | PCM1, |
| | | | | | pheochromocytoma | | | GOLGA5, |
| | | | | | | | | TRIM33, |
| | | | | | | | | KTN1, |
| | | | | | | | | TRIM27, |
| | | | | | | | | HOOK3 |
| ROS1 | v-ros UR2 | 6098 | yes | | glioblastoma, | O | T | GOPC, ROS1 |
| | sarcoma virus | | | | NSCLC | | | |
| | oncogene | | | | | | | |
| | homolog 1 | | | | | | | |
| | (avian) | | | | | | | |
| RPL22 | ribosomal | 6146 | yes | | AML, | L | T | RUNX1 |
| | protein L22 | | | | CML | | | |
| | (EAP) | | | | | | | |
| RPN1 | ribophorin I | 6184 | yes | | AML | L | T | EVI1 |
| RUNX1 | runt-related | 861 | yes | | AML, | L | T | RPL22, |
| | transcription | | | | preB- | | | MDS1, EVI1, |
| | factor 1 | | | | ALL, T- | | | CBFA2T3, |
| | (AML1) | | | | ALL | | | CBFA2T1, |
| | | | | | | | | ETV6, LAF4 |
| RUNXBP2 | runt-related | 7994 | yes | | AML | L | T | CREBBP, |
| | transcription | | | | | | | NCOA2, |
| | factor binding | | | | | | | EP300 |
| | protein 2 | | | | | | | |
| | (MOZ/ZNF220) | | | | | | | |
| SBDS | Shwachman- | 51119 | | yes | AML, | L | Gene | . |
| | Bodian- | | | | MDS | | Conversion | |
| | Diamond | | | | | | | |
| | syndrome | | | | | | | |
| | protein | | | | | | | |
| SDH5 | chromosome | 54949 | | yes | paraganglioma | M | M | . |
| | 11 open | | | | | | | |
| | reading frame | | | | | | | |
| | 79 | | | | | | | |
| SDHB | succinate | 6390 | | yes | paraganglioma, | O | Mis, | . |
| | dehydrogenase | | | | pheochromocytoma | | N, F | |
| | complex, | | | | | | | |
| | subunit B, iron | | | | | | | |
| | sulfur (Ip) | | | | | | | |
| SDHC | succinate | 6391 | | yes | paraganglioma, | O | Mis, | . |
| | dehydrogenase | | | | pheochromocytoma | | N, F | |
| | complex, | | | | | | | |
| | subunit C, | | | | | | | |
| | integral | | | | | | | |
| | membrane | | | | | | | |
| | protein, 15 kDa | | | | | | | |
| SDHD | succinate | 6392 | | yes | paraganglioma, | O | Mis, | . |
| | dehydrogenase | | | | pheochromocytoma | | N, F, S | |
| | complex, | | | | | | | |
| | subunit D, | | | | | | | |
| | integral | | | | | | | |
| | membrane | | | | | | | |
| | protein | | | | | | | |
| SEPT6 | septin 6 | 23157 | yes | | AML | L | T | MLL |
| SET | SET | 6418 | yes | | AML | L | T | NUP214 |
| | translocation | | | | | | | |
| SFPQ | splicing factor | 6421 | yes | | papillary | E | T | TFE3 |
| | proline/glutamine | | | | renal | | | |
| | rich(polypyrimidine | | | | cell | | | |
| | tract | | | | | | | |
| | binding | | | | | | | |
| | protein | | | | | | | |
| | associated) | | | | | | | |
| SFRS3 | splicing factor, | 6428 | yes | | follicular | L | T | BCL6 |
| | arginine/serine- | | | | lymphoma | | | |
| | rich 3 | | | | | | | |
| SH3GL1 | SH3-domain | 6455 | yes | | AL | L | T | MLL |
| | GRB2-like 1 | | | | | | | |
| | (EEN) | | | | | | | |
| SIL | TAL1 (SCL) | 6491 | yes | | T-ALL | L | T | TAL1 |
| | interrupting | | | | | | | |
| | locus | | | | | | | |
| SLC45A3 | solute carrier | 85414 | yes | | prostate | E | T | ETV1, ETV5, |
| | family 45, | | | | | | | ELK4, ERG |
| | member 3 | | | | | | | |
| SMARCA4 | SWI/SNF | 6597 | yes | | NSCLC | E | F, N, | . |
| | related, matrix | | | | | | Mis | |
| | associated, | | | | | | | |
| | actin | | | | | | | |
| | dependent | | | | | | | |
| | regulator of | | | | | | | |
| | chromatin, | | | | | | | |
| | subfamily a, | | | | | | | |
| | member 4 | | | | | | | |
| SMARCB1 | SWI/SNF | 6598 | yes | yes | malignant | M | D, N, | . |
| | related, matrix | | | | rhabdoid | | F, S | |
| | associated, | | | | | | | |
| | actin | | | | | | | |
| | dependent | | | | | | | |
| | regulator of | | | | | | | |
| | chromatin, | | | | | | | |
| | subfamily b, | | | | | | | |
| | member 1 | | | | | | | |
| SMO | smoothened | 6608 | yes | | skin | E | Mis | . |
| | homolog | | | | basal | | | |
| | (Drosophila) | | | | cell | | | |
| SOCS1 | suppressor of | 8651 | yes | | Hodgkin | L | F, O | . |
| | cytokine | | | | Lymphoma, | | | |
| | signaling 1 | | | | PMBL | | | |
| SRGAP3 | SLIT-ROBO | 9901 | yes | | pilocytic | M | T | RAF1 |
| | Rho GTPase | | | | astrocytoma | | | |
| | activating | | | | | | | |
| | protein 3 | | | | | | | |
| SS18 | synovial | 6760 | yes | | synovial | M | T | SSX1, SSX2 |
| | sarcoma | | | | sarcoma | | | |
| | translocation, | | | | | | | |
| | chromosome | | | | | | | |
| | 18 | | | | | | | |
| SS18L1 | synovial | 26039 | yes | | synovial | M | T | SSX1 |
| | sarcoma | | | | sarcoma | | | |
| | translocation | | | | | | | |
| | gene on | | | | | | | |
| | chromosome | | | | | | | |
| | 18-like 1 | | | | | | | |
| SSH3BP1 | spectrin SH3 | 10006 | yes | | AML | L | T | MLL |
| | domain | | | | | | | |
| | binding | | | | | | | |
| | protein 1 | | | | | | | |
| SSX1 | synovial | 6756 | yes | | synovial | M | T | SS18 |
| | sarcoma, X | | | | sarcoma | | | |
| | breakpoint 1 | | | | | | | |
| SSX2 | synovial | 6757 | yes | | synovial | M | T | SS18 |
| | sarcoma, X | | | | sarcoma | | | |
| | breakpoint 2 | | | | | | | |
| SSX4 | synovial | 6759 | yes | | synovial | M | T | SS18 |
| | sarcoma, X | | | | sarcoma | | | |
| | breakpoint 4 | | | | | | | |
| STK11 | serine/threonine | 6794 | yes | yes | NSCLC, | E, M, O | D, | . |
| | kinase 11 | | | | pancreatic, | | Mis, | |
| | gene (LKB1) | | | | jejunal | | N, F, S | |
| | | | | | harmartoma, | | | |
| | | | | | ovarian, | | | |
| | | | | | testicular, | | | |
| STL | Six-twelve | 7955 | yes | | B-ALL | L | T | ETV6 |
| | leukemia gene | | | | | | | |
| SUFU | suppressor of | 51684 | yes | yes | medulloblastoma | O | D, F, S | . |
| | fused homolog | | | | | | | |
| | (Drosophila) | | | | | | | |
| SUZ12 | suppressor of | 23512 | yes | | endometrial | M | T | JAZF1 |
| | zeste 12 | | | | stromal | | | |
| | homolog | | | | tumors | | | |
| | (Drosophila) | | | | | | | |
| SYK | spleen tyrosine | 6850 | yes | | MDS, | L | T | ETV6, ITK |
| | kinase | | | | peripheral | | | |
| | | | | | T-cell | | | |
| | | | | | lymphoma | | | |
| TAF15 | TAF15 RNA | 8148 | yes | | extraskeletal | L, M | T | TEC, CHN1, |
| | polymerase II, | | | | myxoid | | | ZNF384 |
| | TATA box | | | | chondrosarcomas, | | | |
| | binding | | | | ALL | | | |
| | protein (TBP)- | | | | | | | |
| | associated | | | | | | | |
| | factor, 68 kDa | | | | | | | |
| TAL1 | T-cell acute | 6886 | yes | | lymphoblastic | L | T | TRD@, SIL |
| | lymphocytic | | | | leukemia/ | | | |
| | leukemia 1 | | | | biphasic | | | |
| | (SCL) | | | | | | | |
| TAL2 | T-cell acute | 6887 | yes | | T-ALL | L | T | TRB@ |
| | lymphocytic | | | | | | | |
| | leukemia 2 | | | | | | | |
| TCEA1 | transcription | 6917 | yes | | salivary | E | T | PLAG1 |
| | elongation | | | | adenoma | | | |
| | factor A (SII), 1 | | | | | | | |
| TCF1 | transcription | 6927 | yes | yes | hepatic | E | Mis, F | . |
| | factor 1, | | | | adenoma, | | | |
| | hepatic | | | | hepatocellular | | | |
| | (HNF1) | | | | ca | | | |
| TCF12 | transcription | 6938 | yes | | extraskeletal | M | T | TEC |
| | factor 12 | | | | myxoid | | | |
| | (HTF4, helix- | | | | chondrosarcoma | | | |
| | loop-helix | | | | | | | |
| | transcription | | | | | | | |
| | factors 4) | | | | | | | |
| TCF3 | transcription | 6929 | yes | | pre B- | L | T | PBX1, HLF, |
| | factor 3 (E2A | | | | ALL | | | TFPT |
| | immunoglobulin | | | | | | | |
| | enhancer | | | | | | | |
| | binding factors | | | | | | | |
| | E12/E47) | | | | | | | |
| TCL1A | T-cell | 8115 | yes | | T-CLL | L | T | TRA@ |
| | leukemia/lymphoma | | | | | | | |
| | 1A | | | | | | | |
| TCL6 | T-cell | 27004 | yes | | T-ALL | L | T | TRA@ |
| | leukemia/lymphoma 6 | | | | | | | |
| TET2 | tet oncogene | 54790 | yes | | MDS | L | Mis | . |
| | family | | | | | | N, F | |
| | member 2 | | | | | | | |
| TFE3 | transcription | 7030 | yes | | papillary | E | T | SFPQ, |
| | factor binding | | | | renal, | | | ASPSCR1, |
| | to IGHM | | | | alveolar | | | PRCC, |
| | enhancer 3 | | | | soft part | | | NONO, CLTC |
| | | | | | sarcoma, | | | |
| | | | | | renal | | | |
| TFEB | transcription | 7942 | yes | | renal | E, M | T | ALPHA |
| | factor EB | | | | (childhood | | | |
| | | | | | epithelioid) | | | |
| TFG | TRK-fused | 10342 | yes | | papillary | E, L | T | NTRK1, ALK |
| | gene | | | | thyroid, | | | |
| | | | | | ALCL, | | | |
| | | | | | NSCLC | | | |
| TFPT | TCF3 (E2A) | 29844 | yes | | pre-B | L | T | TCF3 |
| | fusion partner | | | | ALL | | | |
| | (in childhood | | | | | | | |
| | Leukemia) | | | | | | | |
| TFRC | transferrin | 7037 | yes | | NHL | L | T | BCL6 |
| | receptor (p90, | | | | | | | |
| | CD71) | | | | | | | |
| THRAP3 | thyroid | 9967 | yes | | aneurysmal | M | T | USP6 |
| | hormone | | | | bone | | | |
| | recetor | | | | cysts | | | |
| | associated | | | | | | | |
| | protein 3 | | | | | | | |
| | (TRAP150) | | | | | | | |
| TIF1 | transcriptional | 8805 | yes | | APL | L | T | RARA |
| | intermediary | | | | | | | |
| | factor 1 | | | | | | | |
| | (PTC6, TIF1A) | | | | | | | |
| TLX1 | T-cell | 3195 | yes | | T-ALL | L | T | TRB@, |
| | leukemia, | | | | | | | TRD@ |
| | homeobox 1 | | | | | | | |
| | (HOX11) | | | | | | | |
| TLX3 | T-cell | 30012 | yes | | T-ALL | L | T | BCL11B |
| | leukemia, | | | | | | | |
| | homeobox 3 | | | | | | | |
| | (HOX11L2) | | | | | | | |
| TMPRSS2 | transmembrane | 7113 | yes | | prostate | E | T | ERG, ETV1, |
| | protease, | | | | | | | ETV4, ETV5 |
| | serine 2 | | | | | | | |
| TNFRSF17 | tumor necrosis | 608 | yes | | intestinal | L | T | IL2 |
| | factor receptor | | | | T-cell | | | |
| | superfamily, | | | | lymphoma | | | |
| | member 17 | | | | | | | |
| TNFRSF6 | tumor necrosis | 355 | yes | | TGCT, | L, E, O | Mis | . |
| | factor receptor | | | | nasal | | | |
| | superfamily, | | | | NK/T | | | |
| | member 6 | | | | lymphoma, | | | |
| | (FAS) | | | | skin | | | |
| | | | | | squamous | | | |
| | | | | | cell ca- | | | |
| | | | | | burn | | | |
| | | | | | scar- | | | |
| | | | | | related | | | |
| TOP1 | topoisomerase | 7150 | yes | | AML* | L | T | NUP98 |
| | (DNA) I | | | | | | | |
| TP53 | tumor protein | 7157 | yes | yes | breast, | L, E, | Mis, | . |
| | p53 | | | | colorectal, | M, O | N, F | |
| | | | | | lung, | | | |
| | | | | | sarcoma, | | | |
| | | | | | adrenocortical, | | | |
| | | | | | glioma, | | | |
| | | | | | multiple | | | |
| | | | | | other | | | |
| | | | | | tumor | | | |
| | | | | | types | | | |
| TPM3 | tropomyosin 3 | 7170 | yes | | papillary | E, L | T | NTRK1, ALK |
| | | | | | thyroid, | | | |
| | | | | | ALCL | | | |
| TPM4 | tropomyosin 4 | 7171 | yes | | ALCL | L | T | ALK |
| TPR | translocated | 7175 | yes | | papillary | E | T | NTRK1 |
| | promoter | | | | thyroid | | | |
| | region | | | | | | | |
| TRA@ | T cell receptor | 6955 | yes | | T-ALL | L | T | ATL, OLIG2, |
| | alpha locus | | | | | | | MYC, |
| | | | | | | | | TCL1A, |
| | | | | | | | | TCL6, |
| | | | | | | | | MTCP1, TCL6 |
| TRB@ | T cell receptor | 6957 | yes | | T-ALL | L | T | HOX11, LCK, |
| | beta locus | | | | | | | NOTCH1, |
| | | | | | | | | TAL2, LYL1 |
| TRD@ | T cell receptor | 6964 | yes | | T-cell | L | T | TAL1, |
| | delta locus | | | | leukemia | | | HOX11, |
| | | | | | | | | TLX1, LMO1, |
| | | | | | | | | LMO2, |
| | | | | | | | | RANBP17 |
| TRIM27 | tripartite | 5987 | yes | | papillary | E | T | RET |
| | motif- | | | | thyroid | | | |
| | containing 27 | | | | | | | |
| TRIM33 | tripartite | 51592 | yes | | papillary | E | T | RET |
| | motif- | | | | thyroid | | | |
| | containing 33 | | | | | | | |
| | (PTC7, TIF1G) | | | | | | | |
| TRIP11 | thyroid | 9321 | yes | | AML | L | T | PDGFRB |
| | hormone | | | | | | | |
| | receptor | | | | | | | |
| | interactor 11 | | | | | | | |
| TSC1 | tuberous | 7248 | | yes | hamartoma, | E, O | D, | . |
| | sclerosis 1 | | | | renal | | Mis, | |
| | gene | | | | cell | | N, F, S | |
| TSC2 | tuberous | 7249 | | yes | hamartoma, | E, O | D, | . |
| | sclerosis 2 | | | | renal | | Mis, | |
| | gene | | | | cell | | N, F, S | |
| TSHR | thyroid | 7253 | yes | yes | toxic | E | Mis | . |
| | stimulating | | | | thyroid | | | |
| | hormone | | | | adenoma | | | |
| | receptor | | | | | | | |
| TTL | tubulin | 150465 | yes | | ALL | L | T | ETV6 |
| | tyrosine ligase | | | | | | | |
| USP6 | ubiquitin | 9098 | yes | | aneurysmal | M | T | COL1A1, |
| | specific | | | | bone | | | CDH11, |
| | peptidase 6 | | | | cysts | | | ZNF9, OMD |
| | (Tre-2 | | | | | | | |
| | oncogene) | | | | | | | |
| VHL | von Hippel- | 7428 | yes | yes | renal, | E, M, O | D, | . |
| | Lindau | | | | hemangioma, | | Mis, | |
| | syndrome gene | | | | pheochromocytoma | | N, F, S | |
| WAS | Wiskott- | 7454 | | | lymphoma | L | Mis, | . |
| | Aldrich | | | | | | N, F, S | |
| | syndrome | | | | | | | |
| WHSC1 | Wolf- | 7468 | yes | | MM | L | T | IGH@ |
| | Hirschhorn | | | | | | | |
| | syndrome | | | | | | | |
| | candidate | | | | | | | |
| | 1(MMSET) | | | | | | | |
| WHSC1L1 | Wolf- | 54904 | yes | | AML | L | T | NUP98 |
| | Hirschhorn | | | | | | | |
| | syndrome | | | | | | | |
| | candidate 1- | | | | | | | |
| | like 1 (NSD3) | | | | | | | |
| WRN | Werner | 7486 | | yes | osteosarcoma, | L, E, | Mis, | . |
| | syndrome | | | | meningioma, | M, O | N, F, S | |
| | (RECQL2) | | | | others | | | |
| WT1 | Wilms tumor 1 | 7490 | yes | yes | Wilms, | O | D, | EWSR1 |
| | gene | | | | desmoplastic | | Mis, | |
| | | | | | small | | N, F, S | |
| | | | | | round | | | |
| | | | | | cell | | | |
| | | | | | tumor | | | |
| WTX | family with | 139285 | yes | | Wilms | O | F, D, | . |
| | sequence | | | | tumor | | N, | |
| | similarity | | | | | | Mis, | |
| | 123B | | | | | | | |
| | (FAM123B) | | | | | | | |
| XPA | xeroderma | 7507 | | yes | skin | E | Mis, | . |
| | pigmentosum, | | | | basal | | N, F, S | |
| | complementation | | | | cell, skin | | | |
| | group A | | | | squamous | | | |
| | | | | | cell, | | | |
| | | | | | melanoma | | | |
| XPC | xeroderma | 7508 | | yes | skin | E | Mis, | . |
| | pigmentosum, | | | | basal | | N, F, S | |
| | complementation | | | | cell, skin | | | |
| | group C | | | | squamous | | | |
| | | | | | cell, | | | |
| | | | | | melanoma | | | |
| ZNF145 | zinc finger | 7704 | yes | | APL | L | T | RARA |
| | protein 145 | | | | | | | |
| | (PLZF) | | | | | | | |
| ZNF198 | zinc finger | 7750 | yes | | MPD, | L | T | FGFR1 |
| | protein 198 | | | | NHL | | | |
| ZNF278 | zinc finger | 23598 | yes | | Ewing | M | T | EWSR1 |
| | protein 278 | | | | sarcoma | | | |
| | (ZSG) | | | | | | | |
| ZNF331 | zinc finger | 55422 | yes | | follicular | E | T | . |
| | protein 331 | | | | thyroid | | | |
| | | | | | adenoma | | | |
| ZNF384 | zinc finger | 171017 | yes | | ALL | L | T | EWSR1, |
| | protein 384 | | | | | | | TAF15 |
| | (CIZ/NMP4) | | | | | | | |
| ZNF521 | zinc finger | 25925 | yes | | ALL | L | T | PAX5 |
| | protein 521 | | | | | | | |
| ZNF9 | zinc finger | 7555 | yes | | aneurysmal | M | T | USP6 |
| | protein 9 (a | | | | bone | | | |
| | cellular | | | | cysts | | | |
| | retroviral | | | | | | | |
| | nucleic acid | | | | | | | |
| | binding | | | | | | | |
| | protein) | | | | | | | |
| ZNFN1A1 | zinc finger | 10320 | yes | | ALL, | L | T | BCL6 |
| | protein, | | | | DLBL | | | |
| | subfamily 1A, | | | | | | | |
| | 1 (Ikaros) | | | | | | | |

A, amplification;
AEL, acute eosinophilic leukemia;
AL, acute leukemia;
ALCL, anaplastic large-cell lymphoma;
ALL, acute lymphocytic leukemia;
AML, acute myelogenous leukemia;
AML*, acute myelogenous leukemia (primarily treatment associated);
APL, acute promyelocytic leukemia;
B-ALL, B-cell acute lymphocytic leukemia;
B-CLL, B-cell Lymphocytic leukemia;
B-NHL, B-cell Non-Hodgkin Lymphoma;
CLL, chronic lymphatic leukemia;
CML, chronic myeloid leukemia;
CMML, chronic myelomonocytic leukemia;
CNS, central nervous system;
D, large deletion;
DFSP, dermatofibrosarcoma protuberans;
DLBL, diffuse large B-cell lymphoma;
DLCL, diffuse large-cell lymphoma;
Dom, dominant;
E, epithelial;
F, frameshift;
GIST, gastrointestinal stromal tumor;
JMML, juvenile myelomonocytic leukemia;
L, leukaemia/lymphoma;
M, mesenchymal;
MALT, mucosa-associated lymphoid tissue lymphoma;
MDS, myelodysplastic syndrome;
Mis, Missense;
MLCLS, mediastinal large cell lymphoma with sclerosis;
MM, multiple myeloma;
MPD, Myeloproliferative disorder;
N, nonsense;
NHL, non-Hodgkin lymphoma;
NK/T, natural killer T cell;
NSCLC, non small cell lung cancer;
O, other;
PMBL, primary mediastinal B-cell lymphoma;
pre-B All, pre-B-cell acute lymphoblastic leukemia;
Rec, reccessive;
S, splice site;
T, translocation;
T-ALL, T-cell acute lymphoblastic leukemia;
T-CLL, T-cell chronic lymphocytic leukemia;
TGCT, testicular germ cell tumor;
T-PLL, T cell prolymphocytic leukemia;
Germ., Germline.

### Library of GEOIs (Genetic Elements of Interest):

The term “genetic elements of interest” of “GEOI” refers to those genetic elements (e.g., genes) that have been linked or associated with cancer or associated with biological pathways of genes that drive cancer growth and metastasis. A library of genetic elements of interest refer to a plurality of specific genetic elements of interest or variations thereof (e.g., somatic or germline mutations) that have been linked to a human cancer or a tumorigenic phenotype or metastatic phenotype.

A collection of genetic elements (cDNAs, shRNAs), defined by different means, including genomically altered GEOIs such as ones resident in regions of genomic amplifications; somatic mutated genes such as “driver kinases” shown to harbor statistical significant mutations in diverse human cancers; components of a defined pathway or biological process or a class of molecules, such as metabolic pathway enzymes, or GPCRs.

The GEOIs may be categorized as genomics driven libraries, class based libraries, druggable genome libraries, or cellular process libraries, which are described in further detail below.

The libraries of the GEOIs are nucleic acid libraries. This includes nucleic acid libraries comprising nucleic acids that encode for the genes or genetic elements of interest. The nucleic acid libraries may also be made up of siRNA, shRNA, microRNA or an antisense nucleic acids to the genes or genetic elements of interest. In some embodiments, the nucleic acid library comprises nucleic acids encoding inactive or dominant negative versions of the genes or genetic elements of interest.

### Druggable Genome Libraries

Druggable genome libraries are libraries including genes that are known druggable enzymes implicated in human cancer. For example, human kinases are frequently altered in human cancer, either by amplification, overexpression, or mutation and have been successfully inhibited with small molecule inhibitors (i.e., Gleevec). Examples of druggable genome libraries include, but are not limited to, libraries of genes encoding kinases, phosphatases, histone methyltransferases, histone demethylases, and histone acetyltransferases, and histone deacetylases.

### Kinases

As used herein, the term “protein kinase” includes a protein or polypeptide which is capable of modulating its own phosphorylation state or the phosphorylation state of another protein or polypeptide. Protein kinases can have a specificity for (i.e., a specificity to phosphorylate) serine/threonine residues, tyrosine residues, or both serine/threonine and tyrosine residues, e.g., the dual specificity kinases. As referred to herein, protein kinases may include a catalytic domain of about 150-400 amino acid residues in length, preferably about 170-300 amino acid residues in length, or more preferably about 190-300 amino acid residues in length, which includes preferably 5-20, more preferably 5-15, or preferably 11 highly conserved motifs or subdomains separated by sequences of amino acids with reduced or minimal conservation. Specificity of a protein kinase for phosphorylation of either tyrosine or serine/threonine can be predicted by the sequence of two of the subdomains (VIb and VIII) in which different residues are conserved in each class (as described in, for example, Hanks et al. (1988) Science 241:42-52) the contents of which are incorporated herein by reference). These subdomains are also described in further detail herein.

Protein kinases play a role in signaling pathways associated with cellular growth. For example, protein kinases are involved in the regulation of signal transmission from cellular receptors, e.g., growth-factor receptors; entry of cells into mitosis; and the regulation of cytoskeleton function, e.g., actin bundling. Thus, the molecules of the present invention may be involved in: 1) the regulation of transmission of signals from cellular receptors, e.g., cardiac cell growth factor receptors; 2) the modulation of the entry of cells, e.g., cardiac precursor cells, into mitosis; 3) the modulation of cellular differentiation; 4) the modulation of cell death; and 5) the regulation of cytoskeleton function, e.g., actin bundling.

Inhibition or over stimulation of the activity of protein kinases involved in cell-cycle signaling pathways can lead to tumorigenesis and metastasis. For example, kinases such as c-Src, c-Abl, mitogen activated protein (MAP) kinase, phosphotidylinositol-3-kinase (PI3K) AKT, and the epidermal growth factor (EGF) receptor are commonly activated in cancer cells, and are known to contribute to tumorigenesis. Many of these occur in the same signaling pathway—for example, HER-kinase family members (HER1 [EGFR], HER3, and HER4) transmit signals through MAP kinase and PI3 kinase to promote cell proliferation.

As a class, somatically mutated kinases have proven to be prime therapeutic targets in human cancer, motivating extensive efforts to identify commonly mutated kinases that may serve key oncogenic roles in specific cancer types. One such kinome sequencing effort has identified 120 kinases harboring statistically significant somatic driver mutations in diverse human cancers, including BRAF^{V600E} mutation in a significant proportion of human melanomas (Davies). While itself a powerful starting point, the efficient translation of these genomic data into effective drug development endpoints requires an understanding of the genetic and biological context in which these cancer kinases serve critical tumor maintenance roles, i.e., a clinical path hypothesis for drug development.

Preferred kinase genes and/or genetic elements of interest include one or more (e.g., 2, 3, 4, 5, 6, 7, 8, 9 . . . all) of the following:

| Gene ID | Gene Symbol | Gene Name |
|---|---|---|
| 22848 | AAK1 | Ap2 Associated Kinase 1 |
| 9625 | AATK | Apoptosis-Associated Tyrosine Kinase |
| 25 | ABL1 | V-Abl Abelson Murine Leukemia Viral Oncogene Homolog 1 |
| 27 | ABL2 | V-Abl Abelson Murine Leukemia Viral Oncogene Homolog 2 (Arg, |
| | | Abelson-Related Gene) |
| 90 | ACVR1 | Activin A Receptor, Type I |
| 91 | ACVR1B | Activin A Receptor, Type Ib |
| 130399 | ACVR1C | Activin A Receptor, Type Ic |
| 92 | ACVR2A | Activin A Receptor, Type Iia |
| 93 | ACVR2B | Activin A Receptor, Type Iib |
| 94 | ACVRL1 | Activin A Receptor Type Ii-Like 1 |
| 57143 | ADCK1 | Aarf Domain Containing Kinase 1 |
| 90956 | ADCK2 | Aarf Domain Containing Kinase 2 |
| 79934 | ADCK4 | Aarf Domain Containing Kinase 4 |
| 203054 | ADCK5 | Aarf Domain Containing Kinase 5 |
| 132 | ADK | Adenosine Kinase |
| 83440 | ADPGK | Adp-Dependent Glucokinase |
| 156 | ADRBK1 | Adrenergic, Beta, Receptor Kinase 1 |
| 157 | ADRBK2 | Adrenergic, Beta, Receptor Kinase 2 |
| 55750 | AGK | Multiple Substrate Lipid Kinase |
| 203 | AK1 | Adenylate Kinase 1 |
| 204 | AK2 | Adenylate Kinase 2 |
| 50808 | AK3 | Adenylate Kinase 3 |
| 205 | AK3L2 | Adenylate Kinase 3-Like 1 |
| 26289 | AK5 | Adenylate Kinase 5 |
| 122481 | AK7 | Adenylate Kinase 7 |
| 207 | AKT1 | V-Akt Murine Thymoma Viral Oncogene Homolog 1 |
| 208 | AKT2 | V-Akt Murine Thymoma Viral Oncogene Homolog 2 |
| 10000 | AKT3 | V-Akt Murine Thymoma Viral Oncogene Homolog 3 (Protein Kinase |
| | | B, Gamma) |
| 5832 | ALDH18A1 | Aldehyde Dehydrogenase 18 Family, Member A1 |
| 238 | ALK | Anaplastic Lymphoma Kinase (Ki-1) |
| 80216 | ALPK1 | Kiaa1527 Protein |
| 115701 | ALPK2 | Alpha-Kinase 2 |
| 57538 | ALPK3 | Alpha-Kinase 3 |
| 55437 | ALS2CR2 | Amyotrophic Lateral Sclerosis 2 (Juvenile) Chromosome Region, |
| | | Candidate 2 |
| 269 | AMHR2 | Anti-Mullerian Hormone Receptor, Type Ii |
| 255239 | ANKK1 | Ankyrin Repeat And Kinase Domain Containing 1 |
| 369 | ARAF | V-Raf Murine Sarcoma 3611 Viral Oncogene Homolog |
| 22901 | ARSG | Arylsulfatase G |
| 472 | ATM | Ataxia Telangiectasia Mutated (Includes Complementation Groups A, |
| | | C And D) |
| 23300 | ATMIN | Atm/Atr-Substrate Chk2-Interacting Zn2+-Finger Protein |
| 545 | ATR | Ataxia Telangiectasia And Rad3 Related |
| 6790 | AURKA | Aurora Kinase A |
| 9212 | AURKB | Aurora Kinase B |
| 6795 | AURKC | Aurora Kinase C |
| 558 | AXL | Axl Receptor Tyrosine Kinase |
| 10295 | BCKDK | Branched Chain Ketoacid Dehydrogenase Kinase |
| 613 | BCR | Breakpoint Cluster Region |
| 640 | BLK | B Lymphoid Tyrosine Kinase |
| 55589 | BMP2K | Bmp2 Inducible Kinase |
| 347359 | BMP2KL | Bmp2 Inducible Kinase-Like |
| 657 | BMPR1A | Bone Morphogenetic Protein Receptor, Type Ia |
| 658 | BMPR1B | Bone Morphogenetic Protein Receptor, Type Ib |
| 659 | BMPR2 | Bone Morphogenetic Protein Receptor, Type Ii (Serine/Threonine |
| | | Kinase) |
| 660 | BMX | Bmx Non-Receptor Tyrosine Kinase |
| 673 | BRAF | V-Raf Murine Sarcoma Viral Oncogene Homolog B1 |
| 6046 | BRD2 | Bromodomain Containing 2 |
| 8019 | BRD3 | Bromodomain Containing 3 |
| 23476 | BRD4 | Bromodomain Containing 4 |
| 676 | BRDT | Bromodomain, Testis-Specific |
| 84446 | BRSK1 | Br Serine/Threonine Kinase 1 |
| 9024 | BRSK2 | Br Serine/Threonine Kinase 2 |
| 695 | BTK | Bruton Agammaglobulinemia Tyrosine Kinase |
| 699 | BUB1 | Bub1 Budding Uninhibited By Benzimidazoles 1 Homolog (Yeast) |
| 701 | BUB1B | Bub1 Budding Uninhibited By Benzimidazoles 1 Homolog Beta |
| | | (Yeast) |
| 90381 | C15ORF42 | Chromosome 15 Open Reading Frame 42 |
| 64149 | C17ORF75 | Chromosome 17 Open Reading Frame 75 |
| 374872 | C19ORF35 | Chromosome 19 Open Reading Frame 35 |
| 84284 | C1ORF57 | Chromosome 1 Open Reading Frame 57 |
| 56911 | C21ORF7 | Chromosome 21 Open Reading Frame 7 |
| 54981 | C9ORF95 | Chromosome 9 Open Reading Frame 95 |
| 169436 | C9ORF96 | Chromosome 9 Open Reading Frame 96 |
| 158067 | C9ORF98 | Chromosome 9 Open Reading Frame 98 |
| 56997 | CABC1 | Chaperone, Abc1 Activity Of Bc1 Complex Like (S. Pombe) |
| 801 | CALM3 | Calmodulin 1 (Phosphorylase Kinase, Delta) |
| 805 | CALM3 | Calmodulin 1 (Phosphorylase Kinase, Delta) |
| 808 | CALM3 | Calmodulin 1 (Phosphorylase Kinase, Delta) |
| 8536 | CAMK1 | Calcium/Calmodulin-Dependent Protein Kinase I |
| 57118 | CAMK1D | Calcium/Calmodulin-Dependent Protein Kinase Id |
| 57172 | CAMK1G | Calcium/Calmodulin-Dependent Protein Kinase Ig |
| 815 | CAMK2A | Calcium/Calmodulin-Dependent Protein Kinase (Cam Kinase) Ii Alpha |
| 816 | CAMK2B | Calcium/Calmodulin-Dependent Protein Kinase (Cam Kinase) Ii Beta |
| 817 | CAMK2D | Calcium/Calmodulin-Dependent Protein Kinase (Cam Kinase) Ii Delta |
| 818 | CAMK2G | Calcium/Calmodulin-Dependent Protein Kinase (Cam Kinase) Ii |
| | | Gamma |
| 814 | CAMK4 | Calcium/Calmodulin-Dependent Protein Kinase Iv |
| 84254 | CAMKK1 | Calcium/Calmodulin-Dependent Protein Kinase Kinase 1, Alpha |
| 10645 | CAMKK2 | Calcium/Calmodulin-Dependent Protein Kinase Kinase 2, Beta |
| 79012 | CAMKV | Cam Kinase-Like Vesicle-Associated |
| 84433 | CARD11 | Caspase Recruitment Domain Family, Member 11 |
| 23729 | CARKL | Carbohydrate Kinase-Like |
| 8573 | CASK | Calcium/Calmodulin-Dependent Serine Protein Kinase (Maguk Family) |
| 6347 | CCL2 | Chemokine (C-C Motif) Ligand 2 |
| 6351 | CCL4L2 | Chemokine (C-C Motif) Ligand 4 |
| 23552 | CCRK | Cell Cycle Related Kinase |
| 914 | CD2 | Cd2 Antigen (P50), Sheep Red Blood Cell Receptor |
| 983 | CDC2 | Cell Division Cycle 2, G1 To S And G2 To M |
| 984 | CDC2L1 | Cell Division Cycle 2-Like 1 (Pitslre Proteins) |
| 985 | CDC2L1 | Cell Division Cycle 2-Like 1 (Pitslre Proteins) |
| 8621 | CDC2L5 | Cell Division Cycle 2-Like 5 (Cholinesterase-Related Cell Division |
| | | Controller) |
| 23097 | CDC2L6 | Cell Division Cycle 2-Like 6 (Cdk8-Like) |
| 8476 | CDC42BPA | Cdc42 Binding Protein Kinase Alpha (Dmpk-Like) |
| 9578 | CDC42BPB | Cdc42 Binding Protein Kinase Beta (Dmpk-Like) |
| 55561 | CDC42BPG | Cdc42 Binding Protein Kinase Gamma (Dmpk-Like) |
| 8317 | CDC7 | Cdc7 Cell Division Cycle 7 (S. Cerevisiae) |
| 8558 | CDK10 | Cyclin-Dependent Kinase (Cdc2-Like) 10 |
| 1017 | CDK2 | Cyclin-Dependent Kinase 2 |
| 1018 | CDK3 | Cyclin-Dependent Kinase 3 |
| 1019 | CDK4 | Cyclin-Dependent Kinase 4 |
| 1020 | CDK5 | Cyclin-Dependent Kinase 5 |
| 8851 | CDK5R1 | Cyclin-Dependent Kinase 5, Regulatory Subunit 1 (P35) |
| 8941 | CDK5R2 | Cyclin-Dependent Kinase 5, Regulatory Subunit 2 (P39) |
| 1021 | CDK6 | Cyclin-Dependent Kinase 6 |
| 1022 | CDK7 | Cyclin-Dependent Kinase 7 (Mo15 Homolog, Xenopus Laevis, Cdk- |
| | | Activating Kinase) |
| 1024 | CDK8 | Cyclin-Dependent Kinase 8 |
| 1025 | CDK9 | Cyclin-Dependent Kinase 9 (Cdc2-Related Kinase) |
| 8814 | CDKL1 | Cyclin-Dependent Kinase-Like 1 (Cdc2-Related Kinase) |
| 8999 | CDKL2 | Cyclin-Dependent Kinase-Like 2 (Cdc2-Related Kinase) |
| 51265 | CDKL3 | Cyclin-Dependent Kinase-Like 3 |
| 344387 | CDKL4 | Cyclin-Dependent Kinase-Like 4 |
| 6792 | CDKL5 | Cyclin-Dependent Kinase-Like 5 |
| 64781 | CERK | Ceramide Kinase |
| 375298 | CERKL | Ceramide Kinase-Like |
| 1111 | CHEK1 | Chk1 Checkpoint Homolog (S. Pombe) |
| 11200 | CHEK2 | Chk2 Checkpoint Homolog (S. Pombe) |
| 1119 | CHKA | Choline Kinase Alpha |
| 1120 | CHKB | Choline Kinase Beta |
| 1147 | CHUK | Conserved Helix-Loop-Helix Ubiquitous Kinase |
| 10519 | CIB1 | Calcium And Integrin Binding 1 (Calmyrin) |
| 130106 | CIB4 | Calcium And Integrin Binding Family Member 4 |
| 11113 | CIT | Citron (Rho-Interacting, Serine/Threonine Kinase 21) |
| 1152 | CKB | Creatine Kinase, Brain |
| 1158 | CKM | Creatine Kinase, Muscle |
| 548596 | CKMT1B | Creatine Kinase, Mitochondrial 1b |
| 1160 | CKMT2 | Creatine Kinase, Mitochondrial 2 (Sarcomeric) |
| 1163 | CKS1B | Cdc28 Protein Kinase Regulatory Subunit 1b |
| 1164 | CKS2 | Cdc28 Protein Kinase Regulatory Subunit 2 |
| 1195 | CLK1 | Cdc-Like Kinase 1 |
| 1196 | CLK2 | Cdc-Like Kinase 2 |
| 1198 | CLK3 | Cdc-Like Kinase 3 |
| 57396 | CLK4 | Cdc-Like Kinase 4 |
| 51727 | CMPK | Cytidylate Kinase |
| 80347 | COASY | Coenzyme A Synthase |
| 10087 | COL4A3BP | Collagen, Type Iv, Alpha 3 (Goodpasture Antigen) Binding Protein |
| 8895 | CPNE3 | Copine Iii |
| 1399 | CRKL | V-Crk Sarcoma Virus Ct10 Oncogene Homolog (Avian)-Like |
| 51755 | CRKRS | Cdc2-Related Kinase, Arginine/Serine-Rich |
| 1436 | CSF1R | Colony Stimulating Factor 1 Receptor, Formerly Mcdonough Feline |
| | | Sarcoma Viral (V-Fms) Oncogene Homolog |
| 1445 | CSK | C-Src Tyrosine Kinase |
| 1452 | CSNK1A1 | Casein Kinase 1, Alpha 1 |
| 122011 | CSNK1A1L | Casein Kinase 1, Alpha 1-Like |
| 1453 | CSNK1D | Casein Kinase 1, Delta |
| 1454 | CSNK1E | Casein Kinase 1, Epsilon |
| 53944 | CSNK1G1 | Casein Kinase 1, Gamma 1 |
| 1455 | CSNK1G2 | Casein Kinase 1, Gamma 2 |
| 1456 | CSNK1G3 | Casein Kinase 1, Gamma 3 |
| 1457 | CSNK2A1 | Casein Kinase 2, Alpha 1 Polypeptide |
| 1459 | CSNK2A2 | Casein Kinase 2, Alpha Prime Polypeptide |
| 1460 | CSNK2B | Casein Kinase 2, Beta Polypeptide |
| 26007 | DAK | Dihydroxyacetone Kinase 2 Homolog (Yeast) |
| 1612 | DAPK1 | Death-Associated Protein Kinase 1 |
| 23604 | DAPK2 | Death-Associated Protein Kinase 2 |
| 1613 | DAPK3 | Death-Associated Protein Kinase 3 |
| 79877 | DCAKD | Dephospho-Coa Kinase Domain Containing |
| 1633 | DCK | Deoxycytidine Kinase |
| 9201 | DCLK1 | Doublecortin And Cam Kinase-Like 1 |
| 166614 | DCLK2 | Doublecortin And Cam Kinase-Like 2 |
| 85443 | DCLK3 | Doublecortin And Cam Kinase-Like 3 |
| 780 | DDR1 | Discoidin Domain Receptor Family, Member 1 |
| 4921 | DDR2 | Discoidin Domain Receptor Family, Member 2 |
| 1606 | DGKA | Diacylglycerol Kinase, Alpha 80 kda |
| 1607 | DGKB | Diacylglycerol Kinase, Beta 90 kda |
| 8527 | DGKD | Diacylglycerol Kinase, Delta 130 kda |
| 8526 | DGKE | Diacylglycerol Kinase, Epsilon 64 kda |
| 1608 | DGKG | Diacylglycerol Kinase, Gamma 90 kda |
| 160851 | DGKH | Diacylglycerol Kinase, Eta |
| 9162 | DGKI | Diacylglycerol Kinase, Iota |
| 139189 | DGKK | Diacylglycerol Kinase, Kappa |
| 1609 | DGKQ | Diacylglycerol Kinase, Theta 110 kda |
| 8525 | DGKZ | Diacylglycerol Kinase, Zeta 104 kda |
| 1716 | DGUOK | Deoxyguanosine Kinase |
| 91156 | DKFZP434B1231 | Eef1a2 Binding Protein |
| 1739 | DLG1 | Discs, Large Homolog 1 (Drosophila) |
| 1740 | DLG2 | Discs, Large Homolog 2, Chapsyn-110 (Drosophila) |
| 1741 | DLG3 | Discs, Large Homolog 3 (Neuroendocrine-Dlg, Drosophila) |
| 1760 | DMPK | Dystrophia Myotonica-Protein Kinase |
| 9829 | DNAJC6 | Dnaj (Hsp40) Homolog, Subfamily C, Member 6 |
| 1841 | DTYMK | Deoxythymidylate Kinase (Thymidylate Kinase) |
| 1859 | DYRK1A | Dual-Specificity Tyrosine-(Y)-Phosphorylation Regulated Kinase 1a |
| 9149 | DYRK1B | Dual-Specificity Tyrosine-(Y)-Phosphorylation Regulated Kinase 1b |
| 8445 | DYRK2 | Dual-Specificity Tyrosine-(Y)-Phosphorylation Regulated Kinase 2 |
| 8444 | DYRK3 | Dual-Specificity Tyrosine-(Y)-Phosphorylation Regulated Kinase 3 |
| 8798 | DYRK4 | Dual-Specificity Tyrosine-(Y)-Phosphorylation Regulated Kinase 4 |
| 29904 | EEF2K | Eukaryotic Elongation Factor-2 Kinase |
| 1956 | EGFR | Epidermal Growth Factor Receptor (Erythroblastic Leukemia Viral (V- |
| | | Erb-B) Oncogene Homolog, Avian) |
| 27102 | EIF2AK1 | Eukaryotic Translation Initiation Factor 2-Alpha Kinase 1 |
| 5610 | EIF2AK2 | Eukaryotic Translation Initiation Factor 2-Alpha Kinase 2 |
| 9451 | EIF2AK3 | Eukaryotic Translation Initiation Factor 2-Alpha Kinase 3 |
| 440275 | EIF2AK4 | Eukaryotic Translation Initiation Factor 2 Alpha Kinase 4 |
| 2041 | EPHA1 | Eph Receptor A1 |
| 284656 | EPHA10 | Eph Receptor A10 |
| 1969 | EPHA2 | Eph Receptor A2 |
| 2042 | EPHA3 | Eph Receptor A3 |
| 2043 | EPHA4 | Eph Receptor A4 |
| 2044 | EPHA5 | Eph Receptor A5 |
| 285220 | EPHA6 | Eph Receptor A6 |
| 2045 | EPHA7 | Eph Receptor A7 |
| 2046 | EPHA8 | Eph Receptor A8 |
| 2047 | EPHB1 | Eph Receptor B1 |
| 2048 | EPHB2 | Eph Receptor B2 |
| 2049 | EPHB3 | Eph Receptor B3 |
| 2050 | EPHB4 | Eph Receptor B4 |
| 2051 | EPHB6 | Eph Receptor B6 |
| 2064 | ERBB2 | V-Erb-B2 Erythroblastic Leukemia Viral Oncogene Homolog 2, |
| | | Neuro/Glioblastoma Derived Oncogene Homolog (Avian) |
| 2065 | ERBB3 | V-Erb-B2 Erythroblastic Leukemia Viral Oncogene Homolog 3 |
| | | (Avian) |
| 2066 | ERBB4 | V-Erb-A Erythroblastic Leukemia Viral Oncogene Homolog 4 (Avian) |
| 2081 | ERN1 | Endoplasmic Reticulum To Nucleus Signalling 1 |
| 10595 | ERN2 | Endoplasmic Reticulum To Nucleus Signalling 2 |
| 55500 | ETNK1 | Ethanolamine Kinase 1 |
| 55224 | ETNK2 | Ethanolamine Kinase 2 |
| 5394 | EXOSC10 | Exosome Component 10 |
| 10922 | FASTK | Fas-Activated Serine/Threonine Kinase |
| 79675 | FASTKD1 | Hypothetical Protein Flj21901 |
| 22868 | FASTKD2 | Kiaa0971 |
| 79072 | FASTKD3 | Hypothetical Protein Mgc5297 |
| 60493 | FASTKD5 | Hypothetical Protein Flj13149 |
| 2241 | FER | Fer (Fps/Fes Related) Tyrosine Kinase (Phosphoprotein Ncp94) |
| 2242 | FES | Feline Sarcoma Oncogene |
| 2260 | FGFR1 | Fibroblast Growth Factor Receptor 1 (Fms-Related Tyrosine Kinase 2, |
| | | Pfeiffer Syndrome) |
| 2263 | FGFR2 | Fibroblast Growth Factor Receptor 2 (Bacteria-Expressed Kinase, |
| | | Keratinocyte Growth Factor Receptor, Craniofacial Dysostosis 1, |
| | | Crouzon Syndrome, Pfeiffer Syndrome, Jackson-Weiss Syndrome) |
| 2261 | FGFR3 | Fibroblast Growth Factor Receptor 3 (Achondroplasia, Thanatophoric |
| | | Dwarfism) |
| 2264 | FGFR4 | Fibroblast Growth Factor Receptor 4 |
| 53834 | FGFRL1 | Fibroblast Growth Factor Receptor-Like 1 |
| 2268 | FGR | Gardner-Rasheed Feline Sarcoma Viral (V-Fgr) Oncogene Homolog |
| 55277 | FLJ10986 | Hypothetical Protein Flj10986 |
| 84197 | FLJ23356 | Hypothetical Protein Flj23356 |
| 124923 | FLJ25006 | Hypothetical Protein Flj25006 |
| 285962 | FLJ40852 | Hypothetical Protein Flj40852 |
| 2321 | FLT1 | Fms-Related Tyrosine Kinase 1 (Vascular Endothelial Growth |
| | | Factor/Vascular Permeability Factor Receptor) |
| 2322 | FLT3 | Fms-Related Tyrosine Kinase 3 |
| 2324 | FLT4 | Fms-Related Tyrosine Kinase 4 |
| 64122 | FN3K | Fructosamine 3 Kinase |
| 79672 | FN3KRP | Fructosamine-3-Kinase-Related Protein |
| 2475 | FRAP1 | Fk506 Binding Protein 12-Rapamycin Associated Protein 1 |
| 2444 | FRK | Fyn-Related Kinase |
| 197258 | FUK | Fucokinase |
| 2395 | FXN | Frataxin |
| 2534 | FYN | Fyn Oncogene Related To Src, Fgr, Yes |
| 2580 | GAK | Cyclin G Associated Kinase |
| 2584 | GALK1 | Galactokinase 1 |
| 2585 | GALK2 | Galactokinase 2 |
| 2645 | GCK | Glucokinase (Hexokinase 4, Maturity Onset Diabetes Of The Young 2) |
| 2710 | GK | Glycerol Kinase |
| 2712 | GK2 | Glycerol Kinase 2 |
| 256356 | GK5 | Hypothetical Protein Mgc40579 |
| 132158 | GLYCTK | Cg9886-Like |
| 10020 | GNE | Glucosamine (Udp-N-Acetyl)-2-Epimerase/N-Acetylmannosamine |
| | | Kinase |
| 9950 | GOLGA5 | Golgi Autoantigen, Golgin Subfamily A, 5 |
| 80852 | GRIP2 | Glutamate Receptor Interacting Protein 2 |
| 6011 | GRK1 | G Protein-Coupled Receptor Kinase 1 |
| 2868 | GRK4 | G Protein-Coupled Receptor Kinase 4 |
| 2869 | GRK5 | G Protein-Coupled Receptor Kinase 5 |
| 2870 | GRK6 | G Protein-Coupled Receptor Kinase 6 |
| 131890 | GRK7 | G Protein-Coupled Receptor Kinase 7 |
| 83903 | GSG2 | Germ Cell Associated 2 (Haspin) |
| 2931 | GSK3A | Glycogen Synthase Kinase 3 Alpha |
| 2932 | GSK3B | Glycogen Synthase Kinase 3 Beta |
| 2965 | GTF2H1 | General Transcription Factor Iih, Polypeptide 1, 62 kda |
| 2984 | GUCY2C | Guanylate Cyclase 2c (Heat Stable Enterotoxin Receptor) |
| 3000 | GUCY2D | Guanylate Cyclase 2d, Membrane (Retina-Specific) |
| 2986 | GUCY2F | Guanylate Cyclase 2f, Retinal |
| 2987 | GUK1 | Guanylate Kinase 1 |
| 3055 | HCK | Hemopoietic Cell Kinase |
| 204851 | HIPK1 | Kiaa0630 Protein |
| 28996 | HIPK2 | Homeodomain Interacting Protein Kinase 2 |
| 10114 | HIPK3 | Homeodomain Interacting Protein Kinase 3 |
| 147746 | HIPK4 | Homeodomain Interacting Protein Kinase 4 |
| 3098 | HK1 | Hexokinase 1 |
| 3099 | HK2 | Hexokinase 2 |
| 3101 | HK3 | Hexokinase 3 (White Cell) |
| 80201 | HKDC1 | Hexokinase Domain Containing 1 |
| 26353 | HSPB8 | Heat Shock 22 kda Protein 8 |
| 30811 | HUNK | Hormonally Upregulated Neu-Associated Kinase |
| 22858 | ICK | Intestinal Cell (Mak-Like) Kinase |
| 3480 | IGF1R | Insulin-Like Growth Factor 1 Receptor |
| 283284 | IGSF22 | Immunoglobulin Superfamily, Member 22 |
| 9807 | IHPK1 | Inositol Hexaphosphate Kinase 1 |
| 51447 | IHPK2 | Dkfzp586m0617 Protein |
| 117283 | IHPK3 | Inositol Hexaphosphate Kinase 3 |
| 3551 | IKBKB | Inhibitor Of Kappa Light Polypeptide Gene Enhancer In B-Cells, |
| | | Kinase Beta |
| 9641 | IKBKE | Inhibitor Of Kappa Light Polypeptide Gene Enhancer In B-Cells, |
| | | Kinase Epsilon |
| 3611 | ILK | Integrin-Linked Kinase |
| 3643 | INSR | Insulin Receptor |
| 3645 | INSRR | Insulin Receptor-Related Receptor |
| 253430 | IPMK | Inositol Polyphosphate Multikinase |
| 64768 | IPPK | Inositol 1,3,4,5,6-Pentakisphosphate 2-Kinase |
| 3654 | IRAK1 | Interleukin-1 Receptor-Associated Kinase 1 |
| 3656 | IRAK2 | Interleukin-1 Receptor-Associated Kinase 2 |
| 11213 | IRAK3 | Interleukin-1 Receptor-Associated Kinase 3 |
| 51135 | IRAK4 | Interleukin-1 Receptor-Associated Kinase 4 |
| 27231 | ITGB1BP3 | Integrin Beta 1 Binding Protein 3 |
| 3702 | ITK | Il2-Inducible T-Cell Kinase |
| 3705 | ITPK1 | Inositol 1,3,4-Triphosphate 5/6 Kinase |
| 3706 | ITPKA | Inositol 1,4,5-Trisphosphate 3-Kinase A |
| 3707 | ITPKB | Inositol 1,4,5-Trisphosphate 3-Kinase B |
| 80271 | ITPKC | Inositol 1,4,5-Trisphosphate 3-Kinase C |
| 3716 | JAK1 | Janus Kinase 1 (A Protein Tyrosine Kinase) |
| 3717 | JAK2 | Janus Kinase 2 (A Protein Tyrosine Kinase) |
| 3718 | JAK3 | Janus Kinase 3 (A Protein Tyrosine Kinase, Leukocyte) |
| 8997 | KALRN | Kalirin, Rhogef Kinase |
| 3791 | KDR | Kinase Insert Domain Receptor (A Type Iii Receptor Tyrosine Kinase) |
| 3795 | KHK | Ketohexokinase (Fructokinase) |
| 23387 | KIAA0999 | Kiaa0999 Protein |
| 84451 | KIAA1804 | Mixed Lineage Kinase 4 |
| 3815 | KIT | V-Kit Hardy-Zuckerman 4 Feline Sarcoma Viral Oncogene Homolog |
| 8844 | KSR1 | Kinase Suppressor Of Ras 1 |
| 283455 | KSR2 | Kinase Suppressor Of Ras 2 |
| 9113 | LATS1 | Lats, Large Tumor Suppressor, Homolog 1 (Drosophila) |
| 26524 | LATS2 | Lats, Large Tumor Suppressor, Homolog 2 (Drosophila) |
| 3932 | LCK | Lymphocyte-Specific Protein Tyrosine Kinase |
| 3984 | LIMK1 | Lim Domain Kinase 1 |
| 3985 | LIMK2 | Lim Domain Kinase 2 |
| 22853 | LMTK2 | Lemur Tyrosine Kinase 2 |
| 114783 | LMTK3 | Lemur Tyrosine Kinase 3 |
| 390877 | LOC390877 | Similar To Adenylate Kinase 5 |
| 442075 | LOC442075 | Weakly Similar To Serine/Threonine Protein Kinase Kp78 |
| 646505 | LOC646505 | Similar To Dual Specificity Protein Kinase Clk3 (Cdc-Like Kinase 3) |
| 647279 | LOC647279 | Similar To Map/Microtubule Affinity-Regulating Kinase 3 |
| 648152 | LOC648152 | Similar To Ataxia Telangiectasia And Rad3 Related Protein |
| 649288 | LOC649288 | Similar To Adenylate Kinase Isoenzyme 4, Mitochondrial (Atp-Amp |
| | | Transphosphorylase) |
| 650122 | LOC650122 | Similar To Choline Kinase Alpha Isoform A |
| 652722 | LOC652722 | Similar To Ptk2 Protein Tyrosine Kinase 2 Isoform A |
| 652799 | LOC652799 | Similar To Mast/Stem Cell Growth Factor Receptor Precursor (Scfr) |
| | | (Proto-Oncogene Tyrosine-Protein Kinase Kit) (C-Kit) (Cd117 |
| | | Antigen) |
| 653052 | LOC653052 | Similar To Homeodomain-Interacting Protein Kinase 2 (Hhipk2) |
| 653155 | LOC653155 | Similar To Prp4 Pre-Mrna Processing Factor 4 Homolog B (Yeast) |
| | | (Predicted) |
| 91461 | LOC91461 | Hypothetical Protein Bc007901 |
| 136332 | LRGUK | Hypothetical Protein Flj32786 |
| 10128 | LRPPRC | Leucine-Rich Ppr-Motif Containing |
| 79705 | LRRK1 | Leucine-Rich Repeat Kinase 1 |
| 120892 | LRRK2 | Leucine-Rich Repeat Kinase 2 |
| 4058 | LTK | Leukocyte Tyrosine Kinase |
| 92335 | LYK5 | Protein Kinase Lyk5 |
| 4067 | LYN | V-Yes-1 Yamaguchi Sarcoma Viral Related Oncogene Homolog |
| 9223 | MAGI1 | Membrane Associated Guanylate Kinase, Ww And Pdz Domain |
| | | Containing 1 |
| 9863 | MAGI2 | Membrane Associated Guanylate Kinase, Ww And Pdz Domain |
| | | Containing 2 |
| 260425 | MAGI3 | Kiaa1634 Protein |
| 4117 | MAK | Male Germ Cell-Associated Kinase |
| 5604 | MAP2K1 | Mitogen-Activated Protein Kinase Kinase 1 |
| 8649 | MAP2K1IP1 | Mitogen-Activated Protein Kinase Kinase 1 Interacting Protein 1 |
| 5605 | MAP2K2 | Mitogen-Activated Protein Kinase Kinase 2 |
| 5606 | MAP2K3 | Mitogen-Activated Protein Kinase Kinase 3 |
| 6416 | MAP2K4 | Mitogen-Activated Protein Kinase Kinase 4 |
| 5607 | MAP2K5 | Mitogen-Activated Protein Kinase Kinase 5 |
| 5608 | MAP2K6 | Mitogen-Activated Protein Kinase Kinase 6 |
| 5609 | MAP2K7 | Mitogen-Activated Protein Kinase Kinase 7 |
| 4214 | MAP3K1 | Mitogen-Activated Protein Kinase Kinase Kinase 1 |
| 4294 | MAP3K10 | Mitogen-Activated Protein Kinase Kinase Kinase 10 |
| 4296 | MAP3K11 | Mitogen-Activated Protein Kinase Kinase Kinase 11 |
| 7786 | MAP3K12 | Mitogen-Activated Protein Kinase Kinase Kinase 12 |
| 9175 | MAP3K13 | Mitogen-Activated Protein Kinase Kinase Kinase 13 |
| 9020 | MAP3K14 | Mitogen-Activated Protein Kinase Kinase Kinase 14 |
| 389840 | MAP3K15 | Mitogen-Activated Protein Kinase Kinase Kinase 15 |
| 10746 | MAP3K2 | Mitogen-Activated Protein Kinase Kinase Kinase 2 |
| 4215 | MAP3K3 | Mitogen-Activated Protein Kinase Kinase Kinase 3 |
| 4216 | MAP3K4 | Mitogen-Activated Protein Kinase Kinase Kinase 4 |
| 4217 | MAP3K5 | Mitogen-Activated Protein Kinase Kinase Kinase 5 |
| 9064 | MAP3K6 | Mitogen-Activated Protein Kinase Kinase Kinase 6 |
| 6885 | MAP3K7 | Mitogen-Activated Protein Kinase Kinase Kinase 7 |
| 1326 | MAP3K8 | Mitogen-Activated Protein Kinase Kinase Kinase 8 |
| 4293 | MAP3K9 | Mitogen-Activated Protein Kinase Kinase Kinase 9 |
| 11184 | MAP4K1 | Mitogen-Activated Protein Kinase Kinase Kinase Kinase 1 |
| 5871 | MAP4K2 | Mitogen-Activated Protein Kinase Kinase Kinase Kinase 2 |
| 8491 | MAP4K3 | Mitogen-Activated Protein Kinase Kinase Kinase Kinase 3 |
| 9448 | MAP4K4 | Mitogen-Activated Protein Kinase Kinase Kinase Kinase 4 |
| 11183 | MAP4K5 | Mitogen-Activated Protein Kinase Kinase Kinase Kinase 5 |
| 5594 | MAPK1 | Mitogen-Activated Protein Kinase 1 |
| 5602 | MAPK10 | Mitogen-Activated Protein Kinase 10 |
| 5600 | MAPK11 | Mitogen-Activated Protein Kinase 11 |
| 6300 | MAPK12 | Mitogen-Activated Protein Kinase 12 |
| 5603 | MAPK13 | Mitogen-Activated Protein Kinase 13 |
| 1432 | MAPK14 | Mitogen-Activated Protein Kinase 14 |
| 225689 | MAPK15 | Mitogen-Activated Protein Kinase 15 |
| 5595 | MAPK3 | Mitogen-Activated Protein Kinase 3 |
| 5596 | MAPK4 | Mitogen-Activated Protein Kinase 4 |
| 5597 | MAPK6 | Mitogen-Activated Protein Kinase 6 |
| 5598 | MAPK7 | Mitogen-Activated Protein Kinase 7 |
| 5599 | MAPK8 | Mitogen-Activated Protein Kinase 8 |
| 5601 | MAPK9 | Mitogen-Activated Protein Kinase 9 |
| 9261 | MAPKAPK2 | Mitogen-Activated Protein Kinase-Activated Protein Kinase 2 |
| 7867 | MAPKAPK3 | Mitogen-Activated Protein Kinase-Activated Protein Kinase 3 |
| 8550 | MAPKAPK5 | Mitogen-Activated Protein Kinase-Activated Protein Kinase 5 |
| 4139 | MARK1 | Map/Microtubule Affinity-Regulating Kinase 1 |
| 2011 | MARK2 | Map/Microtubule Affinity-Regulating Kinase 2 |
| 4140 | MARK3 | Map/Microtubule Affinity-Regulating Kinase 3 |
| 57787 | MARK4 | Map/Microtubule Affinity-Regulating Kinase 4 |
| 22983 | MAST1 | Microtubule Associated Serine/Threonine Kinase 1 |
| 23139 | MAST2 | Microtubule Associated Serine/Threonine Kinase 2 |
| 23031 | MAST3 | Microtubule Associated Serine/Threonine Kinase 3 |
| 375449 | MAST4 | Similar To Microtubule Associated Testis Specific Serine/Threonine |
| | | Protein Kinase |
| 84930 | MASTL | Microtubule Associated Serine/Threonine Kinase-Like |
| 4145 | MATK | Megakaryocyte-Associated Tyrosine Kinase |
| 9833 | MELK | Maternal Embryonic Leucine Zipper Kinase |
| 10461 | MERTK | C-Mer Proto-Oncogene Tyrosine Kinase |
| 4233 | MET | Met Proto-Oncogene (Hepatocyte Growth Factor Receptor) |
| 84206 | MEX3B | Ring Finger And Kh Domain Containing 3 |
| 93627 | MGC16169 | Hypothetical Protein Mgc16169 |
| 167359 | MGC42105 | Hypothetical Protein Mgc42105 |
| 50488 | MINK1 | Misshapen-Like Kinase 1 (Zebrafish) |
| 8569 | MKNK1 | Map Kinase Interacting Serine/Threonine Kinase 1 |
| 2872 | MKNK2 | Map Kinase Interacting Serine/Threonine Kinase 2 |
| 91807 | MLCK | Mlck Protein |
| 197259 | MLKL | Mixed Lineage Kinase Domain-Like |
| 79906 | MORN1 | Morn Repeat Containing 1 |
| 378464 | MORN2 | Morn Repeat Containing 2 |
| 4342 | MOS | V-Mos Moloney Murine Sarcoma Viral Oncogene Homolog |
| 4354 | MPP1 | Membrane Protein, Palmitoylated 1, 55 kda |
| 4355 | MPP2 | Membrane Protein, Palmitoylated 2 (Maguk P55 Subfamily Member 2) |
| 4356 | MPP3 | Membrane Protein, Palmitoylated 3 (Maguk P55 Subfamily Member 3) |
| 58538 | MPP4 | Membrane Protein, Palmitoylated 4 (Maguk P55 Subfamily Member 4) |
| 64398 | MPP5 | Membrane Protein, Palmitoylated 5 (Maguk P55 Subfamily Member 5) |
| 51678 | MPP6 | Membrane Protein, Palmitoylated 6 (Maguk P55 Subfamily Member 6) |
| 143098 | MPP7 | Membrane Protein, Palmitoylated 7 (Maguk P55 Subfamily Member 7) |
| 4486 | MST1R | Macrophage Stimulating 1 Receptor (C-Met-Related Tyrosine Kinase) |
| 4593 | MUSK | Muscle, Skeletal, Receptor Tyrosine Kinase |
| 4598 | MVK | Mevalonate Kinase (Mevalonic Aciduria) |
| 4638 | MYLK | Myosin, Light Polypeptide Kinase |
| 85366 | MYLK2 | Myosin Light Chain Kinase 2, Skeletal Muscle |
| 53904 | MYO3A | Myosin Iiia |
| 140469 | MYO3B | Myosin Iiib |
| 55728 | N4BP2 | Nedd4 Binding Protein 2 |
| 220686 | NA | Na |
| 388957 | NA | Na |
| 65220 | NADK | Nad Kinase |
| 55577 | NAGK | N-Acetylglucosamine Kinase |
| 4750 | NEK1 | Nima (Never In Mitosis Gene A)-Related Kinase 1 |
| 152110 | NEK10 | Nima (Never In Mitosis Gene A)-Related Kinase 10 |
| 79858 | NEK11 | Nima (Never In Mitosis Gene A)-Related Kinase 11 |
| 4751 | NEK2 | Nima (Never In Mitosis Gene A)-Related Kinase 2 |
| 4752 | NEK3 | Nima (Never In Mitosis Gene A)-Related Kinase 3 |
| 6787 | NEK4 | Nima (Never In Mitosis Gene A)-Related Kinase 4 |
| 341676 | NEK5 | Nima (Never In Mitosis Gene A)-Related Kinase 5 |
| 10783 | NEK6 | Nima (Never In Mitosis Gene A)-Related Kinase 6 |
| 140609 | NEK7 | Nima (Never In Mitosis Gene A)-Related Kinase 7 |
| 284086 | NEK8 | Nima (Never In Mitosis Gene A)-Related Kinase 8 |
| 91754 | NEK9 | Nima (Never In Mitosis Gene A)-Related Kinase 9 |
| 51701 | NLK | Nemo-Like Kinase |
| 4830 | NME1 | Non-Metastatic Cells 1, Protein (Nm23a) Expressed In |
| 654364 | NME1-NME2 | Nme1-Nme2 Protein |
| 4831 | NME2 | Non-Metastatic Cells 2, Protein (Nm23b) Expressed In |
| 4832 | NME3 | Non-Metastatic Cells 3, Protein Expressed In |
| 4833 | NME4 | Non-Metastatic Cells 4, Protein Expressed In |
| 8382 | NME5 | Non-Metastatic Cells 5, Protein Expressed In (Nucleoside-Diphosphate |
| | | Kinase) |
| 10201 | NME6 | Non-Metastatic Cells 6, Protein Expressed In (Nucleoside-Diphosphate |
| | | Kinase) |
| 29922 | NME7 | Non-Metastatic Cells 7, Protein Expressed In (Nucleoside-Diphosphate |
| | | Kinase) |
| 4881 | NPR1 | Natriuretic Peptide Receptor A/Guanylate Cyclase A (Atrionatriuretic |
| | | Peptide Receptor A) |
| 4882 | NPR2 | Natriuretic Peptide Receptor B/Guanylate Cyclase B (Atrionatriuretic |
| | | Peptide Receptor B) |
| 29959 | NRBP1 | Nuclear Receptor Binding Protein 1 |
| 340371 | NRBP2 | Nuclear Receptor Binding Protein 2 |
| 203447 | NRK | Nik Related Kinase |
| 4914 | NTRK1 | Neurotrophic Tyrosine Kinase, Receptor, Type 1 |
| 4915 | NTRK2 | Neurotrophic Tyrosine Kinase, Receptor, Type 2 |
| 4916 | NTRK3 | Neurotrophic Tyrosine Kinase, Receptor, Type 3 |
| 9891 | NUAK1 | Nuak Family, Snf1-Like Kinase, 1 |
| 81788 | NUAK2 | Nuak Family, Snf1-Like Kinase, 2 |
| 23636 | NUP62 | Nucleoporin 62 kda |
| 84033 | OBSCN | Hypothetical Protein Flj14124 |
| 9943 | OXSR1 | Oxidative-Stress Responsive 1 |
| 5058 | PAK1 | P21/Cdc42/Rac1-Activated Kinase 1 (Ste20 Homolog, Yeast) |
| 5062 | PAK2 | P21 (Cdkn1a)-Activated Kinase 2 |
| 5063 | PAK3 | P21 (Cdkn1a)-Activated Kinase 3 |
| 10298 | PAK4 | P21(Cdkn1a)-Activated Kinase 4 |
| 56924 | PAK6 | P21(Cdkn1a)-Activated Kinase 6 |
| 57144 | PAK7 | P21(Cdkn1a)-Activated Kinase 7 |
| 53354 | PANK1 | Pantothenate Kinase 1 |
| 80025 | PANK2 | Pantothenate Kinase 2 (Hallervorden-Spatz Syndrome) |
| 79646 | PANK3 | Pantothenate Kinase 3 |
| 55229 | PANK4 | Pantothenate Kinase 4 |
| 9061 | PAPSS1 | 3′-Phosphoadenosine 5′-Phosphosulfate Synthase 1 |
| 9060 | PAPSS2 | 3′-Phosphoadenosine 5′-Phosphosulfate Synthase 2 |
| 23178 | PASK | Pas Domain Containing Serine/Threonine Kinase |
| 55872 | PBK | Pdz Binding Kinase |
| 5105 | PCK1 | Phosphoenolpyruvate Carboxykinase 1 (Soluble) |
| 5106 | PCK2 | Phosphoenolpyruvate Carboxykinase 2 (Mitochondrial) |
| 5127 | PCTK1 | Pctaire Protein Kinase 1 |
| 5128 | PCTK2 | Pctaire Protein Kinase 2 |
| 5129 | PCTK3 | Pctaire Protein Kinase 3 |
| 5156 | PDGFRA | Platelet-Derived Growth Factor Receptor, Alpha Polypeptide |
| 5159 | PDGFRB | Platelet-Derived Growth Factor Receptor, Beta Polypeptide |
| 5157 | PDGFRL | Platelet-Derived Growth Factor Receptor-Like |
| 149420 | PDIK1L | Pdlim1 Interacting Kinase 1 Like |
| 5163 | PDK1 | Pyruvate Dehydrogenase Kinase, Isozyme 1 |
| 5164 | PDK2 | Pyruvate Dehydrogenase Kinase, Isozyme 2 |
| 5165 | PDK3 | Pyruvate Dehydrogenase Kinase, Isozyme 3 |
| 5166 | PDK4 | Pyruvate Dehydrogenase Kinase, Isozyme 4 |
| 5170 | PDPK1 | 3-Phosphoinositide Dependent Protein Kinase-1 |
| 8566 | PDXK | Pyridoxal (Pyridoxine, Vitamin B6) Kinase |
| 5207 | PFKFB1 | 6-Phosphofructo-2-Kinase/Fructose-2,6-Biphosphatase 1 |
| 5208 | PFKFB2 | 6-Phosphofructo-2-Kinase/Fructose-2,6-Biphosphatase 2 |
| 5209 | PFKFB3 | 6-Phosphofructo-2-Kinase/Fructose-2,6-Biphosphatase 3 |
| 5210 | PFKFB4 | 6-Phosphofructo-2-Kinase/Fructose-2,6-Biphosphatase 4 |
| 5211 | PFKL | Phosphofructokinase, Liver |
| 5213 | PFKM | Phosphofructokinase, Muscle |
| 5214 | PFKP | Phosphofructokinase, Platelet |
| 5218 | PFTK1 | Pftaire Protein Kinase 1 |
| 65061 | PFTK2 | Amyotrophic Lateral Sclerosis 2 (Juvenile) Chromosome Region, |
| | | Candidate 7 |
| 5230 | PGK1 | Phosphoglycerate Kinase 1 |
| 5232 | PGK2 | Phosphoglycerate Kinase 2 |
| 5255 | PHKA1 | Phosphorylase Kinase, Alpha 1 (Muscle) |
| 5256 | PHKA2 | Phosphorylase Kinase, Alpha 2 (Liver) |
| 5257 | PHKB | Phosphorylase Kinase, Beta |
| 5260 | PHKG1 | Phosphorylase Kinase, Gamma 1 (Muscle) |
| 5261 | PHKG2 | Phosphorylase Kinase, Gamma 2 (Testis) |
| 55361 | PI4K2A | Phosphatidylinositol 4-Kinase Type Ii |
| 55300 | PI4K2B | Phosphatidylinositol 4-Kinase Type 2 Beta |
| 5297 | PI4KA | Phosphatidylinositol 4-Kinase, Catalytic, Alpha Polypeptide |
| 375133 | PI4KAP2 | Similar To Phosphatidylinositol 4-Kinase Alpha |
| 5298 | PI4KB | Phosphatidylinositol 4-Kinase, Catalytic, Beta Polypeptide |
| 5286 | PIK3C2A | Phosphoinositide-3-Kinase, Class 2, Alpha Polypeptide |
| 5287 | PIK3C2B | Phosphoinositide-3-Kinase, Class 2, Beta Polypeptide |
| 5288 | PIK3C2G | Phosphoinositide-3-Kinase, Class 2, Gamma Polypeptide |
| 5289 | PIK3C3 | Phosphoinositide-3-Kinase, Class 3 |
| 5290 | PIK3CA | Phosphoinositide-3-Kinase, Catalytic, Alpha Polypeptide |
| 5291 | PIK3CB | Phosphoinositide-3-Kinase, Catalytic, Beta Polypeptide |
| 5293 | PIK3CD | Phosphoinositide-3-Kinase, Catalytic, Delta Polypeptide |
| 5294 | PIK3CG | Phosphoinositide-3-Kinase, Catalytic, Gamma Polypeptide |
| 5295 | PIK3R1 | Phosphoinositide-3-Kinase, Regulatory Subunit 1 (P85 Alpha) |
| 5296 | PIK3R2 | Phosphoinositide-3-Kinase, Regulatory Subunit 2 (P85 Beta) |
| 8503 | PIK3R3 | Phosphoinositide-3-Kinase, Regulatory Subunit 3 (P55, Gamma) |
| 30849 | PIK3R4 | Phosphoinositide-3-Kinase, Regulatory Subunit 4, P150 |
| 23533 | PIK3R5 | Phosphoinositide-3-Kinase, Regulatory Subunit 5, P101 |
| 5292 | PIM1 | Pim-1 Oncogene |
| 11040 | PIM2 | Pim-2 Oncogene |
| 415116 | PIM3 | Pim-3 Oncogene |
| 65018 | PINK1 | Pten Induced Putative Kinase 1 |
| 5305 | PIP4K2A | Phosphatidylinositol-4-Phosphate 5-Kinase, Type Ii, Alpha |
| 8396 | PIP4K2B | Phosphatidylinositol-4-Phosphate 5-Kinase, Type Ii, Beta |
| 79837 | PIP4K2C | Phosphatidylinositol-4-Phosphate 5-Kinase, Type Ii, Gamma |
| 8394 | PIP5K1A | Phosphatidylinositol-4-Phosphate 5-Kinase, Type I, Alpha |
| 8395 | PIP5K1B | Phosphatidylinositol-4-Phosphate 5-Kinase, Type I, Beta |
| 23396 | PIP5K1C | Phosphatidylinositol-4-Phosphate 5-Kinase, Type I, Gamma |
| 200576 | PIP5K3 | Likely Ortholog Of Mouse Phosphatidylinositol-4-Phosphate 5-Kinase, |
| | | Type Iii |
| 138429 | PIP5KL1 | Phosphatidylinositol-4-Phosphate 5-Kinase-Like 1 |
| 5313 | PKLR | Pyruvate Kinase, Liver And Rbc |
| 5315 | PKM2 | Pyruvate Kinase, Muscle |
| 9088 | PKMYT1 | Protein Kinase, Membrane Associated Tyrosine/Threonine 1 |
| 5585 | PKN1 | Protein Kinase N1 |
| 5586 | PKN2 | Protein Kinase N2 |
| 29941 | PKN3 | Protein Kinase N3 |
| 5328 | PLAU | Plasminogen Activator, Urokinase |
| 5347 | PLK1 | Polo-Like Kinase 1 (Drosophila) |
| 10769 | PLK2 | Polo-Like Kinase 2 (Drosophila) |
| 1263 | PLK3 | Polo-Like Kinase 3 (Drosophila) |
| 10733 | PLK4 | Polo-Like Kinase 4 (Drosophila) |
| 5361 | PLXNA1 | Plexin A1 |
| 5362 | PLXNA2 | Plexin A2 |
| 55558 | PLXNA3 | Plexin A3 |
| 91584 | PLXNA4 | Plexin A4, B |
| 5364 | PLXNB1 | Plexin B1 |
| 23654 | PLXNB2 | Plexin B2 |
| 5365 | PLXNB3 | Plexin B3 |
| 10154 | PLXNC1 | Plexin C1 |
| 23129 | PLXND1 | Plexin D1 |
| 10654 | PMVK | Phosphomevalonate Kinase |
| 139728 | PNCK | Pregnancy Upregulated Non-Ubiquitously Expressed Cam Kinase |
| 11284 | PNKP | Polynucleotide Kinase 3′-Phosphatase |
| 157285 | PRAGMIN | Hypothetical Protein Dkfzp761p0423 |
| 5562 | PRKAA1 | Protein Kinase, Amp-Activated, Alpha 1 Catalytic Subunit |
| 5563 | PRKAA2 | Protein Kinase, Amp-Activated, Alpha 2 Catalytic Subunit |
| 5564 | PRKAB1 | Protein Kinase, Amp-Activated, Beta 1 Non-Catalytic Subunit |
| 5565 | PRKAB2 | Protein Kinase, Amp-Activated, Beta 2 Non-Catalytic Subunit |
| 5566 | PRKACA | Protein Kinase, Camp-Dependent, Catalytic, Alpha |
| 5567 | PRKACB | Protein Kinase, Camp-Dependent, Catalytic, Beta |
| 5568 | PRKACG | Protein Kinase, Camp-Dependent, Catalytic, Gamma |
| 5571 | PRKAG1 | Protein Kinase, Amp-Activated, Gamma 1 Non-Catalytic Subunit |
| 51422 | PRKAG2 | Protein Kinase, Amp-Activated, Gamma 2 Non-Catalytic Subunit |
| 53632 | PRKAG3 | Protein Kinase, Amp-Activated, Gamma 3 Non-Catalytic Subunit |
| 5573 | PRKAR1A | Protein Kinase, Camp-Dependent, Regulatory, Type I, Alpha (Tissue |
| | | Specific Extinguisher 1) |
| 5575 | PRKAR1B | Protein Kinase, Camp-Dependent, Regulatory, Type I, Beta |
| 5576 | PRKAR2A | Protein Kinase, Camp-Dependent, Regulatory, Type Ii, Alpha |
| 5577 | PRKAR2B | Protein Kinase, Camp-Dependent, Regulatory, Type Ii, Beta |
| 5578 | PRKCA | Protein Kinase C, Alpha |
| 5579 | PRKCB1 | Protein Kinase C, Beta 1 |
| 5580 | PRKCD | Protein Kinase C, Delta |
| 5581 | PRKCE | Protein Kinase C, Epsilon |
| 5582 | PRKCG | Protein Kinase C, Gamma |
| 5583 | PRKCH | Protein Kinase C, Eta |
| 5584 | PRKCI | Protein Kinase C, Iota |
| 5588 | PRKCQ | Protein Kinase C, Theta |
| 5590 | PRKCZ | Protein Kinase C, Zeta |
| 5587 | PRKD1 | Protein Kinase D1 |
| 25865 | PRKD2 | Protein Kinase D2 |
| 23683 | PRKD3 | Protein Kinase D3 |
| 5591 | PRKDC | Protein Kinase, Dna-Activated, Catalytic Polypeptide |
| 5592 | PRKG1 | Protein Kinase, Cgmp-Dependent, Type I |
| 5593 | PRKG2 | Protein Kinase, Cgmp-Dependent, Type Ii |
| 5613 | PRKX | Protein Kinase, X-Linked |
| 5616 | PRKY | Protein Kinase, Y-Linked |
| 26121 | PRPF31 | Prp31 Pre-Mrna Processing Factor 31 Homolog (Yeast) |
| 8899 | PRPF4B | Prp4 Pre-Mrna Processing Factor 4 Homolog B (Yeast) |
| 221823 | PRPS1L1 | Phosphoribosyl Pyrophosphate Synthetase 1-Like 1 |
| 5631 | PRPS2 | Phosphoribosyl Pyrophosphate Synthetase 1 |
| 5634 | PRPS2 | Phosphoribosyl Pyrophosphate Synthetase 1 |
| 5681 | PSKH1 | Protein Serine Kinase H1 |
| 85481 | PSKH2 | Protein Serine Kinase H2 |
| 5747 | PTK2 | Ptk2 Protein Tyrosine Kinase 2 |
| 2185 | PTK2B | Ptk2b Protein Tyrosine Kinase 2 Beta |
| 5753 | PTK6 | Ptk6 Protein Tyrosine Kinase 6 |
| 5754 | PTK7 | Ptk7 Protein Tyrosine Kinase 7 |
| 54899 | PXK | Px Domain Containing Serine/Threonine Kinase |
| 5894 | RAF1 | V-Raf-1 Murine Leukemia Viral Oncogene Homolog 1 |
| 5891 | RAGE | Renal Tumor Antigen |
| 64080 | RBKS | Ribokinase |
| 5979 | RET | Ret Proto-Oncogene (Multiple Endocrine Neoplasia And Medullary |
| | | Thyroid Carcinoma 1, Hirschsprung Disease) |
| 55312 | RFK | Riboflavin Kinase |
| 83732 | RIOK1 | Rio Kinase 1 (Yeast) |
| 55781 | RIOK2 | Rio Kinase 2 (Yeast) |
| 8780 | RIOK3 | Rio Kinase 3 (Yeast) |
| 8737 | RIPK1 | Receptor (Tnfrsf)-Interacting Serine-Threonine Kinase 1 |
| 8767 | RIPK2 | Receptor-Interacting Serine-Threonine Kinase 2 |
| 11035 | RIPK3 | Receptor-Interacting Serine-Threonine Kinase 3 |
| 54101 | RIPK4 | Receptor-Interacting Serine-Threonine Kinase 4 |
| 25778 | RIPK5 | Receptor Interacting Protein Kinase 5 |
| 6041 | RNASEL | Ribonuclease L (2′,5′-Oligoisoadenylate Synthetase-Dependent) |
| 6093 | ROCK1 | Rho-Associated, Coiled-Coil Containing Protein Kinase 1 |
| 9475 | ROCK2 | Rho-Associated, Coiled-Coil Containing Protein Kinase 2 |
| 4919 | ROR1 | Receptor Tyrosine Kinase-Like Orphan Receptor 1 |
| 4920 | ROR2 | Receptor Tyrosine Kinase-Like Orphan Receptor 2 |
| 6098 | ROS1 | V-Ros Ur2 Sarcoma Virus Oncogene Homolog 1 (Avian) |
| 340156 | RP11-145H9.1 | Hypothetical Protein Loc340156 |
| 6102 | RP2 | Retinitis Pigmentosa 2 (X-Linked Recessive) |
| 51765 | RP6-213H19.1 | Mst3 And Sok1-Related Kinase |
| 6195 | RPS6KA1 | Ribosomal Protein S6 Kinase, 90 kda, Polypeptide 1 |
| 6196 | RPS6KA2 | Ribosomal Protein S6 Kinase, 90 kda, Polypeptide 2 |
| 6197 | RPS6KA3 | Ribosomal Protein S6 Kinase, 90 kda, Polypeptide 3 |
| 8986 | RPS6KA4 | Ribosomal Protein S6 Kinase, 90 kda, Polypeptide 4 |
| 9252 | RPS6KA5 | Ribosomal Protein S6 Kinase, 90 kda, Polypeptide 5 |
| 27330 | RPS6KA6 | Ribosomal Protein S6 Kinase, 90 kda, Polypeptide 6 |
| 6198 | RPS6KB1 | Ribosomal Protein S6 Kinase, 70 kda, Polypeptide 1 |
| 6199 | RPS6KB2 | Ribosomal Protein S6 Kinase, 70 kda, Polypeptide 2 |
| 26750 | RPS6KC1 | Ribosomal Protein S6 Kinase, 52 kda, Polypeptide 1 |
| 83694 | RPS6KL1 | Ribosomal Protein S6 Kinase-Like 1 |
| 6259 | RYK | Ryk Receptor-Like Tyrosine Kinase |
| 57410 | SCYL1 | Scy1-Like 1 (S. Cerevisiae) |
| 55681 | SCYL2 | Scy1-Like 2 (S. Cerevisiae) |
| 57147 | SCYL3 | Scy1-Like 3 (S. Cerevisiae) |
| 22928 | SEPHS2 | Selenophosphate Synthetase 2 |
| 6446 | SGK1 | Serum/Glucocorticoid Regulated Kinase |
| 10110 | SGK2 | Serum/Glucocorticoid Regulated Kinase 2 |
| 79834 | SGK269 | Kiaa2002 Protein |
| 23678 | SGK3 | Serum/Glucocorticoid Regulated Kinase Family, Member 3 |
| 23677 | SH3BP4 | Sh3-Domain Binding Protein 4 |
| 9467 | SH3BP5 | Sh3-Domain Binding Protein 5 (Btk-Associated) |
| 80851 | SH3BP5L | Sh3-Binding Domain Protein 5-Like |
| 114836 | SLAMF6 | Slam Family Member 6 |
| 9748 | SLK | Ste20-Like Kinase (Yeast) |
| 23049 | SMG1 | Pi-3-Kinase-Related Kinase Smg-1 |
| 150094 | SNF1LK | Snf1-Like Kinase |
| 23235 | SNF1LK2 | Snf1-Like Kinase 2 |
| 54861 | SNRK | Snf Related Kinase |
| 64089 | SNX16 | Sorting Nexin 16 |
| 10290 | SPEG | Aortic Preferentially Expressed Gene 1 |
| 8877 | SPHK1 | Sphingosine Kinase 1 |
| 56848 | SPHK2 | Sphingosine Kinase 2 |
| 6714 | SRC | V-Src Sarcoma (Schmidt-Ruppin A-2) Viral Oncogene Homolog |
| | | (Avian) |
| 6725 | SRMS | Src-Related Kinase Lacking C-Terminal Regulatory Tyrosine And N- |
| | | Terminal Myristylation Sites |
| 6732 | SRPK1 | Sfrs Protein Kinase 1 |
| 6733 | SRPK2 | Sfrs Protein Kinase 2 |
| 26576 | SRPK3 | Serine/Threonine Kinase 23 |
| 6793 | STK10 | Serine/Threonine Kinase 10 |
| 6794 | STK11 | Serine/Threonine Kinase 11 |
| 8576 | STK16 | Serine/Threonine Kinase 16 |
| 9263 | STK17A | Serine/Threonine Kinase 17a (Apoptosis-Inducing) |
| 9262 | STK17B | Serine/Threonine Kinase 17b (Apoptosis-Inducing) |
| 8859 | STK19 | Serine/Threonine Kinase 19 |
| 8428 | STK24 | Serine/Threonine Kinase 24 (Ste20 Homolog, Yeast) |
| 10494 | STK25 | Serine/Threonine Kinase 25 (Ste20 Homolog, Yeast) |
| 6788 | STK3 | Serine/Threonine Kinase 3 (Ste20 Homolog, Yeast) |
| 56164 | STK31 | Serine/Threonine Kinase 31 |
| 202374 | STK32A | Serine/Threonine Kinase 32a |
| 55351 | STK32B | Serine/Threonine Kinase 32b |
| 282974 | STK32C | Serine/Threonine Kinase 32c |
| 65975 | STK33 | Serine/Threonine Kinase 33 |
| 140901 | STK35 | Serine/Threonine Kinase 35 |
| 27148 | STK36 | Serine/Threonine Kinase 36 (Fused Homolog, Drosophila) |
| 11329 | STK38 | Serine/Threonine Kinase 38 |
| 23012 | STK38L | Serine/Threonine Kinase 38 Like |
| 27347 | STK39 | Serine Threonine Kinase 39 (Ste20/Sps1 Homolog, Yeast) |
| 6789 | STK4 | Serine/Threonine Kinase 4 |
| 83931 | STK40 | Serine/Threonine Kinase 40 |
| 55359 | STYK1 | Serine/Threonine/Tyrosine Kinase 1 |
| 6850 | SYK | Spleen Tyrosine Kinase |
| 6872 | TAF1 | Taf1 Rna Polymerase Ii, Tata Box Binding Protein (Tbp)-Associated |
| | | Factor, 250 kda |
| 138474 | TAF1L | Taf1-Like Rna Polymerase Ii, Tata Box Binding Protein (Tbp)- |
| | | Associated Factor, 210 kda |
| 57551 | TAOK1 | Tao Kinase 1 |
| 9344 | TAOK2 | Tao Kinase 2 |
| 51347 | TAOK3 | Tao Kinase 3 |
| 29110 | TBK1 | Tank-Binding Kinase 1 |
| 54103 | TCAG7.1314 | Hypothetical Protein Loc54103 |
| 389599 | TCAG7.875 | Similar To Amyotrophic Lateral Sclerosis 2 (Juvenile) Chromosome |
| | | Region, Candidate 2; Ilp-Interacting Protein Ilpipa |
| 7006 | TEC | Tec Protein Tyrosine Kinase |
| 7010 | TEK | Tek Tyrosine Kinase, Endothelial (Venous Malformations, Multiple |
| | | Cutaneous And Mucosal) |
| 7016 | TESK1 | Testis-Specific Kinase 1 |
| 10420 | TESK2 | Testis-Specific Kinase 2 |
| 56155 | TEX14 | Testis Expressed Sequence 14 |
| 7046 | TGFBR1 | Transforming Growth Factor, Beta Receptor I (Activin A Receptor |
| | | Type Ii-Like Kinase, 53 kda) |
| 7048 | TGFBR2 | Transforming Growth Factor, Beta Receptor Ii (70/80 kda) |
| 7049 | TGFBR3 | Transforming Growth Factor, Beta Receptor Iii (Betaglycan, 300 kda) |
| 7075 | TIE1 | Tyrosine Kinase With Immunoglobulin-Like And Egf-Like Domains 1 |
| 9414 | TJP2 | Tight Junction Protein 2 (Zona Occludens 2) |
| 7083 | TK1 | Thymidine Kinase 1, Soluble |
| 7084 | TK2 | Thymidine Kinase 2, Mitochondrial |
| 9874 | TLK1 | Tousled-Like Kinase 1 |
| 11011 | TLK2 | Tousled-Like Kinase 2 |
| 23043 | TNIK | Traf2 And Nck Interacting Kinase |
| 8711 | TNK1 | Tyrosine Kinase, Non-Receptor, 1 |
| 10188 | TNK2 | Tyrosine Kinase, Non-Receptor, 2 |
| 51086 | TNNI3K | Tnni3 Interacting Kinase |
| 112858 | TP53RK | Tp53 Regulating Kinase |
| 89882 | TPD52L3 | Tumor Protein D52-Like 3 |
| 27010 | TPK1 | Thiamin Pyrophosphokinase 1 |
| 7175 | TPR | Translocated Promoter Region (To Activated Met Oncogene) |
| 10221 | TRIB1 | Tribbles Homolog 1 (Drosophila) |
| 28951 | TRIB2 | Tribbles Homolog 2 (Drosophila) |
| 57761 | TRIB3 | Tribbles Homolog 3 (Drosophila) |
| 5987 | TRIM27 | Ret Finger Protein |
| 7204 | TRIO | Triple Functional Domain (Ptprf Interacting) |
| 140803 | TRPM6 | Hypothetical Protein Flj20087 |
| 54822 | TRPM7 | Transient Receptor Potential Cation Channel, Subfamily M, Member 7 |
| 8295 | TRRAP | Transformation/Transcription Domain-Associated Protein |
| 83942 | TSSK1B | Testis-Specific Serine Kinase 7 Pseudogene |
| 23617 | TSSK2 | Testis-Specific Serine Kinase 2 |
| 81629 | TSSK3 | Testis-Specific Serine Kinase 3 |
| 283629 | TSSK4 | Testis-Specific Serine Kinase 4 |
| 83983 | TSSK6 | Testis-Specific Serine Kinase 6 |
| 84630 | TTBK1 | Tau Tubulin Kinase 1 |
| 146057 | TTBK2 | Kiaa0847 Protein |
| 7272 | TTK | Ttk Protein Kinase |
| 7273 | TTN | Titin |
| 5756 | TWF1 | Ptk9 Protein Tyrosine Kinase 9 |
| 11344 | TWF2 | Ptk9l Protein Tyrosine Kinase 9-Like (A6-Related Protein) |
| 7294 | TXK | Txk Tyrosine Kinase |
| 51314 | TXNDC3 | Thioredoxin Domain Containing 3 (Spermatozoa) |
| 347736 | TXNDC6 | Thioredoxin Domain Containing 6 |
| 7297 | TYK2 | Tyrosine Kinase 2 |
| 7301 | TYRO3 | Tyro3 Protein Tyrosine Kinase |
| 83549 | UCK1 | Uridine-Cytidine Kinase 1 |
| 7371 | UCK2 | Uridine-Cytidine Kinase 2 |
| 54963 | UCKL1 | Uridine-Cytidine Kinase 1-Like 1 |
| 127933 | UHMK1 | U2af Homology Motif (Uhm) Kinase 1 |
| 8408 | ULK1 | Unc-51-Like Kinase 1 (C. Elegans) |
| 9706 | ULK2 | Unc-51-Like Kinase 2 (C. Elegans) |
| 25989 | ULK3 | Unc-51-Like Kinase 3 (C. Elegans) |
| 54986 | ULK4 | Unc-51-Like Kinase 4 (C. Elegans) |
| 7443 | VRK1 | Vaccinia Related Kinase 1 |
| 7444 | VRK2 | Vaccinia Related Kinase 2 |
| 51231 | VRK3 | Vaccinia Related Kinase 3 |
| 7465 | WEE1 | Wee1 Homolog (S. Pombe) |
| 65125 | WNK1 | Kinase Deficient Protein |
| 65268 | WNK2 | Serologically Defined Colon Cancer Antigen 43 |
| 65267 | WNK3 | Kiaa1566 Protein |
| 65266 | WNK4 | Wnk Lysine Deficient Protein Kinase 4 |
| 91419 | XRCC6BP1 | Xrcc6 Binding Protein 1 |
| 9942 | XYLB | Xylulokinase Homolog (H. Influenzae) |
| 7525 | YES1 | V-Yes-1 Yamaguchi Sarcoma Viral Oncogene Homolog 1 |
| 80122 | YSK4 | Yeast Sps1/Ste20-Related Kinase 4 (S. Cerevisiae) |
| 51776 | ZAK | Sterile Alpha Motif And Leucine Zipper Containing Kinase Azk |
| 7535 | ZAP70 | Zeta-Chain (Tcr) Associated Protein Kinase 70 kda |

### Phosphatases

Phosphatases are enzymes that catalyze dephosphorylation, i.e. removal of phosphate group(s) from substrates. A common phosphatase in many organisms is alkaline phosphatase. Protein phosphatases catalyze protein dephosphorylation, the opposite process of protein phosphorylation which is catalyzed by protein kinases. Protein phosphorylation occurs mainly on serine, threonine or tyrosine. Hence main classes of protein phosphatases include serine/threonine phosphatases and tyrosine phosphatases. In addition, there are lipid phosphatases, such as phosphatidylinositol-3,4,5-trisphosphate 3-phosphatase.

Preferred phosphatase genes and/or genetic elements of interest include one or more (e.g., 2, 3, 4, 5, 6, 7, 8, 9 . . . all) of the following:

| GENE ID | GENE Symbol | GENE NAME |
|---|---|---|
| 52 | ACP1 | Acid Phosphatase 1, Soluble |
| 53 | ACP2 | Acid Phosphatase 2, Lysosomal |
| 54 | ACP5 | Acid Phosphatase 5, Tartrate Resistant |
| 51205 | ACP6 | Acid Phosphatase 6, Lysophosphatidic |
| 55 | ACPP | Acid Phosphatase, Prostate |
| 11215 | AKAP11 | A Kinase (Prka) Anchor Protein 11 |
| 248 | ALPI | Alkaline Phosphatase, Intestinal |
| 249 | ALPL | Alkaline Phosphatase, Liver/Bone/Kidney |
| 250 | ALPP | Alkaline Phosphatase, Placental (Regan Isozyme) |
| 251 | ALPPL2 | Alkaline Phosphatase, Placental-Like 2 |
| 81611 | ANP32E | Acidic (Leucine-Rich) Nuclear Phosphoprotein 32 Family, |
| | | Member E |
| 669 | BPGM | 2,3-Bisphosphoglycerate Mutase |
| 10380 | BPNT1 | 3′(2′),5′-Bisphosphate Nucleotidase 1 |
| 10842 | C7ORF16 | Chromosome 7 Open Reading Frame 16 |
| 23523 | CABIN1 | Calcineurin Binding Protein 1 |
| 818 | CAMK2G | Calcium/Calmodulin-Dependent Protein Kinase (Cam Kinase) Ii |
| | | Gamma |
| 23589 | CARHSP1 | Calcium Regulated Heat Stable Protein 1, 24 kda |
| 8556 | CDC14A | Cdc14 Cell Division Cycle 14 Homolog A (S. Cerevisiae) |
| 8555 | CDC14B | Cdc14 Cell Division Cycle 14 Homolog B (S. Cerevisiae) |
| 993 | CDC25A | Cell Division Cycle 25a |
| 994 | CDC25B | Cell Division Cycle 25b |
| 995 | CDC25C | Cell Division Cycle 25c |
| 1033 | CDKN3 | Cyclin-Dependent Kinase Inhibitor 3 (Cdk2-Associated Dual |
| | | Specificity Phosphatase) |
| 8483 | CILP | Cartilage Intermediate Layer Protein, Nucleotide |
| | | Pyrophosphohydrolase |
| 9150 | CTDP1 | Ctd (Carboxy-Terminal Domain, Rna Polymerase Ii, Polypeptide |
| | | A) Phosphatase, Subunit 1 |
| 58190 | CTDSP1 | Ctd (Carboxy-Terminal Domain, Rna Polymerase Ii, Polypeptide |
| | | A) Small Phosphatase 1 |
| 10106 | CTDSP2 | Ctd (Carboxy-Terminal Domain, Rna Polymerase Ii, Polypeptide |
| | | A) Small Phosphatase 2 |
| 27071 | DAPP1 | Dual Adaptor Of Phosphotyrosine And 3-Phosphoinositides |
| 9829 | DNAJC6 | Dnaj (Hsp40) Homolog, Subfamily C, Member 6 |
| 1843 | DUSP1 | Dual Specificity Phosphatase 1 |
| 11221 | DUSP10 | Dual Specificity Phosphatase 10 |
| 8446 | DUSP11 | Dual Specificity Phosphatase 11 (Rna/Rnp Complex 1- |
| | | Interacting) |
| 11266 | DUSP12 | Dual Specificity Phosphatase 12 |
| 51207 | DUSP13 | Dual Specificity Phosphatase 13 |
| 11072 | DUSP14 | Dual Specificity Phosphatase 14 |
| 128853 | DUSP15 | Dual Specificity Phosphatase 15 |
| 80824 | DUSP16 | Dual Specificity Phosphatase 16 |
| 150290 | DUSP18 | Dual Specificity Phosphatase 18 |
| 142679 | DUSP19 | Dual Specificity Phosphatase 19 |
| 1844 | DUSP2 | Dual Specificity Phosphatase 2 |
| 63904 | DUSP21 | Dual Specificity Phosphatase 21 |
| 54935 | DUSP23 | Dual Specificity Phosphatase 23 |
| 1845 | DUSP3 | Dual Specificity Phosphatase 3 (Vaccinia Virus Phosphatase |
| | | Vh1-Related) |
| 1846 | DUSP4 | Dual Specificity Phosphatase 4 |
| 1847 | DUSP5 | Dual Specificity Phosphatase 5 |
| 1848 | DUSP6 | Dual Specificity Phosphatase 6 |
| 1849 | DUSP7 | Dual Specificity Phosphatase 7 |
| 1852 | DUSP9 | Dual Specificity Phosphatase 9 |
| 5610 | EIF2AK2 | Eukaryotic Translation Initiation Factor 2-Alpha Kinase 2 |
| 7957 | EPM2A | Epilepsy, Progressive Myoclonus Type 2a, Lafora Disease |
| | | (Laforin) |
| 2138 | EYA1 | Eyes Absent Homolog 1 (Drosophila) |
| 2139 | EYA2 | Eyes Absent Homolog 2 (Drosophila) |
| 2140 | EYA3 | Eyes Absent Homolog 3 (Drosophila) |
| 2070 | EYA4 | Eyes Absent Homolog 4 (Drosophila) |
| 10818 | FRS2 | Fibroblast Growth Factor Receptor Substrate 2 |
| 3476 | IGBP1 | Immunoglobulin (Cd79a) Binding Protein 1 |
| 3486 | IGFBP3 | Insulin-Like Growth Factor Binding Protein 3 |
| 3628 | INPP1 | Inositol Polyphosphate-1-Phosphatase |
| 3632 | INPP5A | Inositol Polyphosphate-5-Phosphatase, 40 kda |
| 3635 | INPP5D | Inositol Polyphosphate-5-Phosphatase, 145 kda |
| 3636 | INPPL1 | Inositol Polyphosphate Phosphatase-Like 1 |
| 10859 | LILRB1 | Leukocyte Immunoglobulin-Like Receptor, Subfamily B (With |
| | | Tm And Itim Domains), Member 1 |
| 9562 | MINPP1 | Multiple Inositol Polyphosphate Histidine Phosphatase, 1 |
| 4534 | MTM1 | Myotubularin 1 |
| 8776 | MTMR1 | Myotubularin Related Protein 1 |
| 8898 | MTMR2 | Myotubularin Related Protein 2 |
| 8897 | MTMR3 | Myotubularin Related Protein 3 |
| 9110 | MTMR4 | Myotubularin Related Protein 4 |
| 9107 | MTMR6 | Myotubularin Related Protein 6 |
| 9108 | MTMR7 | Myotubularin Related Protein 7 |
| 66036 | MTMR9 | Dkfzp434k171 Protein |
| 140838 | NANP | N-Acetylneuraminic Acid Phosphatase |
| 57546 | PDP2 | Pyruvate Dehydrogenase Phosphatase Isoenzyme 2 |
| 5223 | PGAM1 | Phosphoglycerate Mutase 1 (Brain) |
| 5224 | PGAM2 | Phosphoglycerate Mutase 2 (Muscle) |
| 441531 | PGAM4 | Phosphoglycerate Mutase Family Member 4 |
| 221692 | PHACTR1 | Kiaa1733 Protein |
| 9749 | PHACTR2 | Phosphatase And Actin Regulator 2 |
| 116154 | PHACTR3 | Phosphatase And Actin Regulator 3 |
| 23239 | PHLPP | Ph Domain And Leucine Rich Repeat Protein Phosphatase |
| 23035 | PHLPPL | Ph Domain And Leucine Rich Repeat Protein Phosphatase-Like |
| 29085 | PHPT1 | Phosphohistidine Phosphatase 1 |
| 27124 | PIB5PA | Inositol Polyphosphate 5-Phosphatase |
| 8611 | PPAP2A | Phosphatidic Acid Phosphatase Type 2a |
| 8613 | PPAP2B | Phosphatidic Acid Phosphatase Type 2b |
| 8612 | PPAP2C | Phosphatidic Acid Phosphatase Type 2c |
| 5475 | PPEF1 | Protein Phosphatase, Ef-Hand Calcium Binding Domain 1 |
| 5470 | PPEF2 | Protein Phosphatase, Ef-Hand Calcium Binding Domain 2 |
| 5494 | PPM1A | Protein Phosphatase 1a (Formerly 2c), Magnesium-Dependent, |
| | | Alpha Isoform |
| 5495 | PPM1B | Protein Phosphatase 1b (Formerly 2c), Magnesium-Dependent, |
| | | Beta Isoform |
| 8493 | PPM1D | Protein Phosphatase 1d Magnesium-Dependent, Delta Isoform |
| 9647 | PPM1F | Protein Phosphatase 1f (Pp2c Domain Containing) |
| 5496 | PPM1G | Protein Phosphatase 1g (Formerly 2c), Magnesium-Dependent, |
| | | Gamma Isoform |
| 152926 | PPM1K | Protein Phosphatase 1k (Pp2c Domain Containing) |
| 132160 | PPM1M | Protein Phosphatase 1m (Pp2c Domain Containing) |
| 54704 | PPM2C | Protein Phosphatase 2c, Magnesium-Dependent, Catalytic |
| | | Subunit |
| 51400 | PPME1 | Protein Phosphatase Methylesterase 1 |
| 5499 | PPP1CA | Protein Phosphatase 1, Catalytic Subunit, Alpha Isoform |
| 5500 | PPP1CB | Protein Phosphatase 1, Catalytic Subunit, Beta Isoform |
| 5501 | PPP1CC | Protein Phosphatase 1, Catalytic Subunit, Gamma Isoform |
| 5514 | PPP1R10 | Protein Phosphatase 1, Regulatory Subunit 10 |
| 6992 | PPP1R11 | Protein Phosphatase 1, Regulatory (Inhibitor) Subunit 11 |
| 94274 | PPP1R14A | Protein Phosphatase 1, Regulatory (Inhibitor) Subunit 14a |
| 26472 | PPP1R14B | Protein Phosphatase 1, Regulatory (Inhibitor) Subunit 14b |
| 81706 | PPP1R14C | Protein Phosphatase 1, Regulatory (Inhibitor) Subunit 14c |
| 54866 | PPP1R14D | Protein Phosphatase 1, Regulatory (Inhibitor) Subunit 14d |
| 26051 | PPP1R16B | Protein Phosphatase 1, Regulatory (Inhibitor) Subunit 16b |
| 5502 | PPP1R1A | Protein Phosphatase 1, Regulatory (Inhibitor) Subunit 1a |
| 84152 | PPP1R1B | Protein Phosphatase 1, Regulatory (Inhibitor) Subunit 1b |
| | | (Dopamine And Camp Regulated Phosphoprotein, Darpp-32) |
| 5504 | PPP1R2 | Protein Phosphatase 1, Regulatory (Inhibitor) Subunit 2 |
| 5506 | PPP1R3A | Protein Phosphatase 1, Regulatory (Inhibitor) Subunit 3a |
| | | (Glycogen And Sarcoplasmic Reticulum Binding Subunit, |
| | | Skeletal Muscle) |
| 5507 | PPP1R3C | Protein Phosphatase 1, Regulatory (Inhibitor) Subunit 3c |
| 5509 | PPP1R3D | Protein Phosphatase 1, Regulatory Subunit 3d |
| 5510 | PPP1R7 | Protein Phosphatase 1, Regulatory Subunit 7 |
| 5511 | PPP1R8 | Protein Phosphatase 1, Regulatory (Inhibitor) Subunit 8 |
| 5515 | PPP2CB | Protein Phosphatase 2 (Formerly 2a), Catalytic Subunit, Alpha |
| | | Isoform |
| 5516 | PPP2CB | Protein Phosphatase 2 (Formerly 2a), Catalytic Subunit, Alpha |
| | | Isoform |
| 5518 | PPP2R1A | Protein Phosphatase 2 (Formerly 2a), Regulatory Subunit A (Pr |
| | | 65), Alpha Isoform |
| 5518 | PPP2R1A | Protein Phosphatase 2 (Formerly 2a), Regulatory Subunit A (Pr |
| | | 65), Alpha Isoform |
| 5519 | PPP2R1B | Protein Phosphatase 2 (Formerly 2a), Regulatory Subunit A (Pr |
| | | 65), Beta Isoform |
| 5521 | PPP2R2B | Protein Phosphatase 2 (Formerly 2a), Regulatory Subunit B (Pr |
| | | 52), Beta Isoform |
| 5522 | PPP2R2C | Protein Phosphatase 2 (Formerly 2a), Regulatory Subunit B (Pr |
| | | 52), Gamma Isoform |
| 5523 | PPP2R3A | Protein Phosphatase 2 (Formerly 2a), Regulatory Subunit B″, |
| | | Alpha |
| 28227 | PPP2R3B | Protein Phosphatase 2 (Formerly 2a), Regulatory Subunit B″, |
| | | Beta |
| 5524 | PPP2R4 | Protein Phosphatase 2a, Regulatory Subunit B′ (Pr 53) |
| 5525 | PPP2R5A | Protein Phosphatase 2, Regulatory Subunit B (B56), Alpha |
| | | Isoform |
| 5526 | PPP2R5B | Protein Phosphatase 2, Regulatory Subunit B (B56), Beta Isoform |
| 5527 | PPP2R5C | Protein Phosphatase 2, Regulatory Subunit B (B56), Gamma |
| | | Isoform |
| 5528 | PPP2R5D | Protein Phosphatase 2, Regulatory Subunit B (B56), Delta |
| | | Isoform |
| 5529 | PPP2R5E | Protein Phosphatase 2, Regulatory Subunit B (B56), Epsilon |
| | | Isoform |
| 5530 | PPP3CA | Protein Phosphatase 3 (Formerly 2b), Catalytic Subunit, Alpha |
| | | Isoform (Calcineurin A Alpha) |
| 5532 | PPP3CB | Protein Phosphatase 3 (Formerly 2b), Catalytic Subunit, Beta |
| | | Isoform (Calcineurin A Beta) |
| 5533 | PPP3CC | Protein Phosphatase 3 (Formerly 2b), Catalytic Subunit, Gamma |
| | | Isoform (Calcineurin A Gamma) |
| 5534 | PPP3R1 | Protein Phosphatase 3 (Formerly 2b), Regulatory Subunit B, |
| | | 19 kda, Alpha Isoform (Calcineurin B, Type I) |
| 5531 | PPP4C | Protein Phosphatase 4 (Formerly X), Catalytic Subunit |
| 9989 | PPP4R1 | Protein Phosphatase 4, Regulatory Subunit 1 |
| 5536 | PPP5C | Protein Phosphatase 5, Catalytic Subunit |
| 5537 | PPP6C | Protein Phosphatase 6, Catalytic Subunit |
| 5723 | PSPH | Phosphoserine Phosphatase |
| 5728 | PTEN | Phosphatase And Tensin Homolog (Mutated In Multiple |
| | | Advanced Cancers 1) |
| 5764 | PTN | Pleiotrophin (Heparin Binding Growth Factor 8, Neurite Growth- |
| | | Promoting Factor 1) |
| 7803 | PTP4A1 | Protein Tyrosine Phosphatase Type Iva, Member 1 |
| 8073 | PTP4A2 | Protein Tyrosine Phosphatase Type Iva, Member 2 |
| 11156 | PTP4A3 | Protein Tyrosine Phosphatase Type Iva, Member 3 |
| 9200 | PTPLA | Protein Tyrosine Phosphatase-Like (Proline Instead Of Catalytic |
| | | Arginine), Member A |
| 114971 | PTPMT1 | Protein Tyrosine Phosphatase, Mitochondrial 1 |
| 5770 | PTPN1 | Protein Tyrosine Phosphatase, Non-Receptor Type 1 |
| 5781 | PTPN11 | Protein Tyrosine Phosphatase, Non-Receptor Type 11 (Noonan |
| | | Syndrome 1) |
| 5782 | PTPN12 | Protein Tyrosine Phosphatase, Non-Receptor Type 12 |
| 5783 | PTPN13 | Protein Tyrosine Phosphatase, Non-Receptor Type 13 (Apo- |
| | | 1/Cd95 (Fas)-Associated Phosphatase) |
| 5784 | PTPN14 | Protein Tyrosine Phosphatase, Non-Receptor Type 14 |
| 26469 | PTPN18 | Protein Tyrosine Phosphatase, Non-Receptor Type 18 (Brain- |
| | | Derived) |
| 5771 | PTPN2 | Protein Tyrosine Phosphatase, Non-Receptor Type 2 |
| 26095 | PTPN20B | Protein Tyrosine Phosphatase, Non-Receptor Type 20b |
| 11099 | PTPN21 | Protein Tyrosine Phosphatase, Non-Receptor Type 21 |
| 26191 | PTPN22 | Protein Tyrosine Phosphatase, Non-Receptor Type 22 |
| | | (Lymphoid) |
| 25930 | PTPN23 | Protein Tyrosine Phosphatase, Non-Receptor Type 23 |
| 5774 | PTPN3 | Protein Tyrosine Phosphatase, Non-Receptor Type 3 |
| 5775 | PTPN4 | Protein Tyrosine Phosphatase, Non-Receptor Type 4 |
| | | (Megakaryocyte) |
| 84867 | PTPN5 | Protein Tyrosine Phosphatase, Non-Receptor Type 5 (Striatum- |
| | | Enriched) |
| 5777 | PTPN6 | Protein Tyrosine Phosphatase, Non-Receptor Type 6 |
| 5778 | PTPN7 | Protein Tyrosine Phosphatase, Non-Receptor Type 7 |
| 5780 | PTPN9 | Protein Tyrosine Phosphatase, Non-Receptor Type 9 |
| 5786 | PTPRA | Protein Tyrosine Phosphatase, Receptor Type, A |
| 5787 | PTPRB | Protein Tyrosine Phosphatase, Receptor Type, B |
| 5788 | PTPRC | Protein Tyrosine Phosphatase, Receptor Type, C |
| 5791 | PTPRE | Protein Tyrosine Phosphatase, Receptor Type, E |
| 5792 | PTPRF | Protein Tyrosine Phosphatase, Receptor Type, F |
| 5793 | PTPRG | Protein Tyrosine Phosphatase, Receptor Type, G |
| 5794 | PTPRH | Protein Tyrosine Phosphatase, Receptor Type, H |
| 5795 | PTPRJ | Protein Tyrosine Phosphatase, Receptor Type, J |
| 5796 | PTPRK | Protein Tyrosine Phosphatase, Receptor Type, K |
| 5797 | PTPRM | Protein Tyrosine Phosphatase, Receptor Type, M |
| 5798 | PTPRN | Protein Tyrosine Phosphatase, Receptor Type, N |
| 5799 | PTPRN2 | Protein Tyrosine Phosphatase, Receptor Type, N Polypeptide 2 |
| 5800 | PTPRO | Protein Tyrosine Phosphatase, Receptor Type, O |
| 5801 | PTPRR | Protein Tyrosine Phosphatase, Receptor Type, R |
| 5789 | PTPRS | Protein Tyrosine Phosphatase, Receptor Type, D |
| 5802 | PTPRS | Protein Tyrosine Phosphatase, Receptor Type, D |
| 11122 | PTPRT | Protein Tyrosine Phosphatase, Receptor Type, T |
| 10076 | PTPRU | Protein Tyrosine Phosphatase, Receptor Type, U |
| 5803 | PTPRZ1 | Protein Tyrosine Phosphatase, Receptor-Type, Z Polypeptide 1 |
| 10231 | RCAN2 | Down Syndrome Critical Region Gene 1-Like 1 |
| 8732 | RNGTT | Rna Guanylyltransferase And 5′-Phosphatase |
| 6295 | SAG | S-Antigen; Retina And Pineal Gland (Arrestin) |
| 6305 | SBF1 | Set Binding Factor 1 |
| 6418 | SET | Set Translocation (Myeloid Leukemia-Associated) |
| 6815 | STYX | Serine/Threonine/Tyrosine Interacting Protein |
| 51657 | STYXL1 | Serine/Threonine/Tyrosine Interacting-Like 1 |
| 8867 | SYNJ1 | Synaptojanin 1 |
| 7145 | TNS1 | Tensin 1 |
| 7179 | TPTE | Transmembrane Phosphatase With Tensin Homology |
| 93492 | TPTE2 | Transmembrane Phosphoinositide 3-Phosphatase And Tensin |
| | | Homolog 2 |
| 7204 | TRIO | Triple Functional Domain (Ptprf Interacting) |
| 9839 | ZEB2 | Zinc Finger Homeobox 1b |

### Histone Methyltransferases

Histone methyltransferases (HMT) are enzymes, histone-lysine N-methyltransferase and histone-arginine N-methyltransferase, which catalyze the transfer of one to three methyl groups from the cofactor S-Adenosyl methionine to lysine and arginine residues of histone proteins. These proteins often contain an SET (Su(var)₃-9, Enhancer of Zeste, Trithorax) domain. Histone methylation serves in epigenetic gene regulation. Methylated histones bind DNA more tightly, which inhibits transcription.

Catalyzed by histone methyltransferases, histone methylation plays a key role in regulation of chromatin status and global gene expression, especially during development and differentiation. Histone methylation can be dysregulated in cancer and other important diseases, including inflammatory, metabolic and neurologic disorders.

Genomic copy number aberrations, mutations, mRNA expression dys-regulation of histone methyltransferases have been identified in various human cancers. Inhibition of histone methyltransferases re-program cells into more differentiated states, therefore this class of enzymes serves as attractive cancer therapeutic targets.

Preferred histone methyltransferase genes and/or genetic elements of interest include one or more (e.g., 2, 3, 4, 5, 6, 7, 8, 9 . . . all) of the following:

| GENE ID | GENE_SYMBOL | Gene Name |
|---|---|---|
| 55870 | ASH1L | ASH1 (ABSENT, SMALL, OR HOMEOTIC)-LIKE |
| | | (DROSOPHILA) |
| 9070 | ASH2L | ASH2 (ABSENT, SMALL, OR HOMEOTIC)-LIKE |
| | | (DROSOPHILA) |
| 10498 | CARM1 | COACTIVATOR-ASSOCIATED ARGININE |
| | | METHYLTRANSFERASE 1 |
| 84444 | DOT1L | DOT1-LIKE, HISTONE H3 METHYLTRANSFERASE |
| | | (S. CEREVISIAE) |
| 79813 | EHMT1 | EUCHROMATIC HISTONE-LYSINE N- |
| | | METHYLTRANSFERASE 1 |
| 10919 | EHMT2 | EUCHROMATIC HISTONE-LYSINE N- |
| | | METHYLTRANSFERASE 2 |
| 2145 | EZH1 | ENHANCER OF ZESTE HOMOLOG 1 (DROSOPHILA) |
| 2146 | EZH2 | ENHANCER OF ZESTE HOMOLOG 2 (DROSOPHILA) |
| 4297 | MLL | MYELOID/LYMPHOID OR MIXED-LINEAGE |
| | | LEUKEMIA (TRITHORAX HOMOLOG, DROSOPHILA) |
| 8085 | MLL2 | MYELOID/LYMPHOID OR MIXED-LINEAGE |
| | | LEUKEMIA 2 |
| 58508 | MLL3 | MYELOID/LYMPHOID OR MIXED-LINEAGE |
| | | LEUKEMIA 3 |
| 9757 | MLL4 | MYELOID/LYMPHOID OR MIXED-LINEAGE |
| | | LEUKEMIA 4 |
| 55904 | MLL5 | HYPOTHETICAL PROTEIN FLJ10078 |
| 64324 | NSD1 | NUCLEAR RECEPTOR BINDING SET DOMAIN |
| | | PROTEIN 1 |
| 93166 | PRDM6 | PR DOMAIN CONTAINING 6 |
| 11105 | PRDM7 | PR DOMAIN CONTAINING 7 |
| 56979 | PRDM9 | PR DOMAIN CONTAINING 9 |
| 9739 | SETD1A | SET DOMAIN CONTAINING 1A |
| 23067 | SETD1B | SET DOMAIN CONTAINING 1B |
| 29072 | SETD2 | HUNTINGTIN INTERACTING PROTEIN B |
| 80854 | SETD7 | SET DOMAIN CONTAINING (LYSINE |
| | | METHYLTRANSFERASE) 7 |
| 387893 | SETD8 | SET DOMAIN CONTAINING (LYSINE |
| | | METHYLTRANSFERASE) 8 |
| 9869 | SETDB1 | SET DOMAIN, BIFURCATED 1 |
| 83852 | SETDB2 | SET DOMAIN, BIFURCATED 2 |
| 6419 | SETMAR | SET DOMAIN AND MARINER TRANSPOSASE FUSION |
| | | GENE |
| 6839 | SUV39H1 | SUPPRESSOR OF VARIEGATION 3-9 HOMOLOG 1 |
| | | (DROSOPHILA) |
| 79723 | SUV39H2 | SUPPRESSOR OF VARIEGATION 3-9 HOMOLOG 2 |
| | | (DROSOPHILA) |
| 51111 | SUV420H1 | SUPPRESSOR OF VARIEGATION 4-20 HOMOLOG 1 |
| | | (DROSOPHILA) |
| 84787 | SUV420H2 | SUPPRESSOR OF VARIEGATION 4-20 HOMOLOG 2 |
| | | (DROSOPHILA) |
| 7468 | WHSC1 | WOLF-HIRSCHHORN SYNDROME CANDIDATE 1 |
| 54904 | WHSC1L1 | WOLF-HIRSCHHORN SYNDROME CANDIDATE 1- |
| | | LIKE 1 |

### Histone Demethylases

Preferred histone demethylase genes and/or genetic elements of interest include one or more (e.g., 2, 3, 4, 5, 6, 7, 8, 9 . . . all) of the following:

| GENE ID | GENE SYMBOL | Gene Name |
|---|---|---|
| 23028 | AOF2 | Amine Oxidase (Flavin Containing) |
| | | Domain 2 |
| 84678 | FBXL10 | F-Box And Leucine-Rich Repeat Protein |
| | | 10 |
| 22992 | FBXL11 | F-Box And Leucine-Rich Repeat Protein |
| | | 11 |
| 5927 | JARID1A | Jumonji, At Rich Interactive Domain 1a |
| | | (Rbbp2-Like) |
| 10765 | JARID1B | Jumonji, At Rich Interactive Domain 1b |
| | | (Rbp2-Like) |
| 8242 | JARID1C | Smcy Homolog, X-Linked (Mouse) |
| 8284 | JARID1D | Smcy Homolog, Y-Linked (Mouse) |
| 55818 | JMJD1A | Jumonji Domain Containing 1a |
| 51780 | JMJD1B | Jumonji Domain Containing 1b |
| 9682 | JMJD2A | Jumonji Domain Containing 2a |
| 23030 | JMJD2B | Jumonji Domain Containing 2b |
| 23081 | JMJD2C | Jumonji Domain Containing 2c |
| 55693 | JMJD2D | Jumonji Domain Containing 2d |
| 23135 | JMJD3 | Jumonji Domain Containing 3 |
| 7403 | UTX | Ubiquitously Transcribed Tetratrico- |
| | | peptide Repeat, X Chromosome |

### Histone Acetyltransferases

Histone acetyltransferases (HAT) are enzymes that acetylate conserved lysine amino acids on histone proteins by transferring an acetyl group from acetyl CoA to form c-N-acetyl lysine.

Preferred histone acetyltransferase genes and/or genetic elements of interest include one or more (e.g., 2, 3, 4, 5, 6, 7, 8, 9 . . . all) of the following:

| Gene ID | Gene Symbol | Gene Name |
|---|---|---|
| 675 | BRCA2 | Breast Cancer 2, Early Onset |
| 9085 | CDY1 | Chromodomain Protein, Y-Linked, 1 |
| 9426 | CDY2B | Chromodomain Protein, Y-Linked, 2a |
| 9425 | CDYL | Chromodomain Protein, Y-Like |
| 9575 | CLOCK | Clock Homolog (Mouse) |
| 1387 | CREBBP | Creb Binding Protein (Rubinstein-Taybi Syndrome) |
| 8721 | EDF1 | Endothelial Differentiation-Related Factor 1 |
| 55140 | ELP3 | Elongation Protein 3 Homolog (S. Cerevisiae) |
| 2033 | EP300 | E1a Binding Protein P300 |
| 80314 | EPC1 | Enhancer Of Polycomb Homolog 1 (Drosophila) |
| 2648 | GCN5L2 | Gcn5 General Control Of Amino-Acid Synthesis 5-Like 2 |
| | | (Yeast) |
| 8520 | HAT1 | Histone Acetyltransferase 1 |
| 10524 | HTATIP | Hiv-1 Tat Interacting Protein, 60 kda |
| 54556 | ING3 | Inhibitor Of Growth Family, Member 3 |
| 10724 | MGEA5 | Meningioma Expressed Antigen 5 (Hyaluronidase) |
| 84148 | MYST1 | Myst Histone Acetyltransferase 1 |
| 11143 | MYST2 | Myst Histone Acetyltransferase 2 |
| 7994 | MYST3 | Myst Histone Acetyltransferase (Monocytic Leukemia) 3 |
| 8648 | NCOA1 | Nuclear Receptor Coactivator 1 |
| 8202 | NCOA3 | Nuclear Receptor Coactivator 3 |
| 8850 | PCAF | P300/Cbp-Associated Factor |
| 79595 | SAP130 | Sin3a-Associated Protein, 130 kda |
| 10847 | SRCAP | Snf2-Related Cbp Activator Protein |
| 8464 | SUPT3H | Suppressor Of Ty 3 Homolog (S. Cerevisiae) |
| 9913 | SUPT7L | Suppressor Of Ty 7 (S. Cerevisiae)-Like |
| 117143 | TADA1L | Transcriptional Adaptor 1 (Hfi1 Homolog, Yeast)-Like |
| 6871 | TADA2L | Transcriptional Adaptor 2 (Ada2 Homolog, Yeast)-Like |
| 10474 | TADA3L | Transcriptional Adaptor 3 (Ngg1 Homolog, Yeast)-Like |
| 6872 | TAF1 | Taf1 Rna Polymerase Ii, Tata Box Binding Protein (Tbp)- |
| | | Associated Factor, 250 kda |
| 6881 | TAF10 | Taf10 Rna Polymerase Ii, Tata Box Binding Protein (Tbp)- |
| | | Associated Factor, 30 kda |
| 6883 | TAF12 | Taf12 Rna Polymerase Ii, Tata Box Binding Protein (Tbp)- |
| | | Associated Factor, 20 kda |
| 138474 | TAF1L | Taf1-Like Rna Polymerase Ii, Tata Box Binding Protein (Tbp)- |
| | | Associated Factor, 210 kda |
| 6877 | TAF5 | Taf5 Rna Polymerase Ii, Tata Box Binding Protein (Tbp)- |
| | | Associated Factor, 100 kda |
| 27097 | TAF5L | Taf5-Like Rna Polymerase Ii, P300/Cbp-Associated Factor |
| | | (Pcaf)-Associated Factor, 65 kda |
| 10629 | TAF6L | Taf6-Like Rna Polymerase Ii, P300/Cbp-Associated Factor |
| | | (Pcaf)-Associated Factor, 65 kda |
| 6880 | TAF9 | Taf9 Rna Polymerase Ii, Tata Box Binding Protein (Tbp)- |
| | | Associated Factor, 32 kda |

### Histone Deacetylases

Histone deacetylases (HDAC) are a class of enzymes that remove acetyl groups from an c-N-acetyl lysine amino acid on a histone. Its action is opposite to that of histone acetyltransferase.

Preferred histone deacetylases genes and/or genetic elements of interest include one or more (e.g., 2, 3, 4, 5, 6, 7, 8, 9 . . . all) of the following:

| Gene ID | Gene Symbol | Gene Name |
|---|---|---|
| 3065 | HDAC1 | Histone Deacetylase 1 |
| 83933 | HDAC10 | Histone Deacetylase 10 |
| 79885 | HDAC11 | Histone Deacetylase 11 |
| 3066 | HDAC2 | Histone Deacetylase 2 |
| 8841 | HDAC3 | Histone Deacetylase 3 |
| 9759 | HDAC4 | Histone Deacetylase 4 |
| 10014 | HDAC5 | Histone Deacetylase 5 |
| 10013 | HDAC6 | Histone Deacetylase 6 |
| 51564 | HDAC7A | Dkfzp586j0917 Protein |
| 55869 | HDAC8 | Histone Deacetylase 8 |
| 9734 | HDAC9 | Histone Deacetylase 9 |
| 9219 | MTA2 | Metastasis Associated 1 |
| | | Family, Member 2 |
| 51547 | PYCR1 | Pyrroline-5-Carboxylate |
| | | Reductase 1 |
| 23411 | SIRT1 | Sirtuin (Silent Mating Type |
| | | Information Regulation 2 Homolog) |
| | | 1 (S. Cerevisiae) |
| 22933 | SIRT2 | Sirtuin (Silent Mating Type |
| | | Information Regulation 2 Homolog) |
| | | 2 (S. Cerevisiae) |
| 23410 | SIRT3 | Sirtuin (Silent Mating Type |
| | | Information Regulation 2 Homolog) |
| | | 3 (S. Cerevisiae) |
| 23409 | SIRT4 | Sirtuin (Silent Mating Type |
| | | Information Regulation 2 Homolog) |
| | | 4 (S. Cerevisiae) |
| 23408 | SIRT5 | Sirtuin (Silent Mating Type |
| | | Information Regulation 2 Homolog) |
| | | 5 (S. Cerevisiae) |
| 51548 | SIRT6 | Sirtuin (Silent Mating Type |
| | | Information Regulation 2 Homolog) |
| | | 6 (S. Cerevisiae) |

### Genomics Driven Libraries

Genomics driven libraries are libraries including genes known to be genomically altered in human cancers. Using datasets like those generated by The Cancer Genome Atlas (TCGA) and other genome profiling libraries are developed representing genes that i) reside in regions of chromosome amplification; or ii) are somatically mutated in human cancers.

Preferred cancer genes and/or genetic elements of interest that are amplified in cancer include the following:

| | | Entrez |
|---|---|---|
| Symbol | Name | GeneID |
| AKT2 | v-akt murine thymoma viral oncogene homolog 2 | 208 |
| ALK | anaplastic lymphoma kinase (Ki-1) | 238 |
| EGFR | epidermal growth factor receptor (erythroblastic | 1956 |
| | leukemia viral (v-erb-b) oncogene homolog, avian) | |
| ERBB2 | v-erb-b2 erythroblastic leukemia viral oncogene | 2064 |
| | homolog 2, neuro/glioblastoma derived oncogene | |
| | homolog (avian) | |
| MDM2 | Mdm2 p53 binding protein homolog | 4193 |
| MDM4 | Mdm4 p53 binding protein homolog | 4194 |
| MITF | microphthalmia-associated transcription factor | 4286 |
| MYC | v-myc myelocytomatosis viral oncogene homolog | 4609 |
| | (avian) | |
| MYCL1 | v-myc myelocytomatosis viral oncogene homolog 1, | 4610 |
| | lung carcinoma derived (avian) | |
| MYCN | v-myc myelocytomatosis viral related oncogene, | 4613 |
| | neuroblastoma derived (avian) | |
| REL | v-rel reticuloendotheliosis viral oncogene homolog | 5966 |
| | (avian) | |

The table below provides a list of the cancer genes and/or genetic elements of interest that are somatically mutated.

| | | Entrez |
|---|---|---|
| Symbol | Name | GeneID |
| ABL1 | v-abl Abelson murine leukemia viral oncogene homolog 1 | 25 |
| ABL2 | v-abl Abelson murine leukemia viral oncogene homolog 2 | 27 |
| ACSL3 | acyl-CoA synthetase long-chain family member 3 | 2181 |
| AF15Q14 | AF15q14 protein | 57082 |
| AF1Q | ALL1-fused gene from chromosome 1q | 10962 |
| AF3p21 | SH3 protein interacting with Nck, 90 kDa (ALL1 fused gene from | 51517 |
| | 3p21) | |
| AF5q31 | ALL1 fused gene from 5q31 | 27125 |
| AKAP9 | A kinase (PRKA) anchor protein (yotiao) 9 | 10142 |
| AKT1 | v-akt murine thymoma viral oncogene homolog 1 | 207 |
| AKT2 | v-akt murine thymoma viral oncogene homolog 2 | 208 |
| ALK | anaplastic lymphoma kinase (Ki-1) | 238 |
| ALO17 | KIAA1618 protein | 57714 |
| APC | adenomatous polyposis of the colon gene | 324 |
| ARHGEF12 | RHO guanine nucleotide exchange factor (GEF) 12 (LARG) | 23365 |
| ARHH | RAS homolog gene family, member H (TTF) | 399 |
| ARNT | aryl hydrocarbon receptor nuclear translocator | 405 |
| ASPSCR1 | alveolar soft part sarcoma chromosome region, candidate 1 | 79058 |
| ASXL1 | additional sex combs like 1 | 171023 |
| ATF1 | activating transcription factor 1 | 466 |
| ATIC | 5-aminoimidazole-4-carboxamide ribonucleotide | 471 |
| | formyltransferase/IMP cyclohydrolase | |
| ATM | ataxia telangiectasia mutated | 472 |
| BCL10 | B-cell CLL/lymphoma 10 | 8915 |
| BCL11A | B-cell CLL/lymphoma 11A | 53335 |
| BCL11B | B-cell CLL/lymphoma 11B (CTIP2) | 64919 |
| BCL2 | B-cell CLL/lymphoma 2 | 596 |
| BCL3 | B-cell CLL/lymphoma 3 | 602 |
| BCL5 | B-cell CLL/lymphoma 5 | 603 |
| BCL6 | B-cell CLL/lymphoma 6 | 604 |
| BCL7A | B-cell CLL/lymphoma 7A | 605 |
| BCL9 | B-cell CLL/lymphoma 9 | 607 |
| BCR | breakpoint cluster region | 613 |
| BIRC3 | baculoviral IAP repeat-containing 3 | 330 |
| BRAF | v-raf murine sarcoma viral oncogene homolog B1 | 673 |
| BRCA1 | familial breast/ovarian cancer gene 1 | 672 |
| BRCA2 | familial breast/ovarian cancer gene 2 | 675 |
| BRD3 | bromodomain containing 3 | 8019 |
| BRD4 | bromodomain containing 4 | 23476 |
| BTG1 | B-cell translocation gene 1, anti-proliferative | 694 |
| C12orf9 | chromosome 12 open reading frame 9 | 93669 |
| C15orf21 | chromosome 15 open reading frame 21 | 283651 |
| CANT1 | calcium activated nucleotidase 1 | 124583 |
| CARD11 | caspase recruitment domain family, member 11 | 84433 |
| CARS | cysteinyl-tRNA synthetase | 833 |
| CBFA2T1 | core-binding factor, runt domain, alpha subunit 2; translocated to, 1 | 862 |
| | (ETO) | |
| CBFA2T3 | core-binding factor, runt domain, alpha subunit 2; translocated to, 3 | 863 |
| | (MTG-16) | |
| CBFB | core-binding factor, beta subunit | 865 |
| CBL | Cas-Br-M (murine) ecotropic retroviral transforming | 867 |
| CBLB | Cas-Br-M (murine) ecotropic retroviral transforming sequence b | 868 |
| CBLC | Cas-Br-M (murine) ecotropic retroviral transforming sequence c | 23624 |
| CCND1 | cyclin D1 | 595 |
| CCND2 | cyclin D2 | 894 |
| CCND3 | cyclin D3 | 896 |
| CD74 | CD74 molecule, major histocompatibility complex, class II invariant | 972 |
| | chain | |
| CDH1 | cadherin 1, type 1, E-cadherin (epithelial) (ECAD) | 999 |
| CDH11 | cadherin 11, type 2, OB-cadherin (osteoblast) | 1009 |
| CDK6 | cyclin-dependent kinase 6 | 1021 |
| CDKN2A- | cyclin-dependent kinase inhibitor 2A-- p14ARF protein | 1029 |
| p14ARF | | |
| CDKN2A - | cyclin-dependent kinase inhibitor 2A (p16(INK4a)) gene | 1029 |
| p16(INK4a) | | |
| CDX2 | caudal type homeo box transcription factor 2 | 1045 |
| CEBPA | CCAAT/enhancer binding protein (C/EBP), alpha | 1050 |
| CEP1 | centrosomal protein 1 | 11064 |
| CHCHD7 | coiled-coil-helix-coiled-coil-helix domain containing 7 | 79145 |
| CHIC2 | cysteine-rich hydrophobic domain 2 | 26511 |
| CHN1 | chimerin (chimaerin) 1 | 1123 |
| CIC | capicua homolog (Drosophila) | 23152 |
| CLTC | clathrin, heavy polypeptide (Hc) | 1213 |
| CLTCL1 | clathrin, heavy polypeptide-like 1 | 8218 |
| CMKOR1 | chemokine orphan receptor 1 | 57007 |
| COL1A1 | collagen, type I, alpha 1 | 1277 |
| COPEB | core promoter element binding protein (KLF6) | 1316 |
| COX6C | cytochrome c oxidase subunit VIc | 1345 |
| CREB1 | cAMP responsive element binding protein 1 | 1385 |
| CREB3L2 | cAMP responsive element binding protein 3-like 2 | 64764 |
| CREBBP | CREB binding protein (CBP) | 1387 |
| CRTC3 | CREB regulated transcription coactivator 3 | 64784 |
| CTNNB1 | catenin (cadherin-associated protein), beta 1 | 1499 |
| CYLD | familial cylindromatosis gene | 1540 |
| D10S170 | DNA segment on chromosome 10 (unique) 170, H4 gene (PTC1) | 8030 |
| DDIT3 | DNA-damage-inducible transcript 3 | 1649 |
| DDX10 | DEAD (Asp-Glu-Ala-Asp) box polypeptide 10 | 1662 |
| DDX5 | DEAD (Asp-Glu-Ala-Asp) box polypeptide 5 | 1655 |
| DDX6 | DEAD (Asp-Glu-Ala-Asp) box polypeptide 6 | 1656 |
| DEK | DEK oncogene (DNA binding) | 7913 |
| DUX4 | double homeobox, 4 | 22947 |
| EGFR | epidermal growth factor receptor (erythroblastic leukemia viral | 1956 |
| | (v-erb-b) oncogene homolog, avian) | |
| EIF4A2 | eukaryotic translation initiation factor 4A, isoform 2 | 1974 |
| ELF4 | E74-like factor 4 (ets domain transcription factor) | 2000 |
| ELK4 | ELK4, ETS-domain protein (SRF accessory protein 1) | 2005 |
| ELKS | ELKS protein | 23085 |
| ELL | ELL gene (11-19 lysine-rich leukemia gene) | 8178 |
| ELN | elastin | 2006 |
| EML4 | echinoderm microtubule associated protein like 4 | 27436 |
| EP300 | 300 kd E1A-Binding protein gene | 2033 |
| EPS15 | epidermal growth factor receptor pathway substrate 15 (AF1p) | 2060 |
| ERBB2 | v-erb-b2 erythroblastic leukemia viral oncogene homolog 2, | 2064 |
| | neuro/glioblastoma derived oncogene homolog (avian) | |
| ERG | v-ets erythroblastosis virus E26 oncogene like (avian) | 2078 |
| ETV1 | ets variant gene 1 | 2115 |
| ETV4 | ets variant gene 4 (E1A enhancer binding protein, E1AF) | 2118 |
| ETV5 | ets variant gene 5 | 2119 |
| ETV6 | ets variant gene 6 (TEL oncogene) | 2120 |
| EVI1 | ecotropic viral integration site 1 | 2122 |
| EWSR1 | Ewing sarcoma breakpoint region 1 (EWS) | 2130 |
| FACL6 | fatty-acid-coenzyme A ligase, long-chain 6 | 23305 |
| FBXW7 | F-box and WD-40 domain protein 7 (archipelago homolog, | 55294 |
| | Drosophila) | |
| FCGR2B | Fc fragment of IgG, low affinity IIb, receptor for (CD32) | 2213 |
| FEV | FEV protein - (HSRNAFEV) | 54738 |
| FGFR1 | fibroblast growth factor receptor 1 | 2260 |
| FGFR1OP | FGFR1 oncogene partner (FOP) | 11116 |
| FGFR2 | fibroblast growth factor receptor 2 | 2263 |
| FGFR3 | fibroblast growth factor receptor 3 | 2261 |
| FH | fumarate hydratase | 2271 |
| FIP1L1 | FIP1 like 1 (S. cerevisiae) | 81608 |
| FLI1 | Friend leukemia virus integration 1 | 2313 |
| FLT3 | fms-related tyrosine kinase 3 | 2322 |
| FNBP1 | formin binding protein 1 (FBP17) | 23048 |
| FOXL2 | forkhead box L2 | 668 |
| FOXO1A | forkhead box O1A (FKHR) | 2308 |
| FOXO3A | forkhead box O3A | 2309 |
| FOXP1 | forkhead box P1 | 27086 |
| FSTL3 | follistatin-like 3 (secreted glycoprotein) | 10272 |
| FUS | fusion, derived from t(12; 16) malignant liposarcoma | 2521 |
| FVT1 | follicular lymphoma variant translocation 1 | 2531 |
| GAS7 | growth arrest-specific 7 | 8522 |
| GATA1 | GATA binding protein 1 (globin transcription factor 1) | 2623 |
| GATA2 | GATA binding protein 2 | 2624 |
| GMPS | guanine monphosphate synthetase | 8833 |
| GNAQ | guanine nucleotide binding protein (G protein), q polypeptide | 2776 |
| GNAS | guanine nucleotide binding protein (G protein), alpha stimulating | 2778 |
| | activity polypeptide 1 | |
| GOLGA5 | golgi autoantigen, golgin subfamily a, 5 (PTC5) | 9950 |
| GOPC | golgi associated PDZ and coiled-coil motif containing | 57120 |
| GPHN | gephyrin (GPH) | 10243 |
| GRAF | GTPase regulator associated with focal adhesion kinase pp125(FAK) | 23092 |
| HCMOGT-1 | sperm antigen HCMOGT-1 | 92521 |
| HEAB | ATP_GTP binding protein | 10978 |
| HEI10 | enhancer of invasion 10 - fused to HMGA2 | 57820 |
| HERPUD1 | homocysteine-inducible, endoplasmic reticulum stress-inducible, | 9709 |
| | ubiquitin-like domain member 1 | |
| HIP1 | huntingtin interacting protein 1 | 3092 |
| HIST1H4I | histone 1, H4i (H4FM) | 8294 |
| HLF | hepatic leukemia factor | 3131 |
| HLXB9 | homeo box HB9 | 3110 |
| HMGA1 | high mobility group AT-hook 1 | 3159 |
| HMGA2 | high mobility group AT-hook 2 (HMGIC) | 8091 |
| HNRNPA2B1 | heterogeneous nuclear ribonucleoprotein A2/B1 | 3181 |
| HOOK3 | hook homolog 3 | 84376 |
| HOXA11 | homeo box A11 | 3207 |
| HOXA13 | homeo box A13 | 3209 |
| HOXA9 | homeo box A9 | 3205 |
| HOXC11 | homeo box C11 | 3227 |
| HOXC13 | homeo box C13 | 3229 |
| HOXD11 | homeo box D11 | 3237 |
| HOXD13 | homeo box D13 | 3239 |
| HRAS | v-Ha-ras Harvey rat sarcoma viral oncogene homolog | 3265 |
| HRPT2 | hyperparathyroidism 2 | 3279 |
| HSPCA | heat shock 90 kDa protein 1, alpha | 3320 |
| HSPCB | heat shock 90 kDa protein 1, beta | 3326 |
| IDH1 | isocitrate dehydrogenase 1 (NADP+), soluble | 3417 |
| IDH2 | socitrate dehydrogenase 2 (NADP+), mitochondrial | 3418 |
| IGH@ | immunoglobulin heavy locus | 3492 |
| IGK@ | immunoglobulin kappa locus | 50802 |
| IGL@ | immunoglobulin lambda locus | 3535 |
| IKZF1 | IKAROS family zinc finger 1 | 10320 |
| IL2 | interleukin 2 | 3558 |
| IL21R | interleukin 21 receptor | 50615 |
| IL6ST | interleukin 6 signal transducer (gp130, oncostatin M receptor) | 3572 |
| IRF4 | interferon regulatory factor 4 | 3662 |
| IRTA1 | immunoglobulin superfamily receptor translocation associated 1 | 83417 |
| ITK | IL2-inducible T-cell kinase | 3702 |
| JAK2 | Janus kinase 2 | 3717 |
| JAK3 | Janus kinase 3 | 3718 |
| JAZF1 | juxtaposed with another zinc finger gene 1 | 221895 |
| KDM5A | lysine (K)-specific demethylase 5A, JARID1A | 5927 |
| KDM6A | lysine (K)-specific demethylase 6A, UTX | 7403 |
| KIAA1549 | KIAA1549 | 57670 |
| KIT | v-kit Hardy-Zuckerman 4 feline sarcoma viral oncogene homolog | 3815 |
| KLK2 | kallikrein-related peptidase 2 | 3817 |
| KRAS | v-Ki-ras2 Kirsten rat sarcoma 2 viral oncogene homolog | 3845 |
| KTN1 | kinectin 1 (kinesin receptor) | 3895 |
| LAF4 | lymphoid nuclear protein related to AF4 | 3899 |
| LASP1 | LIM and SH3 protein 1 | 3927 |
| LCK | lymphocyte-specific protein tyrosine kinase | 3932 |
| LCP1 | lymphocyte cytosolic protein 1 (L-plastin) | 3936 |
| LCX | leukemia-associated protein with a CXXC domain | 80312 |
| LHFP | lipoma HMGIC fusion partner | 10186 |
| LIFR | leukemia inhibitory factor receptor | 3977 |
| LMO1 | LIM domain only 1 (rhombotin 1) (RBTN1) | 4004 |
| LMO2 | LIM domain only 2 (rhombotin-like 1) (RBTN2) | 4005 |
| LPP | LIM domain containing preferred translocation partner in lipoma | 4026 |
| LYL1 | lymphoblastic leukemia derived sequence 1 | 4066 |
| MADH4 | Homolog of Drosophila Mothers Against Decapentaplegic 4 gene | 4089 |
| MAFB | v-maf musculoaponeurotic fibrosarcoma oncogene homolog B (avian) | 9935 |
| MALT1 | mucosa associated lymphoid tissue lymphoma translocation gene 1 | 10892 |
| MAML2 | mastermind-like 2 (Drosophila) | 84441 |
| MAP2K4 | mitogen-activated protein kinase kinase 4 | 6416 |
| MDM2 | Mdm2 p53 binding protein homolog | 4193 |
| MDM4 | Mdm4 p53 binding protein homolog | 4194 |
| MDS1 | myelodysplasia syndrome 1 | 4197 |
| MDS2 | myelodysplastic syndrome 2 | 259283 |
| MECT1 | mucoepidermoid translocated 1 | 94159 |
| MEN1 | multiple endocrine neoplasia type 1 gene | 4221 |
| MET | met proto-oncogene (hepatocyte growth factor receptor) | 4233 |
| MHC2TA | MHC class II transactivator | 4261 |
| MITF | microphthalmia-associated transcription factor | 4286 |
| MKL1 | megakaryoblastic leukemia (translocation) 1 | 57591 |
| MLF1 | myeloid leukemia factor 1 | 4291 |
| MLH1 | E. coli MutL homolog gene | 4292 |
| MLL | myeloid/lymphoid or mixed-lineage leukemia (trithorax homolog, | 4297 |
| | Drosophila) | |
| MLLT1 | myeloid/lymphoid or mixed-lineage leukemia (trithorax homolog, | 4298 |
| | Drosophila); translocated to, 1 (ENL) | |
| MLLT10 | myeloid/lymphoid or mixed-lineage leukemia (trithorax homolog, | 8028 |
| | Drosophila); translocated to, 10 (AF10) | |
| MLLT2 | myeloid/lymphoid or mixed-lineage leukemia (trithorax homolog, | 4299 |
| | Drosophila); translocated to, 2 (AF4) | |
| MLLT3 | myeloid/lymphoid or mixed-lineage leukemia (trithorax homolog, | 4300 |
| | Drosophila); translocated to, 3 (AF9) | |
| MLLT4 | myeloid/lymphoid or mixed-lineage leukemia (trithorax homolog, | 4301 |
| | Drosophila); translocated to, 4 (AF6) | |
| MLLT6 | myeloid/lymphoid or mixed-lineage leukemia (trithorax homolog, | 4302 |
| | Drosophila); translocated to, 6 (AF17) | |
| MLLT7 | myeloid/lymphoid or mixed-lineage leukemia (trithorax homolog, | 4303 |
| | Drosophila); translocated to, 7 (AFX1) | |
| MN1 | meningioma (disrupted in balanced translocation) 1 | 4330 |
| MPL | myeloproliferative leukemia virus oncogene, thrombopoietin | 4352 |
| | receptor | |
| MSF | MLL septin-like fusion | 10801 |
| MSH2 | mutS homolog 2 (E. coli) | 4436 |
| MSH6 | mutS homolog 6 (E. coli) | 2956 |
| MSI2 | musashi homolog 2 (Drosophila) | 124540 |
| MSN | moesin | 4478 |
| MTCP1 | mature T-cell proliferation 1 | 4515 |
| MUC1 | mucin 1, transmembrane | 4582 |
| MYC | v-myc myelocytomatosis viral oncogene homolog (avian) | 4609 |
| MYCL1 | v-myc myelocytomatosis viral oncogene homolog 1, lung carcinoma | 4610 |
| | derived (avian) | |
| MYCN | v-myc myelocytomatosis viral related oncogene, neuroblastoma | 4613 |
| | derived (avian) | |
| MYH11 | myosin, heavy polypeptide 11, smooth muscle | 4629 |
| MYH9 | myosin, heavy polypeptide 9, non-muscle | 4627 |
| MYST4 | MYST histone acetyltransferase (monocytic leukemia) 4 (MORF) | 23522 |
| NACA | nascent-polypeptide-associated complex alpha polypeptide | 4666 |
| NCOA1 | nuclear receptor coactivator 1 | 8648 |
| NCOA2 | nuclear receptor coactivator 2 (TIF2) | 10499 |
| NCOA4 | nuclear receptor coactivator 4 - PTC3 (ELE1) | 8031 |
| NF1 | neurofibromatosis type 1 gene | 4763 |
| NF2 | neurofibromatosis type 2 gene | 4771 |
| NFKB2 | nuclear factor of kappa light polypeptide gene enhancer in B-cells 2 | 4791 |
| | (p49/p100) | |
| NIN | ninein (GSK3B interacting protein) | 51199 |
| NONO | non-POU domain containing, octamer-binding | 4841 |
| NOTCH1 | Notch homolog 1, translocation-associated (Drosophila) (TAN1) | 4851 |
| NOTCH2 | Notch homolog 2 | 4853 |
| NPM1 | nucleophosmin (nucleolar phosphoprotein B23, numatrin) | 4869 |
| NR4A3 | nuclear receptor subfamily 4, group A, member 3 (NOR1) | 8013 |
| NRAS | neuroblastoma RAS viral (v-ras) oncogene homolog | 4893 |
| NSD1 | nuclear receptor binding SET domain protein 1 | 64324 |
| NTRK1 | neurotrophic tyrosine kinase, receptor, type 1 | 4914 |
| NTRK3 | neurotrophic tyrosine kinase, receptor, type 3 | 4916 |
| NUMA1 | nuclear mitotic apparatus protein 1 | 4926 |
| NUP214 | nucleoporin 214 kDa (CAN) | 8021 |
| NUP98 | nucleoporin 98 kDa | 4928 |
| NUT | nuclear protien in testis | 256646 |
| OLIG2 | oligodendrocyte lineage transcription factor 2 (BHLHB1) | 10215 |
| OMD | osteomodulin | 4958 |
| PAFAH1B2 | platelet-activating factor acetylhydrolase, isoform Ib, beta subunit | 5049 |
| | 30 kDa | |
| PAX3 | paired box gene 3 | 5077 |
| PAX5 | paired box gene 5 (B-cell lineage specific activator protein) | 5079 |
| PAX7 | paired box gene 7 | 5081 |
| PAX8 | paired box gene 8 | 7849 |
| PBX1 | pre-B-cell leukemia transcription factor 1 | 5087 |
| PCM1 | pericentriolar material 1 (PTC4) | 5108 |
| PCSK7 | proprotein convertase subtilisin/kexin type 7 | 9159 |
| PDE4DIP | phosphodiesterase 4D interacting protein (myomegalin) | 9659 |
| PDGFB | platelet-derived growth factor beta polypeptide (simian sarcoma viral | 5155 |
| | (v-sis) oncogene homolog) | |
| PDGFRA | platelet-derived growth factor, alpha-receptor | 5156 |
| PDGFRB | platelet-derived growth factor receptor, beta polypeptide | 5159 |
| PER1 | period homolog 1 (Drosophila) | 5187 |
| PHOX2B | paired-like homeobox 2b | 8929 |
| PICALM | phosphatidylinositol binding clathrin assembly protein (CALM) | 8301 |
| PIK3CA | phosphoinositide-3-kinase, catalytic, alpha polypeptide | 5290 |
| PIK3R1 | phosphoinositide-3-kinase, regulatory subunit 1 (alpha) | 5295 |
| PIM1 | pim-1 oncogene | 5292 |
| PLAG1 | pleiomorphic adenoma gene 1 | 5324 |
| PML | promyelocytic leukemia | 5371 |
| PMX1 | paired mesoderm homeo box 1 | 5396 |
| PNUTL1 | peanut-like 1 (Drosophila) | 5413 |
| POU2AF1 | POU domain, class 2, associating factor 1 (OBF1) | 5450 |
| POU5F1 | POU domain, class 5, transcription factor 1 | 5460 |
| PPARG | peroxisome proliferative activated receptor, gamma | 5468 |
| PRCC | papillary renal cell carcinoma (translocation-associated) | 5546 |
| PRDM16 | PR domain containing 16 | 63976 |
| PRKAR1A | protein kinase, cAMP-dependent, regulatory, type I, alpha (tissue | 5573 |
| | specific extinguisher 1) | |
| PRO1073 | PRO1073 protein (ALPHA) | 29005 |
| PSIP2 | PC4 and SFRS1 interacting protein 2 (LEDGF) | 11168 |
| PTCH | Homolog of Drosophila Patched gene | 5727 |
| PTEN | phosphatase and tensin homolog gene | 5728 |
| PTPN11 | protein tyrosine phosphatase, non-receptor type 11 | 5781 |
| RAB5EP | rabaptin, RAB GTPase binding effector protein 1 (RABPT5) | 9135 |
| RAD51L1 | RAD51-like 1 (S. cerevisiae) (RAD51B) | 5890 |
| RAF1 | v-raf-1 murine leukemia viral oncogene homolog 1 | 5894 |
| RANBP17 | RAN binding protein 17 | 64901 |
| RAP1GDS1 | RAP1, GTP-GDP dissociation stimulator 1 | 5910 |
| RARA | retinoic acid receptor, alpha | 5914 |
| RB1 | retinoblastoma gene | 5925 |
| RBM15 | RNA binding motif protein 15 | 64783 |
| REL | v-rel reticuloendotheliosis viral oncogene homolog (avian) | 5966 |
| RET | ret proto-oncogene | 5979 |
| ROS1 | v-ros UR2 sarcoma virus oncogene homolog 1 (avian) | 6098 |
| RPL22 | ribosomal protein L22 (EAP) | 6146 |
| RPN1 | ribophorin I | 6184 |
| RUNX1 | runt-related transcription factor 1 (AML1) | 861 |
| RUNXBP2 | runt-related transcription factor binding protein 2 (MOZ/ZNF220) | 7994 |
| 6-Sep | septin 6 | 23157 |
| SET | SET translocation | 6418 |
| SFPQ | splicing factor proline/glutamine rich(polypyrimidine tract binding | 6421 |
| | protein associated) | |
| SFRS3 | splicing factor, arginine/serine-rich 3 | 6428 |
| SH3GL1 | SH3-domain GRB2-like 1 (EEN) | 6455 |
| SIL | TAL1 (SCL) interrupting locus | 6491 |
| SLC45A3 | solute carrier family 45, member 3 | 85414 |
| SMARCA4 | SWI/SNF related, matrix associated, actin dependent regulator of | 6597 |
| | chromatin, subfamily a, member 4 | |
| SMARCB1 | SWI/SNF related, matrix associated, actin dependent regulator of | 6598 |
| | chromatin, subfamily b, member 1 | |
| SMO | smoothened homolog (Drosophila) | 6608 |
| SOCS1 | suppressor of cytokine signaling 1 | 8651 |
| SRGAP3 | SLIT-ROBO Rho GTPase activating protein 3 | 9901 |
| SS18 | synovial sarcoma translocation, chromosome 18 | 6760 |
| SS18L1 | synovial sarcoma translocation gene on chromosome 18-like 1 | 26039 |
| SSH3BP1 | spectrin SH3 domain binding protein 1 | 10006 |
| SSX1 | synovial sarcoma, X breakpoint 1 | 6756 |
| SSX2 | synovial sarcoma, X breakpoint 2 | 6757 |
| SSX4 | synovial sarcoma, X breakpoint 4 | 6759 |
| STK11 | serine/threonine kinase 11 gene (LKB1) | 6794 |
| STL | Six-twelve leukemia gene | 7955 |
| SUFU | suppressor of fused homolog (Drosophila) | 51684 |
| SUZ12 | suppressor of zeste 12 homolog (Drosophila) | 23512 |
| SYK | spleen tyrosine kinase | 6850 |
| TAF15 | TAF15 RNA polymerase II, TATA box binding protein (TBP)- | 8148 |
| | associated factor, 68 kDa | |
| TAL1 | T-cell acute lymphocytic leukemia 1 (SCL) | 6886 |
| TAL2 | T-cell acute lymphocytic leukemia 2 | 6887 |
| TCEA1 | transcription elongation factor A (SII), 1 | 6917 |
| TCF1 | transcription factor 1, hepatic (HNF1) | 6927 |
| TCF12 | transcription factor 12 (HTF4, helix-loop-helix transcription factors 4) | 6938 |
| TCF3 | transcription factor 3 (E2A immunoglobulin enhancer binding | 6929 |
| | factors E12/E47) | |
| TCL1A | T-cell leukemia/lymphoma 1A | 8115 |
| TCL6 | T-cell leukemia/lymphoma 6 | 27004 |
| TET2 | tet oncogene family member 2 | 54790 |
| TFE3 | transcription factor binding to IGHM enhancer 3 | 7030 |
| TFEB | transcription factor EB | 7942 |
| TFG | TRK-fused gene | 10342 |
| TFPT | TCF3 (E2A) fusion partner (in childhood Leukemia) | 29844 |
| TFRC | transferrin receptor (p90, CD71) | 7037 |
| THRAP3 | thyroid hormone receptor associated protein 3 (TRAP150) | 9967 |
| TIF1 | transcriptional intermediary factor 1 (PTC6, TIF1A) | 8805 |
| TLX1 | T-cell leukemia, homeobox 1 (HOX11) | 3195 |
| TLX3 | T-cell leukemia, homeobox 3 (HOX11L2) | 30012 |
| TMPRSS2 | transmembrane protease, serine 2 | 7113 |
| TNFRSF17 | tumor necrosis factor receptor superfamily, member 17 | 608 |
| TNFRSF6 | tumor necrosis factor receptor superfamily, member 6 (FAS) | 355 |
| TOP1 | topoisomerase (DNA) I | 7150 |
| TP53 | tumor protein p53 | 7157 |
| TPM3 | tropomyosin 3 | 7170 |
| TPM4 | tropomyosin 4 | 7171 |
| TPR | translocated promoter region | 7175 |
| TRA@ | T cell receptor alpha locus | 6955 |
| TRB@ | T cell receptor beta locus | 6957 |
| TRD@ | T cell receptor delta locus | 6964 |
| TRIM27 | tripartite motif-containing 27 | 5987 |
| TRIM33 | tripartite motif-containing 33 (PTC7, TIF1G) | 51592 |
| TRIP11 | thyroid hormone receptor interactor 11 | 9321 |
| TSHR | thyroid stimulating hormone receptor | 7253 |
| TTL | tubulin tyrosine ligase | 150465 |
| USP6 | ubiquitin specific peptidase 6 (Tre-2 oncogene) | 9098 |
| VHL | von Hippel-Lindau syndrome gene | 7428 |
| WHSC1L1 | Wolf-Hirschhorn syndrome candidate 1-like 1 (NSD3) | 54904 |
| WT1 | Wilms tumor 1 gene | 7490 |
| WTX | family with sequence similarity 123B (FAM123B) | 139285 |
| ZNF145 | zinc finger protein 145 (PLZF) | 7704 |
| ZNF198 | zinc finger protein 198 | 7750 |
| ZNF278 | zinc finger protein 278 (ZSG) | 23598 |
| ZNF331 | zinc finger protein 331 | 55422 |
| ZNF384 | zinc finger protein 384 (CIZ/NMP4) | 171017 |
| ZNF521 | zinc finger protein 521 | 25925 |
| ZNF9 | zinc finger protein 9 (a cellular retroviral nucleic acid binding | 7555 |
| | protein) | |
| ZNFN1A1 | zinc finger protein, subfamily 1A, 1 (Ikaros) | 10320 |

### Cellular Process Libraries

Cellular process libraries are libraries including genes involved in particular cellular processes. For example, library of genes involved in cellular metabolism and chromatin modification. The rationale is based on recent literature suggesting the involvement and deregulation of these processes in cancer.

### Class Based Libraries

Class based libraries are libraries including genes representing a particular class of molecules. For example, we will develop a cDNA library including the class of receptor tyrosine kinases (RTKs). Other libraries in development include G-protein coupled receptors (GPCR), genes involved in PI3K signaling, and membrane bound proteins.

### Receptor Tyrosine Kinases

Receptor tyrosine kinases (RTK) are high affinity cell surface receptors for polypeptide growth factors, cytokines and hormones. Receptor tyrosine kinases have been shown to be not only key regulators of normal cellular processes but also to have a critical role in the development and progression of many types of cancer. There are several different RTK classes, which include, but is not limited to the following: RTK class I (EGF receptor family), RTK class II (Insulin receptor family), RTK class III (PDGF receptor family), RTK class IV (FGF receptor family), RTK class V (VEGF receptors family), RTK class VI (HGF receptor family), RTK class VII (Trk receptor family), RTK class IX (AXL receptor family), RTK class X (LTK receptor family), RTK class XI (TIE receptor family), RTK class XII (ROR receptor family), RTK class XIII (DDR receptor family), RTK class XV (KLG receptor family), RTK class XVI (RYK receptor family), and RTK class XVII (MuSK receptor family).

The ErbB protein family or epidermal growth factor receptor (EGFR) family is a family of four structurally related receptor tyrosine kinases. Insufficient ErbB signaling in humans is associated with the development of neurodegenerative diseases, such as multiple sclerosis and Alzheimer's Disease. In mice loss of signaling by any member of the ErbB family results in embryonic lethality with defects in organs including the lungs, skin, heart and brain. Excessive ErbB signaling is associated with the development of a wide variety of types of solid tumor. ErbB-1 and ErbB-2 are found in many human cancers and their excessive signaling may be critical factors in the development and malignancy of these tumors. The ErbB protein family includes the following: ErbB-1, also named epidermal growth factor receptor (EGFR); ErbB-2, also named HER2 in humans and neu in rodents; ErbB-3, also named HER3 and ErbB-4, also named HER4.

The platelet-derived growth factors PDGF-A and -B are recognized as important factors regulating cell proliferation, cellular differentiation, cell growth, development and many diseases including cancer. The PDGF family consists of PDGF-A, -B, -C and -D, which form either homo- or heterodimers (PDGF-AA, -AB, -BB, -CC, -DD). The four PDGFs are inactive in their monomeric forms. The PDGFs bind to the protein tyrosine kinase receptors PDGF receptor-α and -β. These two receptor isoforms dimerize upon binding the PDGF dimer, leading to three possible receptor combinations, namely -αα, -ββ and -αβ. The extracellular region of the receptor consists of five immunoglobulin-like domains while the intracellular part is a tyrosine kinase domain. The ligand-binding sites of the receptors are located to the three first immunoglobulin-like domains. PDGF-CC specifically interacts with PDGFR-αα and -αβ, but not with -ββ, and thereby resembles PDGF-AB. PDGF-DD binds to PDGFR-ββ with high affinity, and to PDGFR-αβ to a markedly lower extent and is therefore regarded as PDGFR-ββ specific. PDGF-AA binds only to PDGFR-αα, while PDGF-BB is the only PDGF that can bind all three receptor combinations with high affinity.

The fibroblast growth factor receptors are, as their name implies, receptors which bind to members of the fibroblast growth factor family of proteins. Five distinct membrane FGFR have been identified in vertebrates and all of them belong to the tyrosine kinase superfamily (FGFR1 to FGFR4).

VEGF receptors are receptors for Vascular Endothelial Growth Factor (VEGF). These include VEGF-A, VEGFR-1 (Flt-1), VEGFR-2 (KDR/Flk-1), and VEGFR-3. MET (mesenchymal-epithelial transition factor) is a proto-oncogene that encodes a protein MET, also known as c-Met or hepatocyte growth factor receptor (HGFR). Abnormal MET activation in cancer correlates with poor prognosis, where aberrantly active MET triggers tumor growth, formation of new blood vessels (angiogenesis) that supply the tumor with nutrients, and cancer spread to other organs (metastasis). MET is deregulated in many types of human malignancies, including cancers of kidney, liver, stomach, breast, and brain. Various mutations in the MET gene are associated with papillary renal carcinoma.

Trk receptors are a family of tyrosine kinases that regulates synaptic strength and plasticity in the mammalian nervous system. The three most common types of trk receptors are trkA, trkB, and trkC.

The angiopoietin receptors are receptors which bind angiopoietin. There are four identified angiopoietins: Ang1, Ang2, Ang3, Ang4.

The related to receptor tyrosine kinase (RYK) gene encodes the protein Ryk. The protein encoded by this gene is an atypical member of the family of growth factor receptor protein tyrosine kinases, differing from other members at a number of conserved residues in the activation and nucleotide binding domains.

Preferred RTK libraries include one or more (e.g., 2, 3, 4, 5, 6, 7, 8, 9 . . . all) of the following:

| GENE ID | GENE SYMBOL | Gene Name |
|---|---|---|
| 238 | ALK | Anaplastic Lymphoma Kinase (Ki-1) |
| 558 | AXL | Axl Receptor Tyrosine Kinase |
| 1436 | CSF1R | Colony Stimulating Factor 1 Receptor, Formerly Mcdonough |
| | | Feline Sarcoma Viral (V-Fms) Oncogene Homolog |
| 780 | DDR1 | Discoidin Domain Receptor Family, Member 1 |
| 4921 | DDR2 | Discoidin Domain Receptor Family, Member 2 |
| 1956 | EGFR | Epidermal Growth Factor Receptor (Erythroblastic Leukemia |
| | | Viral (V-Erb-B) Oncogene Homolog, Avian) |
| 2041 | EPHA1 | Eph Receptor A1 |
| 284656 | EPHA10 | Eph Receptor A10 |
| 1969 | EPHA2 | Eph Receptor A2 |
| 2042 | EPHA3 | Eph Receptor A3 |
| 2043 | EPHA4 | Eph Receptor A4 |
| 2044 | EPHA5 | Eph Receptor A5 |
| 285220 | EPHA6 | Eph Receptor A6 |
| 2045 | EPHA7 | Eph Receptor A7 |
| 2046 | EPHA8 | Eph Receptor A8 |
| 2047 | EPHB1 | Eph Receptor B1 |
| 2048 | EPHB2 | Eph Receptor B2 |
| 2049 | EPHB3 | Eph Receptor B3 |
| 2050 | EPHB4 | Eph Receptor B4 |
| 2051 | EPHB6 | Eph Receptor B6 |
| 2064 | ERBB2 | V-Erb-B2 Erythroblastic Leukemia Viral Oncogene Homolog 2, |
| | | Neuro/Glioblastoma Derived Oncogene Homolog (Avian) |
| 2065 | ERBB3 | V-Erb-B2 Erythroblastic Leukemia Viral Oncogene Homolog 3 |
| | | (Avian) |
| 2066 | ERBB4 | V-Erb-A Erythroblastic Leukemia Viral Oncogene Homolog 4 |
| | | (Avian) |
| 2260 | FGFR1 | Fibroblast Growth Factor Receptor 1 (Fms-Related Tyrosine |
| | | Kinase 2, Pfeiffer Syndrome) |
| 2263 | FGFR2 | Fibroblast Growth Factor Receptor 2 (Bacteria-Expressed |
| | | Kinase, Keratinocyte Growth Factor Receptor, Craniofacial |
| | | Dysostosis 1, Crouzon Syndrome, Pfeiffer Syndrome, Jackson- |
| | | Weiss Syndrome) |
| 2261 | FGFR3 | Fibroblast Growth Factor Receptor 3 (Achondroplasia, |
| | | Thanatophoric Dwarfism) |
| 2264 | FGFR4 | Fibroblast Growth Factor Receptor 4 |
| 2321 | FLT1 | Fms-Related Tyrosine Kinase 1 (Vascular Endothelial Growth |
| | | Factor/Vascular Permeability Factor Receptor) |
| 2322 | FLT3 | Fms-Related Tyrosine Kinase 3 |
| 2324 | FLT4 | Fms-Related Tyrosine Kinase 4 |
| 3480 | IGF1R | Insulin-Like Growth Factor 1 Receptor |
| 3643 | INSR | Insulin Receptor |
| 3645 | INSRR | Insulin Receptor-Related Receptor |
| 3791 | KDR | Kinase Insert Domain Receptor (A Type Iii Receptor Tyrosine |
| | | Kinase) |
| 3815 | KIT | V-Kit Hardy-Zuckerman 4 Feline Sarcoma Viral Oncogene |
| | | Homolog |
| 4058 | LTK | Leukocyte Tyrosine Kinase |
| 10461 | MERTK | C-Mer Proto-Oncogene Tyrosine Kinase |
| 4233 | MET | Met Proto-Oncogene (Hepatocyte Growth Factor Receptor) |
| 4486 | MST1R | Macrophage Stimulating 1 Receptor (C-Met-Related Tyrosine |
| | | Kinase) |
| 4593 | MUSK | Muscle, Skeletal, Receptor Tyrosine Kinase |
| 4914 | NTRK1 | Neurotrophic Tyrosine Kinase, Receptor, Type 1 |
| 4915 | NTRK2 | Neurotrophic Tyrosine Kinase, Receptor, Type 2 |
| 4916 | NTRK3 | Neurotrophic Tyrosine Kinase, Receptor, Type 3 |
| 5156 | PDGFRA | Platelet-Derived Growth Factor Receptor, Alpha Polypeptide |
| 5159 | PDGFRB | Platelet-Derived Growth Factor Receptor, Beta Polypeptide |
| 5754 | PTK7 | Ptk7 Protein Tyrosine Kinase 7 |
| 5979 | RET | Ret Proto-Oncogene (Multiple Endocrine Neoplasia And |
| | | Medullary Thyroid Carcinoma 1, Hirschsprung Disease) |
| 4919 | ROR1 | Receptor Tyrosine Kinase-Like Orphan Receptor 1 |
| 4920 | ROR2 | Receptor Tyrosine Kinase-Like Orphan Receptor 2 |
| 6098 | ROS1 | V-Ros Ur2 Sarcoma Virus Oncogene Homolog 1 (Avian) |
| 6259 | RYK | Ryk Receptor-Like Tyrosine Kinase |
| 7010 | TEK | Tek Tyrosine Kinase, Endothelial (Venous Malformations, |
| | | Multiple Cutaneous And Mucosal) |
| 7075 | TIE1 | Tyrosine Kinase With Immunoglobulin-Like And Egf-Like |
| | | Domains 1 |
| 7301 | TYRO3 | Tyro3 Protein Tyrosine Kinase |

### G-Protein Coupled Receptors

The human genome encodes roughly 350 G protein-coupled receptors (GPCR), which bind hormones, growth factors, and other endogenous ligands. Approximately 150 of the GPCRs found in the human genome have unknown functions. GPCRs can be grouped into 6 classes based on sequence homology and functional similarity. These are Class A (or 1) (Rhodopsin-like); Class B (or 2) (Secretin receptor family); Class C (or 3) (Metabotropic glutamate/pheromone); Class D (or 4) (Fungal mating pheromone receptors); Class E (or 5) (Cyclic AMP receptors); and Class F (or 6) (Frizzled/Smoothened).

Preferred GPCR libraries include one or more (e.g., 2, 3, 4, 5, 6, 7, 8, 9 . . . all) of the following:

| GENE ID | GENE Symbol | GENE NAME |
|---|---|---|
| 117 | ADCYAP1R1 | Adenylate Cyclase Activating Polypeptide 1 (Pituitary) |
| | | Receptor Type I |
| 134 | ADORA1 | Adenosine A1 Receptor |
| 135 | ADORA2A | Adenosine A2a Receptor |
| 136 | ADORA2B | Adenosine A2b Receptor |
| 140 | ADORA3 | Adenosine A3 Receptor |
| 148 | ADRA1A | Adrenergic, Alpha-1a-, Receptor |
| 147 | ADRA1B | Adrenergic, Alpha-1b-, Receptor |
| 146 | ADRA1D | Adrenergic, Alpha-1d-, Receptor |
| 150 | ADRA2A | Adrenergic, Alpha-2a-, Receptor |
| 152 | ADRA2C | Adrenergic, Alpha-2c-, Receptor |
| 153 | ADRB1 | Adrenergic, Beta-1-, Receptor |
| 154 | ADRB2 | Adrenergic, Beta-2-, Receptor, Surface |
| 155 | ADRB3 | Adrenergic, Beta-3-, Receptor |
| 185 | AGTR1 | Angiotensin Ii Receptor, Type 1 |
| 186 | AGTR2 | Angiotensin Ii Receptor, Type 2 |
| 187 | AGTRL1 | Angiotensin Ii Receptor-Like 1 |
| 552 | AVPR1A | Arginine Vasopressin Receptor 1a |
| 553 | AVPR1B | Arginine Vasopressin Receptor 1b |
| 554 | AVPR2 | Arginine Vasopressin Receptor 2 (Nephrogenic Diabetes |
| | | Insipidus) |
| 577 | BAI3 | Brain-Specific Angiogenesis Inhibitor 3 |
| 623 | BDKRB1 | Bradykinin Receptor B1 |
| 624 | BDKRB2 | Bradykinin Receptor B2 |
| 643 | BLR1 | Burkitt Lymphoma Receptor 1, Gtp Binding Protein |
| | | (Chemokine (C-X-C Motif) Receptor 5) |
| 680 | BRS3 | Bombesin-Like Receptor 3 |
| 719 | C3AR1 | Complement Component 3a Receptor 1 |
| 728 | C5AR1 | Complement Component 5a Receptor 1 |
| 1903 | C9ORF47 | Endothelial Differentiation, Sphingolipid G-Protein-Coupled |
| | | Receptor, 3 |
| 799 | CALCR | Calcitonin Receptor |
| 10203 | CALCRL | Calcitonin Receptor-Like |
| 846 | CASR | Calcium-Sensing Receptor (Hypocalciuric Hypercalcemia 1, |
| | | Severe Neonatal Hyperparathyroidism) |
| 1238 | CCBP2 | Chemokine Binding Protein 2 |
| 887 | CCKBR | Cholecystokinin B Receptor |
| 1230 | CCR1 | Chemokine (C-C Motif) Receptor 1 |
| 2826 | CCR10 | Chemokine (C-C Motif) Receptor 10 |
| 1231 | CCR2 | Chemokine (C-C Motif) Receptor 2 |
| 1232 | CCR3 | Chemokine (C-C Motif) Receptor 3 |
| 1233 | CCR4 | Chemokine (C-C Motif) Receptor 4 |
| 1234 | CCR5 | Chemokine (C-C Motif) Receptor 5 |
| 1235 | CCR6 | Chemokine (C-C Motif) Receptor 6 |
| 1236 | CCR7 | Chemokine (C-C Motif) Receptor 7 |
| 1237 | CCR8 | Chemokine (C-C Motif) Receptor 8 |
| 10803 | CCR9 | Chemokine (C-C Motif) Receptor 9 |
| 51554 | CCRL1 | Chemokine (C-C Motif) Receptor-Like 1 |
| 9034 | CCRL2 | Chemokine (C-C Motif) Receptor-Like 2 |
| 976 | CD97 | Cd97 Antigen |
| 1128 | CHRM1 | Cholinergic Receptor, Muscarinic 1 |
| 1129 | CHRM2 | Cholinergic Receptor, Muscarinic 2 |
| 1131 | CHRM3 | Cholinergic Receptor, Muscarinic 3 |
| 1133 | CHRM5 | Cholinergic Receptor, Muscarinic 5 |
| 1240 | CMKLR1 | Chemokine-Like Receptor 1 |
| 1268 | CNR1 | Cannabinoid Receptor 1 (Brain) |
| 1269 | CNR2 | Cannabinoid Receptor 2 (Macrophage) |
| 1394 | CRHR1 | Corticotropin Releasing Hormone Receptor 1 |
| 1524 | CX3CR1 | Chemokine (C-X3-C Motif) Receptor 1 |
| 2833 | CXCR3 | Chemokine (C-X-C Motif) Receptor 3 |
| 7852 | CXCR4 | Chemokine (C-X-C Motif) Receptor 4 |
| 10663 | CXCR6 | Chemokine (C-X-C Motif) Receptor 6 |
| 57007 | CXCR7 | Chemokine Orphan Receptor 1 |
| 10800 | CYSLTR1 | Cysteinyl Leukotriene Receptor 1 |
| 57105 | CYSLTR2 | Cysteinyl Leukotriene Receptor 2 |
| 2532 | DARC | Duffy Blood Group, Chemokine Receptor |
| 1812 | DRD1 | Dopamine Receptor D1 |
| 1813 | DRD2 | Dopamine Receptor D2 |
| 1814 | DRD3 | Dopamine Receptor D3 |
| 1815 | DRD4 | Dopamine Receptor D4 |
| 1816 | DRD5 | Dopamine Receptor D5 |
| 1880 | EBI2 | Epstein-Barr Virus Induced Gene 2 (Lymphocyte-Specific G |
| | | Protein-Coupled Receptor) |
| 1901 | EDG1 | Endothelial Differentiation, Sphingolipid G-Protein-Coupled |
| | | Receptor, 1 |
| 1902 | EDG2 | Endothelial Differentiation, Lysophosphatidic Acid G- |
| | | Protein-Coupled Receptor, 2 |
| 9170 | EDG4 | Endothelial Differentiation, Lysophosphatidic Acid G- |
| | | Protein-Coupled Receptor, 4 |
| 9294 | EDG5 | Endothelial Differentiation, Sphingolipid G-Protein-Coupled |
| | | Receptor, 5 |
| 8698 | EDG6 | Endothelial Differentiation, Lysophosphatidic Acid G- |
| | | Protein-Coupled Receptor, 6 |
| 23566 | EDG7 | Endothelial Differentiation, Lysophosphatidic Acid G- |
| | | Protein-Coupled Receptor, 7 |
| 53637 | EDG8 | Endothelial Differentiation, Sphingolipid G-Protein-Coupled |
| | | Receptor, 8 |
| 1909 | EDNRA | Endothelin Receptor Type A |
| 1910 | EDNRB | Endothelin Receptor Type B |
| 64123 | ELTD1 | Egf, Latrophilin And Seven Transmembrane Domain |
| | | Containing 1 |
| 30817 | EMR2 | Egf-Like Module Containing, Mucin-Like, Hormone |
| | | Receptor-Like 2 |
| 2149 | F2R | Coagulation Factor Ii (Thrombin) Receptor |
| 2150 | F2RL1 | Coagulation Factor Ii (Thrombin) Receptor-Like 1 |
| 2151 | F2RL2 | Coagulation Factor Ii (Thrombin) Receptor-Like 2 |
| 9002 | F2RL3 | Coagulation Factor Ii (Thrombin) Receptor-Like 3 |
| 2864 | FFAR1 | Free Fatty Acid Receptor 1 |
| 2867 | FFAR2 | Free Fatty Acid Receptor 2 |
| 2865 | FFAR3 | Free Fatty Acid Receptor 3 |
| 2357 | FPR1 | Formyl Peptide Receptor 1 |
| 2358 | FPRL1 | Formyl Peptide Receptor-Like 1 |
| 2359 | FPRL2 | Formyl Peptide Receptor-Like 2 |
| 2492 | FSHR | Follicle Stimulating Hormone Receptor |
| 8321 | FZD1 | Frizzled Homolog 1 (Drosophila) |
| 11211 | FZD10 | Frizzled Homolog 10 (Drosophila) |
| 2535 | FZD2 | Frizzled Homolog 2 (Drosophila) |
| 7976 | FZD3 | Frizzled Homolog 3 (Drosophila) |
| 8322 | FZD4 | Frizzled Homolog 4 (Drosophila) |
| 7855 | FZD5 | Frizzled Homolog 5 (Drosophila) |
| 8323 | FZD6 | Frizzled Homolog 6 (Drosophila) |
| 8324 | FZD7 | Frizzled Homolog 7 (Drosophila) |
| 8325 | FZD8 | Frizzled Homolog 8 (Drosophila) |
| 8326 | FZD9 | Frizzled Homolog 9 (Drosophila) |
| 2550 | GABBR1 | Gamma-Aminobutyric Acid (Gaba) B Receptor, 1 |
| 9568 | GABBR2 | Gamma-Aminobutyric Acid (Gaba) B Receptor, 2 |
| 8484 | GALR3 | Galanin Receptor 3 |
| 2642 | GCGR | Glucagon Receptor |
| 2692 | GHRHR | Growth Hormone Releasing Hormone Receptor |
| 2693 | GHSR | Growth Hormone Secretagogue Receptor |
| 2696 | GIPR | Gastric Inhibitory Polypeptide Receptor |
| 2740 | GLP1R | Glucagon-Like Peptide 1 Receptor |
| 9340 | GLP2R | Glucagon-Like Peptide 2 Receptor |
| 2798 | GNRHR | Gonadotropin-Releasing Hormone Receptor |
| 2852 | GPER | G Protein-Coupled Receptor 30 |
| 2825 | GPR1 | G Protein-Coupled Receptor 1 |
| 83550 | GPR101 | G Protein-Coupled Receptor 101 |
| 84109 | GPR103 | G Protein-Coupled Receptor 103 |
| 338442 | GPR109A | G Protein-Coupled Receptor 109a |
| 8843 | GPR109B | G Protein-Coupled Receptor 109b |
| 221188 | GPR114 | G Protein-Coupled Receptor 114 |
| 221395 | GPR116 | G Protein-Coupled Receptor 116 |
| 139760 | GPR119 | G Protein-Coupled Receptor 119 |
| 2835 | GPR12 | G Protein-Coupled Receptor 12 |
| 166647 | GPR125 | G Protein-Coupled Receptor 125 |
| 57211 | GPR126 | G Protein-Coupled Receptor 126 |
| 84873 | GPR128 | G Protein-Coupled Receptor 128 |
| 29933 | GPR132 | G Protein-Coupled Receptor 132 |
| 64582 | GPR135 | G Protein-Coupled Receptor 135 |
| 350383 | GPR142 | G Protein-Coupled Receptor 142 |
| 115330 | GPR146 | G Protein-Coupled Receptor 146 |
| 344561 | GPR148 | G Protein-Coupled Receptor 148 |
| 344758 | GPR149 | G Protein-Coupled Receptor 149 |
| 2838 | GPR15 | G Protein-Coupled Receptor 15 |
| 151556 | GPR155 | G Protein-Coupled Receptor 155 |
| 26996 | GPR160 | G Protein-Coupled Receptor 160 |
| 23432 | GPR161 | G Protein-Coupled Receptor 161 |
| 27239 | GPR162 | Leprecan-Like 2 |
| 2840 | GPR17 | G Protein-Coupled Receptor 17 |
| 29909 | GPR171 | G Protein-Coupled Receptor 171 |
| 79581 | GPR172A | G Protein-Coupled Receptor 172a |
| 55065 | GPR172B | G Protein-Coupled Receptor 172b |
| 54328 | GPR173 | G Protein-Coupled Receptor 173 |
| 84636 | GPR174 | G Protein-Coupled Receptor 174 |
| 11245 | GPR176 | G Protein-Coupled Receptor 176 |
| 2841 | GPR18 | G Protein-Coupled Receptor 18 |
| 11318 | GPR182 | Adrenomedullin Receptor |
| 2842 | GPR19 | G Protein-Coupled Receptor 19 |
| 2843 | GPR20 | G Protein-Coupled Receptor 20 |
| 2844 | GPR21 | G Protein-Coupled Receptor 21 |
| 2845 | GPR22 | G Protein-Coupled Receptor 22 |
| 2846 | GPR23 | G Protein-Coupled Receptor 23 |
| 2848 | GPR25 | G Protein-Coupled Receptor 25 |
| 2849 | GPR26 | G Protein-Coupled Receptor 26 |
| 2850 | GPR27 | G Protein-Coupled Receptor 27 |
| 2827 | GPR3 | G Protein-Coupled Receptor 3 |
| 2853 | GPR31 | G Protein-Coupled Receptor 31 |
| 2854 | GPR32 | G Protein-Coupled Receptor 32 |
| 2857 | GPR34 | G Protein-Coupled Receptor 34 |
| 2859 | GPR35 | G Protein-Coupled Receptor 35 |
| 2861 | GPR37 | G Protein-Coupled Receptor 37 (Endothelin Receptor Type |
| | | B-Like) |
| 9283 | GPR37L1 | G Protein-Coupled Receptor 37 Like 1 |
| 2863 | GPR39 | G Protein-Coupled Receptor 39 |
| 2828 | GPR4 | G Protein-Coupled Receptor 4 |
| 2866 | GPR42 | G Protein-Coupled Receptor 42 |
| 11251 | GPR44 | Chemoattractant Receptor-Homologous Molecule Expressed |
| | | On Th2 Cells |
| 11250 | GPR45 | G Protein-Coupled Receptor 45 |
| 9248 | GPR50 | G Protein-Coupled Receptor 50 |
| 9293 | GPR52 | G Protein-Coupled Receptor 52 |
| 9290 | GPR55 | G Protein-Coupled Receptor 55 |
| 9289 | GPR56 | G Protein-Coupled Receptor 56 |
| 2830 | GPR6 | G Protein-Coupled Receptor 6 |
| 83873 | GPR61 | G Protein-Coupled Receptor 61 |
| 118442 | GPR62 | G Protein-Coupled Receptor 62 |
| 81491 | GPR63 | G Protein-Coupled Receptor 63 |
| 10149 | GPR64 | G Protein-Coupled Receptor 64 |
| 8477 | GPR65 | G Protein-Coupled Receptor 65 |
| 8111 | GPR68 | G Protein-Coupled Receptor 68 |
| 10936 | GPR75 | G Protein-Coupled Receptor 75 |
| 27202 | GPR77 | G Protein-Coupled Receptor 77 |
| 27201 | GPR78 | G Protein-Coupled Receptor 78 |
| 27198 | GPR81 | G Protein-Coupled Receptor 81 |
| 27197 | GPR82 | G Protein-Coupled Receptor 82 |
| 10888 | GPR83 | G Protein-Coupled Receptor 83 |
| 53831 | GPR84 | G Protein-Coupled Receptor 84 |
| 54329 | GPR85 | G Protein-Coupled Receptor 85 |
| 53836 | GPR87 | G Protein-Coupled Receptor 87 |
| 54112 | GPR88 | G Protein-Coupled Receptor 88 |
| 51463 | GPR89B | G Protein-Coupled Receptor 89a |
| 57121 | GPR92 | G Protein-Coupled Receptor 92 |
| 222487 | GPR97 | G Protein-Coupled Receptor 97 |
| 9052 | GPRC5A | G Protein-Coupled Receptor, Family C, Group 5, Member A |
| 55890 | GPRC5C | G Protein-Coupled Receptor, Family C, Group 5, Member C |
| 55507 | GPRC5D | G Protein-Coupled Receptor, Family C, Group 5, Member D |
| 2911 | GRM1 | Glutamate Receptor, Metabotropic 1 |
| 2912 | GRM2 | Glutamate Receptor, Metabotropic 2 |
| 2913 | GRM3 | Glutamate Receptor, Metabotropic 3 |
| 2914 | GRM4 | Glutamate Receptor, Metabotropic 4 |
| 2915 | GRM5 | Glutamate Receptor, Metabotropic 5 |
| 2917 | GRM7 | Glutamate Receptor, Metabotropic 7 |
| 2918 | GRM8 | Glutamate Receptor, Metabotropic 8 |
| 2925 | GRPR | Gastrin-Releasing Peptide Receptor |
| 3061 | HCRTR1 | Hypocretin (Orexin) Receptor 1 |
| 3269 | HRH1 | Histamine Receptor H1 |
| 3274 | HRH2 | Histamine Receptor H2 |
| 59340 | HRH4 | Histamine Receptor H4 |
| 3350 | HTR1A | 5-Hydroxytryptamine (Serotonin) Receptor 1a |
| 3351 | HTR1B | 5-Hydroxytryptamine (Serotonin) Receptor 1b |
| 3352 | HTR1D | 5-Hydroxytryptamine (Serotonin) Receptor 1d |
| 3354 | HTR1E | 5-Hydroxytryptamine (Serotonin) Receptor 1e |
| 3355 | HTR1F | 5-Hydroxytryptamine (Serotonin) Receptor 1f |
| 3356 | HTR2A | 5-Hydroxytryptamine (Serotonin) Receptor 2a |
| 3358 | HTR2C | 5-Hydroxytryptamine (Serotonin) Receptor 2c |
| 3360 | HTR4 | 5-Hydroxytryptamine (Serotonin) Receptor 4 |
| 3361 | HTR5A | 5-Hydroxytryptamine (Serotonin) Receptor 5a |
| 3362 | HTR6 | 5-Hydroxytryptamine (Serotonin) Receptor 6 |
| 3363 | HTR7 | 5-Hydroxytryptamine (Serotonin) Receptor 7 (Adenylate |
| | | Cyclase-Coupled) |
| 3577 | IL8RA | Interleukin 8 Receptor, Alpha |
| 3579 | IL8RB | Interleukin 8 Receptor, Beta |
| 84634 | KISS1R | Kiss1 Receptor |
| 55366 | LGR4 | Leucine-Rich Repeat-Containing G Protein-Coupled Receptor 4 |
| 8549 | LGR5 | Leucine-Rich Repeat-Containing G Protein-Coupled Receptor 5 |
| 23266 | LPHN2 | Latrophilin 2 |
| 23284 | LPHN3 | Latrophilin 3 |
| 1241 | LTB4R | Leukotriene B4 Receptor |
| 56413 | LTB4R2 | Leukotriene B4 Receptor 2 |
| 4142 | MAS1 | Mas1 Oncogene |
| 4157 | MC1R | Melanocortin 1 Receptor (Alpha Melanocyte Stimulating |
| | | Hormone Receptor) |
| 4158 | MC2R | Melanocortin 2 Receptor (Adrenocorticotropic Hormone) |
| 4159 | MC3R | Melanocortin 3 Receptor |
| 4160 | MC4R | Melanocortin 4 Receptor |
| 4161 | MC5R | Melanocortin 5 Receptor |
| 2847 | MCHR1 | Melanin-Concentrating Hormone Receptor 1 |
| 84539 | MCHR2 | Melanin-Concentrating Hormone Receptor 2 |
| 219928 | MRGPRF | Mas-Related Gpr, Member F |
| 259249 | MRGPRX1 | Mas-Related Gpr, Member X1 |
| 117194 | MRGPRX2 | Mas-Related Gpr, Member X2 |
| 117195 | MRGPRX3 | Mas-Related Gpr, Member X3 |
| 117196 | MRGPRX4 | Mas-Related Gpr, Member X4 |
| 4543 | MTNR1A | Melatonin Receptor 1a |
| 4829 | NMBR | Neuromedin B Receptor |
| 10316 | NMUR1 | Neuromedin U Receptor 1 |
| 56923 | NMUR2 | Neuromedin U Receptor 2 |
| 2831 | NPBWR1 | Neuropeptides B/W Receptor 1 |
| 2832 | NPBWR2 | Neuropeptides B/W Receptor 2 |
| 4886 | NPY1R | Neuropeptide Y Receptor Y1 |
| 4887 | NPY2R | Neuropeptide Y Receptor Y2 |
| 4889 | NPY5R | Neuropeptide Y Receptor Y5 |
| 4923 | NTSR1 | Neurotensin Receptor 1 (High Affinity) |
| 23620 | NTSR2 | Neurotensin Receptor 2 |
| 23596 | OPN3 | Opsin 3 (Encephalopsin, Panopsin) |
| 4986 | OPRK1 | Opioid Receptor, Kappa 1 |
| 4987 | OPRL1 | Opiate Receptor-Like 1 |
| 4988 | OPRM1 | Opioid Receptor, Mu 1 |
| 10280 | OPRS1 | Opioid Receptor, Sigma 1 |
| 138799 | OR13C5 | Olfactory Receptor, Family 13, Subfamily C, Member 5 |
| 4992 | OR1F1 | Olfactory Receptor, Family 1, Subfamily F, Member 1 |
| 346528 | OR2A1 | Olfactory Receptor, Family 2, Subfamily A, Member 1 |
| 4993 | OR2C1 | Olfactory Receptor, Family 2, Subfamily C, Member 1 |
| 120775 | OR2D3 | Olfactory Receptor, Family 2, Subfamily D, Member 3 |
| 143503 | OR51E1 | Olfactory Receptor, Family 51, Subfamily E, Member 1 |
| 81285 | OR51E2 | Prostate Specific G-Protein Coupled Receptor |
| 143502 | OR52I2 | Olfactory Receptor, Family 52, Subfamily I, Member 2 |
| 338751 | OR52L1 | Olfactory Receptor, Family 52, Subfamily L, Member 1 |
| 165140 | OXER1 | Oxoeicosanoid (Oxe) Receptor 1 |
| 27199 | OXGR1 | Oxoglutarate (Alpha-Ketoglutarate) Receptor 1 |
| 5021 | OXTR | Oxytocin Receptor |
| 5028 | P2RY1 | Purinergic Receptor P2y, G-Protein Coupled, 1 |
| 27334 | P2RY10 | Purinergic Receptor P2y, G-Protein Coupled, 10 |
| 5032 | P2RY11 | Purinergic Receptor P2y, G-Protein Coupled, 11 |
| 64805 | P2RY12 | Purinergic Receptor P2y, G-Protein Coupled, 12 |
| 53829 | P2RY13 | Purinergic Receptor P2y, G-Protein Coupled, 13 |
| 9934 | P2RY14 | Purinergic Receptor P2y, G-Protein Coupled, 14 |
| 5029 | P2RY2 | Purinergic Receptor P2y, G-Protein Coupled, 2 |
| 10161 | P2RY5 | Purinergic Receptor P2y, G-Protein Coupled, 5 |
| 5031 | P2RY6 | Pyrimidinergic Receptor P2y, G-Protein Coupled, 6 |
| 286530 | P2RY8 | Purinergic Receptor P2y, G-Protein Coupled, 8 |
| 5540 | PPYR1 | Pancreatic Polypeptide Receptor 1 |
| 2834 | PRLHR | Prolactin Releasing Hormone Receptor |
| 10887 | PROKR1 | Prokineticin Receptor 1 |
| 128674 | PROKR2 | Prokineticin Receptor 2 |
| 5724 | PTAFR | Platelet-Activating Factor Receptor |
| 5729 | PTGDR | Prostaglandin D2 Receptor (Dp) |
| 5731 | PTGER1 | Prostaglandin E Receptor 1 (Subtype Ep1), 42 kda |
| 5732 | PTGER2 | Prostaglandin E Receptor 2 (Subtype Ep2), 53 kda |
| 5733 | PTGER3 | Prostaglandin E Receptor 3 (Subtype Ep3) |
| 5734 | PTGER4 | Prostaglandin E Receptor 4 (Subtype Ep4) |
| 5737 | PTGFR | Prostaglandin F Receptor (Fp) |
| 5739 | PTGIR | Prostaglandin I2 (Prostacyclin) Receptor (Ip) |
| 5746 | PTH2R | Parathyroid Hormone Receptor 2 |
| 5745 | PTHR1 | Parathyroid Hormone Receptor 1 |
| 5995 | RGR | Retinal G Protein Coupled Receptor |
| 59350 | RXFP1 | Leucine-Rich Repeat-Containing G Protein-Coupled Receptor 7 |
| 51289 | RXFP3 | Relaxin 3 Receptor 1 |
| 6751 | SSTR1 | Somatostatin Receptor 1 |
| 6752 | SSTR2 | Somatostatin Receptor 2 |
| 6753 | SSTR3 | Somatostatin Receptor 3 |
| 6754 | SSTR4 | Somatostatin Receptor 4 |
| 6755 | SSTR5 | Somatostatin Receptor 5 |
| 56670 | SUCNR1 | Succinate Receptor 1 |
| 134864 | TAAR1 | Trace Amine Associated Receptor 1 |
| 9287 | TAAR2 | Trace Amine Associated Receptor 2 |
| 9038 | TAAR5 | Trace Amine Associated Receptor 5 |
| 319100 | TAAR6 | Trace Amine Associated Receptor 6 |
| 83551 | TAAR8 | Trace Amine Associated Receptor 8 |
| 6869 | TACR1 | Tachykinin Receptor 1 |
| 6865 | TACR2 | Tachykinin Receptor 2 |
| 6915 | TBXA2R | Thromboxane A2 Receptor |
| 10430 | TMEM147 | Seven Transmembrane Domain Protein |
| 134285 | TMEM171 | Proline-Rich Protein Prp2 |
| 7201 | TRHR | Thyrotropin-Releasing Hormone Receptor |
| 7253 | TSHR | Thyroid Stimulating Hormone Receptor |
| 2837 | UTS2R | Urotensin 2 Receptor |
| 7433 | VIPR1 | Vasoactive Intestinal Peptide Receptor 1 |
| 7434 | VIPR2 | Vasoactive Intestinal Peptide Receptor 2 |
| 57191 | VN1R1 | Vomeronasal 1 Receptor 1 |
| 2829 | XCR1 | Chemokine (C Motif) Receptor 1 |

### Class A (or 1) (Rhodopsin-Like)

Rhodopsin-like receptors are a family of proteins which comprise the largest group of G-protein coupled receptors. The rhodopsin A group has been further subdivided into 19 subgroups (A1-A19).

Subfamily A1 includes the following: Chemokine (C-C motif) receptor 1 (CCR1, CKR1); Chemokine (C-C motif) receptor 2 (CCR2, CKR2); Chemokine (C-C motif) receptor 3 (CCR3, CKR3); Chemokine (C-C motif) receptor 4 (CCR4, CKR4); Chemokine (C-C motif) receptor 5 (CCR5, CKR5); Chemokine (C-C motif) receptor 8 (CCR8, CKR8); Chemokine (C-C motif) receptor-like 2 (CCRL2, CKRX); chemokine (C motif) receptor 1 (XCR1, CXC1); chemokine (C-X3-C motif) receptor 1 (CX3CR1, C3X1); GPR137B (GPR137B, TM7SF1)

Subfamily A2 includes the following: Chemokine receptor; Chemokine (C-C motif) receptor-like 1 (CCRL1 CCRL1, CCR11); Chemokine (C-C motif) receptor 6 (CCR6, CKR6); Chemokine (C-C motif) receptor 7 (CCR7, CKR7); Chemokine (C-C motif) receptor 9 (CCR9, CKR9); Chemokine (C-C motif) receptor 10 (CCR10, CKRA); CXC chemokine receptors IPRO01053; Chemokine (C-X-C motif) receptor 6 (CXCR6, BONZO); Chemokine (C-X-C motif) receptor 7 (CXCR7, RDC1); Interleukin-8 IPRO00174 (IL8R); IL8R-α (IL8RA, CXCR1); IL8R-β (IL8RB, CXCR2); Adrenomedullin receptor (GPR182); Duffy blood group, chemokine receptor (DARC, DUFF); G Protein-coupled Receptor 30 (GPER, CML2, GPCR estrogen receptor).

Subfamily A3 includes the following: Angiotensin II receptor; Angiotensin II receptor, type 1 (AGTR1, AG2S); Angiotensin II receptor, type 2 (AGTR2, AG22); Apelin receptor (AGTRL1, APJ); Bradykinin receptor IPRO00496; Bradykinin receptor B1 (BDKRB1, BRB1); Bradykinin receptor B2 (BDKRB2, BRB2); GPR15 (GPR15, GPRF); GPR25 (GPR25).

Subfamily A4 includes the following: Opioid receptor IPRO01418; delta Opioid receptor (OPRD1, OPRD); kappa Opioid receptor (OPRK1, OPRK); mu Opioid receptor (OPRM1, OPRM); Nociceptin receptor (OPRL1, OPRX); Somatostatin receptor IPRO00586; Somatostatin receptor 1 (SSTR1, SSR1); Somatostatin receptor 2 (SSTR2, SSR2); Somatostatin receptor 3 (SSTR3, SSR3); Somatostatin receptor 4 (SSTR4, SSR4); Somatostatin receptor 5 (SSTR5, SSR5); GPCR neuropeptide receptor IPRO09150; Neuropeptides B/W receptor 1 (NPBWR1, GPR7); Neuropeptides B/W receptor 2 (NPBWR2, GPR8); GPR1 orphan receptor (GPR1) IPRO02275

Subfamily A5 includes the following: Galanin receptor IPRO00405; Galanin receptor 1 (GALR1, GALR); Galanin receptor 2 (GALR2, GALS); Galanin receptor 3 (GALR3, GALT); Cysteinyl leukotriene receptor IPRO04071; Cysteinyl leukotriene receptor 1 (CYSLTR1); Cysteinyl leukotriene receptor 2 (CYSLTR2); Leukotriene B4 receptor IPRO03981; Leukotriene B4 receptor (LTB4R, P2Y7); Leukotriene B4 receptor 2 (LTB4R2); Relaxin receptor IPRO08112; Relaxin/insulin-like family peptide receptor 1 (RXFP1, LGR7); Relaxin/insulin-like family peptide receptor 2 (RXFP2, GPR106); Relaxin/insulin-like family peptide receptor 3 (RXFP3, SALPR); Relaxin/insulin-like family peptide receptor 4 (RXFP4, GPR100/GPR142); KiSS1-derived peptide receptor (GPR54) (KISS1R) IPRO08103; Melanin-concentrating hormone receptor 1 (MCHR1, GPRO) IPRO08361; Urotensin-II receptor (UTS2R, UR2R) IPRO00670.

Subfamily A6 includes the following: Cholecystokinin receptor IPRO09126; Cholecystokinin A receptor (CCKAR, CCKR); Cholecystokinin B receptor (CCKBR, GASR); Neuropeptide FF receptor IPRO05395; Neuropeptide FF receptor 1 (NPFFR1, FF1R); Neuropeptide FF receptor 2 (NPFFR2, FF2R); Orexin receptor IPRO00204; Hypocretin (orexin) receptor 1 (HCRTR1, OX1R); Hypocretin (orexin) receptor 2 (HCRTR2, OX2R); Vasopressin receptor IPRO01817; Arginine vasopressin receptor 1A (AVPR1A, V1AR); Arginine vasopressin receptor 1B (AVPR1B, V1BR); Arginine vasopressin receptor 2 (AVPR2, V2R); Gonadotrophin releasing hormone receptor (GNRHR, GRHR) IPRO01658; GPR22 (GPR22, GPRM); GPR103 (GPR103); GPR176 (GPR176, GPR).

Subfamily A7 includes the following: Bombesin receptor IPRO01556; Bombesin-like receptor 3 (BRS3); Neuromedin B receptor (NMBR); Gastrin-releasing peptide receptor (GRPR); Endothelin receptor IPRO00499; Endothelin receptor type A (EDNRA, ET1R); Endothelin receptor type B (EDNRB, ETBR); GPR37 (GPR37, ETBR-LP2) IPRO03909; Neuromedin U receptor IPRO05390; Neuromedin U receptor 1 (NMUR1); Neuromedin U receptor 2 (NMU2R); Neurotensin receptor IPRO03984; Neurotensin receptor 1 (NTSR1, NTR1); Neurotensin receptor 2 (NTSR2, NTR2); Thyrotropin-releasing hormone receptor (TRHR, TRFR) IPRO09144; Growth hormone secretagogue receptor (GHSR) IPRO03905; GPR39 (GPR39); Motilin receptor (MLNR, GPR38).

Subfamily A8 includes the following: Anaphylatoxin receptors IPRO02234; C3a receptor (C3AR1, C3AR); C5a receptor (C5AR1, C5AR); Chemokine-like receptor 1 (CMKLR1, CML1) IPRO02258; Formyl peptide receptor IPRO00826; Formyl peptide receptor 1 (FPR1, FMLR); Formyl peptide receptor-like 1 (FPRL1, FML2); Formyl peptide receptor-like 2 (FPRL2, FML1); MAS1 oncogene IPRO00820; MAS1 (MAS1, MAS); MAS1L (MAS1L, MRG); GPR1 (GPR1); GPR32 (GPR32, GPRW); GPR44 (GPR44); GPR77 (GPR77, C5L2).

Subfamily A9 includes the following: Melatonin receptor IPRO00025; Melatonin receptor 1A (MTNR1A, ML1A); Melatonin receptor 1B (MTNR1B, ML1B); Neurokinin receptor IPRO01681; Tachykinin receptor 1 (TACR1, NK1R); Tachykinin receptor 2 (TACR2, NK2R); Tachykinin receptor 3 (TACR3, NK3R); Neuropeptide Y receptor IPRO00611; Neuropeptide Y receptor Y1 (NPY1R, NY1R); Neuropeptide Y receptor Y2 (NPY2R, NY2R); Pancreatic polypeptide receptor 1 (PPYR1, NY4R); Neuropeptide Y receptor Y5 (NPY5R, NY5R); Prolactin-releasing peptide receptor (PRLHR, GPRA) IPRO01402; Prokineticin receptor 1 (PROKR1, GPR73); GPR19 (GPR19, GPRJ); GPR50 (GPR50, ML1X); GPR75 (GPR75); GPR83 (GPR83, GPR72).

Subfamily A10 includes the following: Glycoprotein hormone receptor IPRO02131; FSH-receptor (FSHR); Luteinizing hormone/choriogonadotropin receptor (LHCGR, LSHR); Thyrotropin receptor (TSHR); Leucine-rich repeat-containing G protein-coupled receptor 4 (LGR4, GPR48); Leucine-rich repeat-containing G protein-coupled receptor 5 (LGR5, GPR49).

Subfamily A11 includes the following: GPR40-related receptor IPRO13312; Free fatty acid receptor 1 (FFAR1, GPR40); Free fatty acid receptor 2 (FFAR2, GPR43); Free fatty acid receptor 3 (FFAR3, GPR41); GPR42 (GPR42, FFAR1L); P2 purinoceptor IPRO02286; Purinergic receptor P2Y1 (P2RY1); Purinergic receptor P2Y2 (P2RY2); Purinergic receptor P2Y4 (P2RY4); Purinergic receptor P2Y6 (P2RY6); Purinergic receptor P2Y11 (P2RY11); GPR31 (GPR31, GPRV); GPR81 (GPR81); GPR82 (GPR82); GPR109B (GPR109B, HM74); Oxoglutarate (alpha-ketoglutarate) receptor 1 (OXGR1, GPR80); Succinate receptor 1 (SUCNR1, GPR91).

Subfamily A12 includes the following: P2 purinoceptor IPRO02286; Purinergic receptor P2Y12 (P2RY12); Purinergic receptor P2Y13 (P2RY13, GPR86) IPRO08109; Purinergic receptor P2Y14 (P2RY14, UDP-glucose receptor, KIO1) IPRO05466; GPR34 (GPR34); GPR87 (GPR87); GPR171 (GPR171, H963); Platelet-activating factor receptor (PTAFR, PAFR) IPR002282.

Subfamily A13 includes the following: Cannabinoid receptor IPRO02230; Cannabinoid receptor 1 (brain) (CNR1, CB1R); Cannabinoid receptor 2 (macrophage) (CNR2, CB2R); Lysophosphatidic acid receptor IPRO04065; Endothelial differentiation gene 2 (EDG2); Endothelial differentiation gene 4 (EDG4); Endothelial differentiation gene 7 (EDG7); Sphingosine 1-phosphate receptor IPRO04061; Endothelial differentiation gene 1 (EDG1); Endothelial differentiation gene 3 (EDG3); Endothelial differentiation gene 5 (EDG5); Endothelial differentiation gene 6 (EDGE); Endothelial differentiation gene 8 (EDG8); Melanocortin/ACTH receptor IPRO01671; Melanocortin 1 receptor (MC¹R, MSHR); Melanocortin 3 receptor (MC3R); Melanocortin 4 receptor (MC4R); Melanocortin 5 receptor (MC5R); ACTH receptor (MC2R), ACTR); GPR3 (GPR3); GPR6 (GPR6); GPR12 (GPR12, GPRC).

Subfamily A14 includes the following: Eicosanoid receptor IPRO08365; Prostaglandin D2 receptor (PTGDR, PD2R); Prostaglandin E1 receptor (PTGER1, PE21); Prostaglandin E2 receptor (PTGER2, PE22); Prostaglandin E3 receptor (PTGER3, PE23); Prostaglandin E4 receptor (PTGER4, PE24); Prostaglandin F receptor (PTGFR, PF2R); Prostaglandin 12 (prostacyclin) receptor (PTGIR, PI2R); Thromboxane A2 receptor (TBXA2R, TA2R).

Subfamily A15 includes the following: P2 purinoceptor IPRO02286; Purinergic receptor P2Y5 (P2RY5, P2Y5) IPRO02188; Purinergic receptor P2Y10 (P2RY10, P2Y10); Protease-activated receptor IPRO03912; Coagulation factor II (thrombin) receptor-like 1 (F2RL1, PAR2); Coagulation factor II (thrombin) receptor-like 2 (F2RL2, PAR3); Epstein-Ban virus induced gene 2 (lymphocyte-specific G protein-coupled receptor) (EBI2); Proton-sensing G protein-coupled receptors; GPR4 (GPR4) IPRO02276; GPR65 (GPR65) IPRO05464; GPR68 (GPR68) IPRO05389; GPR132 (GPR132, G2A) IPRO05388; GPR17 (GPR17, GPRH); GPR18 (GPR18, GPR1); GPR20 (GPR20, GPRK); GPR23 (GPR23, P2RY9, P2Y9); GPR35 (GPR35); GPR55 (GPR55); GPR92 (GPR92); Coagulation factor II receptor (F2R, THRR).

Subfamily A16 includes the following: Opsins IPRO01760[7]; Rhodopsin (RHO, OPSD); Opsin 1 (cone pigments), short-wave-sensitive (color blindness, tritan) (OPN1SW, OPSB) (blue-sensitive opsin); Opsin 1 (cone pigments), medium-wave-sensitive (color blindness, deutan) (OPN1MW, OPSG) (green-sensitive opsin); Opsin 1 (cone pigments), long-wave-sensitive (color blindness, protan) (OPN1LW, OPSR) (red-sensitive opsin); Retinal G protein coupled receptor (RGR); Retinal pigment epithelium-derived rhodopsin homolog (RRH, OPSX) (visual pigment-like receptor opsin) IPRO01793.

Subfamily A17 includes the following: 5-Hydroxytryptamine (5-HT) receptor IPRO02231; 5-HT2A (HTR2A, 5H2A); 5-HT2B (HTR2B, 5H₂B); 5-HT2C(HTR2c, 5H₂C); 5-HT6 (HTR6, 5H6) IPRO02232; Adrenergic receptor IPRO02233; Alpha1A (ADRA1A, A1AA); Alpha1B (ADRA1B, A1AB); Alpha1D (ADRA1D, A1AD); Alpha2A (ADRA2A, A2AA); Alpha2B (ADRA2B, A2AB); Alpha2C (ADRA2C, A2AC); Beta1 (ADRB1, B1AR); Beta2 (ADRB2, B2AR); Beta3 (ADRB3, B3AR); Dopamine receptor IPRO00929; D1 (DRD1, DADR); D2 (DRD2, D2DR); D3 (DRD3, D3DR); D4 (DRD4, D4DR); D5 (DRD5, DBDR); Octopamine receptor IPRO02002; Trace amine receptor IPRO09132; TAAR2 (TAAR2, GPR58); TAAR3 (TAAR3, GPR57); TAAR5 (TAAR5, PNR); TAAR8 (TAAR8, GPR102); Histamine H2 receptor (HRH2, HH2R) IPRO00503.

Subfamily A18 includes the following: Histamine H1 receptor (HRH1, HH1R) IPRO00921; Histamine H3 receptor (HRH3) IPRO03980; Histamine H4 receptor (HRH4) IPRO08102; Adenosine receptor IPRO01634; A1 (ADORA1, AA1R); A2a (ADORA2A, AA2A); A2b (ADORA2B, AA2B); A3 (ADORA3, AA3R); Muscarinic acetylcholine receptor IPRO00995; M1 (CHRM1, ACM1); M2 (CHRM2, ACM2); M3 (CHRM3, ACM3); M4 (CHRM4, ACM4); M5 (CHRM5, ACM5); GPR21 (GPR21, GPRL); GPR27 (GPR27); GPR45 (GPR45, PSP24); GPR52 (GPR52); GPR61 (GPR61); GPR62 (GPR62); GPR63 (GPR63); GPR78 (GPR78); GPR84 (GPR84); GPR85 (GPR85); GPR88 (GPR88); GPR101 (GPR101); GPR161 (GPR161, RE2); GPR173 (GPR173, SREB3).

Subfamily A19 includes the following: 5-Hydroxytryptamine (5-HT) receptor IPRO02231; 5-HT1A (HTR1A, 5H1A); 5-HT1B (HTR1B, 5H₁B); 5-HT1D (HTR1D, 5H1D); 5-HT1E (HTR1E, 5H1E); 5-HT1F (HTR1F, 5H₁F); 5-HT4 (HTR4) IPRO01520; 5-HT5A (HTR5A, 5H5A); 5-HT7 (HTR7, 5H7) IPRO01069.

### Class B (or 2) (Secretin Receptor Family)

Secretin family of 7 transmembrane receptors is a family of evolutionarily related proteins. Three distinct sub-families (B1-B3) are recognized. The secretin-like GPCRs include secretin, calcitonin, parathyroid hormone/parathyroid hormone-related peptides and vasoactive intestinal peptide receptors.

Subfamily B1 contains classical hormone receptors, such as receptors for secretin and glucagon, that are all involved in cAMP-mediated signaling pathways. Subfamily B1 includes the following: Pituitary adenylate cyclase-activating polypeptide type 1 receptor IPRO02285; PACR; PACAPR; Calcitonin receptor IPRO03287; CALCR; Corticotropin-releasing hormone receptor IPRO03051; CRHR1; CRHR2; Glucose-dependent insulinotropic polypeptide receptor/Gastric inhibitory polypeptide receptor IPRO01749; GIPR; Glucagon receptor-related IPRO03290; GLP1R; GLP2R; Growth hormone releasing hormone receptor IPRO03288; GHRHR; Parathyroid hormone receptor IPRO02170; PTHR1; PTHR2; Secretin receptor IPRO02144; SCTR; Vasoactive intestinal peptide receptor IPRO01571; VIPR1; VIPR2.

Subfamily B2 contains receptors with long extracellular N-termini, such as the leukocyte cell-surface antigen CD97; calcium-independent receptors for latrotoxin (such as UniProt 094910, and brain-specific angiogenesis inhibitor receptors (such as UniProt 014514) amongst others. Subfamily B2 includes the following: Brain-specific angiogenesis inhibitor IPRO08077; BAI1; BAI2; BAI3; CD97 antigen IPRO03056; CD97; EMR hormone receptor IPRO01740; CELSR1; CELSR2; CELSR3; EMR1; EMR2; EMR3; EMR4; GPR56 orphan receptor IPRO03910; GPR56; GPR64; GPR97; GPR110; GPR111; GPR112; GPR113; GPR114; GPR115; GPR123; GPR125; GPR126; GPR128; GPR133; GPR144; GPR157; Latrophilin receptor IPRO03924; ELTD1; LPHN1; LPHN2; LPHN3.

Subfamily B3 includes Methuselah and other Drosophila proteins. Other than the typical seven-transmembrane region, characteristic structural features include an amino-terminal extracellular domain involved in ligand binding, and an intracellular loop (IC3) required for specific G-protein coupling. Subfamily B3 includes diuretic hormone receptor IPRO02001

Unclassified Secretin family subfamilies includes the following: Ig-hepta receptor IPRO08078; GPR116; DREG; HCTR-5; HCTR-6; KPG_{—}003; KPG_{—}006; KPG_{—}008; KPG_{—}009; RESDA1.

Class C (or 3) (Metabotropic Glutamate/Pheromone)

The metabotropic glutamate receptors, or mGluRs, are a type of glutamate receptor which are active through an indirect metabotropic process. Eight different types of mGluRs, labeled mGluR1 to mGluR8 (GRM1 to GRM8), are divided into groups I, II, and III. The mGluRs are further divided into subtypes, such as mGluR7a and mGluR7b. The mGluRs in group I, including mGluR1 and mGluR5. The receptors in group II, including mGluRs 2 and 3, and group III, including mGluRs 4, 6, 7, and 8.

### Class F (or 6) (Frizzled/Smoothened)

Smoothened is a G protein-coupled receptor protein encoded by the SMO gene of the hedgehog pathway conserved from flies to humans. SMO can function as an oncogene. Activating SMO mutations can lead to unregulated activation of the hedgehog pathway and cancer.

Frizzled is a family of G protein-coupled receptor proteins that serve as receptors in the Wnt signaling pathway and other signaling pathways. When activated, Frizzled leads to activation of Dishevelled in the cytosol. The following is a list of the ten known human frizzled receptors: FZD1; FZD2; FZD3; FZD4; FZD5; FZD6; FZD7; FZD8; FZD9; FZD10.

### PI3K Signaling Pathway

Phosphoinositide 3-kinases (PI 3-kinases or PI3Ks) are a family of related intracellular signal transducer enzymes capable of phosphorylating the 3 position hydroxyl group of the inositol ring of phosphatidylinositol (PtdIns). They are also known as phosphatidylinositol-3-kinases. The pathway, with oncogene PI3KCA and tumor suppressor PTEN (gene) is implicated in insensitivity of cancer tumors to insulin and IGF1, in calorie restriction.

A PI3K signaling pathway library preferably includes one or more (e.g., 2, 3, 4, 5, 6, 7, 8, 9 . . . all) of the following:

| GENE ID | GENE Symbol | GENE NAME |
|---|---|---|
| 90 | ACVR1 | Activin A Receptor, Type I |
| 91 | ACVR1B | Activin A Receptor, Type Ib |
| 94 | ACVRL1 | Activin A Receptor Type Ii-Like 1 |
| 207 | AKT1 | V-Akt Murine Thymoma Viral Oncogene Homolog 1 |
| 9212 | AURKB | Aurora Kinase B |
| 657 | BMPR1A | Bone Morphogenetic Protein Receptor, Type Ia |
| 659 | BMPR2 | Bone Morphogenetic Protein Receptor, Type Ii (Serine/Threonine |
| | | Kinase) |
| 699 | BUB1 | Bub1 Budding Uninhibited By Benzimidazoles 1 Homolog (Yeast) |
| 801 | CALM3 | Calmodulin 1 (Phosphorylase Kinase, Delta) |
| 805 | CALM3 | Calmodulin 1 (Phosphorylase Kinase, Delta) |
| 808 | CALM3 | Calmodulin 1 (Phosphorylase Kinase, Delta) |
| 810 | CALML3 | Calmodulin-Like 3 |
| 163688 | CALML6 | Calmodulin-Like 6 |
| 23729 | CARKL | Carbohydrate Kinase-Like |
| 8621 | CDC2L5 | Cell Division Cycle 2-Like 5 (Cholinesterase-Related Cell Division |
| | | Controller) |
| 10423 | CDIPT | Cdp-Diacylglycerol--Inositol 3-Phosphatidyltransferase |
| | | (Phosphatidylinositol Synthase) |
| 8814 | CDKL1 | Cyclin-Dependent Kinase-Like 1 (Cdc2-Related Kinase) |
| 8999 | CDKL2 | Cyclin-Dependent Kinase-Like 2 (Cdc2-Related Kinase) |
| 1040 | CDS1 | Cdp-Diacylglycerol Synthase (Phosphatidate Cytidylyltransferase) 1 |
| 8760 | CDS2 | Cdp-Diacylglycerol Synthase (Phosphatidate Cytidylyltransferase) 2 |
| 1195 | CLK1 | Cdc-Like Kinase 1 |
| 1196 | CLK2 | Cdc-Like Kinase 2 |
| 57396 | CLK4 | Cdc-Like Kinase 4 |
| 10087 | COL4A3BP | Collagen, Type Iv, Alpha 3 (Goodpasture Antigen) Binding Protein |
| 1457 | CSNK2A1 | Casein Kinase 2, Alpha 1 Polypeptide |
| 1459 | CSNK2A2 | Casein Kinase 2, Alpha Prime Polypeptide |
| 1460 | CSNK2B | Casein Kinase 2, Beta Polypeptide |
| 1606 | DGKA | Diacylglycerol Kinase, Alpha 80 kda |
| 1607 | DGKB | Diacylglycerol Kinase, Beta 90 kda |
| 8527 | DGKD | Diacylglycerol Kinase, Delta 130 kda |
| 8526 | DGKE | Diacylglycerol Kinase, Epsilon 64 kda |
| 1608 | DGKG | Diacylglycerol Kinase, Gamma 90 kda |
| 160851 | DGKH | Diacylglycerol Kinase, Eta |
| 9162 | DGKI | Diacylglycerol Kinase, Iota |
| 1609 | DGKQ | Diacylglycerol Kinase, Theta 110 kda |
| 8525 | DGKZ | Diacylglycerol Kinase, Zeta 104 kda |
| 64122 | FN3K | Fructosamine 3 Kinase |
| 3612 | IMPA1 | Inositol(Myo)-1(Or 4)-Monophosphatase 1 |
| 3613 | IMPA2 | Inositol(Myo)-1(Or 4)-Monophosphatase 2 |
| 3628 | INPP1 | Inositol Polyphosphate-1-Phosphatase |
| 3631 | INPP4A | Inositol Polyphosphate-4-Phosphatase, Type I, 107 kda |
| 8821 | INPP4B | Inositol Polyphosphate-4-Phosphatase, Type Ii, 105 kda |
| 3632 | INPP5A | Inositol Polyphosphate-5-Phosphatase, 40 kda |
| 3633 | INPP5B | Inositol Polyphosphate-5-Phosphatase, 75 kda |
| 3635 | INPP5D | Inositol Polyphosphate-5-Phosphatase, 145 kda |
| 56623 | INPP5E | Inositol Polyphosphate-5-Phosphatase, 72 Kda |
| 3636 | INPPL1 | Inositol Polyphosphate Phosphatase-Like 1 |
| 27231 | ITGB1BP3 | Integrin Beta 1 Binding Protein 3 |
| 3705 | ITPK1 | Inositol 1,3,4-Triphosphate 5/6 Kinase |
| 3706 | ITPKA | Inositol 1,4,5-Trisphosphate 3-Kinase A |
| 3707 | ITPKB | Inositol 1,4,5-Trisphosphate 3-Kinase B |
| 3708 | ITPR1 | Inositol 1,4,5-Triphosphate Receptor, Type 1 |
| 3709 | ITPR2 | Inositol 1,4,5-Triphosphate Receptor, Type 2 |
| 3710 | ITPR3 | Inositol 1,4,5-Triphosphate Receptor, Type 3 |
| 4294 | MAP3K10 | Mitogen-Activated Protein Kinase Kinase Kinase 10 |
| 4342 | MOS | V-Mos Moloney Murine Sarcoma Viral Oncogene Homolog |
| 4750 | NEK1 | Nima (Never In Mitosis Gene A)-Related Kinase 1 |
| 4752 | NEK3 | Nima (Never In Mitosis Gene A)-Related Kinase 3 |
| 4952 | OCRL | Oculocerebrorenal Syndrome Of Lowe |
| 10298 | PAK4 | P21(Cdkn1a)-Activated Kinase 4 |
| 5127 | PCTK1 | Pctaire Protein Kinase 1 |
| 5128 | PCTK2 | Pctaire Protein Kinase 2 |
| 5297 | PI4KA | Phosphatidylinositol 4-Kinase, Catalytic, Alpha Polypeptide |
| 5298 | PI4KB | Phosphatidylinositol 4-Kinase, Catalytic, Beta Polypeptide |
| 27124 | PIB5PA | Inositol Polyphosphate 5-Phosphatase |
| 5286 | PIK3C2A | Phosphoinositide-3-Kinase, Class 2, Alpha Polypeptide |
| 5287 | PIK3C2B | Phosphoinositide-3-Kinase, Class 2, Beta Polypeptide |
| 5288 | PIK3C2G | Phosphoinositide-3-Kinase, Class 2, Gamma Polypeptide |
| 5289 | PIK3C3 | Phosphoinositide-3-Kinase, Class 3 |
| 5290 | PIK3CA | Phosphoinositide-3-Kinase, Catalytic, Alpha Polypeptide |
| 5291 | PIK3CB | Phosphoinositide-3-Kinase, Catalytic, Beta Polypeptide |
| 5293 | PIK3CD | Phosphoinositide-3-Kinase, Catalytic, Delta Polypeptide |
| 5294 | PIK3CG | Phosphoinositide-3-Kinase, Catalytic, Gamma Polypeptide |
| 5295 | PIK3R1 | Phosphoinositide-3-Kinase, Regulatory Subunit 1 (P85 Alpha) |
| 5296 | PIK3R2 | Phosphoinositide-3-Kinase, Regulatory Subunit 2 (P85 Beta) |
| 8503 | PIK3R3 | Phosphoinositide-3-Kinase, Regulatory Subunit 3 (P55, Gamma) |
| 23533 | PIK3R5 | Phosphoinositide-3-Kinase, Regulatory Subunit 5, P101 |
| 11040 | PIM2 | Pim-2 Oncogene |
| 5305 | PIP4K2A | Phosphatidylinositol-4-Phosphate 5-Kinase, Type Ii, Alpha |
| 8396 | PIP4K2B | Phosphatidylinositol-4-Phosphate 5-Kinase, Type Ii, Beta |
| 79837 | PIP4K2C | Phosphatidylinositol-4-Phosphate 5-Kinase, Type Ii, Gamma |
| 8394 | PIP5K1A | Phosphatidylinositol-4-Phosphate 5-Kinase, Type I, Alpha |
| 8395 | PIP5K1B | Phosphatidylinositol-4-Phosphate 5-Kinase, Type I, Beta |
| 23396 | PIP5K1C | Phosphatidylinositol-4-Phosphate 5-Kinase, Type I, Gamma |
| 200576 | PIP5K3 | Likely Ortholog Of Mouse Phosphatidylinositol-4-Phosphate 5- |
| | | Kinase, Type Iii |
| 23236 | PLCB1 | Phospholipase C, Beta 1 (Phosphoinositide-Specific) |
| 5330 | PLCB2 | Phospholipase C, Beta 2 |
| 5331 | PLCB3 | Phospholipase C, Beta 3 (Phosphatidylinositol-Specific) |
| 5332 | PLCB4 | Phospholipase C, Beta 4 |
| 5333 | PLCD1 | Phospholipase C, Delta 1 |
| 113026 | PLCD3 | Phospholipase C, Delta 3 |
| 84812 | PLCD4 | Phospholipase C, Delta 4 |
| 51196 | PLCE1 | Phospholipase C, Epsilon 1 |
| 5335 | PLCG1 | Phospholipase C, Gamma 1 |
| 5336 | PLCG2 | Phospholipase C, Gamma 2 (Phosphatidylinositol-Specific) |
| 89869 | PLCZ1 | Phospholipase C, Zeta 1 |
| 1263 | PLK3 | Polo-Like Kinase 3 (Drosophila) |
| 5566 | PRKACA | Protein Kinase, Camp-Dependent, Catalytic, Alpha |
| 5567 | PRKACB | Protein Kinase, Camp-Dependent, Catalytic, Beta |
| 5568 | PRKACG | Protein Kinase, Camp-Dependent, Catalytic, Gamma |
| 5573 | PRKAR1A | Protein Kinase, Camp-Dependent, Regulatory, Type I, Alpha (Tissue |
| | | Specific Extinguisher 1) |
| 5575 | PRKAR1B | Protein Kinase, Camp-Dependent, Regulatory, Type I, Beta |
| 5576 | PRKAR2A | Protein Kinase, Camp-Dependent, Regulatory, Type Ii, Alpha |
| 5577 | PRKAR2B | Protein Kinase, Camp-Dependent, Regulatory, Type Ii, Beta |
| 5578 | PRKCA | Protein Kinase C, Alpha |
| 5579 | PRKCB1 | Protein Kinase C, Beta 1 |
| 5580 | PRKCD | Protein Kinase C, Delta |
| 5581 | PRKCE | Protein Kinase C, Epsilon |
| 5582 | PRKCG | Protein Kinase C, Gamma |
| 5583 | PRKCH | Protein Kinase C, Eta |
| 5588 | PRKCQ | Protein Kinase C, Theta |
| 5590 | PRKCZ | Protein Kinase C, Zeta |
| 5587 | PRKD1 | Protein Kinase D1 |
| 5592 | PRKG1 | Protein Kinase, Cgmp-Dependent, Type I |
| 5728 | PTEN | Phosphatase And Tensin Homolog (Mutated In Multiple Advanced |
| | | Cancers 1) |
| 114971 | PTPMT1 | Protein Tyrosine Phosphatase, Mitochondrial 1 |
| 5894 | RAF1 | V-Raf-1 Murine Leukemia Viral Oncogene Homolog 1 |
| 6195 | RPS6KA1 | Ribosomal Protein S6 Kinase, 90 kda, Polypeptide 1 |
| 6196 | RPS6KA2 | Ribosomal Protein S6 Kinase, 90 kda, Polypeptide 2 |
| 6197 | RPS6KA3 | Ribosomal Protein S6 Kinase, 90 kda, Polypeptide 3 |
| 8986 | RPS6KA4 | Ribosomal Protein S6 Kinase, 90 kda, Polypeptide 4 |
| 6198 | RPS6KB1 | Ribosomal Protein S6 Kinase, 70 kda, Polypeptide 1 |
| 22938 | SNW1 | Snw Domain Containing 1 |
| 6794 | STK11 | Serine/Threonine Kinase 11 |
| 8867 | SYNJ1 | Synaptojanin 1 |
| 8871 | SYNJ2 | Synaptojanin 2 |
| 7046 | TGFBR1 | Transforming Growth Factor, Beta Receptor I (Activin A Receptor |
| | | Type Ii-Like Kinase, 53 kda) |
| 7443 | VRK1 | Vaccinia Related Kinase 1 |

Tumorigenesis or Metastasis Phenotypic Model

The targets cells comprising a GEOI library according to the present embodiments, are screened for tumorigenic or metastasic phenotype in an appropriate in vitro or in vivo model. The target cells of the present invention are engineered to express and/or overexpress selected oncogenes, thereby defining the genetic context of the cells. The target cells are then used to screen for oncogenic elements that cooperate interact with the selected genetic context of the target cells to induce tumorigenesis and/or metastasis. For example, an array of target cells with selected genetic context may be prepared whereby each individual target cell or population of targets cells positioned within the array is engineered to express a member of a GEOI library. Such GEOI targeted cells are then monitored for a tumorigenic or metastasic phenotype. In vitro and in vivo models for measuring tumorigenesis and metastasis are well known in the art. For example, tumorigenesis can be measured using in vivo mouse models such as a xenograft model (e.g., SCID, SCID/beige or NOD/SCID mice).

In vitro models include the use of three-dimensional matrix. GEOI targets cells are grown in a three-dimensional support exhibit a morphology similar to the in vivo state. An example of such as three-dimensional gel is disclosed in U.S. Pat. No. 5,580,781, the entire contents of which is hereby incorporated by reference in its entirety.

In some embodiments, tumorigenesis and/or spontaneous metastasis may be determined after orthotopic injection of the tumor cells. Here, GEOI targets cells are transplanted directly into the organ or tissue of origin. The advantages of orthotopically transplanted tumors have been demonstrated, for example, for malignant melanomas, prostate tumors or osteosarcomas. See e.g., Kerbel et al., Cancer & Metast. Rev. 10, 201-215, 1991; Stephenson et al., Natl. Cancer Inst. 84, 951-957, 1992; Berlin et al., Cancer Res. 53, 4890-4895, 1993, the entire contents of which are hereby incorporated by reference in their entireties. Methods and models of orthotopic injection of the tumor cells are well known in art and have been described previously, such as in U.S. Pat. No. 5,837,462, the entire contents of which is hereby incorporated by reference in its entirety. Further, orthotopic tumor models are accessible to a routine screening of antitumor drugs. Methods and models of orthotopic injection specific for individual cancer are well known in the art. See e.g., Freytag et al., “Efficacy and toxicity of replication-competent adenovirus-mediated double suicide gene therapy in combination with radiation therapy in an orthotopic mouse prostate cancer model;” Int. J. Radiat. Oncol. Biol. Phys., 54: 873-886, 2002.

Examples of appropriate orthotopic implantation of target cells (e.g., primary tissue cells engineering to express an oncogene know to be involved in a particular cancer) include, but are not limited to, the following: a) Glioma—intracranial; b) Breast carcinoma—intramammary fat pad; c) Lung carcinoma—intrapulmonary (lung pleural space or intratracheal); d) prostate—intraprostatic injection; e) Myeloma—directly into the bone marrow; f) brain—intracranial.

According to some embodiments, the function or a phenotype associated with tumorigenesis is one or more of metastasis, cell migration, angiogenesis, extracellular matrix degradation, anchorage-independent growth (e.g., growth in soft agar), or anoikis.

The metastatic phenotype may be assessed using any method known in the art such as through the measurement of metastatic foci.

### Validation of Candidate GEOIs

The importance of candidate GEOIs that provide a positive result in any in vitro and/or in vivo models for measuring tumorigenesis and metastasis can be validated and/or further evaluated by expression knock-down using RNAi techniques. For example, candidate GEOIs can be validated and/or further evaluated by expression knock-down using RNAi techniques followed by orthotopic injection in a mouse model of tumorigenesis and/or metastasis (e.g., SCID, SCID/beige or NOD/SCID mice). Expression knock-down of candidate GEOIs using RNAi techniques may be performed in in vitro models of tumorigenesis and metastasis. Candidate GEOIs are validated where the RNAi technique inhibits, slows, or prevents the development of the tumorigenic or metastasic phenotype. Such validation screens/assays would allow 1) a determination of whether candidate GEOIs are suitable drug targets, 2) identification of specific GEOIs (by expression profiling cells with intact or disrupted candidate GEOI expression) that would serve as potential novel therapeutic targets, 3) determination of proteomics signatures of candidate GEOIs. The availability of the signature expression profile and proteomics profile provides powerful resources in the evaluation of drug efficacy and specificity directed towards candidate GEOIs.

### Methods of Screening

According to some embodiments, the targets cells comprising GEOI libraries of the present embodiments may be be used in methods for screening for compounds (e.g., drugs, biologically active agents, small molecules, etc.) that interact with the engineered pathway.

In some embodiments, there is provided a method for screening for biologically active agents that interact with an engineered tumorigenesis pathway comprising the following steps: a. producing a genetically engineered target cell having a cancer cell genotype, said producing step comprising introducing into a cell representative of a given phenotype or histological type an oncogene and a one or more genes or genetic elements of interest linked to the oncogenic process associated with the oncogene; b. contacting the genetically engineered target cell with a candidate biologically active agent; and c. determining whether the biologically active agent affects the tumorigenic phenotype. The tumorigenic phenotype may be one or more of metastasis, cell migration, angiogenesis, extracellular matrix degradation, anchorage-independent growth, or anoikis.

### DEFINITIONS

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including definitions, will control. In addition, the materials, methods, and examples are illustrative only not intended to be limiting. Other features and advantages of the invention will be apparent from the following detailed description and claims.

For the purposes of promoting an understanding of the embodiments described herein, reference will be made to preferred embodiments and specific language will be used to describe the same. The terminology used herein is for the purpose of describing particular embodiments only, and is not intended to limit the scope of the present invention. As used throughout this disclosure, the singular forms “a,” “an,” and “the” include plural reference unless the context clearly dictates otherwise. Thus, for example, a reference to “a composition” includes a plurality of such compositions, as well as a single composition, and a reference to “a therapeutic agent” is a reference to one or more therapeutic and/or pharmaceutical agents and equivalents thereof known to those skilled in the art, and so forth. Thus, for example, a reference to “a host cell” includes a plurality of such host cells, and a reference to “an antibody” is a reference to one or more antibodies and equivalents thereof known to those skilled in the art, and so forth. Further, the use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The terms “tumor” or “cancer” refer to the presence of cells possessing characteristics typical of cancer-causing cells, such as uncontrolled proliferation, immortality, metastatic potential, rapid growth and proliferation rate, and certain characteristic morphological features. Cancer cells are often in the form of a tumor, but such cells may exist alone within an animal, or may be a non-tumorigenic cancer cell, such as a leukemia cell. As used herein, the term “cancer” includes premalignant as well as malignant cancers. Cancers include, but are not limited to, pancreatic cancer, e.g., pancreatic adenocarcinoma, melanoma, breast cancer, lung cancer, bronchus cancer, colorectal cancer, prostate cancer, pancreatic cancer, stomach cancer, ovarian cancer, urinary bladder cancer, brain or central nervous system cancer, peripheral nervous system cancer, esophageal cancer, cervical cancer, uterine or endometrial cancer, cancer of the oral cavity or pharynx, liver cancer, kidney cancer, testicular cancer, biliary tract cancer, small bowel or appendix cancer, salivary gland cancer, thyroid gland cancer, adrenal gland cancer, osteosarcoma, chondrosarcoma, cancer of hematological tissues, and the like.

As used herein, the term “promoter/regulatory sequence” means a nucleic acid sequence which is required for expression of a gene product operably linked to the promoter/regulatory sequence. In some instances, this sequence may be the core promoter sequence and in other instances, this sequence may also include an enhancer sequence and other regulatory elements which are required for expression of the gene product. The promoter/regulatory sequence may, for example, be one which expresses the gene product in a spatially or temporally restricted manner.

A “constitutive” promoter is a nucleotide sequence which, when operably linked with a polynucleotide which encodes or specifies a gene product, causes the gene product to be produced in a living human cell under most or all physiological conditions of the cell.

An “inducible” promoter is a nucleotide sequence which, when operably linked with a polynucleotide which encodes or specifies a gene product, causes the gene product to be produced in a living human cell substantially only when an inducer which corresponds to the promoter is present in the cell.

A “tissue-specific” promoter is a nucleotide sequence which, when operably linked with a polynucleotide which encodes or specifies a gene product, causes the gene product The present invention encompasses antisense nucleic acid molecules, i.e., molecules which are complementary to a sense nucleic acid of the invention, e.g., complementary to the coding strand of a double-stranded cDNA molecule corresponding to a marker of the invention or complementary to an mRNA sequence corresponding to a marker of the invention. Accordingly, an antisense nucleic acid molecule of the invention can hydrogen bond to (i.e. anneal with) a sense nucleic acid of the invention. The antisense nucleic acid can be complementary to an entire coding strand, or to only a portion thereof, e.g., all or part of the protein coding region (or open reading frame). An antisense nucleic acid molecule can also be antisense to all or part of a non-coding region of the coding strand of a nucleotide sequence encoding a polypeptide of the invention. The non-coding regions (“5′ and 3′ untranslated regions”) are the 5′ and 3′ sequences which flank the coding region and are not translated into amino acids.

An antisense oligonucleotide can be, for example, about 5, 10, 15, 20, 25, 30, 35, 40, 45, or 50 or more nucleotides in length. An antisense nucleic acid of the invention can be constructed using chemical synthesis and enzymatic ligation reactions using procedures known in the art. For example, an antisense nucleic acid (e.g., an antisense oligonucleotide) can be chemically synthesized using naturally occurring nucleotides or variously modified nucleotides designed to increase the biological stability of the molecules or to increase the physical stability of the duplex formed between the antisense and sense nucleic acids, e.g., phosphorothioate derivatives and acridine substituted nucleotides can be used. Examples of modified nucleotides which can be used to generate the antisense nucleic acid include 5-fluorouracil, 5-bromouracil, 5-chlorouracil, 5-iodouracil, hypoxanthine, xanthine, 4-acetylcytosine, 5-(carboxyhydroxylmethyl) uracil, 5-carboxymethylaminomethyl-2-thiouridine, 5-carboxymethylaminomethyluracil, dihydrouracil, beta-D-galactosylqueosine, inosine, N6-isopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, 5-methoxyaminomethyl-2-thiouracil, beta-D-mannosylqueosine, 5′-methoxycarboxymethyluracil, 5-methoxyuracil, 2-methylthio-N6-isopentenyladenine, uracil-5-oxyacetic acid (v), wybutoxosine, pseudouracil, queosine, 2-thiocytosine, 5-methyl-2-thiouracil, 2-thiouracil, 4-thiouracil, 5-methyluracil, uracil-5-oxyacetic acid methylester, uracil-5-oxyacetic acid (v), 5-methyl-2-thiouracil, 3-(3-amino-3-N2-carboxypropyl) uracil, (acp3)w, and 2,6-diaminopurine. Alternatively, the antisense nucleic acid can be produced biologically using an expression vector into which a nucleic acid has been sub-cloned in an antisense orientation (i.e., RNA transcribed from the inserted nucleic acid will be of an antisense orientation to a target nucleic acid of interest, described further in the following subsection).

The antisense nucleic acid molecules of the invention are typically administered to a subject or generated in situ such that they hybridize with or bind to cellular mRNA and/or genomic DNA encoding a polypeptide corresponding to a selected marker of the invention to thereby inhibit expression of the marker, e.g., by inhibiting transcription and/or translation. The hybridization can be by conventional nucleotide complementarity to form a stable duplex, or, for example, in the case of an antisense nucleic acid molecule which binds to DNA duplexes, through specific interactions in the major groove of the double helix. Examples of a route of administration of antisense nucleic acid molecules of the invention include direct injection at a tissue site or infusion of the antisense nucleic acid into an appropriately-associated body fluid, e.g., cerebrospinal fluid. Alternatively, antisense nucleic acid molecules can be modified to target selected cells and then administered systemically. For example, for systemic administration, antisense molecules can be modified such that they specifically bind to receptors or antigens expressed on a selected cell surface, e.g., by linking the antisense nucleic acid molecules to peptides or antibodies which bind to cell surface receptors or antigens. The antisense nucleic acid molecules can also be delivered to cells using the vectors described herein. To achieve sufficient intracellular concentrations of the antisense molecules, vector constructs in which the antisense nucleic acid molecule is placed under the control of a strong pol II or pol III promoter are preferred.

An antisense nucleic acid molecule of the invention can be an α-anomeric nucleic acid molecule. An α-anomeric nucleic acid molecule forms specific double-stranded hybrids with complementary RNA in which, contrary to the usual .alpha.-units, the strands run parallel to each other (Gaultier et al., 1987, Nucleic Acids Res. 15:6625-6641). The antisense nucleic acid molecule can also comprise a 2′-o-methylribonucleotide (Inoue et al., 1987, Nucleic Acids Res. 15:6131-6148) or a chimeric RNA-DNA analogue (Inoue et al., 1987, FEBS Lett. 215:327-330).

An “RNA interfering agent” as used herein, is defined as any agent which interferes with or inhibits expression of a target gene, e.g., a biomarker of the invention, by RNA interference (RNAi). Such RNA interfering agents include, but are not limited to, nucleic acid molecules including RNA molecules which are homologous to the target gene, e.g., a biomarker of the invention, or a fragment thereof, short interfering RNA (siRNA), and small molecules which interfere with or inhibit expression of a target gene by RNA interference (RNAi).

“RNA interference (RNAi)” is an evolutionally conserved process whereby the expression or introduction of RNA of a sequence that is identical or highly similar to a target gene results in the sequence specific degradation or specific post-transcriptional gene silencing (PTGS) of messenger RNA (mRNA) transcribed from that targeted gene (see Coburn, G. and Cullen, B. (2002) J. of Virology 76(18):9225), thereby inhibiting expression of the target gene. In one embodiment, the RNA is double stranded RNA (dsRNA). This process has been described in plants, invertebrates, and mammalian cells. In nature, RNAi is initiated by the dsRNA-specific endonuclease Dicer, which promotes processive cleavage of long dsRNA into double-stranded fragments termed siRNAs. siRNAs are incorporated into a protein complex that recognizes and cleaves target mRNAs. RNAi can also be initiated by introducing nucleic acid molecules, e.g., synthetic siRNAs or RNA interfering agents, to inhibit or silence the expression of target genes. As used herein, “inhibition of target gene expression” or “inhibition of biomarker gene expression” includes any decrease in expression or protein activity or level of the target gene (e.g., a biomarker gene of the invention) or protein encoded by the target gene, e.g., a biomarker protein of the invention. The decrease may be of at least 30%, 40%, 50%, 60%, 70%, 80%, 90%, 95% or 99% or more as compared to the expression of a target gene or the activity or level of the protein encoded by a target gene which has not been targeted by an RNA interfering agent.

Short interfering RNA″ (siRNA), also referred to herein as “small interfering RNA” is defined as an agent which functions to inhibit expression of a target gene, e.g., by RNAi. An siRNA may be chemically synthesized, may be produced by in vitro transcription, or may be produced within a host cell. In one embodiment, siRNA is a double stranded RNA (dsRNA) molecule of about 15 to about 40 nucleotides in length, preferably about 15 to about 28 nucleotides, more preferably about 19 to about 25 nucleotides in length, and more preferably about 19, 20, 21, or 22 nucleotides in length, and may contain a 3′ and/or 5′ overhang on each strand having a length of about 0, 1, 2, 3, 4, or 5 nucleotides. The length of the overhang is independent between the two strands, i.e., the length of the over hang on one strand is not dependent on the length of the overhang on the second strand. Preferably the siRNA is capable of promoting RNA interference through degradation or specific post-transcriptional gene silencing (PTGS) of the target messenger RNA (mRNA).

In another embodiment, an siRNA is a small hairpin (also called stem loop) RNA (shRNA). In one embodiment, these shRNAs are composed of a short (e.g., 19-25 nucleotide) antisense strand, followed by a 5-9 nucleotide loop, and the analogous sense strand. Alternatively, the sense strand may precede the nucleotide loop structure and the antisense strand may follow. These shRNAs may be contained in plasmids, retroviruses, and lentiviruses and expressed from, for example, the pol III U6 promoter, or another promoter (see, e.g., Stewart, et al. (2003) RNA April; 9(4):493-501 incorporated be reference herein).

RNA interfering agents, e.g., siRNA molecules, may be administered to a subject having or at risk for having cancer, to inhibit expression of a biomarker gene of the invention, e.g., a biomarker gene which is overexpressed in cancer (such as the biomarkers listed in Table 2) and thereby treat, prevent, or inhibit cancer in the subject.

### Methods and Materials

Expression of GEOIs, Oncogene(s) or Gene(s) for which Mutations have been Implicated in Cancer

A nucleic acid comprising the GEOIs, oncogene(s) or gene(s) for which mutations have been implicated in cancer, and other genes or sequences of the present invention described herein may be linked to a regulatory element, e.g., a promoter, enhancer, silencer, and termination signal, as further described herein. One of skill in the art will readily understand that the nucleic acids described herein can be expressed by expression vectors harboring nucleic acids that express these genes and that these expression vectors may be modified in a number of ways.

The term “vector” refers to a nucleic acid capable of transporting another nucleic acid to which it has been linked. One type of vector which may be used in accord with the invention is an episome, i.e., a nucleic acid capable of extra-chromosomal replication. Other vectors include those capable of autonomous replication and expression of nucleic acids to which they are linked. Vectors capable of directing the expression of genes to which they are operatively linked are referred to herein as “expression vectors”.

As used herein, the term “operably linked” refers to a linkage of polynucleotide elements in a functional relationship. For instance, a promoter or enhancer is operably linked to a coding sequence if it affects the transcription of the coding sequence. More precisely, two DNA molecules (such as a polynucleotide containing a promoter region and a polynucleotide encoding a desired polypeptide or polynucleotide) are said to be “operably linked” if the nature of the linkage between the two polynucleotides does not (1) result in the introduction of a frame-shift mutation or (2) interfere with the ability of the polynucleotide containing the promoter to direct the transcription of the coding polynucleotide. In general, expression vectors of utility in recombinant DNA techniques are often in the form of “plasmids” which refer to circular double stranded DNA molecules which, in their vector form are not bound to the chromosome. In the present specification, “plasmid” and “vector” are used interchangeably as the plasmid is the most commonly used form of vector. However, the invention is intended to include such other forms of expression vectors which serve equivalent functions and which become known in the art subsequently hereto.

Appropriate vectors may be introduced into target host cells using well known techniques, such as infection, transduction, transfection, transvection, electroporation and transformation and accompanying reagents typically used to introduce the compositions into a cell. Generally, a plasmid vector is introduced in a precipitate, such as a calcium phosphate precipitate, or in a complex with a charged lipid. If the vector is a virus, it may be packaged in vitro using an appropriate packaging cell line and then transduced into cells. In one embodiment, the vector may be, for example, a phage, plasmid, viral or retroviral. Exemplary viral and retroviral vectors include adenovirus vectors, adeno-associated virus vectors, lentivirus vectors, herpes simplex virus (HSV) vectors, human immunodeficiency virus (HIV) vectors, bovine immunodeficiency virus (BIV), murine leukemia virus (MLV), and the like. Retroviral vectors may be replication competent or replication defective. In the latter case, viral propagation generally will occur only in complementing target host cells. In a preferred embodiment, the vector is a recombinant retroviral vector. A gene delivery vehicle can optionally comprise viral sequences such as a viral origin of replication or packaging signal. These viral sequences can be selected from viruses such as astrovirus, coronavirus, orthomyxovirus, papovavirus, paramyxovirus, parvovirus, picornavirus, poxvirus, retrovirus, togavirus or adenovirus. Recombinant retroviruses and various uses thereof have been described in numerous references including, for example, Mann et al. (Cell 33: 153, 1983), Cane and Mulligan (Proc. Nat'l. Acad. Sci. USA 81:6349, 1984), Miller et al. (Human Gene Therapy 1:5-14, 1990), U.S. Pat. Nos. 4,405,712, 4,861,719, and 4,980,289, and PCT Application Nos. WO 89/02,468, WO 89/05,349, and WO 90/02,806, the entire contents of which are incorporated herein by reference in their entireties. Numerous retroviral gene delivery vehicles can be utilized in the present invention, including for example those described in EP 0,415,731; WO 90/07936; WO 94/03622; WO 93/25698; WO 93/25234; U.S. Pat. No. 5,219,740; WO 9311230; WO 9310218; Vile and Hart (Cancer Res. 53:3860-3864, 1993); Vile and Hart (Cancer Res. 53:962-967, 1993); Ram et al. (Cancer Res. 53:83-88, 1993); Takamiya et al. (J. Neurosci. Res. 33:493-503, 1992); Baba et al. (J. Neurosurg. 79:729-735, 1993); U.S. Pat. No. 4,777,127; GB 2,200,651; EP 0,345,242; and WO91/02805; the entire contents of which are incorporated herein by reference in their entireties.

Other viral vector systems that can be used to deliver a polynucleotide of the invention have been derived from Moloney murine leukemia virus, e.g., Morgenstern and Land, Nucleic Acids Res. 18:3587-3596, 1990, the entire contents of which is incorporated herein by reference in its entirety; herpes virus, e.g., Herpes Simplex Virus (U.S. Pat. No. 5,631,236 by Woo et al., issued May 20, 1997 and WO 00/08191 by Neurovex, the entire contents of which are incorporated herein by reference in their entireties); vaccinia virus (Ridgeway (1988) Ridgeway, “Mammalian expression vectors,” In: Rodriguez R L, Denhardt D T, ed. Vectors: A survey of molecular cloning vectors and their uses; and Stoneham: Butterworth, Baichwal and Sugden (1986) “Vectors for gene transfer derived from animal DNA viruses: Transient and stable expression of transferred genes,” In: Kucherlapati R, ed. Gene transfer. New York: Plenum Press; Coupar et al. (1988) Gene, 68:1-10; the entire contents of which are incorporated herein by reference in their entireties), and several RNA viruses.

Modifications may include individual nucleotide substitutions to a constitutively regulated vector or insertions or deletions of one or more nucleotides in the vector sequences. Modifications or operable linkages to a constitutively regulated vector that alter (i.e., increase or decrease) expression of a sequence interval (e.g., alternative promoters), provide greater cloning flexibility (e.g. alternative multiple cloning sites), provide greater experimental efficiency (e.g. alternative reporter genes), and/or increase vector stability are contemplated herein. In one embodiment, an expression vector of the invention may be modified to replace a Gateway® cloning cassette with a multi-cloning sequence, containing restriction enzyme sites for insertion of potential enhancers through standard ligation.

A “promoter” herein refers to a DNA sequence recognized by the synthetic machinery of the cell required to initiate the specific transcription of a gene. In another embodiment, an expression vector of the invention may be modified to eliminate the strong CMV promoter sequence, to allow testing of an enhancer-promoter combination, including the endogenous gene promoter, inducible promoter, cell type-specific promoter, minimal promoter or other alternative enhancer-promoter sequences known to the skilled artisan. It is also known that many proteins, e.g., kinases, can be activated simply by being overexpressed in a given cell. In one embodiment, the strong CMV promoter sequence can be replaced with an even stronger promoter or coupled with an improved enhancer or the like in order to cause increased expression of wild type or regulatable proteins. In another embodiment, increased expression of wild type or regulatable proteins can be effected through coexpression of multiple copies of the gene with standard promoters.

In one embodiment, an expression vector will further contain sites for transcription initiation, termination and, in the transcribed region, a ribosome binding site for translation. The coding portion of the mature transcripts expressed by the constructs will preferably include a translation initiating site at the beginning and a termination codon (UAA, UGA or UAG) appropriately positioned at the end of the polypeptide to be translated.

In one embodiment, a vector of the invention may be modified to include reporter genes, including genes encoding fluorescent proteins or enzymes, such as f3-galactosidase and alkaline phosphatase. In certain embodiments, fluorescent reporters may be replaced with alternate fluorescent reporters with shorter or longer protein half-life allowing more precise evaluation of the timing of regulatory control. A reporter may also be replaced by cassettes encoding protein substrates that allow observation (direct or indirect) of response based on cell/biochemical activity, e.g., in screens of chemical libraries to identify potential therapeutic chemical targets/leads.

Recombinant vectors can be engineered such that the mammalian nucleotide sequences of the invention are placed under the control of regulatory elements (e.g. promoter sequences, polyadenylation signals, etc.) in the vector sequences. Such regulatory elements can function in a host cell to direct the expression and/or processing of nucleotide transcripts and/or polypeptide sequences encoded by the mammalian nucleotide sequences of the invention.

A large number of vectors have been constructed that contain powerful promoters that generate large amounts of mRNA complementary to cloned sequences of DNA introduced into the vector. For example, and not by way of limitation, expression of eukaryotic nucleotide sequences in E. coli may be accomplished using lac, trp, lambda, and recA promoters. See, for example, “Expression in Escherichia coli”, Section II, pp. 11-195, V. 185, Methods in Enzymology, supra; see also Hawley, D. K., and McClure, W. R., “Compilation and Analysis of Escherichia coli promoter DNA sequences”, Nucl. Acids Res., 11: 4891-4906 (1983), incorporated herein by reference. Expression of mammalian nucleotide sequences of the invention, and the polypeptides they encode, in a recombinant bacterial expression system can be readily accomplished.

Suitable expression systems include those that transiently or stably expressed DNA and those that involve viral expression vectors derived from simian virus 40 (SV-40), retroviruses, and baculoviruses. These vectors usually supply a promoter and other elements such as enhancers, splice acceptor and/or donor sequences, and polyadenylation signals. Possible vectors include, but are not limited to, cosmids, plasmids or modified viruses, but the vector system must be compatible with the host cell used. Viral vectors include, but are not limited to, vaccinia virus, or lambda derivatives. Plasmids include, but are not limited to, pBR322, pUC, or Bluescript7 (Stratagene) plasmid derivatives. Recombinant molecules can be introduced into target host cells via transformation, transfection, infection, electroporation, etc. Generally, expression of a protein in a host is accomplished using a vector containing DNA encoding that protein under the control of regulatory regions that function in the host cell.

Eukaryotic nucleotide sequences of the invention that have been introduced into target host cells can exist as extra-chromosomal sequences or can be integrated into the genome of the host cell by homologous recombination, viral integration, or other means. Standard techniques such as Northern blots and Western blots can be used to determine that introduced sequences are in fact being expressed in the target host cells.

The nucleic acids of the present invention can be introduced into a host (target) cell by any method which will result in the uptake and expression of the gene of interest by the target cells. These can include vectors, liposomes, naked DNA, adjuvant-assisted DNA, catheters, etc. Vectors include chemical conjugates such as described in WO 93/04701, which has a targeting moiety (e.g. a ligand to a cellular surface receptor) and a nucleic acid binding moiety (e.g. polylysine), viral vectors (e.g. a DNA or RNA viral vector), fusion proteins such as described in PCT/US 95/02140 (WO 95/22618) which is a fusion protein containing a target moiety (e.g. an antibody specific for a target cell) and a nucleic acid binding moiety (e.g. a protamine), plasmids, phage, etc. The vectors can be chromosomal, non-chromosomal or synthetic.

Preferred vectors include viral vectors, fusion proteins and chemical conjugates. Retroviral vectors include moloney murine leukemia viruses and HIV-based viruses. One preferred HIV-based viral vector comprises at least two vectors wherein the gag and pol genes are from an HIV genome and the env gene is from another virus. DNA viral vectors are preferred. These vectors include pox vectors such as orthopox or avipox vectors, herpesvirus vectors such as a herpes simplex I virus (HSV) vector [Geller, A. I. et al., J. Neurochem, 64:487 (1995); Lim, F., et al., in DNA Cloning: Mammalian Systems, D. Glover, Ed. (Oxford Univ. Press, Oxford England) (1995); Geller, A. I. et al., Proc Natl. Acad. Sci.: U.S.A.:90 7603 (1993); Geller, A. I., et al., Proc Natl. Acad. Sci. USA: 87:1149 (1990)], adenovirus vectors [LeGal LaSalle et al., Science, 259:988 (1993); Davidson, et al., Nat. Genet. 3: 219 (1993); Yang, et al., J. Virol. 69: 2004 (1995)] and adeno-associated virus vectors [Kaplitt, M. G., et al. Nat. Genet. 8:148 (1994)].

Pox viral vectors introduce the gene into the cells cytoplasm. Avipox virus vectors result in only a short term expression of the MSH5 gene. Adenovirus vectors, adeno-associated virus vectors and herpes simplex virus (HSV) vectors are preferred for introducing the MSH5 gene into neural cells. The adenovirus vector results in a shorter term expression (about 2 months) than adeno-associated virus (about 4 months), which in turn is shorter than HSV vectors. The particular vector chosen will depend upon the target cell and the condition being treated. The introduction can be by standard techniques, e.g. infection, transfection, transduction or transformation. Examples of modes of gene transfer include naked DNA, CaPO₄ precipitation, DEAE dextran, electroporation, protoplast fusion, lipofection, cell microinjection, viral vectors, etc.

Target host cells carrying such introduced sequences can be analyzed to determine the effects that sequence introduction has on the target host cells. In particular, cells could be assayed for alterations in the rate of accumulation of spontaneous mutations (e.g. by the rate of spontaneous mutation to drug resistance), in the rate of reversion of mutations, in the frequency of homologous recombination, in the frequency of recombination between divergent sequences, or in the genomic stability of short repeated sequences. In particular, mammalian cells carrying introduced sequences of the invention could be tested for the stability of di- and trinucleotide repeats by the method of Schalling et al. (Schalling et al. Nature. Genetics, 4:135, 1993, incorporated herein by reference.), or for sensitivity to agents that induce DNA damage such as UV-light, nucleotide analogs, etc.

In particular embodiments, a nucleotide sequence of the invention may be used to inactivate an endogenous gene by homologous recombinations, and thereby create a GEOI-deficient cell, tissue, or animal. For example, and not by way of limitation, a recombinant human nucleotide sequence of the present invention may be engineered to contain an insertional mutation (e.g., the neo gene) which, when inserted, inactivates transcription of an endogenous GEOI. Such a construct, under the control of a suitable promoter operatively linked to a nucleotide sequence of the invention, may be introduced into a cell by a technique such as transformation, transfection, transduction, injection, etc.

In a specific embodiment of the invention, an endogenous GEOI in a cell may be inactivated by homologous recombination with a mutant GEOI, thereby allowing the development of a transgenic animal from that cell, which animal lacks the ability to express the encoded mismatch repair gene polypeptide. In another embodiment, a construct can be provided that, upon transcription, produces an “anti-sense” nucleic acid sequence which, upon translation, will not produce the required mismatch repair gene polypeptide.

### EXAMPLES

### Example 1

### Context-Specific Genetic Screen Identifies JNK Inhibition as a Therapeutic Target in BRAF^{V600E} Melanoma

This example describes a context-specific in vivo forward genetic screen designed and developed to systematically assign relative weight of biological evidence to a library of high-probability driver genetic elements in a genetically defined cancer-sensitized model system. This screen was developed in a BRAF^{V600E} context that identifies JNK pathway activation as the preferred and potent cooperating event in melanoma genesis in vivo. Cooperation of BRAF^{V600E} with JNK activity is consistent with epidemiological and biochemical data demonstrating that ultraviolet radiation (UV) can potently activate endogenous JNK signaling to effect transformation of BRAF^{V600E} melanocytes. RNAi-mediated knockdown of JNK activity resulted in tumor regression in human melanoma cells harboring high endogenous phosphor-cJUN activity. Thus, the BRAF^{V600E} context-specific genetic screen has identified JNK pathway components as key tumor maintenance targets in BRAF^{V600E} melanomas and provides a clinical path hypothesis guiding development of agents targeting the JNK pathway in specific melanoma patients.

A ‘cancer-kinase’ library was constructed containing sequence-verified ORFs in a lentiviral vector for 110 of the 120 kinases reported to sustain somatic driver mutations in diverse human cancers. This library was pooled and introduced into a human HMEL-BRAF^{V600E} melanocyte model system engineered with BRAF^{V600E} and TERT as well as p53DD and CDK4-R24C to inactivate the RB and p53 pathways, respectively. The HMEL-BRAF^{V600E} melanocyte profile, while representing the most common clinically-definable genetic profile in human melanoma, is insufficient to drive efficient melanoma formation following orthotopic transplantation in the skin (penetrance of 10% and latency of 26 weeks). In contrast, 40% of HMEL-BRAF^{V600E} melanocytes transduced with the cancer kinase pools developed tumors with an average latency of 13 weeks (range 10-18 weeks).

Since increased tumor penetrance and acceleration might reflect selection for cancer kinases that cooperate with BRAF^{V600E} in driving tumorigenesis, we performed genomic PCR sequencing and western blotting to catalog candidate cooperative cancer kinases (see Methods).

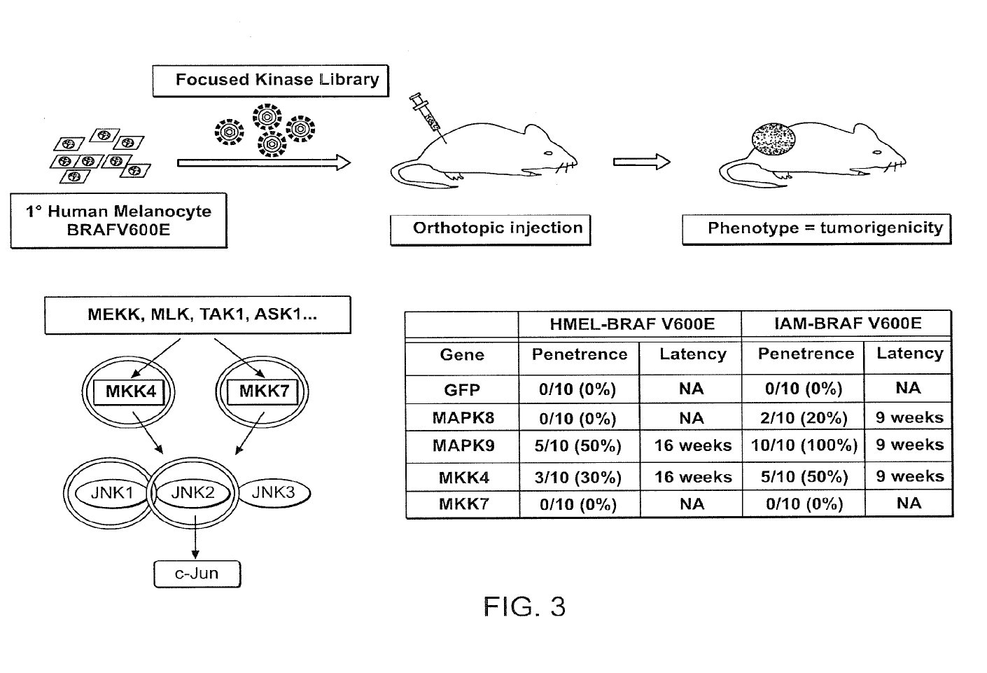

Analysis of the 23 tumors recovered 14 kinases that are positively selected for, singly or in combination, in at least 2 tumors, indicating that 14 of the 110 driver kinases are candidate oncogenic drivers in the BRAF^{V600E} melanocyte model system. Unexpectedly, among these 14 kinase hits are four core signaling mediators of the JNK pathway, including both MAP2Ks (MAP2K4 and MAP2K7) and two MAPKs (MAPK8/JNK1 and MAPK9/JNK2), a pattern reflecting a strong genetic selection pressure for JNK pathway activation during transformation of HMEL-BRAF^{V600E} melanocytes in vivo. During secondary validation screens with individual JNK signaling components, we observed robust oncogenic activity by both MAP2K4 and MAPK9/JNK2 individually when transduced into HMEL-BRAF^{V600E} melanocytes, resulting in tumor formation within 16 weeks with penetrance of 30% and 50% respectively (FIG. 3). Using genetically engineered mouse as an orthogonal validation system, it was further shown that MAP2K4 and MAPK9 were able to transform BRAF^{V600E} expressing Ink4a/Arf−/− melanocytes while enforced BRAF^{V600E} expression alone was insufficient to drive melanogenesis. Consistent with their recovery in tumors containing a second kinase hit in the primary screen (data not shown), MAP2K7 and MAPK8 did not generate tumors individually in the secondary HMEL screens, suggesting that these two kinases require cooperation with other genetic elements in transforming BRAF^{V600E} melanocytes.

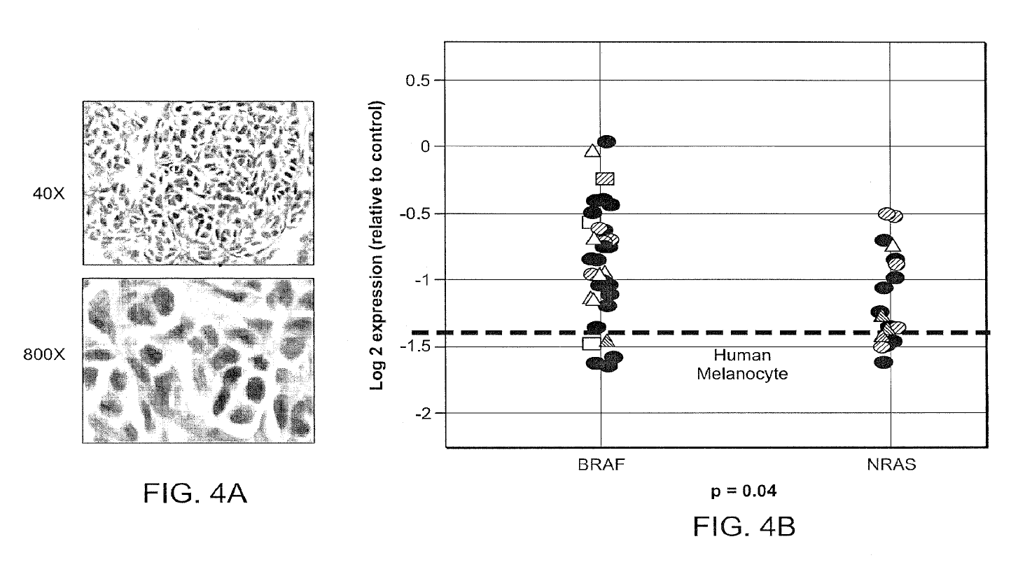

JNK signaling has generally been viewed as pro-apoptotic and tumor-suppressive (ref), hence JNK pathway components have not been targeted for therapeutic development in human cancers. However, the strong genetic selection for multiple components of this pathway in the primary screen, reinforced by secondary validation in mouse and human systems, establishes unequivocally that JNK pathway activation is a potent tumorigenic event in BRAF^{V600E} melanocytes and that JNK pathway inhibition is a rational therapeutic strategy in BRAF^{V600E} melanomas. To address the latter, we examined whether JNK pathway activation is observed in human melanoma. Using phospho-cJUN as a reporter of JNK pathway activity, high level of JNK activity is observed in 25-30% of human melanoma specimens on a tissue microarray [60 cores corresponding to 60 independent patient specimens]. Furthermore, quantitative measure of JNK expression in a cohort of 39 fresh-frozen BRAF^{V600E} mutant human melanomas by Reverse Phase Protein Array (RPPA, see Methods) showed that 31 (79%) of these melanomas expressed phosphorylated JNK at a higher level than primary melanocytes (FIG. 4; p=0.04).

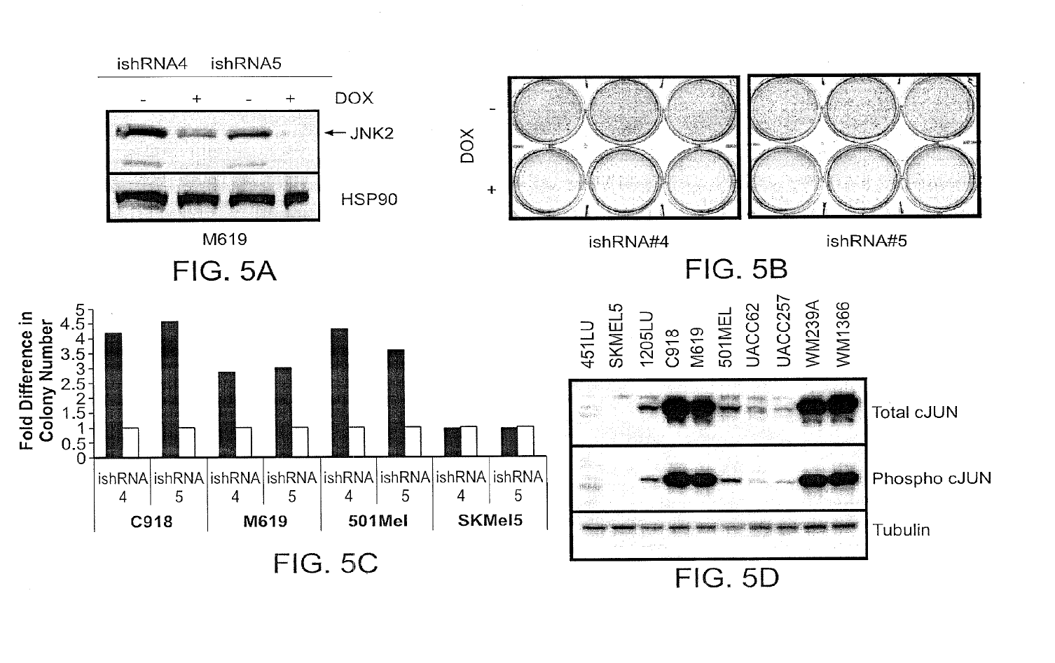

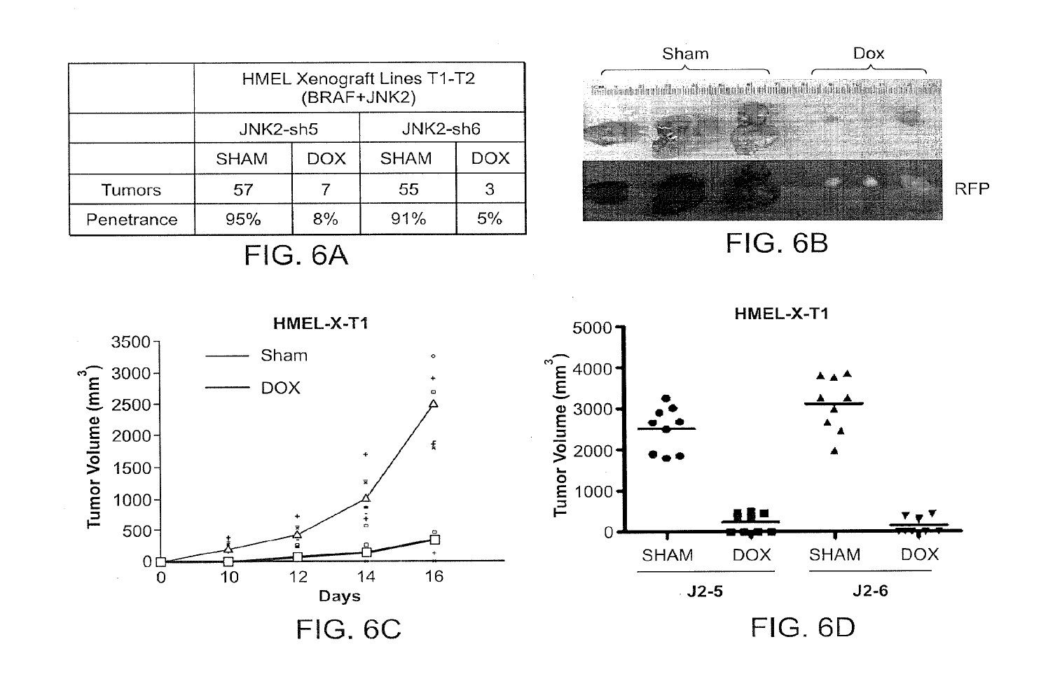

Consistent with these tumor data, we found that JNK activity is variable in a panel of 40 established human melanoma cell lines and RNAi-mediated knockdown of JNK2 in cells with robust JNK activity resulted in impaired tumorigenicity (FIG. 3). Here, using two independent shRNA targeting JNK2 in a doxycycline-inducible vector system, we observed a dramatic inhibition of anchorage independent growth of 5 of 10 human melanoma cells with high level of phospho-cJUN (FIG. 5). When transplanted into immunodeficient hosts, expression of the shRNA upon administration of doxycycline completely inhibited tumorigenicity in vivo (FIG. 6).

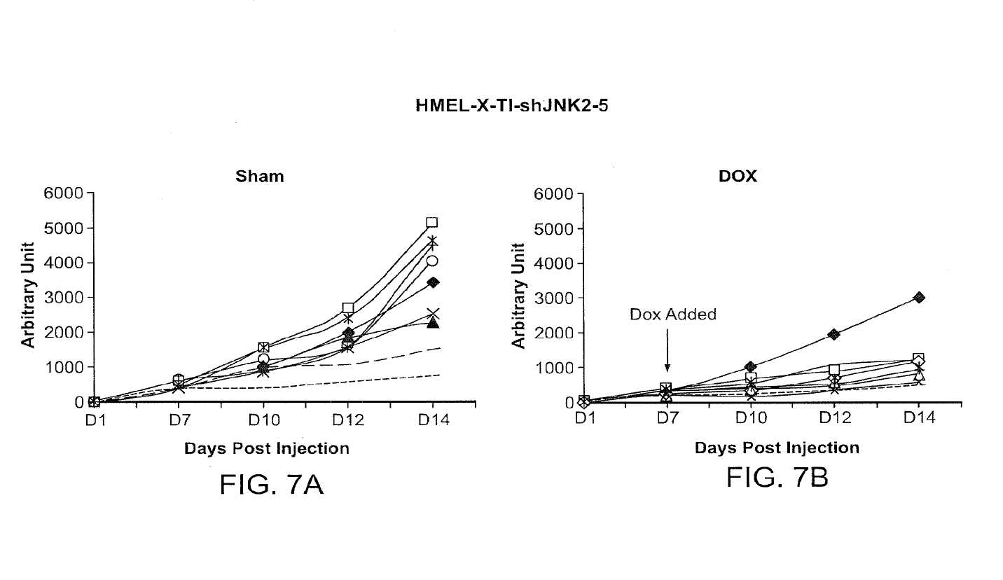

Next, to address the tumor maintenance requirement of JNK activity in melanoma, we induced expression of shRNA against JNK2 via doxycycline administration after xenograft tumors are fully established in immunocompromised animals. As shown in FIG. 7, upon extinction of JNK2, established tumors regressed.

The molecular basis for JNK activation in human melanoma was next explored. Among the 16 somatic driver mutations for core JNK mediators identified, all but one single MAP2K4 mutation were discovered in tumor types other than melanoma. Consistent with such profile, targeted re-sequencing of all 4 JNK signaling components in 76 pairs of melanoma and matched normal DNAs revealed no somatic non-silent mutations in this pathway (data not shown). Furthermore, when assessed for kinase activity (see Methods) and in vivo tumorigenicity, three of the 5 somatic driver mutations defined for MAP2K4 exhibited increased kinase activity (as reported by level of cJUN phosphorylation) and tumorigenicity in vivo, however, the somatic mutation identified in a melanoma did not. See Table 1-1 below. Together, these data suggest that mutational activation is not the primary mode of JNK activation in human melanoma.

TABLE 1-1

| | AA | Kinase | Tumorigenicity | |
|---|---|---|---|---|
| Gene | Change | Activity | in vivo | Observed |
| MAP2K4 | WT | 1X | YES | N/A |
| MAP2K4 | p.R154W | 3X | YES | Colorectal: |
| | | | | Adenocarcinoma |
| MAP2K4 | p.A279T | <1X | NO | Colorectal: |
| | | | | Adenocarcinoma |
| MAP2K4 | p.Q142L | 4X | YES | Colorectal: |
| | | | | Adenocarcinoma |
| MAP2K4 | p.S251N | 1X | NO | Melanoma |
| MAP2K4 | p.N2341 | 2.5X | NO | Ovarian: Serous |
| | | | | Carcinoma |
| MAP2K7 | WT | 1X | NO | N/A |
| MAP2K7 | p.R162C | 1X | NO | Colorectal: |
| | | | | Adenocarcinoma |
| MAP2K7 | p.R162H | 1X | NO | Colorectal: |
| | | | | Adenocarcinoma |
| JNK1 | WT | 1X | YES | N/A |
| JNK1 | p.G177R | 1X | NO | GBM |
| JNK1 | P.G171S | 1X | YES | Renal: Clear |
| | | | | Cell Carcinoma |
| JNK2 | WT | 1X | YES | N/A |
| JNK2 | p.V13M | 1X | YES | Colorectal: |
| | | | | Adenocarcinoma |
| JNK2 | p.K56N | 1X | YES | Head & Neck: |
| | | | | Squamous Cell |

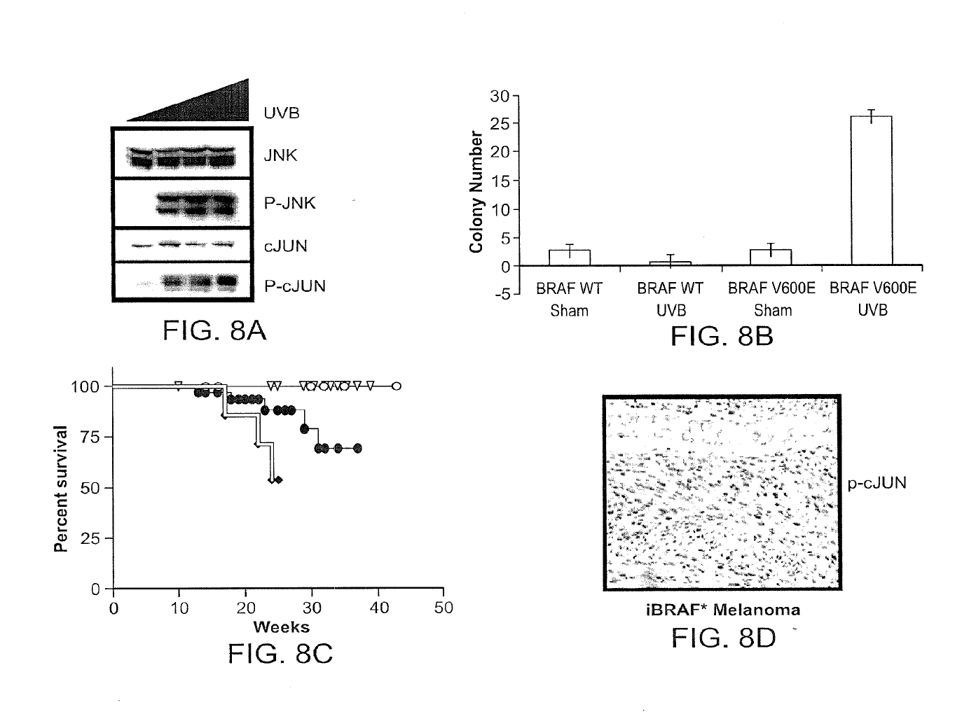

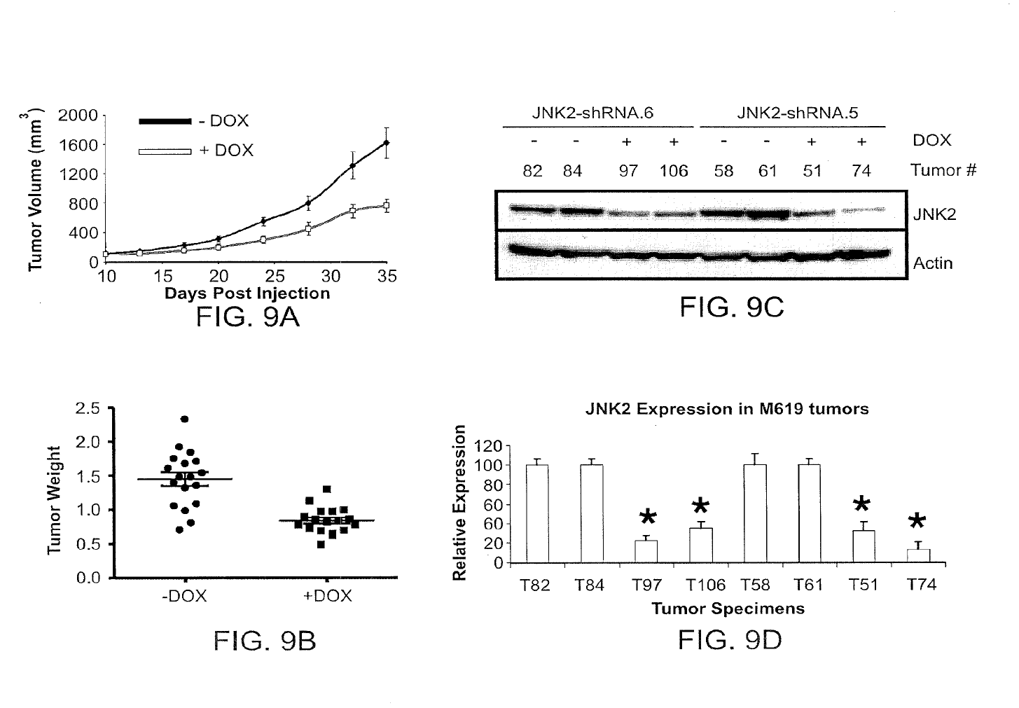

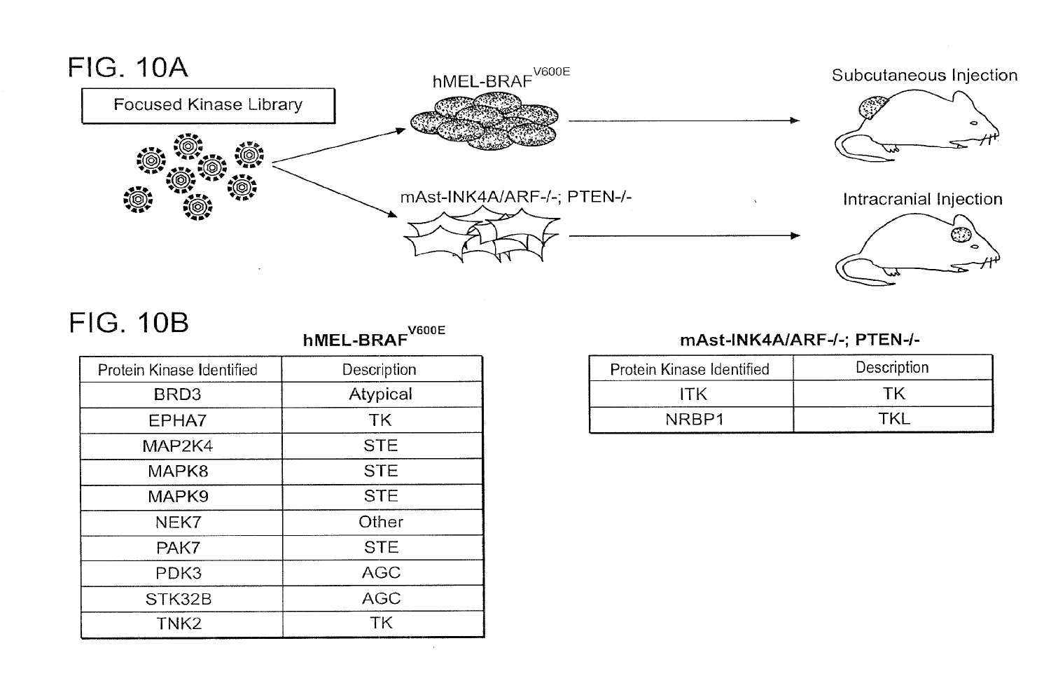

JNK signaling is known to be induced by UVB, a well-recognized environmental carcinogen for melanoma. Interestingly, BRAF^{V600E} mutation is most prevalent among superficial spreading melanoma, a subtype that is associated with intermittent UV exposure. The relevant mode of JNK activation in melanoma may thus be UV exposure, particularly in melanocytes initiated with BRAF^{V600E} mutation. Using BRAF^{V600E} expressing primary melanocytes from Ink4a/Arf−/− mice, we confirmed that UVB exposure indeed activated JNK as reflected by robust phospho-cJun expression. When these UV treated BRAF^{V600E} melanocytes were seeded in soft agar, we found that a single exposure to UVB conferred potent anchorage independent growth In vitro, a strong surrogate of tumorigenicity. In contrast, similar UVB exposure in Ink4a/Arf−/−melanocytes expressing wildtype BRAF resulted in cell deaths and decreased colony formation (FIG. 8B), a clear evidence of context-dependent oncogenicity of JNK activation. Finally, this cooperation between UVB and BRAF^{V600E} was evident in vivo as well. Although expression of BRAF^{V600E} in Ink4a/Arf−/− melanocytes was not sufficient to drive melanoma genesis in a doxycycline-inducible BRAF^{V600E} transgenic model (with genotype of Tyr rtTA/Tet-BRAF^{V600E} Ink4a/Arf−/−; hereafter referred to as “iBRAF*”, a single non-erythrogenic dose of UVB exposure at neonatal stage (postnatal day 1-3) resulted in significant earlier onset of melanoma with increased penetrance (FIG. 8C). These UV induced BRAF^{V600E} melanoma harbored high level of activated JNK activity as measured by phosphor-cJun staining on IHC (FIG. 8D).

In conclusion, a context-specific genetic screen in a BRAF^{V600E} melanocytic target cell unequivocally proved, on a genetic level, a potent oncogenic activity of the JNK pathway. Genetic inhibition of JNK signaling in established melanomas impaired tumorigenicity In vitro and in vivo. Mechanistically, epidemiological and molecular as well as functional data support the thesis that JNK activation is predominantly mediated by UV exposure in melanoma genesis. The demonstration that JNK activation via UV in BRAF wildtype melanocytes induces apoptosis in contrast to its transforming activity in BRAF^{V600E} background reinforces the importance of genetic context in clinical development of targeted therapeutics.

### Materials and Methods

Cell lines and plasmids: All human cell lines were propagated at 37° C. and 5% CO₂ in humidified atmosphere in RPMI 1640 medium (Invitrogen) supplemented with 10% heat-inactivated FBS. hTERT/CDK4(R24C)/p53DD/BRAF(V600E) melanocytes (HMEL) have been described previously. Mouse melanocytes were isolated from Ink4A/Arf−/− mice according to standard protocols and grown in RPMI 1640 medium supplemented with 10% heat-inactivated FBS, 2 nM TPA (Sigma), and 2 nM cholera toxin (Sigma). Mouse melanocytes were propagated at 37° C. and 10% CO₂ in humidified atmosphere. Primary mouse Ink4A/Arf−/−, PTEN−/− astrocytes were isolated from 5 day old pups according to standard protocols and maintained in DMEM medium supplemented with 10% heat-inactivated FBS.

Focused human cancer kinase cDNA Library: ORFs representing 110 human kinases were obtained from Center for Cancer Systems Biology (Dana Farber Cancer Institute), the Harvard Institute of Proteomics (Harvard Medical School), or from Open Biosystems. ORFs were cloned into a universal pDONOR223 entry vector and then transferred via Gateway Recombination Cloning (Invitrogen) into pLenti6/V5/DEST. All clones were sequence and expression verified.

The human cancer kinase cDNA library included the following genes:

| Gene Symbol | Gene ID | Gene Name |
|---|---|---|
| ALPK2 | 115701 | alpha-kinase 2 |
| AURKA | 6790 | aurora kinase A; aurora kinase A pseudogene 1 |
| BMPR1A | 657 | bone morphogenetic protein receptor, type IA; similar to ALK-3 |
| BMPR1B | 658 | bone morphogenetic protein receptor, type IB |
| BRAF | 673 | v-raf murine sarcoma viral oncogene homolog B1 |
| BRD2 | 6046 | bromodomain containing 2 |
| BRD3 | 8019 | bromodomain containing 3 |
| BRDT | 676 | bromodomain, testis-specific; hCG1811337 |
| BRSK1 | 84446 | BR serine/threonine kinase 1 |
| CAMKK2 | 10645 | calcium/calmodulin-dependent protein kinase kinase 2, beta |
| CAMKV | 79012 | CaM kinase-like vesicle-associated |
| CDK15 | 65061 | PFTAIRE protein kinase 2 |
| CDK8 | 1024 | cyclin-dependent kinase 8 |
| CDKL2 | 8999 | cyclin-dependent kinase-like 2 (CDC2-related kinase) |
| CHUK | 1147 | conserved helix-loop-helix ubiquitous kinase |
| DAPK3 | 1613 | death-associated protein kinase 3 |
| DCLK1 | 9201 | doublecortin-like kinase 1 |
| DCLK3 | 85443 | doublecortin-like kinase 3 |
| DYRK2 | 8445 | dual-specificity tyrosine-(Y)-phosphorylation regulated kinase 2 |
| EPHA10 | 284656 | EPH receptor A10 |
| EPHA3 | 2042 | EPH receptor A3 |
| EPHA6 | 285220 | EPH receptor A6 |
| EPHA7 | 2045 | EPH receptor A7 |
| EPHA8 | 2046 | EPH receptor A8 |
| EPHB1 | 2047 | EPH receptor B1 |
| ERBB2 | 2064 | v-erb-b2 erythroblastic leukemia viral oncogene homolog 2, |
| | | neuro/glioblastoma derived oncogene homolog (avian) |
| ERBB4 | 2066 | v-erb-a erythroblastic leukemia viral oncogene homolog 4 (avian) |
| ERN1 | 2081 | endoplasmic reticulum to nucleus signaling 1 |
| FER | 2241 | fer (fps/fes related) tyrosine kinase |
| FGFR1 | 2260 | fibroblast growth factor receptor 1 |
| FGFR2 | 2263 | fibroblast growth factor receptor 2 |
| FGFR3 | 2261 | fibroblast growth factor receptor 3 |
| FGFR4 | 2264 | fibroblast growth factor receptor 4 |
| FLT1 | 2321 | fms-related tyrosine kinase 1 (vascular endothelial growth |
| | | factor/vascular permeability factor receptor) |
| FYN | 2534 | FYN oncogene related to SRC, FGR, YES |
| GRK6 | 2870 | G protein-coupled receptor kinase 6 |
| HSPB8 | 26353 | heat shock 22 kDa protein 8 |
| IGF1R | 3480 | insulin-like growth factor 1 receptor |
| IKBKB | 3551 | inhibitor of kappa light polypeptide gene enhancer in B-cells, |
| | | kinase beta |
| INSRR | 3645 | insulin receptor-related receptor |
| IRAK1 | 3654 | interleukin-1 receptor-associated kinase 1 |
| ITK | 3702 | IL2-inducible T-cell kinase |
| KSR2 | 283455 | kinase suppressor of ras 2 |
| LATS2 | 26524 | LATS, large tumor suppressor, homolog 2 (Drosophila) |
| LRRK2 | 120892 | leucine-rich repeat kinase 2 |
| MAP2K4 | 6416 | mitogen-activated protein kinase kinase 4 |
| MAP2K7 | 5609 | mitogen-activated protein kinase kinase 7 |
| MAP3K15 | 389840 | mitogen-activated protein kinase kinase kinase 15 |
| MAP3K2 | 10746 | mitogen-activated protein kinase kinase kinase 2 |
| MAP3K6 | 9064 | mitogen-activated protein kinase kinase kinase 6 |
| MAPK11 | 5600 | mitogen-activated protein kinase 11 |
| MAPK14 | 1432 | mitogen-activated protein kinase 14 |
| MAPK8 | 5599 | mitogen-activated protein kinase 8 |
| MAPK9 | 5601 | mitogen-activated protein kinase 9 |
| MAPKAPK3 | 7867 | mitogen-activated protein kinase-activated protein kinase 3 |
| MARK1 | 4139 | MAP/microtubule affinity-regulating kinase 1 |
| MAST4 | 375449 | microtubule associated serine/threonine kinase family member 4 |
| MATK | 4145 | megakaryocyte-associated tyrosine kinase |
| MELK | 9833 | maternal embryonic leucine zipper kinase |
| MGC42105 | 167359 | serine/threonine-protein kinase NIM1 |
| MYLK2 | 85366 | myosin light chain kinase 2 |
| MYLK4 | 340156 | myosin light chain kinase family, member 4 |
| MYO3A | 53904 | myosin IIIA |
| NEK10 | 152110 | NIMA (never in mitosis gene a)- related kinase 10 |
| NEK11 | 79858 | NIMA (never in mitosis gene a)- related kinase 11 |
| NEK6 | 10783 | NIMA (never in mitosis gene a)-related kinase 6 |
| NEK7 | 140609 | NIMA (never in mitosis gene a)-related kinase 7 |
| NEK8 | 284086 | NIMA (never in mitosis gene a)- related kinase 8 |
| NRBP1 | 29959 | nuclear receptor binding protein 1 |
| NRK | 203447 | Nik related kinase |
| NTRK3 | 4916 | neurotrophic tyrosine kinase, receptor, type 3 |
| NUAK2 | 81788 | NUAK family, SNF1-like kinase, 2 |
| PAK7 | 57144 | p21 protein (Cdc42/Rac)-activated kinase 7 |
| PDGFRA | 5156 | platelet-derived growth factor receptor, alpha polypeptide |
| PDK3 | 5165 | pyruvate dehydrogenase kinase, isozyme 3 |
| PKN1 | 5585 | protein kinase N1 |
| PLK2 | 10769 | polo-like kinase 2 (Drosophila) |
| PRKAA2 | 5563 | protein kinase, AMP-activated, alpha 2 catalytic subunit |
| PRKCA | 5578 | protein kinase C, alpha |
| PRKCB | 5579 | protein kinase C, beta |
| PRKCH | 5583 | protein kinase C, eta |
| PRKD1 | 5587 | protein kinase D1 |
| PSKH2 | 85481 | protein serine kinase H2 |
| RAF1 | 5894 | v-raf-1 murine leukemia viral oncogene homolog 1 |
| ROR1 | 4919 | receptor tyrosine kinase-like orphan receptor 1 |
| RPS6KA2 | 6196 | ribosomal protein S6 kinase, 90 kDa, polypeptide 2; hypothetical |
| | | LOC100127984 |
| RPS6KA3 | 6197 | ribosomal protein S6 kinase, 90 kDa, polypeptide 3 |
| RPS6KC1 | 26750 | ribosomal protein S6 kinase, 52 kDa, polypeptide 1 |
| SCYL2 | 55681 | SCY1-like 2 (S. cerevisiae) |
| SGK494 | 124923 | uncharacterized serine/threonine-protein kinase SgK494 |
| SIK1 | 150094 | salt-inducible kinase 1 |
| SNRK | 54861 | SNF related kinase |
| SRPK2 | 6733 | SFRS protein kinase 2 |
| STK11 | 6794 | serine/threonine kinase 11 |
| STK19 | 8859 | serine/threonine kinase 19 |
| STK32A | 202374 | serine/threonine kinase 32A |
| STK32B | 55351 | serine/threonine kinase 32B |
| STK36 | 27148 | serine/threonine kinase 36, fused homolog (Drosophila) |
| STK40 | 83931 | serine/threonine kinase 40 |
| TAF1L | 138474 | TAF1 RNA polymerase II, TATA box binding protein (TBP)- |
| | | associated factor, 210 kDa-like |
| TBCK | 93627 | TBC domain-containing protein kinase-like |
| TBK1 | 29110 | TANK-binding kinase 1 |
| TEK | 7010 | TEK tyrosine kinase, endothelial |
| TEX14 | 56155 | testis expressed 14 |
| TGFBR2 | 7048 | transforming growth factor, beta receptor II (70/80 kDa) |
| TNK2 | 10188 | tyrosine kinase, non-receptor, 2 |
| TNNI3K | 51086 | TNNI3 interacting kinase; fucose-1-phosphate guanylyltransferase |
| TRIM24 | 8805 | tripartite motif-containing 24 |
| WNK4 | 65266 | WNK lysine deficient protein kinase 4 |
| YSK4 | 80122 | YSK4 Sps1/Ste20-related kinase homolog (S. cerevisiae) |

In vivo functional genetic screens: Lentivirus were prepared by co-transfecting 293T cells with individual vector backbones and standard virus packaging systems for subsequent collection of viral supernatants. Viral supernatants were then pooled randomly to generate 8 pools of high-titer lentiviral stocks. HMEL cells were transduced with either GFP control lentivirus or each representative lentiviral pool in the presence of 8 ug/ml polybrene (Company). Infected cells were expanded, mixed 1:1 with Matrigel (BD Bioscience) and then subcutaneously implanted in female nude animals (Taconic) at 1×10⁶ cells per site on both flanks. Primary INK4A/ARF−/−, PTEN−/− murine astrocytes were transduced with either GFP control lentivirus or each representative lentiviral pool in the presence of 8 ug/ml polybrene (Company). Infected cells were expanded implanted into the brain parenchyma of female SCID mice (Charles River). Briefly, SCID mice were anesthetized and placed into a stereotactic apparatus equipped with a Z axis (Stoelting). A small hole was bored in the skull 0.5 mm anterior and 3.0 mm lateral to the bregma using a dental drill. Twenty thousand cells in Hank's Buffered Salt Solution were injected into the right caudate nucleus 2 mm below the surface of the brain using a 10-ul Hamilton syringe with an unbeveled 30 gauge needle. The scalp was closed using a 9-mm Autoclip Applier. Animals were followed daily for the development of subQ tumors or signs of neurological deficits. Animals were sacrifice, tumors were harvested, genomic DNA was prepared and kinases expressed in each tumor identified using PCR sequencing using plasmid specific CMV and V5 primers. Expression of each kinase was further validated by western blot analysis. Kinases expressed in each tumor were then enlisted into secondary validation screens in which stable HMEL or mouse astrocyte lines were generated expressing each kinase individually. Cells were again expanded and then implanted in female nude or SCID animals. All mice were housed and treated in accordance with protocols approved by the institutional care and use committees for animal research at the Dana-Farber Cancer Institute.

Anchorage-independent growth: Soft-agar assays were performed on 6-well plates in triplicate. For each well, 1×10⁴ cells were mixed thoroughly in cell growth medium containing 0.4% SeaKem LE agarose (Fisher) in RPMI plus 10% FBS, followed by plating onto bottom agarose prepared with 0.65% agarose in RPMI and 10% FBS. Each well was allowed to solidify and subsequently covered in 1 ml RPMI and 10% FBS, which was refreshed every 4 days. When appropriate, doxycycline was added to agarose and growth medium at a final concentration of 2 ug/ml. Colonies were stained with 0.05% (w/v) iodonitrotetrazolium chloride (Sigma) and scanned at 1,200 dots per inch (d.p.i.) using a flatbed scanner, and counted.

Immunohistochemistry: Melanoma tissue microarrays (Biomax) were stained with p-cJUN (Cell Signaling) using established protocols.

Xenograft studies: For in vivo studies, melanoma xenogaft cells stably expressing inducible JNK2 shRNA were subcutaneously implanted into female nude animals (Taconic) at 1×10⁶ cells per site on both flanks. For analysis of tumor growth mice were fed normal H₂O or H₂O containing 2 mg/ml doxycycline and 2% sucrose. To determine is JNK expression was required for tumor maintenance, cells were implanted and tumors allowed to reach approximately 200 mm³, after which time animals were randomized into separate cohorts for treatment with H₂O or H₂O containing 2 mg/ml doxycycline and 2% sucrose. Tumor volumes were measured after dox administration. Tumor volume was determined by measuring in two directions with vernier calipers and formulated as tumor volume=(length×width²)/2. Growth curves and end-point scatter plots were plotted as tumor volume for each group. Percentage tumor growth inhibition was determined as (1−(TIN))×100, in which T is the mean change in tumor volume of the treated group and N is the mean change in tumor volume of the control group at the assay end-point. Two-tailed t-test calculations were performed using Prism 5 (Graphpad).

UV Irradiation: Prior to treatment with UVB, culture medium was removed and reserved. Cultures were washed once with warm PBS, and then placed uncovered under a panel of four UVB bulbs (RPR-3000, Southern New England Ultraviolet), peak emittance in the UVB range, 311 nm. UV dose was monitored with a Photolight IL1400A radiometer equipped with a SEL240/UVB detector (International Light Technologies). Following irradiation, the reserved medium was replaced, and the cultures were incubated for the indicated periods of time. Sham-treated cultures were handled exactly the same way, except that they were not exposed to UVB.

Transgenic mouse maintenance and UV Treatment: BRAF^{V600E} transgenic mice (with genotype of Tyr-rtTA/Tet-BRAF^{V600E} Ink4a/Arf−/−) have been described previously (Jeong). For UV treatment neonatal mice (1- to 3-day-old pups) were treated with a single dose of total body UV irradiation (9 kJ/m²) by using an FS20T12 UV lamp (peak emittance in the UVB range, 310 nm) as previously described (Sharpless and Chin).

Western Immunoblot Analyses: Cells were harvested by trypsinization, washed once in PBS, and resuspended in RIPA (10 mM Tris-HCl (pH 7.4), 150 mM NaCl, 1 mM EDTA, 1% Nonidet P-40, 0.25% Na-deoxycholate) supplemented with Complete Protease Inhibitor Cocktail (Roche) and 1× phosphatases inhibitor (Calbiochem). After clarifying the extract by centrifugation, protein concentration was determined using the Bradford Assay Reagent (Bio-Rad, Hercules, Calif.). Samples containing equal amounts of protein were mixed with 4×NuPAGE LDS Sample Buffer (Invitrogen) containing 5% β-mercaptoethanol, boiled, and separated by SDS-PAGE. Proteins were transferred to PVDF membrane and probed with antibodies against cJUN, p-cJUN, JNK, p-JNK, HSP90 (Cell Signaling Technology); Actin (Santa Cruz Biotechnology).

JNK Kinase Assay: WT and mutant JNK kinases were immunoprecipitated from HMEL cells using an anti-V5 antibody (Invitrogen). Kinase activity was measured using the non-radioactive JNK kinase assay kit (Cell Signaling) per manufacturers instructions. For MAPK4/7 activity measurements, immunoprecipitated kinase was first incubated with inactive JNK2 (Upstate Biotechnology).

It is understood that modifications which do not substantially affect the activity of the various embodiments of this invention are also provided within the definition of the invention provided herein. Accordingly, the above examples are intended to illustrate but not limit the present invention. While the claimed invention has been described in detail and with reference to specific embodiments thereof, it will be apparent to one of ordinary skill in the art that various changes and modifications can be made to the claimed invention without departing from the spirit and scope thereof. Thus, for example, those skilled in the art will recognize, or be able to ascertain, using no more than routine experimentation, numerous equivalents to the specific substances and procedures described herein. Such equivalents are considered to be within the scope of this invention, and are covered by the following claims.

1. A method of identifying a gene that modulates a function or a phenotype associated with tumorigenesis of a cell comprising the following steps:
a. introducing into a cell culture comprising a cell representative of a given phenotype or histological type:
i. a nucleic acid library wherein said library comprises a collection of genetic elements of interest; and
ii. an oncogene, and/or other genetic element associated with the oncogenic process,
to produce a genetically engineered target cell having a cancer cell genotype;
b. transplanting the target cell into a non-human mammal to produce a tumor in the mammal;
c. identifying in the tumor expression of one or more of the genetic elements of interest.

2. The method of claim 1, wherein the cell representative of a given phenotype or histological type is a primary cell.

3. The method of claim 1, wherein said transplanting is orthotopic.

4. The method of claim 2, wherein said primary cell is immortalized.

5. The method of claim 1, wherein the cell representative of a given phenotype or histological type is a mammalian cell.

6. The method of claim 1, wherein the cell representative of a given phenotype or histological type is a progenitor cell or stem cell.

7. The method of claim 1, further comprising inactivating or suppressing one of more tumor suppressor protein pathways in the cell representative of a given phenotype or histological type.

8. The method of claim 7, wherein the tumor suppressor protein pathway is RB and/or p53.

9. The method of claim 1, wherein said nucleic acid library comprises siRNA, shRNA, microRNA or an antisense nucleic acids to the genetic elements of interest.

10. The method of claim 1, wherein said nucleic acid library comprises nucleic acids encoding inactive or dominant negative versions of the genetic elements of interest.

11. The method of claim 1, wherein the target cell is genetically engineered to express TERT.

12. The method of claim 1, wherein the oncogene is selected from the groups consisting of: a BRAF oncogene; a NRAS oncogene; a KRAS oncogene; a PI3K oncogene; a PKCi oncogene; a HER2 oncogene; a APC oncogene; an EGFR oncogene; a PTEN KD oncogene; aNF1 KD oncogene; a Myr-AKT oncogene; a Myr-P110a oncogene; β-catenin oncogene; an EGFRvIII oncogene.

13. The method according to claim 1 wherein the candidate genes or genetic elements of interest comprises kinase genes and/or genetic elements.

14. The method of claim 13, wherein said kinase is a wildtype kinase or an activated mutant kinase.

15. The method according to claim 1, wherein the candidate genes or genetic elements of interest comprises a phosphatase gene and/or genetic elements.

16. The method according to claim 1, wherein the candidate genes or genetic elements of interest comprises a methyltransferase gene and/or genetic elements.

17. The method according to claim 1, wherein the candidate genes or genetic elements of interest comprises genes and/or genetic elements involved in the PI3K signaling pathway.

18. The method according to claim 1, wherein the candidate genes or genetic elements of interest comprises genes and/or genetic elements involved in a G-protein coupled receptor signaling pathway.

19. The method according to claim 1, wherein the candidate genes or genetic elements of interest comprises genes and/or genetic elements involved in the receptor tyrosine kinase signaling pathway.

20. The method of claim 1, wherein said function or a phenotype associated with tumorigenesis is metastasis, cell migration, angiogenesis, extracellular matrix degradation, anchorage-independent growth, or anoikis.

21. The method of claim 1, wherein said method further comprises a validation step wherein the validation step comprises:
d. introducing into the target cells produced in step (a) an nucleic acid capable of modulating the expression of the genetic element identified in step (c) to produced a modified target cell;
e. orthotopically transplanting the modified target cell into a non-human mammal;
f. determining whether the modified target cell reduces tumor formation in the mammal as compared to a control.

22. A method for screening for biologically active agents that interact with an engineered tumorigenesis pathway comprising the following steps:
a. producing a genetically engineered target cell having a cancer cell genotype, said producing step comprising introducing into a cell culture comprising a cell representative of a given phenotype or histological type an oncogene and a one or more genes or genetic elements of interest linked to the oncogenic process associated with the oncogene;
b. contacting the genetically engineered target cell with a candidate biologically active agent; and
c. determining whether the biologically active agent affects the tumorigenic phenotype.

23. The method of claim 22, wherein the tumorigenic phenotype is metastasis, cell migration, angiogenesis, extracellular matrix degradation, anchorage-independent growth, or anoikis.
